(19) United States
(12) Patent Application Publication
(10) Pub. No.: US 2023/0191490 A1
(43) Pub. Date: Jun. 22, 2023

(54) ACCURATE ADDITIVE MANUFACTURING

(71) Applicant: Velo3D, Inc., Campbell, CA (US)

(72) Inventors: Benyamin BULLER, Cupertino, CA (US); Alexander Vladimirovich VARLAKHANOV, San Carlos, CA (US); Sergey KOREPANOV, Los Altos, CA (US); Tasso LAPPAS, Pasadena, CA (US); Erel MILSHTEIN, Cupertino, CA (US); Rueben MENDELSBERG, Hawthorne, CA (US); Zachary Ryan MURPHREE, San Jose, CA (US); Alan Rick LAPPEN, Rio Rancho, NM (US)

(21) Appl. No.: 17/986,814

(22) Filed: Nov. 14, 2022

Related U.S. Application Data
(60) Provisional application No. 63/290,831, filed on Dec. 17, 2021.
(60) Provisional application No. 63/290,878, filed on Dec. 17, 2021.
(60) Provisional application No. 63/419,620, filed on Oct. 26, 2022.

(51) Int. Cl. B22F 10/37; B22F 12/30; B22F 12/45; B22F 12/90; B22F 10/85; B33Y 30/00; B33Y 50/02

(52) U.S. Cl. CPC B22F 10/37; B22F 12/30; B22F 12/45; B22F 12/90; B22F 10/85; B33Y 30/00; B33Y 50/02; B22F 2201/11; B22F 2201/02

(57) ABSTRACT

The present disclosure provides three-dimensional (3D) printing systems, apparatuses, software, and devices for the production of at least one requested 3D object in a printing cycle, e.g., a control system. The 3D printing includes, or is operatively coupled to, a metrological detection system configured to facilitate assessment of at least one characteristic of the 3D printing, e.g., relating to height. The 3D printing includes synchronization of various operations, and resulting objects printed in the 3D printing system.

### PRIORITY APPLICATIONS

This patent application claims priority to U.S. Provisional Patent Application Ser. No. 63/290,831 filed on Dec. 17, 2021, U.S. Provisional Patent Application Ser. No. 63/290,878 filed on Dec. 17, 2021, and to U.S. Provisional Patent Application Ser. No. 63/419,620 filed on Oct. 26, 2022, each of which is entirely incorporated herein by reference.

### BACKGROUND

Three-dimensional (3D) printing (e.g., additive manufacturing) is a process for making three-dimensional (3D) object(s) of any shape from a design. The design may be in the form of a data source such as an electronic data source or may be in the form of a hard copy. The hard copy may be a two-dimensional representation of a 3D object. The data source may be an electronic 3D model. 3D printing may be accomplished through an additive process in which successive layers of material are laid down one on top of another. This process may be controlled e.g., computer controlled, manually controlled, or both. A 3D printer can be an industrial robot.

3D printing can generate custom parts, e.g., quickly and efficiently. A variety of materials can be used in a 3D printing process including elemental metal, metal alloy, ceramic, an allotrope of elemental carbon, resin, or polymeric material. In some 3D printing processes (e.g., additive manufacturing), a first layer of hardened material is formed, and thereafter successive layers of hardened material are added one by one, wherein each new layer of hardened material is added on a pre-formed layer of hardened material, until the requested three-dimensional structure (3D object) is layer-wise materialized.

3D models may be created with a computer aided design package, via 3D scanner, or manually. The manual modeling process of preparing geometric data for 3D computer graphics may be similar to plastic arts, such as sculpting or animating. 3D scanning is a process of analyzing and collecting digital data on the shape and appearance of a real object (e.g., a real-life object). Based on this data, 3D models of the scanned object can be produced.

A number of 3D printing processes are currently available. They may differ in the manner layers are deposited to create the materialized 3D structure (e.g., hardened 3D structure). They may vary in the material or materials that are used to physically materialize the designed 3D object. Some methods melt, sinter, or soften material to produce the layers that form the 3D object. Examples for 3D printing methods include selective laser melting (SLM), selective laser sintering (SLS), direct metal laser sintering (DMLS), shape deposition manufacturing (SDM) or fused deposition modeling (FDM). Other methods cure liquid materials using different technologies such as stereo lithography (SLA). In the method of laminated object manufacturing (LOM), thin layers (made inter alia of paper, polymer, or metal) are cut to shape and joined together.

At times, at least a portion of a layer within the printed three-dimensional (abbreviated herein as “3D”) object may bend, warp, roll, curl, or otherwise deform during the 3D printing process. In some instances, it is requested to control the way at least a portion of a layer of hardened material (e.g., 3D object) is formed. For example, at times it is requested to control the deformation of at least a layer within the 3D object. The control may include control of the degree and/or direction of the deformation. In some instances, it may be requested to control the deformation of at least a surface of the 3D object. It may be requested to control the 3D object during its formation (e.g., in real-time). At times, it may be requested to control the formation of the 3D object using open loop control, closed loop control, or any combination thereof. At times, it may be requested to control the formation of the 3D object using feed forward control, feedback control, or any combination thereof. The present disclosure delineates detection, control, or both detection and control, of at least the (e.g., afore-mentioned) deformations disclosed herein using at least one of the (e.g., afore-mentioned) control methodologies disclosed herein. The present disclosure delineates reduction (e.g., attenuation and/or prevention) of at least the (e.g., afore-mentioned) degree and/or direction of deformations disclosed herein, using various detection and/or control methodologies. Some of the methodologies utilized in the 3D printing, require energy beams, e.g., that require synchronization. Such synchronization is required during the 3D printing, e.g., to ensure that the object(s) is printed as directed and as requested. The energy beams are controlled by a control system that directs the energy beam, e.g., using several controllers. The controllers should be also synchronized for this purpose. Such synchronization may be required amongst the controllers and amongst the energy beams. The complexity of synchronization may become greater as the number of energy beams and/or controllers increase. The synchronization may become challenging the more layers are printed in a printing cycle, e.g., the larger the printed 3D object is.

Some 3D printing methodologies utilize a material bed to print the 3D object. The material bed may be layerwise deposited, e.g., using a layer dispensing mechanism such as a recoater. Deviation of the exposed surface of the material bed from planarity may present a challenge in printing an accurate 3D object, e.g., with respect to its intended purpose. For example, deviation from planarity may cause defects in the material properties and/or external dimensionality of the resulting 3D object. During the 3D printing, objects may deform (e.g., as delineated above). The deformation may cause portion(s) of the forming 3D object to protrude from the exposed surface, e.g., in an unexpected manner. Such protrusions may cause defects in the material properties and/or external dimensionality of the resulting 3D object, e.g., when the build continues without modification in the printing instructions. Such protrusion may be harmful to the layer dispensing mechanism, e.g., when the layer dispensing mechanism contacts the protruding 3D object, and/or its movement is obstructed by the protruding 3D object. The harm to the layer dispensing mechanism may cause it to become defective (e.g., in operational) such as requiring maintenance or replacement. Such maintenance or replacement may entail pausing or restarting the printing cycle. When the build task is large, this may result in substantial loss of resources (e.g., time, material, labor, and/or money). For this and other reasons, it may be beneficial (I) to minimize such protrusions detect such protrusions, (II) to anticipate such protrusions (e.g., accurately), (III) detect such protrusions in real time during the 3D printing, or any combination of (I), (II), and (III).

### SUMMARY

In some aspects, the present disclosure delineates methods, systems, devices, apparatuses, and/or software that alleviate the above hardships. For example, synchronizing energy beams and/or control boards. For example, using a metrology detector with detectors and/or projectors, which metrology detector (e.g., height mapper) operates in real time during the 3D printing to provide an assessment of the planarity of a target surface such as an exposed surface of a material bed. For example, that allow modeling of 3D objects with a reduced amount of design constraints (e.g., no design constraints). The present disclosure delineates methods, systems, apparatuses, and software that allow materialization (e.g., printing) of these 3D object models.

In other aspects disclosed herein are methods, systems, apparatuses, devices, and/or software for generating a 3D object with a controlled degree of deformation. In some embodiments, the controlled degree comprises controlling the amount and/or direction of deformation. In some embodiments, the controlled degree comprises controlling the type of deformation. In some embodiments, the deformation comprises a curvature. In some embodiments, the curvature is a curvature of at least a portion of a layer within the 3D object.

In other aspects disclosed herein are methods, systems, apparatuses, devices, and/or software for generating a 3D object with a reduced degree of deformation (e.g., substantially non-deformed). In some embodiments, the 3D object is devoid of auxiliary support (e.g., devoid of one or more auxiliary supports), or comprise of one or more auxiliary supports. In some embodiments, the 3D object is devoid of a mark indicating the prior presence of auxiliary support (e.g., one or more auxiliary supports).

In other aspects disclosed herein are methods, systems, apparatuses, devices, and/or software for generating a 3D object with a smooth (e.g., polished, continuous, or regular) and/or planar (e.g., non-warped) bottom surface (e.g., bottom skin). In some embodiments, the bottom skin has a different central tendency of roughness as the upper skin of the 3D object. In some embodiments, the bottom skin has (e.g., substantially) the same central tendency of roughness as the upper skin of the 3D object.

In another aspect, a device for three-dimensional printing, the device comprises at least three components comprising (i) a first projector, (ii) a second projector, (iii) a first detector or (iv) a second detector, the device being configured to detect deviation from planarity of a target surface such as an exposed surface of a material bed, e.g., utilized for the three-dimensional printing. Some of the aspects below disclose devices, methods, apparatuses, and/or program instructions particularizing three of the at least three components. For example, the device comprising at least three component comprising (i) a first projector, (ii) a first detector and (iii) a second detector. For example, the device comprising at least three component comprising (i) a first detector, (ii) a first projector and (iii) a second projector. In some embodiments, the device for three-dimensional printing comprises: at least three component comprising (i) a first projector, (ii) a second projector, (iii) a first detector or (iv) a second detector, the device being configured to detect at least one optical variation corresponding to a physical variation in uniformity of an exposed surface of a material bed utilized in the three-dimensional printing, the material bed supported by a build platform. In some embodiments, the first detector is distant (e.g., disposed at a gap) from the second detector. In some embodiments, the first projector is distant (e.g., disposed at a gap) from the second projector. In some embodiments, the first detector being distant (e.g., disposed at a gap) from the second detector, and the first projector being distant (e.g., disposed at a gap) from the second projector. In some embodiments the first projector is disposed between (e.g., interlaced with) the first detector and the second detector. In some embodiments the first detector is disposed between (e.g., interlaced with) the first projector and the second projector. In some embodiment projectors comprise the first projector and the second projector. In some embodiment detectors comprise the first detector and the second detector. In some embodiment the detector(s) are interleaved, interlaced, staggered, or disposed interchangeably with respect to the projector(s). For example, at least one of the projectors is interleaved the detectors. For example, at least one of the detectors is interleaved the projectors. In some embodiments, the first projector configured to project a first light pattern on the exposed surface of the material bed. In some embodiments, the second projector configured to project a second light pattern on the exposed surface of the material bed. In some embodiments, the first detector configured to optically detect (I) at least a first portion of the first light pattern appearing on the exposed surface and (II) a first variation between the first portion of the first light pattern detected and a corresponding at least the first portion of the first light pattern projected, the first variation corresponding to variation in uniformity of the exposed surface, the first detector disposed adjacent to the build platform. In some embodiments, the second detector configured to optically detect (I) at least a second portion of the second light pattern appearing on the exposed surface and (II) a second variation between the first portion of the first light pattern detected and a corresponding at least the second portion of the second light pattern projected, the second variation corresponding to variation in uniformity of the exposed surface, the second detector disposed adjacent to the build platform.

In another aspect, a device for three-dimensional printing, the device comprising: at least three components comprising (i) a first projector, (ii) a second projector, (iii) a first detector or (iv) a second detector, the device being configured to detect at least one optical variation corresponding to a physical variation in uniformity of an exposed surface of a material bed utilized in the three-dimensional printing, the material bed supported by a build platform; each of the at least three components is separated by at least one gap; the first projector configured to project a first light pattern on the exposed surface of the material bed; the second projector configured to project a second light pattern on the exposed surface of the material bed; the first detector configured to optically detect (I) at least a first portion of the first light pattern appearing on the exposed surface and (II) a first variation between the first portion of the first light pattern detected and a corresponding at least the first portion of the first light pattern projected, the first variation corresponding to variation in uniformity of the exposed surface, the first detector disposed adjacent to the build platform; and the second detector configured to optically detect (A) at least a second portion of the second light pattern appearing on the exposed surface and (B) a second variation between the first portion of the first light pattern detected and a corresponding at least the second portion of the second light pattern projected, the second variation corresponding to variation in uniformity of the exposed surface, the second detector disposed adjacent to the build platform. In some embodiments, the device comprises (i) the first projector. (ii) the first detector and (iii) the second detector. In some embodiments, the first detector is distanced from the second detector by the at least one gap such that during optical detection the device optically detects the exposed surface without becoming saturated, e.g., due to specular reflection. In some embodiments, the device comprises (i) the first projector, (ii) the second projector, and (iii) the first detector. In some embodiments, the first projector is distanced from the second projector by the at least one gap such that during optical detection the device is configured to optically detects the exposed surface without becoming saturated, e.g., due to specular reflection. In some embodiments, at least two of the at least three components are symmetrically related to each other in a symmetrical relationship; and optionally wherein (I) symmetrically related to each other is through a third component of the at least three components, (II) the symmetrical relationship comprises a mirror plane, a C2 rotational symmetry, or an inversion symmetry point, or (III) a combination of (I) and (II). In some embodiments, the first detector and/or the second detector, is configured to differentiate between uniformity along a length and/or a width of the material bed. In some embodiments, the device is part of, or is operatively coupled to, a three-dimensional printing system utilized in the three-dimensional printing. In some embodiments, the at least three components are disposed successively along a direction; and optionally wherein the at least three components are disposed successively in a single file. In some embodiments, the at least three components are disposed in a plane (i) above to the build platform, (ii) parallel or substantially parallel to the build platform, (iii) among optical windows configured to project energy beams to form at least one three-dimensional object above the build platform during the three-dimensional printing, or (iv) any combination of (i) (ii) and (iii); and wherein above is in a direction opposite to a gravitational center of an external environment to a three-dimensional printing system comprising the build platform, and the optical windows. In some embodiments, the light pattern projected comprises a repeating unit. In some embodiments, the device is included in, or is operatively coupled to, a three-dimensional printing system configured for the three-dimensional printing comprising generating one or more melt pools and controlling a temperature of a melt pool of the one or more melt pools. In some embodiments, the three-dimensional printing system is configured to (A) control the temperature of the melt pool (1) in real time during the three-dimensional printing and/or (II) utilizing feed forward control using a physics model of at least one process as part of the three-dimensional printing. In some embodiments, (A) the three-dimensional printing system is configured to communicate between (I) a processor disposed at the three-dimensional printing site and (II) a processor disposed remotely and separate from the three-dimensional printing site; and/or (B) the device is configured to operatively couple to a layer dispensing mechanism that comprises, or that is operatively coupled to, a cyclonic separator. In some embodiments, the device is configured to facilitate synchronizing energy beams utilized for the three-dimensional printing using (i) visible markers and/or (ii) markers removable by a layer dispensing mechanism utilized to dispense the material bed; and wherein synchronizing is of (1) the energy beams with respect to each other, (II) each of the energy beams with respect to its controller, and/or (III) each of the energy beams with respect to its scanner, the device being configure to facilitate the synchronization at least in part by using the first detector and/or the second detector. In some embodiments, the material bed is disposed in an enclosure comprising an atmosphere including (i) a positive pressure above an ambient pressure external to the enclosure and/or (ii) a reactive species at a level below its level in an ambient atmosphere external to the enclosure, which reactive species reacts with pre-transformed material during printing; wherein the device is configured to operate during the three-dimensional printing; optionally wherein the reactive species comprises oxygen or water; optionally wherein the atmosphere of the enclosure comprises an inert gas; and optionally wherein the inert gas comprises argon or nitrogen. In some embodiments, the at least one gap comprises (i) two gaps that are of the same distance or substantially of the same distance or (ii) two different gaps of two different distances.

In another aspect, a method for three-dimensional printing, the method comprising executing one or more operations associated with at least one configuration of the device above (e.g., any of the devices above).

In another aspect, an apparatus for three-dimensional printing, the apparatus comprising at least one controller, the at least one controller being configured (i) operatively couple to the device above (e.g., any of the devices above), and (ii) direct executing one or more operations associated with at least one configuration of the device. In some embodiments, the at least one controller comprises an electrical connector. In some embodiments, the at least one controller comprises electrical circuitry. In some embodiments, the power connector comprises an electrical inlet or an electrical outlet. In some embodiments, the power connector comprises an electrical plug or an electrical socket.

In another aspect, non-transitory computer readable program instructions for three-dimensional printing, the non-transitory computer readable program instructions, when read by one or more processors operatively coupled to the device above (e.g., any of the devices above), cause the one or more processors to direct executing one or more operations associated with at least one configuration of the device. In some embodiments, the non-transitory computer readable program instructions being inscribed on a medium or on media.

In another aspect, a device for three-dimensional printing, the device comprises at least three components comprising (i) a first projector, (ii) a first detector and (iii) a second detector, the device being configured to detect deviation from planarity of a target surface such as an exposed surface of a material bed, e.g., utilized for the three-dimensional printing. In some embodiments, a device for three-dimensional printing comprises: a (e.g., first) projector configured to project a light pattern on an exposed surface of a material bed during the three-dimensional printing, the light pattern comprising areas of various levels of light intensity, the projector being disposed adjacent to a build platform supporting the material bed, the build platform being disposed in a three-dimensional printer; a first detector configured to optically detect (1) at least a first portion of the light pattern appearing on the exposed surface and (II) a first variation between the first portion of the light pattern detected and a corresponding at least the first portion of the light pattern projected, the first variation corresponding to variation in uniformity of the exposed surface, the first detector disposed adjacent to the build platform; and a second detector configured to optically detect (i) at least a second portion of the light pattern appearing on the exposed surface and (ii) a second variation between the second portion of the light pattern detected and a corresponding at least the second portion of the light pattern projected, the variation corresponding to the variation in uniformity of the exposed surface, the second detector being disposed adjacent to the build platform, and the first detector being distant (e.g., disposed at a gap) from the second detector. In some embodiments, the first detector and/or the second detector is configured to differentiate between uniformity along a length and/or a width of the material bed. In some embodiments, the projector is configured to project the light pattern such that it is altered over time. In some embodiments, the projector is configured to project the light pattern such that it is stable and/or unaltered over time. In some embodiments, the at least the first portion of the light pattern, and the at least the second portion of the light pattern are (e.g., substantially) the same. In some embodiments, the at least the first portion of the light pattern, and the at least the second portion of the light pattern are different. In some embodiments, the at least the first portion of the light pattern, and the at least the second portion the light pattern overiap each other or contract each other. In some embodiments, the device is part of, or is operatively coupled to, the three-dimensional printer. In some embodiments the first projector is disposed between (e.g., interlaced with) the first detector and the second detector. In some embodiments, the first detector is distant (e.g., disposed at a gap) from the second detector. In some embodiment, the distance placement is at least in part to facilitate (e.g., such that) capturing variation from the light pattern when the variation causes saturation of the first detector or of the second detector. In some embodiments, the light pattern projected comprises an oscillating light pattern. In some embodiments, the light pattern projected comprises a repeating unit. In some embodiments, the light pattern projected comprises is devoid of a repeating unit. In some embodiments, the material bed is disposed in an enclosure comprising an atmosphere including (i) a positive pressure above an ambient pressure external to the enclosure and/or (ii) a reactive species at a level below its level in an ambient atmosphere external to the enclosure, which reactive species reacts with pre-transformed material during printing; where the device is configured to operate (e.g., at least in part in the enclosure) during the three-dimensional printing. In some embodiments, the method is performed in the enclosure. In some embodiments, the reactive species comprises oxygen or nitrogen. In some embodiments, the atmosphere of the enclosure comprises an inert gas. In some embodiments, the where the inert gas comprises argon or nitrogen. In some embodiments, the device is configured to facilitate assessment of an alteration of at least one characteristic of the three-dimensional printing based at least in part on detection of the first detector and/or the second detector, the assessment being performed in real-time during the three-dimensional printing of a first portion of at least one three-dimensional object in the material bed. In some embodiments, the device is configured to facilitate using the assessment to generate a second portion of the three-dimensional object by the three-dimensional printing. In some embodiments, the first detector is followed by the projector that is followed by the second detector disposed successively along a direction. In some embodiments, the first detector is followed by the projector that is followed by the second detector disposed successively in a single file. In some embodiments, the device is configured to, during the printing, translate in a translation at least one component comprising (i) the first detector. (ii) the (e.g., first) projector or (iii) the second detector. In some embodiments, the device is configured to translate the at least one component continuously. In some embodiments, the device is configured to translate the at least one component discretely. In some embodiments, at least one component is stationary during the printing, the at least one component comprising (i) the first projector, (ii) the detector or (iii) the second projector. In some embodiments, the first detector and/or the second detector comprises a camera. In some embodiments, the camera comprises a charged-coupled device (CCD) camera. In some embodiments, the material bed and/or at least one three-dimensional object comprises elemental metal, metal alloy, ceramic, or an allotrope of elemental carbon. In some embodiments, the material bed comprises powder. In some embodiments, the device is configured to operate between printing of two successive layers of at least one three-dimensional object (e.g., in the material bed). In some embodiments, the at least one three-dimensional object is printed by the three-dimensional printing in a processing chamber configured for accommodating (i) an atmosphere more inert than an ambient atmosphere outside of the processing chamber, and (ii) a pressure above ambient pressure outside of the processing chamber. In some embodiments, the device is configured to facilitate printing one or more three-dimensional objects in an atmosphere maintained to be different from an ambient atmosphere by at least one characteristic, the ambient atmosphere being external to a build module and to a processing chamber. In some embodiments, the at least one characteristic comprises (i) a pressure above a pressure presiding in the ambient atmosphere, or (ii) a reactive agent being at a concentration lower than its concentration in the ambient atmosphere, the reactive agent being reactive with a starting material of the three-dimensional printing at least during the three-dimensional printing. In some embodiments, the first detector, the projector, and the second detector are coupled to a processing chamber. In some embodiments, the first detector, the projector, and the second detector are disposed external to the processing chamber. In some embodiments, the first detector, the projector, and the second detector are coupled to the processing chamber by one or more optical windows. In some embodiments, the first detector, the projector, and the second detector are coupled to the processing chamber by a first optical window, a second optical window, and a third optical window respectively. In some embodiments, the first detector, the projector, and the second detector are coupled to a roof of a processing chamber. In some embodiments, the first detector, the projector, and the second detector are coupled to a processing chamber and are disposed in a plane opposing the exposed surface of the material bed. In some embodiments, the first detector, the projector, and the second detector are disposed among energy beams utilized to print at least one three-dimensional object. In some embodiments, the first detector, the projector, and the second detector are coupled to a processing chamber by one or more optical windows disposed among optical windows of energy beams utilized to print at least one three-dimensional object. In some embodiments, the energy beams are more than two, four, six, or eight energy beams. In some embodiments, the device where the material bed comprises at least one fundamental length scale having a value of at least about 400 mm, 600 mm, 1000 mm, 1200, 1500, or 1750 mm. In some embodiments, the device where the material bed has a weight of at least about 1000 kg. In some embodiments, the three-dimensional printer is configured to facilitate the three-dimensional printing at least in part by facilitating vertical translation of the material bed supported by the build platform comprising an error in vertical positioning of the vertical translation at most about 10%, 5%, or 2% of the vertical translation of the build platform. In some embodiments, the device where the device is configured to facilitate the three-dimensional printing that comprises deposition of pre-transformed material on the exposed surface of the material bed. In some embodiments, the device further comprises a remover configured to remove a second portion of the deposited pre-transformed material from the exposed surface to generate a planar layer of pre-transformed material as part of the material bed. In some embodiments, the remover is operatively coupled to an attractive force source sufficient to attract the pre-transformed material from the exposed surface. In some embodiments, the attractive force comprises a magnetic, electric, electrostatic, or vacuum source. In some embodiments, the attractive force comprises a vacuum source. In some embodiments, the device is configured to operatively couple to a recycling system that (i) recycles at least a fraction of a portion of pre-transformed material removed by the remover and/or (ii) provides at least a portion of the pre-transformed material utilized by a dispenser. In some embodiments, the second portion removed by the remover is at least about 70%, 50% or 30% of the deposited pre-transformed material. In some embodiments, the fraction recycled is at least about 70% or 90% of the portion removed by the remover. In some embodiments, the device where the device is configured to facilitate deposition of pre-transformed material on the exposed surface at least in part by layerwise deposition. In some embodiments, the device where the device is configured to deposit pre-transformed material comprising powder material. In some embodiments, the device where the device is configured to deposit pre-transformed material comprising elemental metal, metal alloy, ceramic, or an allotrope of carbon. In some embodiments, the device where the device is configured to operate under a positive pressure atmosphere relative to an ambient atmosphere external to the device. In some embodiments, the device where the device is configured to operate under an atmosphere depleted of a reactive agent relative to its concentration in an ambient atmosphere external to the device, the reactive agent being configured to react with a starting material of the three-dimensional printing at least during the three-dimensional printing. In some embodiments, the device where the reactive agent comprises oxygen, water, or hydrogen sulfide. In some embodiments, the device where the device further comprises an enclosure operatively coupled to, or comprising, a seal. In some embodiments, the device where the seal is included, or is operatively coupled to a shutter, a lid, a closure, an envelope, or a flap. In some embodiments, the device where the seal is a hermetic seal. In some embodiments, the device where the seal is configured to facilitate retaining an internal atmosphere in the enclosure for a time period, the internal atmosphere being different from an ambient atmosphere external to the enclosure. In some embodiments, the device where the seal is configured to facilitate retaining for a time period (i) a positive pressure within the enclosure relative to an ambient atmosphere external to the device and/or (ii) a reactive agent at a concentration lower than its concentration in an ambient atmosphere external to the enclosure, the reactive agent being configured to at least react with pre-transformed material of the three-dimensional printing during the three-dimensional printing. In some embodiments, the device where the time period is at least a same or greater value than a time period to remove the three-dimensional objects from a build module body. In some embodiments, the device is configured to facilitate three-dimensional printing, where a portion of the three-dimensional printing comprises connecting particulate matter to facilitate printing the at least one three-dimensional object. In some embodiments, at least a portion of the particulate matter is disposed in the material bed during the three-dimensional printing. In some embodiments, the portion of the three-dimensional printing comprises a fusing process. In some embodiments, fusing comprises (i) sintering, (ii) melting, (iii) smelting, or (iv) any combination of (i) (ii) and (iii). In some embodiments, the particulate matter comprises a super alloy. In some embodiments, the super alloy comprises Inconel, In718, Ti64, F357, Haynes282, GRCop-42, C22, CA6NM, or Hastelloy-X. In some embodiments, the device is operatively coupled to a layer dispensing mechanism that comprises, or that is operatively coupled to, a cyclonic separator. In some embodiments, the device is included in, or is operatively coupled to, a three-dimensional printing system configured for the three-dimensional printing comprising generating one or more melt pools and controlling a temperature of a melt pool of the one or more melt pools. In some embodiments, the three-dimensional printer is configured to control the temperature of the melt pool (i) in real time during the 3D printing and/or (ii) utilizing feed forward control using a physics model of at least one process as part of the three-dimensional printing. In some embodiments, the three-dimensional printer is configured to communicate between (I) a processor disposed at the three-dimensional printing site and (II) a processor disposed remotely and separate from the three-dimensional printing site. In some embodiments, the device is configured to facilitate synchronizing energy beams utilized for the three-dimensional printing using (i) visible markers and/or (ii) markers removable by a layer dispensing mechanism utilized to dispense the material bed; and where synchronizing is of (1) the energy beams with respect to each other, (II) each of the energy beams with respect to its controller, and/or (III) each of the energy beams with respect to its scanner, the device being configure to facilitate the synchronization at least in part by using the first detector and/or the second detector. In some embodiments, the device is operatively coupled to circuit boards, each of the circuit boards comprises a controller configured to control an energy beam utilized in the three-dimensional printing, where the controller is configured for synchronization using one or more time synchronization methodologies. In some embodiments, the controller is configured for synchronization using one or more time synchronization methodologies comprising (i) synchronizing barriers or (ii) an oscillating crystal. In some embodiments, at least one component comprises (i) the first detector, (ii) the projector or (iii) the second detector. In some embodiments, the at least one component is stationary during the printing, where stationary is with respect to a horizontal location of the build platform. In some embodiments, the device is configured to, during the printing, translate the at least one component with respect to a horizontal location of the build platform. In some embodiments, the at least one component are aligned relative to each other. In some embodiments, components of the at least one component are arranged symmetrically with respect to each other.

In another aspect, a method for three-dimensional printing, the method comprises: projecting a light pattern, with a projector, on an exposed surface of a material bed during the three-dimensional printing, the light pattern comprising areas of various levels of light intensity the projector being disposed adjacent to a build platform supporting the material bed, the build platform being disposed in a three-dimensional printer, optically detecting, with a first detector, (1) at least a first portion of the light pattern appearing on the exposed surface and (II) a first variation between the first portion of the light pattern detected and a corresponding at least the first portion of the light pattern projected, the first variation corresponding to variation in uniformity of the exposed surface, the first detector disposed adjacent to the build platform; and optically detecting, with a second detector, (i) at least a second portion of the light pattern appearing on the exposed surface and (ii) a second variation between the second portion of the light pattern detected and a corresponding at least the second portion of the light pattern projected, the variation corresponding to the variation in uniformity of the exposed surface, the second detector being disposed adjacent to the build platform; the first detector being distant (e.g., disposed at a gap) from the second detector. In some embodiments, the method where the first detector and/or the second detector is configured to differentiate between uniformity along a length and/or a width of the material bed. In some embodiments, the method where the at least the first portion of the light pattern, and the at least the second portion of the light pattern are (e.g., substantially) the same. In some embodiments, the method where the at least the first portion of the light pattern, and the at least the second portion of the light pattern are different. In some embodiments, the method where the at least the first portion of the light pattern, and the at least the second portion the light pattern overlap each other or contract each other. In some embodiments, the method where the first detector is distant (e.g., disposed at a gap) from the second detector. In some embodiment, the distance placement is at least in part to facilitate (e.g., such that) capturing variation from the light pattern when the variation causes saturation of the first detector or of the second detector. In some embodiments, the method where the light pattern comprises an oscillating light pattern. In some embodiments, the method where the light pattern projected comprises a repeating unit. In some embodiments, the method where the light pattern projected comprises is devoid of a repeating unit. In some embodiments, the method where the material bed is disposed in an enclosure comprising an atmosphere including (i) a positive pressure above an ambient pressure external to the enclosure and/or (ii) a reactive species at a level below its level in an ambient atmosphere external to the enclosure, which reactive species reacts with pre-transformed material during printing; where the method is performed at least in part in the enclosure. In some embodiments, the reactive species comprise oxygen or water. In some embodiments, the atmosphere of the enclosure comprises an inert gas. In some embodiments, the inert gas comprises argon or nitrogen. In some embodiments, the method facilitates (e.g., comprises) assessment of an alteration of at least one characteristic of the three-dimensional printing based at least in part on detection of the first detector and/or the second detector, and performing the assessment in real-time during the three-dimensional printing of a first portion of at least one three-dimensional object in the material bed. In some embodiments, the method facilitates using the assessment to generate a second portion of the three-dimensional object by the three-dimensional printing. In some embodiments, the method where the first detector is followed by the projector that is followed by the second detector disposed successively. In some embodiments, the first detector is followed by the projector that is followed by the second detector disposed successively in a single file. In some embodiments, the method further comprises, during the printing, translating at least one component comprising (i) the first projector, (ii) the detector or (iii) the second projector. In some embodiments, the method where the at least one component is stationary during the printing. In some embodiments, the method where the first detector and/or the second detector is a camera. In some embodiments, the camera comprises a charged-coupled device (CCD) camera. In some embodiments, the method where the material bed and/or at least one three-dimensional object comprises elemental metal, metal alloy, ceramic, or an allotrope of elemental metal. In some embodiments, the method where the material bed comprises powder. In some embodiments, the method further comprises, performing the method between printing two successive layers of at least one three-dimensional object in the material bed. In some embodiments, the method where printing at least one three-dimensional object is in a processing chamber configured for accommodating (i) an atmosphere more inert than an ambient atmosphere outside of the processing chamber, and (ii) a pressure above ambient pressure outside of the processing chamber. In some embodiments, the method where the first detector, the projector, and the second detector are coupled to a processing chamber. In some embodiments, the first detector, the projector, and the second detector are disposed external to the processing chamber. In some embodiments, the first detector, the projector, and the second detector are coupled to the processing chamber by one or more optical windows. In some embodiments, the first detector, the projector, and the second detector are coupled to the processing chamber by a first optical window, a second optical window, and a third optical window respectively. In some embodiments, the method where the first detector, the projector, and the second detector are coupled to a roof of a processing chamber. In some embodiments, the method where the first detector, the projector, and the second detector are coupled to a processing chamber and oppose the exposed surface of the material bed. In some embodiments, the method where the first detector, the projector, and the second detector are coupled to a processing chamber and are disposed in a plane opposing the exposed surface of the material bed. In some embodiments, the method where the first detector, the projector, and the second detector are disposed among energy beams utilized to print at least one three-dimensional object. In some embodiments, the method where the first detector, the projector, and the second detector are coupled to a processing chamber by one or more optical windows disposed among optical windows of energy beams utilized to print at least one three-dimensional object. In some embodiments, the energy beams are more than two, four, six, or eight energy beams. In some embodiments, the method further comprises dispensing the material bed using a layer dispensing mechanism comprises, or is operatively coupled to, a cyclonic separator. In some embodiments, the three-dimensional printing comprises generating one or more melt pools and controlling a temperature of a melt pool of the one or more melt pools. In some embodiments, the three-dimensional (3D) printing comprises controlling the temperature of the melt pool (i) is in real time during the 3D printing and/or (ii) utilizes feed forward control using a physics model of at least one process as part of the 3D printing. In some embodiments, the three-dimensional printing comprises communication between (1) a processor disposed at the three-dimensional printing site and (II) a processor disposed remotely and separate from the three-dimensional printing site. In some embodiments, the method further comprises synchronizing energy beams utilized for the three-dimensional printing using (i) visible markers and/or (ii) markers removable by a layer dispensing mechanism utilized to dispense the material bed; and where synchronizing is of (1) the energy beams with respect to each other, (II) each of the energy beams with respect to its controller, and/or (III) each of the energy beams with respect to its scanner. In some embodiments, the method further comprises synchronizing controllers disposed at different circuit boards using one or more time synchronization methodologies, the controllers configured to control energy beams utilized for the three-dimensional printing. In some embodiments, the one or more synchronization methodologies comprise (i) synchronizing barriers or (ii) an oscillating crystal. In some embodiments, at least one component comprises (i) the first projector, (ii) the detector or (iii) the second projector. In some embodiments, the method further comprises, during the printing, translating the at least one component, where the translation is with respect to a horizontal location of the build platform. In some embodiments, the at least one component are aligned relative to each other. In some embodiments, components of the at least one component are arranged symmetrically with respect to each other.

In another aspect, an apparatus for three-dimensional printing, the apparatus comprising at least one controller configured to perform, or direct performance of, any of the methods above; where the at least one controller is configured to (i) operatively couple to the projector, the first detector and the second detector, and (ii) direct the projector, the first detector and the second detector. In some embodiments, the at least one controller is configured to (1) operatively couple to and (II) direct; a camera, and/or energy beams. In some embodiments, the camera is the one utilized in a metrology detector (e.g., height mapper). In some embodiments, the camera is the first detector or the second detector. In some embodiments, the apparatus where the at least one controller comprises at least one connector configured to connect to a power source. In some embodiments, the apparatus where the at least one controller is configured to operatively couple to a power source at least in part by (I) having a power socket and/or (II) being configured for wireless power transfer using inductive charging. In some embodiments, the apparatus where the at least one controller is included in, or comprises, a hierarchical control system. In some embodiments, the apparatus where the hierarchical control system comprises at least three hierarchical control levels. In some embodiments, the apparatus where the at least one controller is included in a control system configured to control a three-dimensional printer that prints one or more three-dimensional objects. In some embodiments, the apparatus where the at least one controller is configured to (i) operatively couple to an other component of the three-dimensional printing system and (ii) direct operation of the other component. In some embodiments, the apparatus where the at least one controller is configured to direct operation of the other component at least in part for participation of the other component in three-dimensional printing. In some embodiments, the apparatus where the at least one controller is operatively coupled to at least about 900, or 1000 sensors operatively couple to the three-dimensional printer. In some embodiments, the apparatus where the at least one controller is configured to control a pressure in the three-dimensional printer to be above ambient pressure external to the three-dimensional printer. In some embodiments, the apparatus where the at least one controller is configured to control an internal atmosphere of the three-dimensional printer to be depleted of a reactive agent relative to its concentration in an ambient atmosphere external to the three-dimensional printer, the reactive agent being configured to react with a starting material of the three-dimensional printing at least during the three-dimensional printing.

In another aspect, an apparatus for three-dimensional printing, the apparatus comprising at least one controller configured to: direct a projector to project an light pattern on an exposed surface of a material bed during the three-dimensional printing, the light pattern comprising areas of various levels of light intensity, the projector disposed adjacent to the material bed as part of a three-dimensional printer-direct a first detector to optically detect, (I) at least a first portion of the light pattern appearing on the exposed surface and (II) a first variation between the first portion of the light pattern detected and a corresponding at least the first portion of the light pattern projected, the first variation corresponding to variation in uniformity of the exposed surface, the first detector disposed adjacent to a build platform; and direct a second detector to optically, (i) at least a second portion of the light pattern appearing on the exposed surface and (ii) a second variation between the second portion of the light pattern detected and a corresponding at least the second portion of the light pattern projected, the variation corresponding to the variation in uniformity of the exposed surface, the second detector being disposed adjacent to the build platform; the first detector being distant (e.g., disposed at a gap) from the second detector. In some embodiments, the apparatus where the at least one controller comprises circuitry. In some embodiments, the apparatus where the at least one controller comprises at least one connector configured to connect to a power source. In some embodiments, the apparatus where the at least one controller is configured to operatively couple to a power source at least in part by (I) having a power socket and/or (II) being configured for wireless power transfer using inductive charging. In some embodiments, the apparatus where the at least one controller is part of, or is operatively coupled to, a hierarchical network of controllers. In some embodiments, the hierarchical network of controllers comprises three or more control hierarchical control levels. In some embodiments, the apparatus where the at least one controller comprises a microcontroller. In some embodiments, the apparatus where the at least one controller is configured to control, or direct control of, the three-dimensional printing.

In another aspect, non-transitory computer readable program instructions for three-dimensional printing, the non-transitory computer readable program instructions, when read by one or more processors cause the one or more processors to execute, or direct execution of, any of the methods above. In some embodiments, the one or more processors are configured to operatively couple to: a camera and/or energy beams, and where the program instructions are configured to respectively direct the camera and the energy beams. In some embodiments, the non-transitory computer readable program instructions where the program instructions are inscribed in one or more media.

In another aspect, non-transitory computer readable program instructions for three-dimensional printing, the non-transitory computer readable program instructions, when read by one or more processors cause the one or more processors to execute operations comprising: directing a projector to project an light pattern on an exposed surface of a material bed during the three-dimensional printing, the light pattern comprising areas of various levels of light intensity, the projector disposed adjacent to the material bed as part of a three-dimensional printer; directing a first detector to optically detect, (I) at least a first portion of the light pattern appearing on the exposed surface and (II) a first variation between the first portion of the light pattern detected and a corresponding at least the first portion of the light pattern projected, the first variation corresponding to variation in uniformity of the exposed surface, the first detector disposed adjacent to a build platform; and directing a second detector to optically detect, (i) at least a second portion of the light pattern appearing on the exposed surface and (ii) a second variation between the second portion of the light pattern detected and a corresponding at least the second portion of the light pattern projected, the variation corresponding to the variation in uniformity of the exposed surface, the second detector being disposed adjacent to the build platform; the first detector being distant (e.g., disposed at a gap) from the second detector. In some embodiments, the non-transitory computer readable program instructions where the one or more processors are part of, or are operatively coupled to, a hierarchical network of processors. In some embodiments, the hierarchical network of processors comprises three or more hierarchical levels. In some embodiments, the non-transitory computer readable program instructions where the non-transitory computer readable program instructions are inscribed in one or more media. In some embodiments, the non-transitory computer readable program instructions where the one or more processors are configured to control, or direct control of, the three-dimensional printing. In some embodiments, the non-transitory computer readable program instructions where the one or more processors comprise a microprocessor. In some embodiments, the non-transitory computer readable program instructions where the one or more processors comprise a processor disposed externally to a facility in which the three-dimensional printer is disposed. In some embodiments, outside of the facility comprises the cloud.

In another aspect, a device for three-dimensional printing, the device comprises at least three components comprising (i) a first detector. (ii) a first projector and (iii) a second projector, the device being configured to detect deviation from planarity of a target surface such as an exposed surface of a material bed, e.g., utilized for the three-dimensional printing. In some embodiments, a device for three-dimensional printing, the device comprises: a first projector configured to project a first light pattern on at least a first portion of an exposed surface of a material bed during the three-dimensional printing, the first light pattern comprising areas of various levels of light intensity, the first projector disposed adjacent to a build platform supporting the material bed, the build platform being disposed in a three-dimensional printer, a second projector configured to project a second light pattern on at least a second portion of the exposed surface of a material bed during the three-dimensional printing, the second light pattern comprising areas of various levels of light intensity, the second projector disposed adjacent to the material bed as part of a three-dimensional printer, where light patterns projected include the first light pattern projected and the second light pattern projected, and where light patterns appearing on the exposed surface include the first light pattern appearing on the at least the first portion of exposed surface and the second light pattern appearing on the at least the second portion of the exposed surface; a (e.g., first) detector configured optically detect (i) the light patterns appearing on the exposed surface, and (ii) a variation between the light patterns projected and the light patterns detected, the variation corresponding to variation in uniformity of the exposed surface, the detector being disposed adjacent to the build platform as part of the three-dimensional printer, and the first projector being distant (e.g., disposed at a gap) from the second projector. In some embodiments, the detector is configured to differentiate between uniformity along a length and/or a width of the material bed. In some embodiments, the projector is configured to project the light pattern such that it is altered over time. In some embodiments, the projector is configured to project the light pattern such that it is stable and/or unaltered over time. In some embodiments, the at least the first portion of the exposed surface, and the at least the second portion of the exposed surface are (e.g., substantially) the same. In some embodiments, the at least the first portion of the exposed surface, and the at least the second portion of the exposed surface are different. In some embodiments, the at least the first portion of the exposed surface, and the at least the second portion the exposed surface overlap each other or contract each other. In some embodiments, the first detector is distant (e.g., disposed at a gap) from the second detector. In some embodiment, the distance placement is at least in part to facilitate (e.g., such that) capturing variation from the light pattern when the variation causes saturation of the first detector or of the second detector. In some embodiments, the light pattern comprises an oscillating light pattern. In some embodiments, the light pattern projected comprises a repeating unit. In some embodiments, the light pattern projected is devoid of a repeating unit. In some embodiments, during printing, the material bed is disposed in an enclosure comprising an atmosphere including (i) a positive pressure above an ambient pressure external to the enclosure and/or (ii) a reactive species at a level below its level in an ambient atmosphere external to the enclosure, which reactive species reacts with pre-transformed material during printing; where the device is configured to operatively couple to the enclosure during the three-dimensional printing. In some embodiments, the reactive species comprises oxygen or water. In some embodiments, the atmosphere of the enclosure comprises an inert gas. In some embodiments, the inert gas comprises argon or nitrogen. In some embodiments, the device is configured to facilitate assessment of an alteration of at least one characteristic of the three-dimensional printing based at least in part on detection of the device, the assessment being performed in real-time during the three-dimensional printing of a first portion of at least one three-dimensional object in the material bed. In some embodiments, the device is configured to facilitate using the assessment to generate a second portion of the three-dimensional object by the three-dimensional printing. In some embodiments, the first projector is followed by the detector that is followed by the second projector disposed successively along a direction. In some embodiments, the first projector is followed by the detector that is followed by the second projector disposed successively in a single file. In some embodiments, the device is configured to, during the printing, translate in a translation at least one component comprising (i) the first projector, (ii) the detector or (iii) the second projector. In some embodiments, at least one component is stationary during the printing, the at least one component comprising (i) the first projector, (ii) the detector or (iii) the second projector. In some embodiments, the detector comprises a camera. In some embodiments, the camera comprises a charged-coupled device (CCD) camera. In some embodiments, the material bed and/or at least one three-dimensional object comprising elemental metal, metal alloy, ceramic, or an allotrope of elemental carbon. In some embodiments, the material bed comprises powder. In some embodiments, the device is configured to operate between printing two successive layers of at least one three-dimensional object in the material bed. In some embodiments, printing at least one three-dimensional object is in a processing chamber configured for accommodating (i) an atmosphere more inert than an ambient atmosphere outside of the processing chamber, and (ii) a pressure above ambient pressure outside of the processing chamber. In some embodiments, the device where the device and/or the three-dimensional printer is configured to facilitate printing one or more three-dimensional objects in an atmosphere maintained to be different from an ambient atmosphere by at least one characteristic, the ambient atmosphere being external to the device and/or to the three-dimensional printer. In some embodiments, the device where the at least one characteristic comprises (i) a pressure above a pressure presiding in the ambient atmosphere, or (ii) a reactive agent being at a concentration lower than its concentration in the ambient atmosphere, the reactive agent being reactive with a starting material of the three-dimensional printing at least during the three-dimensional printing. In some embodiments, the first projector, the detector, and the second projector, are coupled to a processing chamber included in the three-dimensional printer. In some embodiments, the first projector, the detector, and the second projector are disposed external to the processing chamber. In some embodiments, the first projector, the detector, and the second projector are operatively coupled to the processing chamber by one or more optical windows. In some embodiments, the first projector, the detector, and the second projector are (e.g., respectively) coupled to the processing chamber by one or more optical windows comprising. In some embodiments, during the printing, the three-dimensional printer is configured to facilitate gas flow away from the one or more optical windows and in a direction towards the build platform. In some embodiments, the first projector, the detector, and the second projector are coupled to a roof of a processing chamber. In some embodiments, the first projector, the detector, and the second projector are coupled to a processing chamber and are disposed in a plane opposing the exposed surface of the material bed. In some embodiments, the first projector, the detector, and the second projector are disposed among energy beams utilized to print at least one three-dimensional object. In some embodiments, the first projector, the detector, and the second projector are coupled to a processing chamber by one or more optical windows disposed among optical windows of energy beams utilized to print at least one three-dimensional object. In some embodiments, the energy beams are more than two, four, six, or eight energy beams, the processing chamber being part of the three-dimensional printer. In some embodiments, the material bed generated on the exposed surface comprises at least one fundamental length scale having a value of at least about 400 mm, 600 mm, 1000 mm, 1200, 1500, or 1750 mm. In some embodiments, the material bed has a weight of at least about 1000 kg. In some embodiments, the three-dimensional printer is configured to facilitate the three-dimensional printing at least in part by facilitating vertical translation of the material bed supported by the build platform comprising an error in vertical positioning of the vertical translation at most about 10%, 5%, or 2% of the vertical translation of the build platform. In some embodiments, the device where the device is configured to facilitate the three-dimensional printing that comprises deposition of pre-transformed material on the exposed surface of the material bed. In some embodiments, the device further comprises a remover configured to remove a second portion of the deposited pre-transformed material from the exposed surface to generate a planar layer of pre-transformed material as part of the material bed. In some embodiments, the remover is operatively coupled to an attractive force source sufficient to attract the pre-transformed material from the exposed surface. In some embodiments, the attractive force comprises a magnetic, electric, electrostatic, or vacuum source. In some embodiments, the device of claim, where the attractive force comprises a vacuum source. In some embodiments, the device is configured to operatively couple to a recycling system that (i) recycles at least a fraction of a portion of pre-transformed material removed by the remover and/or (ii) provides at least a portion of the pre-transformed material utilized by a dispenser. In some embodiments, the second portion removed by the remover is at least about 70%, 50% or 30% of the deposited pre-transformed material. In some embodiments, the fraction recycled is at least about 70% or 90% of the portion removed by the remover. In some embodiments, the device where the device is configured to facilitate deposition of pre-transformed material on the exposed surface at least in part by layerwise deposition. In some embodiments, the device where the device is configured to deposit pre-transformed material comprising powder material. In some embodiments, the device where the device is configured to deposit pre-transformed material comprising elemental metal, metal alloy, ceramic, or an allotrope of elemental carbon. In some embodiments, the device where the device is configured to operate under a positive pressure atmosphere relative to an ambient atmosphere external to the device. In some embodiments, the device where the device and/or the three-dimensional printer is configured to operate under an atmosphere depleted of a reactive agent relative to its concentration in an ambient atmosphere external to the device and/or to the three-dimensional printer, the reactive agent being configured to react with a starting material of the three-dimensional printing at least during the three-dimensional printing. In some embodiments, the device where the reactive agent comprises oxygen, water, or hydrogen sulfide. In some embodiments, the device where the device further comprises an enclosure operatively coupled to, or comprising, a seal. In some embodiments, the device where the seal is included, or is operatively coupled to a shutter, a lid, a closure, an envelope, or a flap. In some embodiments, the device where the seal is a hermetic seal. In some embodiments, the device where the seal is configured to facilitate retaining an internal atmosphere in the enclosure for a time period, the internal atmosphere being different from an ambient atmosphere external to the enclosure. In some embodiments, the device where the seal is configured to facilitate retaining for a time period (i) a positive pressure within the enclosure relative to an ambient atmosphere external to the device and/or (ii) a reactive agent at a concentration lower than its concentration in an ambient atmosphere external to the enclosure, the reactive agent being configured to at least react with pre-transformed material of the three-dimensional printing during the three-dimensional printing. In some embodiments, the device where the time period is at least a same or greater value than a time period to remove three-dimensional objects from a build module body. In some embodiments, the device is configured to facilitate three-dimensional printing, where a portion of the three-dimensional printing comprises connecting particulate matter to facilitate printing at least one three-dimensional object. In some embodiments, at least a portion of the particulate matter is disposed in a material bed during the three-dimensional printing. In some embodiments, the portion of the three-dimensional printing comprises a fusing process. In some embodiments, fusing comprises (i) sintering, (ii) melting, (iii) smelting, or (iv) any combination of (i), (ii) and (iii). In some embodiments, the particulate matter comprises a super alloy. In some embodiments, the super alloy comprises Inconel, In718, Ti64, F357, Haynes282, GRCop-42, C22, CA6NM, or Hastelloy-X. In some embodiments, the first projector is followed by the detector that is followed by the second projector disposed successively along a direction. In some embodiments, the first projector is followed by the detector that is followed by the second projector disposed successively in a single file. In some embodiments, the device is configured to, during the printing, translate in a translation at least one component comprising (i) the first projector, (ii) the detector or (iii) the second projector. In some embodiments, the device is operatively coupled to a layer dispensing mechanism that comprises, or that is operatively coupled to, a cyclonic separator. In some embodiments, the device is included in, or is operatively coupled to, a three-dimensional printing system configured for the three-dimensional printing comprising generating one or more melt pools and controlling a temperature of a melt pool of the one or more melt pools. In some embodiments, the three-dimensional printer is configured to control the temperature of the melt pool (i) in real time during the 3D printing and/or (ii) utilizing feed forward control using a physics model of at least one process as part of the three-dimensional printing. In some embodiments, the three-dimensional printer is configured to communicate between (I) a processor disposed at the three-dimensional printing site and (II) a processor disposed remotely and separate from the three-dimensional printing site. In some embodiments, the device is configured to facilitate synchronizing energy beams utilized for the three-dimensional printing using (i) visible markers and/or (ii) markers removable by a layer dispensing mechanism utilized to dispense the material bed; and where synchronizing is of (1) the energy beams with respect to each other, (II) each of the energy beams with respect to its controller, and/or (III) each of the energy beams with respect to its scanner, the device being configure to facilitate the synchronization at least in part by using the detector. In some embodiments, the device is operatively coupled to circuit boards, each of the circuit boards comprises a controller configured to control an energy beam utilized in the three-dimensional printing, where the controller is configured for synchronization using one or more time synchronization methodologies. In some embodiments, the controller is configured for synchronization using one or more time synchronization methodologies comprising (i) synchronizing barriers or (ii) an oscillating crystal. In some embodiments, at least one component comprises (i) the first projector, (ii) the detector or (iii) the second projector.

In some embodiments, the at least one component is stationary during the printing, where stationary is with respect to a horizontal location of the build platform. In some embodiments, the device is configured to, during the printing, translate the at least one component with respect to a horizontal location of the build platform. In some embodiments, the at least one component are aligned relative to each other. In some embodiments, components of the at least one component are arranged symmetrically with respect to each other.

In another aspect, a method for three-dimensional printing, the method comprises: (a) projecting a first light pattern, with a first projector, on at least a first portion of an exposed surface of a material bed during the three-dimensional printing, the first light pattern comprising areas of various levels of light intensity, the first projector disposed adjacent to a build platform supporting the material bed, the build platform being disposed in a three-dimensional printer; (b) projecting a second light pattern, with a second projector, on at least a second portion of the exposed surface of a material bed during the three-dimensional printing, the second light pattern comprising areas of various levels of light intensity, the second projector disposed adjacent to the material bed as part of a three-dimensional printer, where light patterns projected include the first light pattern projected and the second light pattern projected, and where light patterns appearing on the exposed surface include the first light pattern appearing on the at least the first portion of exposed surface and the second light pattern appearing on the at least the second portion of the exposed surface; and (c) optically detecting with a detector (i) the light patterns appearing on the exposed surface, and (ii) a variation between the light patterns projected and the light patterns detected, the variation corresponding to variation in uniformity of the exposed surface, the detector being disposed adjacent to the build platform as part of the three-dimensional printer, and the first projector being distant (e.g., disposed at a gap) from the second projector. In some embodiments, the method further comprises, differentiating, with the detector, between uniformity along a length and/or a width of the material bed. In some embodiments, the at least the first portion of the exposed surface, and the at least the second portion of the exposed surface are (e.g., substantially) the same. In some embodiments, the at least the first portion of the exposed surface, and the at least the second portion of the exposed surface are different. In some embodiments, the at least the first portion of the exposed surface, and the at least the second portion the exposed surface overlap each other or contract each other. In some embodiments, the first detector is distant (e.g., disposed at a gap) from the second detector. In some embodiment, the distance placement is at least in part to facilitate (e.g., such that) capturing variation from the light pattern when the variation causes saturation of the first detector or of the second detector. In some embodiments, the light pattern comprises an oscillating light pattern. In some embodiments, the light pattern projected comprises a repeating unit. In some embodiments, the light pattern projected comprises is devoid of a repeating unit. In some embodiments, the method where the light pattern comprises an oscillating light pattern. In some embodiments, the method where during the printing, the material bed is disposed in an enclosure comprising an atmosphere including (i) a positive pressure above an ambient pressure external to the enclosure and/or (ii) a reactive species at a level below its level in an ambient atmosphere external to the enclosure, the reactive species being reactive with pre-transformed material during printing; where the device is configured to operatively couple to the enclosure during the three-dimensional printing. In some embodiments, the reactive species comprises oxygen or water. In some embodiments, the atmosphere of the enclosure comprises an inert gas. In some embodiments, the inert gas comprises argon or nitrogen. In some embodiments, the method where the device facilitates assessment of an alteration of at least one characteristic of the three-dimensional printing based at least in part on the light patterns detected, and performing the assessment in real-time during the three-dimensional printing of a first portion of at least one three-dimensional object in the material bed. In some embodiments, the method where the device facilitates using the assessment to generate a second portion of the three-dimensional object by the three-dimensional printing. In some embodiments, the method where the first projector is followed by the detector that is followed by the second projector disposed successively. In some embodiments, the first projector is followed by the detector that is followed by the second projector disposed successively in a single file. In some embodiments, the method further comprises, during the printing, translating at least one component comprising (i) the first projector, (ii) the detector or (iii) the second projector. In some embodiments, the method where at least one component is stationary during the printing, the at least one component being at least one component comprising (i) the first projector, (ii) the detector or (iii) the second projector. In some embodiments, the method where the detector comprises a camera. In some embodiments, the camera comprises a charged-coupled device (CCD) camera. In some embodiments, the method where the material bed and/or at least one three-dimensional object comprising elemental metal, metal alloy, ceramic, or an allotrope of elemental carbon. In some embodiments, the method where the material bed comprises powder. In some embodiments, the method further comprises performing the method between printing two successive layers of at least one three-dimensional object in the material bed. In some embodiments, the method where three-dimensional printing comprises printing at least one three-dimensional object in a processing chamber configured for accommodating (i) an atmosphere more inert than an ambient atmosphere outside of the processing chamber, and (ii) a pressure above ambient pressure outside of the processing chamber. In some embodiments, the method where the first projector, the detector, and the second projector are operatively coupled to a processing chamber included in the three-dimensional printing. In some embodiments, the first projector, the detector, and the second projector are disposed external to the processing chamber. In some embodiments, the first projector, the detector, and the second projector are operatively coupled to the processing chamber by one or more optical windows. In some embodiments, the first projector, the detector, and the second projector are (e.g., respectively) coupled to the processing chamber by one or more optical windows comprising: a first optical window, a second optical window, and a third optical window. In some embodiments, the method where during the printing, the three-dimensional printer is configured to facilitate gas flow away from the one or more optical windows and in a direction towards the build platform. In some embodiments, the method where the first projector, the detector, and the second projector are coupled to a roof of a processing chamber. In some embodiments, the method where the first projector, the detector, and the second projector are coupled to a processing chamber and are disposed in a plane opposing the exposed surface of the material bed. In some embodiments, the method where the first projector, the detector, and the second projector are disposed among energy beams utilized to print at least one three-dimensional object. In some embodiments, the method where the first projector, the detector, and the second projector are coupled to a processing chamber by one or more optical windows disposed among optical windows of energy beams utilized to print at least one three-dimensional object. In some embodiments, the energy beams are more than two, four, six, or eight energy beams, the processing chamber being part of the three-dimensional printer. In some embodiments, the layer dispensing mechanism comprises, or is operatively coupled to, a cyclonic separator. In some embodiments, the 3D printing comprises generating one or more melt pools and controlling a temperature of a melt pool of the one or more melt pools. In some embodiments, controlling the temperature of the melt pool (i) is in real time during the 3D printing and/or (ii) utilizes feed forward control using a physics model of at least one process as part of the 3D printing. In some embodiments, the 3D printing comprises communication between (I) a processor disposed at the 3D printing site and (II) a processor disposed remotely and separate from the 3D printing site. In some embodiments, at least one component comprises (i) the first projector, (ii) the detector or (iii) the second projector. In some embodiments, the method further comprises, during the printing, translating the at least one component, where the translation is with respect to a horizontal location of the build platform. In some embodiments, the at least one component are aligned relative to each other. In some embodiments, components of the at least one component are arranged symmetrically with respect to each other. In some embodiments, the method further comprises dispensing the material bed using a layer dispensing mechanism comprises, or is operatively coupled to, a cyclonic separator. In some embodiments, the three-dimensional printing comprises generating one or more melt pools and controlling a temperature of a melt pool of the one or more melt pools. In some embodiments, the three-dimensional (3D) printing comprises controlling the temperature of the melt pool (i) is in real time during the 3D printing and/or (ii) utilizes feed forward control using a physics model of at least one process as part of the 3D printing. In some embodiments, the three-dimensional printing comprises communication between (I) a processor disposed at the three-dimensional printing site and (II) a processor disposed remotely and separate from the three-dimensional printing site. In some embodiments, the method further comprises synchronizing controllers disposed at different circuit boards using one or more time synchronization methodologies, the controllers configured to control lasers utilized for the three-dimensional printing comprising the first laser and the second laser. In some embodiments, the one or more synchronization methodologies comprise (i) synchronizing barriers or (ii) an oscillating crystal. In some embodiments, the method further comprises using a metrology detector configured to detect vertical variations in the exposed surface of the material bed having a central tendency of planarity. In some embodiments, the method further comprises using the metrology detector comprising a projector, a detector and at least one of: another projector and another detector. In some embodiments, the method further comprises using the metrology detector configured for translation during the three-dimensional printing. In some embodiments, the exposure time of the camera comprises a plurality of periods of the first pattern and/or the second pattern. In some embodiments, the method further comprises dispensing the material bed using a layer dispensing mechanism comprises, or is operatively coupled to, a cyclonic separator. In some embodiments, the three-dimensional printing comprises generating one or more melt pools and controlling a temperature of a melt pool of the one or more melt pools. In some embodiments, the three-dimensional (3D) printing comprises controlling the temperature of the melt pool (i) is in real time during the 3D printing and/or (ii) utilizes feed forward control using a physics model of at least one process as part of the 3D printing. In some embodiments, the three-dimensional printing comprises communication between (I) a processor disposed at the three-dimensional printing site and (II) a processor disposed remotely and separate from the three-dimensional printing site. In some embodiments, the method further comprises synchronizing controllers disposed at different circuit boards using one or more time synchronization methodologies, the controllers configured to control lasers utilized for the three-dimensional printing. In some embodiments, the one or more synchronization methodologies comprise (i) synchronizing barriers or (ii) an oscillating crystal. In some embodiments, the method further comprises using a metrology detector configured to detect vertical variations in the exposed surface of the material bed having a central tendency of planarity. In some embodiments, the method further comprises using the metrology detector comprising a projector, a detector and at least one of: another projector and another detector. In some embodiments, the method further comprises using the metrology detector configured for translation during the three-dimensional printing. In some embodiments, the exposure time of the camera comprises a plurality of periods of the pattern.

In another aspect, an apparatus for three-dimensional printing, the apparatus comprising at least one controller configured to perform, or direct performance of, any of the methods above; where the at least one controller is configured to (i) operatively couple to the first projector, the second projector and a detector, and (ii) direct the first projector, the second projector and the detector. In some embodiments, the at least one controller is configured to (I) operatively couple to and (II) direct: a camera and/or energy beams.

In another aspect, an apparatus for three-dimensional printing, the apparatus comprising at least one controller configured to: (a) operatively coupled to a first projector, a second projector, and a detector; (b) direct the first projector to project a first light pattern on at least a first portion of an exposed surface of a material bed during the three-dimensional printing, the first light pattern comprising areas of various levels of light intensity, the first projector disposed adjacent to a build platform supporting the material bed, the build platform being disposed in a three-dimensional printer; (c) direct the second projector to project a second light pattern on at least a second portion of the exposed surface of a material bed during the three-dimensional printing, the second light pattern comprising areas of various levels of light intensity, the second projector disposed adjacent to the material bed as part of a three-dimensional printer, where light patterns projected include the first light pattern projected and the second light pattern projected, and where light patterns appearing on the exposed surface include the first light pattern appearing on the at least the first portion of exposed surface and the second light pattern appearing on the at least the second portion of the exposed surface; (d) direct the detector to optically detect (i) the light patterns appearing on the exposed surface, and (ii) a variation between the light patterns projected and the light patterns detected, the variation corresponding to variation in uniformity of the exposed surface, the detector being disposed adjacent to the build platform as part of the three-dimensional printer, and the first projector being distant (e.g., disposed at a gap) from the second projector. In some embodiments, the apparatus where the at least one controller comprises circuitry. In some embodiments, the apparatus where the at least one controller comprises at least one connector configured to connect to a power source. In some embodiments, the apparatus where the at least one controller is configured to operatively couple to a power source at least in part by (1) having a power socket and/or (II) being configured for wireless power transfer using inductive charging. In some embodiments, the apparatus where the light pattern comprises an oscillating light pattern. In some embodiments, the apparatus where the at least one controller is part of, or is operatively coupled to, a hierarchical network of controllers. In some embodiments, the hierarchical network of controllers comprises three or more control hierarchical control levels. In some embodiments, the apparatus where the at least one controller comprises a microcontroller. In some embodiments, the apparatus where the at least one controller is configured to control, or direct control of, the three-dimensional printing.

In another aspect, non-transitory computer readable program instructions for three-dimensional printing, the non-transitory computer readable program instructions, when read by one or more processors cause the one or more processors to execute, or direct execution of, any of the methods above; where the one or more processors are configured to operatively couple to: a camera and/or energy beams, and where the program instructions are configured to respectively direct the camera and/or the energy beams.

In another aspect, non-transitory computer readable program instructions for three-dimensional printing, the non-transitory computer readable program instructions, when read by one or more processors operatively coupled to a first projector, a second projector, and a detector, cause the one or more processors to execute operations comprising: (b) directing the first projector to project a first light pattern on at least a first portion of an exposed surface of a material bed during the three-dimensional printing, the first light pattern comprising areas of various levels of light intensity, the first projector disposed adjacent to a build platform supporting the material bed, the build platform being disposed in a three-dimensional printer; (c) directing the second projector to project a second light pattern on at least a second portion of the exposed surface of a material bed during the three-dimensional printing, the second light pattern comprising areas of various levels of light intensity, the second projector disposed adjacent to the material bed as part of a three-dimensional printer, where light patterns projected include the first light pattern projected and the second light pattern projected, and where light patterns appearing on the exposed surface include the first light pattern appearing on the at least the first portion of exposed surface and the second light pattern appearing on the at least the second portion of the exposed surface; (d) directing the detector to optically detect (i) the light patterns appearing on the exposed surface, and (ii) a variation between the light patterns projected and the light patterns detected, the variation corresponding to variation in uniformity of the exposed surface, the detector being disposed adjacent to the build platform as part of the three-dimensional printer, and the first projector being distant (e.g., disposed at a gap) from the second projector. In some embodiments, the non-transitory computer readable program instructions where the one or more processors are part of, or are operatively coupled to, a hierarchical network of processors. In some embodiments, the hierarchical network of processors comprises three or more hierarchical levels. In some embodiments, the non-transitory computer readable program instructions where the light pattern comprises an oscillating light pattern. In some embodiments, the non-transitory computer readable program instructions where the non-transitory computer readable program instructions are inscribed in one or more media. In some embodiments, the non-transitory computer readable program instructions where the one or more processors are configured to control, or direct control of, the three-dimensional printing. In some embodiments, the non-transitory computer readable program instructions where the one or more processors comprise a microprocessor. In some embodiments, the non-transitory computer readable program instructions where the one or more processors comprise a processor disposed external to a facility in which the three-dimensional printer is disposed. In some embodiments, outside of the facility comprises the cloud.

A method for three-dimensional printing, the method comprises: (a) shining a first pattern on an exposed surface of a material bed using a first laser, the first pattern being a closed continuous shape, detectable, and excludes transforming material of the material bed, the first laser otherwise utilized to transform material forming the material bed to layerwise print at least one three-dimensional object during the three-dimensional printing; and (b) shining a second pattern on the exposed surface of the material bed using a second laser, the second pattern being the closed continuous shape, detectable, and excludes transforming material of the material bed, the second laser otherwise utilized to transform material forming the material bed to layerwise print the at least one three-dimensional object during the three-dimensional printing, where shining the first pattern and the second pattern occurs during the three-dimensional printing of the at least one three-dimensional object from the material bed in one printing cycle, the shining utilized to align the first laser with the second laser, where the method is repeated for one or more other lasers to align the first laser, the second laser, and the one or more other lasers, with respect to (1) each other, (II) each with respect to its controller, and/or (III) each with respect to its scanner. In some embodiments, the method where the material bed and/or at least one three-dimensional object comprises elemental metal, metal alloy, ceramic, or an allotrope of elemental carbon. In some embodiments, the method where the first laser and the second laser constitute a first pair of lasers, and where operations (a) and (b) are repeated for a second pair of lasers. In some embodiments, the method where the second pair of lasers comprises the second laser and a third laser. In some embodiments, the method where the second pair of lasers comprises a third laser and a fourth laser. In some embodiments, the method where the one or more other lasers comprise at least 1, 2, 3, 4, 5, 6, 7, 8, 16, 25, 32, or 64 lasers. In some embodiments, the method where a first controller of the first pair of lasers is time synchronized with a second controller of the second pair of lasers. In some embodiments, the method where the time synchronization comprises using crystal oscillations. In some embodiments, the method where the time synchronization is using a counter disposed on a first printed circuit board (PCB), on a second PCB or on another PCB. In some embodiments, the method where a first controller of the first pair of lasers is disposed on a first printed circuit board (PCB) and where a second controller of the second pair of lasers is disposed on a second printed circuit board (PCB), and where the first controller is timewise synchronized with the second controller via clock synchronization. In some embodiments, the method where the first PCB comprises a first clock and the second PCB comprises a second clock, and where the clock synchronization comprises reference to a global clock to which both the first clock and the second clock refer to for synchronization. In some embodiments, the first clock and the second clock utilize crystal oscillations. In some embodiments, the method where the first PCB and the second PCB are two PCBs, and where the clock synchronization comprises having one reference clock disposed in one of the two PCBs, and the clock of the other PCB of the two PCBs is synchronized with reference to the one reference clock. In some embodiments, the first clock and the second clock utilize crystal oscillations. In some embodiments, the method where the material bed comprises powder. In some embodiments, the method where the shining of the first pattern and/or the second pattern occurs between printing two successive layers of the at least one three-dimensional object in the material bed; where the shining of the first pattern and/or second pattern occurs between printing at least about 30%, 50%, or 80% of two successive layers of the at least one three-dimensional object in the material bed. In some embodiments, the method where printing the at least one three-dimensional object is in a processing chamber configured for accommodating (i) an atmosphere more inert than an ambient atmosphere outside of the processing chamber, and (ii) a pressure above ambient pressure outside of the processing chamber. In some embodiments, the method where the material bed is disposed in an enclosure comprising an atmosphere including (i) a positive pressure above an ambient pressure external to the enclosure and/or (ii) a reactive species at a level below its level in an ambient atmosphere external to the enclosure, which reactive species reacts with pre-transformed material during printing; and where the method is performed in the enclosure. In some embodiments, the method where the reactive species comprises oxygen or water. In some embodiments, the method where the atmosphere of the enclosure comprises an inert gas. In some embodiments, the method where the inert gas comprises argon or nitrogen. In some embodiments, the method where the closed continuous shape is a geometric shape. In some embodiments, the method where the closed continuous shape comprises at least one diagonal line with respect to an edge of the material bed that is rectangular. In some embodiments, the method where the closed continuous shape comprises diagonal lines with respect to an edge of the material bed that is rectangular. In some embodiments, the method where the closed continuous shape is a rhombus. In some embodiments, the method where the detectable first pattern and/or second pattern is detectable by at least one camera. In some embodiments, the detectable first pattern is detectable by a first camera and the detectable second pattern is detectable by a second camera. In some embodiments, the method where the detectable first pattern and/or second pattern is detectable by a visible camera. In some embodiments, the camera comprises a charged-coupled device (CCD) camera. In some embodiments, the method where the detectable first pattern and/or second pattern excludes infrared radiation. In some embodiments, the method where the detectable first pattern and/or second pattern excludes a residual footprint once the laser progresses beyond the first pattern and/or second pattern respectively. In some embodiments, the method further comprises capturing the first pattern and/or the second pattern in real-time as it is generated. In some embodiments, the method where the first pattern and/or the second pattern has a uniform light density. In some embodiments, the method further comprises capturing the first pattern and/or the second pattern using a camera configured to detect an integrated radiation of the first pattern and/or the second pattern. In some embodiments, the method further comprises capturing the first pattern and/or the second pattern using a camera configured to detect an integrated radiation of the first pattern and/or the second pattern. In some embodiments, the method further comprises shining on the exposed surface of a material bed one or more additional patterns using one or more additional lasers respectively, each of the one or more additional patterns being a closed continuous shape, detectable, and excludes transforming material of the material bed, the one or more additional lasers otherwise utilized to transform material forming the material bed to layerwise print at least one three-dimensional object during the three-dimensional printing. In some embodiments, the one or more additional lasers comprise at least four or six lasers. In some embodiments, the method further comprises capturing the first pattern and/or the second pattern using a camera having an exposure time. In some embodiments, the method where the exposure time of the camera is proportional to the time it takes to draw the first pattern and/or the second pattern. In some embodiments, the method where the exposure time of the camera comprises a plurality of periods of the first pattern and/or the second pattern. In some embodiments, the method where the exposure time of the camera includes a plurality of the first pattern and/or the second pattern. In some embodiments, the method where the exposure time of the camera differs from the time it takes to draw the first pattern and/or the second pattern by at least about two, three or four times. In some embodiments, the method where the exposure time of the camera is synchronized with generating the first pattern and/or the second pattern. In some embodiments, the method where the synchronization of the camera with generating the first pattern and/or the second pattern is synchronized using a schedule. In some embodiments, the method where the synchronization of the camera with generating the first pattern and/or the second pattern is electronically triggered by the first laser and/or the second laser respectively. In some embodiments, the method where the synchronization of the camera with generating the first pattern and/or second pattern comprises clock synchronization. In some embodiments, the clock comprises an oscillating crystal clock. In some embodiments, the method where the first laser is controlled by a first controller having a first clock, where the second laser is controlled by a second controller having a second clock, and where aligning the first laser with the second laser comprises synchronizing the first clock with the second clock. In some embodiments, the first clock utilizes crystal oscillations and the second clock utilizes crystal oscillations.

In another aspect, an apparatus for three-dimensional printing, the apparatus comprising at least one controller configured to perform, or direct performance of, any of the methods above.

In another aspect, an apparatus for three-dimensional printing, the apparatus comprising at least one controller configured to: (a) direct shining on an exposed surface of a material bed a first pattern using a first laser, the first pattern being a closed continuous shape, detectable, and excludes transforming material of the material bed, the first laser otherwise utilized to transform material forming the material bed to layerwise print at least one three-dimensional object during the three-dimensional printing; and (b) direct shining on the exposed surface of the material bed a second pattern using a second laser, the second pattern being the closed continuous shape, detectable, and excludes transforming material of the material bed, the second laser otherwise utilized to transform material forming the material bed to layerwise print the at least one three-dimensional object during the three-dimensional printing, where shining the first pattern and the second pattern occurs during the three-dimensional printing of the at least one three-dimensional object from the material bed in one printing cycle, the shining utilized to align the first laser with the second laser, where (a)-(c) is repeated for one or more other lasers to align the first laser, the second laser, and the one or more other lasers, with respect to (I) each other, (II) each with respect to its controller, and/or (III) each with respect to its scanner. In some embodiments, the at least one controller is configured to (i) operatively couple to the first laser, and (ii) direct the first laser to generate (e.g., shine) the first pattern. In some embodiments, the at least one controller is configured to (i) operatively couple to the second laser, and (ii) direct the second projector to generate (e.g., shine) the second laser. In some embodiments, the apparatus where the at least one controller comprises circuitry. In some embodiments, the apparatus where the at least one controller comprises at least one connector configured to connect to a power source. In some embodiments, the apparatus where the at least one controller is configured to operatively couple to a power source at least in part by (I) having a power socket and/or (II) being configured for wireless power transfer using inductive charging. In some embodiments, the apparatus where the at least one controller is part of, or is operatively coupled to, a hierarchical network of controllers. In some embodiments, the hierarchical network of controllers comprises three or more control hierarchical control levels. In some embodiments, the apparatus where the at least one controller comprises a microcontroller. In some embodiments, the apparatus where the at least one controller is configured to control, or direct control of, the three-dimensional printing. In another aspect, non-transitory computer readable program instructions for three-dimensional printing, the non-transitory computer readable program instructions, when read by one or more processors, cause the one or more processors to execute, or direct execution of, any of the methods above.

In another aspect, non-transitory computer readable program instructions for three-dimensional printing, the non-transitory computer readable program instructions, when read by one or more processors, cause the one or more processors to execute operations comprising: (a) directing shining, on an exposed surface of a material bed a first pattern using a first laser, the first pattern being a closed continuous shape, detectable, and excludes transforming material of the material bed, the first laser otherwise utilized to transform material forming the material bed to layerwise print at least one three-dimensional object during the three-dimensional printing; and (b) directing shining, on the exposed surface of the material bed a second pattern using a second laser, the second pattern being the closed continuous shape, detectable, and excludes transforming material of the material bed, the second laser otherwise utilized to transform material forming the material bed to layerwise print the at least one three-dimensional object during the three-dimensional printing, where shining the first pattern and the second pattern occurs during the three-dimensional printing of the at least one three-dimensional object from the material bed in one printing cycle, the shining utilized to align the first laser with the second laser, where (a)-(c) is repeated for one or more other lasers to align the first laser, the second laser, and the one or more other lasers, with respect to each other. In some embodiments, the one or more processors are configured to operatively couple to the first laser, and the operations comprise directing the first laser to generate (e.g., shine) the first pattern. In some embodiments, the one or more processors are configured to operatively couple to the second laser, and the operations comprise directing the second laser to generate (e.g., shine) the second pattern. In some embodiments, the non-transitory computer readable program instructions where the one or more processors are part of, or are operatively coupled to, a hierarchical network of processors. In some embodiments, the hierarchical network of processors comprises three or more hierarchical levels. In some embodiments, the non-transitory computer readable program instructions where the non-transitory computer readable program instructions are inscribed in one or more media. In some embodiments, the non-transitory computer readable program instructions where the one or more processors are configured to control, or direct control of, the three-dimensional printing. In some embodiments, the non-transitory computer readable program instructions where the one or more processors comprise a microprocessor. In some embodiments, the non-transitory computer readable program instructions where the one or more processors comprise a processor disposed externally to a facility in which a three-dimensional printer performing the three-dimensional printing is disposed. In some embodiments, outside of the facility comprises the cloud.

In another aspect, a method for three-dimensional printing, the method comprises: (a) shining on an exposed surface of a material bed a first pattern using a laser, the pattern being a closed continuous shape, detectable, and excludes transforming material of the material bed, the laser otherwise utilized to transform material forming the material bed to layerwise print at least one three-dimensional object during the three-dimensional printing; and (b) repeating operation (a) for two or more other lasers to align the lasers including the laser and the two or more other lasers with respect to (I) each other (II) each with respect to its controller, and/or (III) each with respect to its scanner, where shining the pattern occurs during the three-dimensional printing of the at least one three-dimensional object from the material bed in one printing cycle, the shining utilized to align the laser with a scanner of the laser. In some embodiments, the method where the material bed and/or at least one three-dimensional object comprises elemental metal, metal alloy, ceramic, or an allotrope of elemental metal. In some embodiments, the method where the two or more other lasers comprise at least 2, 3, 4, 5, 6, 7, 8, 16, 24, 32, or 64 lasers. In some embodiments, the method where the laser is a first laser; where the two or more lasers comprise a second laser; where the first laser and the second laser constitute a first pair of lasers; where the two or more lasers comprise a second pair of lasers; and where a first controller of the first pair of lasers is timewise synchronized with a second controller of the second pair of lasers. In some embodiments, the method where the time synchronization comprises using crystal oscillations. In some embodiments, the method where the time synchronization is using a counter disposed on a first printed circuit board (PCB), on a second PCB or on another PCB. In some embodiments, the method where a first controller of the first pair of lasers is disposed on a first printed circuit board (PCB) and where a second controller of the second pair of lasers is disposed on a second printed circuit board (PCB), and where the first controller is time synchronized with the second controller via clock synchronization. In some embodiments, the method where the first PCB comprises a first clock and the second PCB comprises a second clock, and where the clock synchronization comprises reference to a global clock to which both the first clock and the second clock refer to for synchronization. In some embodiments, the first clock and the second clock utilize crystal oscillations. In some embodiments, the method where the first PCB and the second PCB are two PCBs, and where the clock synchronization comprises having one reference clock disposed in one of the two PCBs, and the clock of the other PCB of the two PCBs is synchronized with reference to the one reference clock. In some embodiments, the first clock and the second clock utilize crystal oscillations. In some embodiments, the method where the material bed comprises powder. In some embodiments, the method where the shining of the pattern occurs between printing two successive layers of the at least one three-dimensional object in the material bed; where the shining of the pattern occurs between printing at least about 30%, 50%, or 80% of two successive layers of the at least one three-dimensional object in the material bed. In some embodiments, the method where printing the at least one three-dimensional object is in a processing chamber configured for accommodating (i) an atmosphere more inert than an ambient atmosphere outside of the processing chamber, and (ii) a pressure above ambient pressure outside of the processing chamber. In some embodiments, the method where the material bed is disposed in an enclosure comprising an atmosphere including (i) a positive pressure above an ambient pressure external to the enclosure and/or (ii) a reactive species at a level below its level in an ambient atmosphere external to the enclosure, which reactive species reacts with pre-transformed material during printing: and where the method is performed in the enclosure. In some embodiments, the method where the reactive species comprises oxygen or water. In some embodiments, the method where the atmosphere of the enclosure comprises an inert gas. In some embodiments, the method where the inert gas comprises argon or nitrogen. In some embodiments, the method where the closed continuous shape is a geometric shape. In some embodiments, the method where the closed continuous shape comprises at least one diagonal line with respect to an edge of the material bed that is rectangular. In some embodiments, the method where the closed continuous shape comprises diagonal lines with respect to an edge of the material bed that is rectangular. In some embodiments, the method where the closed continuous shape is a rhombus. In some embodiments, the method where the detectable pattern is detectable by a camera. In some embodiments, the method where the detectable pattern is detectable by a visible camera. In some embodiments, the camera comprises a charged-coupled device (CCD) camera. In some embodiments, the method where the detectable pattern excludes infrared radiation. In some embodiments, the method where the detectable pattern excludes a residual footprint once the laser progresses beyond the pattern. In some embodiments, the method further comprises capturing the pattern in real-time as it is generated. In some embodiments, the method where the pattern has a uniform light density. In some embodiments, the method further comprises capturing the pattern using a camera configured to detect an integrated radiation of the pattern. In some embodiments, the method further comprises capturing the pattern using a camera configured to detect an integrated radiation of the pattern. In some embodiments, the method further comprises shining on the exposed surface of a material bed one or more additional patterns using one or more additional lasers respectively, each of the one or more additional patterns being a closed continuous shape, detectable, and excludes transforming material of the material bed, the one or more additional lasers otherwise utilized to transform material forming the material bed to layerwise print at least one three-dimensional object during the three-dimensional printing. In some embodiments, the one or more additional lasers comprise at least three, five, or seven lasers. In some embodiments, the method further comprises capturing the pattern using a camera having an exposure time. In some embodiments, the method where the exposure time of the camera is proportional to the time it takes to draw the pattern. In some embodiments, the method where the exposure time of the camera comprises a plurality of periods of the pattern. In some embodiments, the method where the exposure time of the camera includes a plurality of the pattern. In some embodiments, the method where the exposure time of the camera differs from the time it takes to draw the pattern by at least about by at least about two, three or four times. In some embodiments, the method where the exposure time of the camera is synchronized with generating the pattern. In some embodiments, the method where the synchronization of the camera with generating the pattern is synchronized using a schedule. In some embodiments, the method where the synchronization of the camera with generating the pattern is electronically triggered by the laser. In some embodiments, the method where the synchronization of the camera with generating the pattern comprises clock synchronization. In some embodiments, the clock comprises an oscillating crystal clock.

In another aspect, an apparatus for three-dimensional printing, the apparatus comprising at least one controller configured to perform, or direct performance of, any of the methods above.

In another aspect, an apparatus for three-dimensional printing, the apparatus comprising at least one controller configured to: (a) shine, or direct shining, on an exposed surface of a material bed a first pattern using a laser, the pattern being a closed continuous shape, detectable, and excludes transforming material of the material bed, the laser otherwise utilized to transform material forming the material bed to layerwise print at least one three-dimensional object during the three-dimensional printing; and (b) repeat, or direct repeating of, operation (a) for two or more other lasers to align the lasers including the laser and the two or more other lasers with respect to (1) each other, (II) each with respect to its controller, and/or (III) each with respect to its scanner, where shining the pattern occurs during the three-dimensional printing of the at least one three-dimensional object from the material bed in one printing cycle, the shining utilized to align the laser with a scanner of the laser. In some embodiments, the apparatus where the at least one controller comprises circuitry. In some embodiments, the apparatus where the at least one controller comprises at least one connector configured to connect to a power source. In some embodiments, the apparatus where the at least one controller is configured to operatively couple to a power source at least in part by (1) having a power socket and/or (II) being configured for wireless power transfer using inductive charging. In some embodiments, the apparatus where the at least one controller is part of, or is operatively coupled to, a hierarchical network of controllers. In some embodiments, the hierarchical network of controllers comprises three or more control hierarchical control levels. In some embodiments, the apparatus where the at least one controller comprises a microcontroller. In some embodiments, the apparatus where the at least one controller is configured to control, or direct control of, the three-dimensional printing.

In another aspect, non-transitory computer readable program instructions for three-dimensional printing, the non-transitory computer readable program instructions, when read by one or more processors, cause the one or more processors to execute, or direct execution of, any of the methods above.

In another aspect, non-transitory computer readable program instructions for three-dimensional printing, the non-transitory computer readable program instructions, when read by one or more processors, cause the one or more processors to execute operations comprising: (a) shining, or directing shining, on an exposed surface of a material bed a first pattern using a laser, the pattern being a closed continuous shape, detectable, and excludes transforming material of the material bed, the laser otherwise utilized to transform material forming the material bed to layerwise print at least one three-dimensional object during the three-dimensional printing; and (b) repeating, or directing repeating of, operation (a) for two or more other lasers to align the lasers including the laser and the two or more other lasers with respect to each other, where shining the pattern occurs during the three-dimensional printing of the at least one three-dimensional object from the material bed in one printing cycle, the shining utilized to align the laser with a scanner of the laser. In some embodiments, the non-transitory computer readable program instructions where the one or more processors are part of, or are operatively coupled to, a hierarchical network of processors. In some embodiments, the hierarchical network of processors comprises three or more hierarchical levels. In some embodiments, the non-transitory computer readable program instructions where the non-transitory computer readable program instructions are inscribed in one or more media. In some embodiments, the non-transitory computer readable program instructions where the one or more processors are configured to control, or direct control of, the three-dimensional printing. In some embodiments, the non-transitory computer readable program instructions where the one or more processors comprise a microprocessor. In some embodiments, the non-transitory computer readable program instructions where the one or more processors comprise a processor disposed externally to a facility in which a three-dimensional printer performing the three-dimensional printing is disposed. In some embodiments, outside of the facility comprises the cloud.

In another aspect, a system for effectuating the methods, operations of an apparatus, operation of a device, and/or operations inscribed by a non-transitory computer readable program instructions (e.g., inscribed on a media/medium), disclosed herein.

In another aspect, device(s) (e.g., apparatus) for effectuating the methods, operations of an apparatus, and/or operations inscribed by a non-transitory computer readable program instructions (e.g., inscribed on a media/medium).

In another aspect, a system for effectuating the methods, operations of the device, operations of the apparatus, and/or operations inscribed by non-transitory computer readable program instructions (e.g., inscribed on a media/medium), disclosed herein.

In other aspects, device(s) (e.g., apparatus) for effectuating the methods, operations of an apparatus, and/or operations inscribed by non-transitory computer readable program instructions (e.g., inscribed on a media/medium).

In other aspects, systems, apparatuses (e.g., controller(s)), and/or non-transitory computer-readable program instructions (e.g., software) that implement any of the methods disclosed herein. In some embodiments, the program instructions is inscribed on at least one medium (e.g., on a medium or on media).

In other aspects, methods, systems, apparatuses (e.g., controller(s)), and/or non-transitory computer-readable program instructions (e.g., software) that implement any of the devices disclosed herein and/or any operation of these devices. In some embodiments, the program instructions is inscribed on at least one medium (e.g., on a medium or on media).

Another aspect of the present disclosure provides methods, systems, apparatuses (e.g., controller(s)), and/or non-transitory computer-readable program instructions (e.g., software) that implement any operation associated with any of the devices disclosed herein. In some embodiments, the program instructions is inscribed on at least one medium (e.g., on a medium or on media).

In another aspect, an apparatus (e.g., for printing one or more 3D objects) comprises at least one controller that is configured (e.g., programmed) to direct a mechanism used in a 3D printing methodology to implement (e.g., effectuate) any of the method and/or operations disclosed herein, wherein the controller(s) is operatively coupled to the mechanism. In some embodiments, the controller(s) implements any of the methods and/or operations disclosed herein. In some embodiments, the at least one controller comprises, or be operatively coupled to, a hierarchical control system. In some embodiments, the hierarchical control system comprises at least three, four, or five, control levels.

In another aspect, an apparatus (e.g., for printing one or more 3D objects) comprises at least one controller that is configured (e.g., programmed) to implement (e.g., effectuate), or direct implementation of, the method, process, and/or operation disclosed herein. In some embodiments, the at least one controller implements any of the methods, processes, and/or operations disclosed herein.

In another aspect, non-transitory computer readable program instructions (e.g., for printing one or more 3D objects), when read by one or more processors, are configured to execute, or direct execution of, the method, process, and/or operation disclosed herein. In some embodiments, the at least one controller implements any of the methods, processes, and/or operations disclosed herein. In some embodiments, at least a portion of the one or more processors is part of a 3D printer, outside of the 3D printer, in a location remote from the 3D printer (e.g., in the cloud).

In another aspect, a system for printing one or more 3D objects comprises an apparatus (e.g., used in a 3D printing methodology) and at least one controller that is configured (e.g., programmed) to direct operation of the apparatus, wherein the at least one controller is operatively coupled to the apparatus. In some embodiments, the apparatus includes any apparatus or device disclosed herein. In some embodiments, the at least one controller implements, or direct implementation of, any of the methods disclosed herein. In some embodiments, the at least one controller directs any apparatus (or component thereof) disclosed herein.

In some embodiments, at least two of operations of the apparatus are directed by the same controller. In some embodiments, at least two of operations of the apparatus are directed by different controllers.

In some embodiments, at least operations (e.g., instructions) are carried out by the same processor and/or by the same sub-computer software product. In some embodiments, at least two of operations (e.g., instructions) are carried out by different processors and/or sub-computer software products.

In another aspect, a computer software product, comprising a (e.g., non-transitory) computer-readable medium/media in which program instructions are stored, which instructions, when read by a computer, cause the computer to direct a mechanism used in the 3D printing process to implement (e.g., effectuate) any of the method disclosed herein, wherein the non-transitory computer-readable medium is operatively coupled to the mechanism. In some embodiments, the mechanism comprises an apparatus or an apparatus component.

In another aspect, a non-transitory computer-readable medium/media comprising machine-executable code that, upon execution by one or more computer processors, implements any of the methods and/or operations disclosed herein.

In another aspect, a non-transitory computer-readable medium/media comprising machine-executable code that, upon execution by one or more computer processors, effectuates directions of the controller(s) (e.g., as disclosed herein).

In another aspect, a computer system comprising one or more computer processors and a non-transitory computer-readable medium coupled thereto. In some embodiments, the non-transitory computer-readable medium comprises machine-executable code that, upon execution by the one or more computer processors, implements any of the methods disclosed herein and/or effectuates directions of the controller(s) disclosed herein.

In another aspect, a method for three-dimensional printing, the method comprises executing one or more operations associated with at least one configuration of the device(s) disclosed herein.

In another aspect, an apparatus for three-dimensional printing, the apparatus comprising at least one controller is configured (i) operatively couple to the device, and (ii) direct executing one or more operations associated with at least one configuration of the device(s) disclosed herein.

In another aspect, non-transitory computer readable program instructions for three-dimensional printing, the non-transitory computer readable program instructions, when read by one or more processors operatively couped to the device, cause the one or more processors to direct executing one or more operations associated with at least one configuration of the device(s) disclosed herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the present disclosure are set forth with particularity in the appended claims. A better understanding of the features and advantages of the present disclosure will be obtained by reference to the following detailed description that sets forth illustrative embodiments, in which the principles of the present disclosure are utilized, and the accompanying drawings or figures (also “Fig.” and “Figs.” Herein), of which:

FIG. 1 shows a schematic side view of a 3D printing system and apparatuses;

FIG. 2 schematically illustrates an optical system;

FIG. 3 shows a schematic side view of a 3D printing system and apparatuses;

FIG. 4 shows a schematic side view of a 3D printing system and apparatuses:

FIG. 5 shows a schematic side view of a 3D printing system and apparatuses;

FIG. 6 shows a schematic views of 3D objects;

FIG. 7 shows schematics of various vertical cross-sectional views of different 3D objects;

FIG. 8 shows a horizontal view of a 3D object;

FIG. 9 schematically illustrates a coordinate system;

FIGS. 10A-10C shows various 3D objects and schemes thereof;

FIG. 11 schematically illustrates a computer control system that is programmed or otherwise configured to facilitate the formation of one or more 3D objects;

FIG. 12 illustrates a path;

FIG. 13 illustrates various paths;

FIG. 14 illustrates a schematic side view (as a vertical cross sectional) of a 3D printing system portion;

FIG. 15 illustrates a schematic side view (as a vertical cross sectional) of a 3D printing system portion;

FIG. 16 illustrates a schematic side view (e.g., vertical cross sectional) of a 3D printing system portion;

FIG. 17 shows schematics of various vertical cross-sectional views of different 3D objects;

FIG. 18 shows a schematic representation of a 3D object;

FIG. 19 shows an exposed surface of a material bed;

FIG. 20 shows a representation of a control scheme;

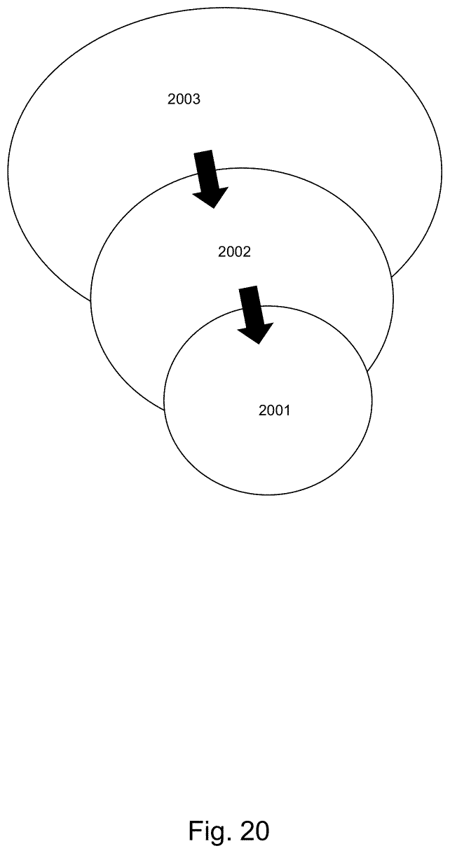

FIGS. 21A-21D show various schematic representations of intensity as a function of time;

FIGS. 22A-22B show various schematic representations of physical attribute profiles as a function of time;

FIGS. 23A-23B show various schematic representations of physical attribute profiles as a function of time;

FIG. 24 schematically illustrates a control system used in the formation of one or more 3D objects;

FIG. 25 schematically illustrates a control system that is programmed or otherwise configured to facilitate debris reduction (e.g., avoidance) during formation of one or more 3D objects;

FIGS. 26A-26B show schematic representations of a material bed;

FIGS. 27A-27B schematically illustrate various physical models:

FIGS. 28A-28D show various schematic representations of measured physical profiles over times;

FIG. 29 shows a schematic side view of a 3D printing system and apparatuses:

FIGS. 30A-30D schematically illustrate various steps in a 3D printing process; and FIG. 30E schematically illustrates a graph associated with a 3D printing process;

FIG. 31 shows a schematic top view of a layer of material;

FIGS. 32A-32D show various schematic representations of measured physical attribute profiles as a function of time;

FIG. 33 shows a schematic side view of a 3D printing system and apparatuses;

FIG. 34 shows a cross section in a 3D object;

FIG. 35 shows a 3D object;

FIG. 36 schematically illustrates a cross section in portion of a 3D object;

FIG. 37 schematically illustrates a vertical cross section in a portion of an optical detection system;

FIG. 38 schematically illustrates a device comprising optical window holders;

FIG. 39 schematically illustrates graphs and a top view of a material bed; and

FIG. 40 schematically depicts usage of a conversion model having parameters.

The figures and components therein may not be drawn to scale. Various components of the figures described herein may not be drawn to scale. Any dimensions in the various drawings are for illustrative purposes only and are not intended to be limiting. Other dimensions and proportions not listed or visualized are contemplated and intended to be included within the scope of the present disclosure.

### DETAILED DESCRIPTION

While various embodiments have been shown and described herein, it will be obvious to those skilled in the art that such embodiments are provided by way of example only. Numerous variations, changes, and substitutions may occur to those skilled in the art without departing from the present disclosure. It should be understood that various alternatives to the embodiments described herein might be employed.

Terms such as “a”. “an” and “the” are not intended to refer to only a singular entity but include the general class of which a specific example may be used for illustration. The terminology herein is used to describe specific embodiments in the present disclosure, but their usage does not delimit to the specific embodiments of the present disclosure.

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.” When ranges are mentioned (e.g., between, at least, at most, and the like) the endpoint(s) of the range is/are also claimed. For example, when the range is from X to Y, the values of X and Y are also claimed. For example, when the range is at most Z, the value of Z is also claimed. For example, when the range is at least W, the value of W is also claimed.

The conjunction “and/or” as used herein in X and/or Y (including in the specification and claims) is meant to include (i) X, (ii) Y. and (iii) X and Y. The conjunction of “and/or” in the phrase “including X, Y, and/or Z” is meant to include any combination and plurality thereof. For example, it is meant to include the following: (1) a single X, (2) a single Y, (3) a single Z, (4) a single X and a single Y, (5) a single X and a single Z, (6) a single Y and a single Z, (7) a single X, a single Y, and a single Z, (8) a plurality of X, (9) a plurality of Y, (10) a plurality of Z, (11) a plurality of X and a single Y, (12) a plurality of X, a single Y and a single Z, (13) a plurality of X and a single Z, (14) a plurality of Y and a single X, (15) a plurality of Y, a single X, and a single Z, (16) a plurality of Y and a single Z, (17) a plurality of Z and a single X, (18) a plurality of Z, a single X, and a single Y (19) a plurality of Z and a single Y, (20) a plurality X and a plurality Y, (21) a plurality X and a plurality Z, (22) a plurality Y and a plurality Z, and (23) a plurality X, a plurality Y, and a plurality Z. The phrase “including X, Y, and/or Z” is meant to have the same meaning as “comprising X, Y, or Z.”

The term “operatively coupled” or “operatively connected” refers to a first mechanism that is coupled (or connected) to a second mechanism to allow the intended operation of the second and/or first mechanism. The coupling may comprise physical or non-physical coupling. The non-physical coupling may comprise signal induced coupling (e.g., wireless coupling).

“Real-time” as understood herein may be during at least part of the printing of a 3D object. In some embodiments, real-time may be during a print operation. In some embodiments, real-time may be during a print cycle. In some embodiments, real-time may comprise: during formation of (i) a 3D object, (ii) a layer of hardened material as part of the 3D object, (iii) a hatch line, or (iv) a melt pool.

The phrase “is/are structured” or “is/are configured,” when modifying an article, refers to a structure of the article that is able to bring about the referred result.

A central tendency as understood herein comprises mean, median, or mode. The mean may comprise a geometric mean.

Transformed material, as understood herein, is a material that underwent a physical change. The physical change can comprise a phase change. The physical change can comprise fusing (e.g., melting or sintering), connecting, or bonding (e.g., physical, or chemical bond). The physical change can be a phase transformation such as from a solid to a partially liquid, or to a liquid, phase.

The 3D printing process may comprise printing one or more layers of hardened material in a building cycle, e.g., in a printing cycle. A building cycle (e.g., a printing cycle), as understood herein, comprises printing the (e.g., hardened, or solid) material layers of a print job (e.g., all, or substantially all, the layers of a printing job), which may comprise printing one or more 3D objects above a build platform (e.g., in a single material bed). The one or more 3D object(s) may or may not be physically anchored to the platform (e.g., a build platform) above which it/they are printed.

Pre-transformed material (also referred to herein as “starting material”), as understood herein, is a material before it has been transformed (e.g., once transformed) by an energy beam during an upcoming 3D printing process, e.g., it is a starting material for an upcoming 3D printing process. The pre-transformed material may be a material that was, or was not, transformed prior to its use in the upcoming 3D printing process. The pre-transformed material may be a material that was partially transformed prior to its use in the upcoming 3D printing process. The pre-transformed material may be a starting material for the upcoming 3D printing process. The pre-transformed material may be liquid, solid, or semi-solid (e.g., gel). The pre-transformed material may be a particulate material. For example, the particulate material may be a powder material. The powder material may comprise solid particles of material(s). The particulate material may comprise vesicles (e.g., containing liquid or semi-solid material). The particulate material may comprise solid or semi-solid material particles. The pre-transformed material may have been transformed by a 3D printer process prior to the upcoming 3D printing process. For example, in a first 3D printing process (having a first build cycle), powder material was used to form a 3D object. A remainder of the powder material of the first 3D printing process may become a pre-transformed material for an upcoming second 3D printing process (having a second build cycle). Thus, even though the remainder powder of the first 3D printing process may comprise transformed material (e.g., bits of sintered powder), it is still considered a pre-transformed material relative to the second 3D printing process. The remainder can be filtered and otherwise recycled for use as a pre-transformed material in the second 3D printing process.

Fundamental length scale (abbreviated herein as “FLS”) comprises any suitable scale (e.g., dimension) of an object. For example, an FLS of an object may comprise a length, a width, a height, a diameter, a spherical equivalent diameter, a diameter of a bounding circle, a diameter of a bounding sphere, a radius, a spherical equivalent radius, or a radius of a bounding circle, or a radius of a bounding sphere.

Performing a reversible first operation is understood herein to mean performing the first operation and being capable of performing the opposite of that first operation (e.g., which is a second operation). For example, when at least one controller directs reversibly opening a shutter, that shutter can also close, and the controller can optionally direct a closure of that shutter. For example, when a recoater (e.g., also referred to herein as layer dispensing mechanism) reversibly translates in a first direction, that recoater can also translate in a second direction opposite to the first direction. For example, when at least one controller directs reversibly translating a recoater in a first direction, that recoater can translate in the first direction and can also translate in a second direction opposite to the first direction, e.g., when the controller directs the recoater to translate in the second direction.

Where suitable, one or more of the features shown in a figure comprising a 3D printer and/or components thereof can be combined with one or more of the various features of other 3D printers and/or components thereof described herein. A figure shown herein may not show certain features of a 3D printer and/or components thereof described herein. It should be understood that any such features can be incorporated within the 3D printer as requested and where suitable.

At times, the methods described herein are performed in an enclosure comprising an interior space (e.g., container, processing chamber, and/or build module). One or more 3D objects can be formed (e.g., generated, and/or printed) in the enclosure (e.g., simultaneously, and/or sequentially). The enclosure may have a predetermined and/or controlled (e.g., maintained) pressure. The enclosure may have an interior atmosphere that is different than an external atmosphere to the enclosure. The enclosure may have a predetermined and/or controlled atmosphere, e.g., during the 3D printing. The control may be manual or via a control system. The enclosure may comprise a processing chamber and/or a build module. The interior volume of the enclosure may be extended by coupling a processing chamber and a build module to form an extended interior volume.

In some embodiments, the 3D printer comprises a chamber having an interior space. The chamber may be referred to herein as a “processing chamber.” The processing chamber may facilitate ingress of at least one energy beam into the processing chamber. The energy beam(s) may be directed towards a target surface, e.g., an exposed surface of a material bed. The 3D printer may comprise one or more modules, e.g., build modules. At times, at least one build module may be situated in the enclosure and coupled with the processing chamber. At times, at least one build module engages with the processing chamber to expand an interior volume of the processing chamber, e.g., to form at least a portion of the chamber.

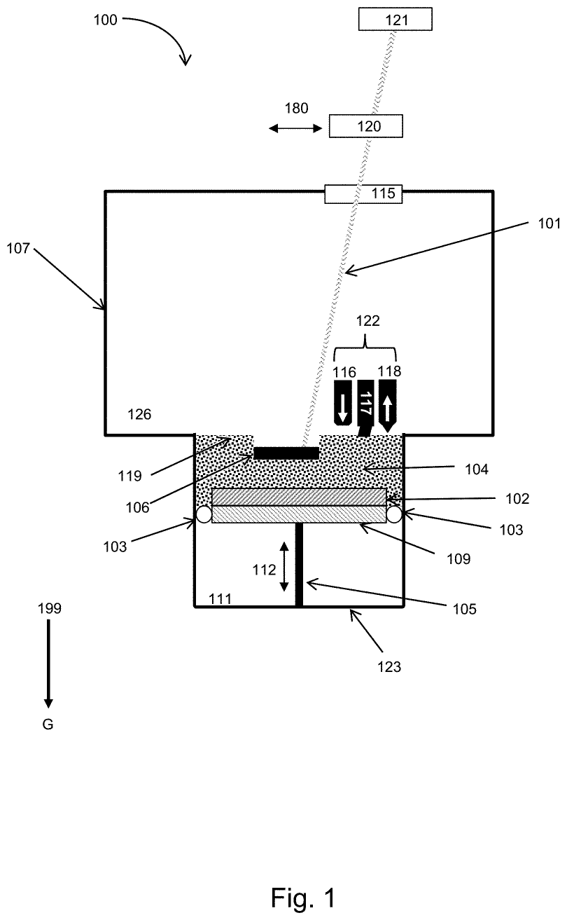

FIG. 1 shows an example of a 3D printing system 100 and apparatuses. A transforming energy beam 101 is generated by an energy source 121. The generated energy beam may travel through an optical assembly 120 and/or an optical window 115 towards the material bed 104. Energy source (e.g., laser source) 121 generates energy beam 101 that traverses through the optical assembly 120 (e.g., comprising a scanner) and through an optical window 115 into processing chamber 107 enclosing interior space in enclosure 126 that can include an atmosphere. The optical window 115 is configured to allow the energy beam to pass through without (e.g., substantial) energetic loss. The transforming energy beam 101 may travel along a path to transform at least a portion of the material bed 104 into a transformed material. The transformed material may harden into at least a portion of the 3D object. In the example shown in FIG. 1, part 106 represents a layer of transformed material within the material bed 104. The material bed may be disposed above a build platform. As depicted in FIG. 1, the 3D printer comprises a layer dispensing mechanism 122. The layer dispensing mechanism 122 includes a material dispenser 116 and a powder removal mechanism (e.g., remover 118) to form a layer of pre-transformed material (e.g., starting material) within the enclosure. Layer dispensing mechanism 122 includes a leveler 117. The system 100 comprises a platform. The platform may comprise a substrate 109 and/or a base (e.g., a build platform 102). The platform may translate (e.g., vertically 112) using a translating mechanism (e.g., an elevation mechanism 105). The translating mechanism may travel in the direction to or away from the bottom 111 of the enclosure (e.g., vertically). For example, the platform may decrease in height before a new layer of pre-transformed material is dispensed by the material dispensing mechanism (e.g., a material dispenser 116). The top surface of the material bed 119 may be leveled using a leveling mechanism (e.g., comprising leveler 117 and remover 118). Processing chamber 107 can include an optional temperature adjustment device (e.g., cooling plate, not shown). Build module 123 is configured to enclose a substrate 109 and arranged adjacent to a bottom 111 of build module 123. Bottom 111 is defined relative to the gravitational field along gravitational vector 199 pointing towards gravitational center G, or relative to the position of the footprint of the energy beam 101 on the layer of pre-transformed material as part of a material bed 104. Build module 123 comprises a build platform 102. The substrate is coupled to one or more seals 103 that enclose the material in a selected area within the build module to form material bed 104. One or more components of 3D printing system 100 are controlled by a control system (not shown in FIG. 1). The interior of the enclosure 126 may comprise an inert gas and/or an oxygen and/or humidity reduced atmosphere. Examples of atmospheres. 3D printers, related control system, related methods, apparatuses, systems, and program instructions (e.g., software), can be found in international patent application number PCT/US15/36802, titled “APPARATUSES, SYSTEMS AND METHODS FOR THREE-DIMENSIONAL PRINTING” that was filed on Jun. 19, 2015, which is incorporated herein by reference in its entirety.

In some embodiments, the 3D printing system comprises a build module. The build module may be mobile or stationary. The build module may comprise an elevation mechanism, e.g., comprising a build platform assembly. The build module may comprise a build platform (e.g., a base) that may be coupled to the build platform assembly. The build platform may be disposed within the build module. The build platform may reside adjacent to a substrate, e.g., above the substrate relative to a gravitational center of the environment (e.g., Earth). An elevation mechanism (e.g., also referred to herein as an “elevator”) may be reversibly connected to (and disconnected from) at least a portion of the build platform. The elevation mechanism may comprise a portion that vertically translates the build platform with respect to a gravitational center (e.g., a gravitational center of the Earth). The build platform may be disposed on the substrate. The build platform and the substrate may operatively couple (e.g., physically connect). A material bed may be disposed above build platform. The build platform may support the material bed. The build platform may comprise, or be configured to operatively couple to, an engagement mechanism. The substrate may comprise, or be configured to operatively couple to, an engagement mechanism. The engagement mechanism may facilitate engagement and/or dis-engagement between the build platform and the substrate. The build platform may be configured to support one or more layers of pre-transformed material (e.g., as part of the material bed). The build platform may be configured to support at least a portion of the 3D object (e.g., during forming of the 3D object). The substrate and/or the base (e.g., build platform) may be removable or non-removable (e.g., from the 3D printing system and/or relative to each other). The substrate and/or base may be fastened (I) to the build module and/or (II) to each other. The build platform and/or substrate may be translatable. The translation of the build platform may be controlled and/or regulated by at least one controller (e.g., by a control system). The translation of the substrate may be controlled and/or regulated by at least one controller (e.g., by a control system). The build platform and/or substrate may be translatable horizontally, vertically, or at an angle (e.g., planar or compound angle). The control system may be any control system disclosed herein, e.g., a control system of the 3D printer such as the one controlling an energy beam. The substrate may comprise a piston. At times, the 3D printing system may comprise more than one substrate. At times, the 3D printing system may comprise more than one piston. The disclosure herein relating to the substrate may apply to the substrates.

In some embodiments, the build platform is translated, e.g., before, during, and/or after printing one or more 3D objects in a print cycle. The translation may be in both directions (e.g., back and forth such as up and down relative to a gravitational vector). The translation may be vertical. The translation may be effectuated by a build platform assembly and/or an actuator (e.g., controlled by a control system). The build platform assembly may be configured to provide a high precision platform for building one or more 3D objects in a printing cycle with high fidelity e.g., having a high fidelity (e.g., high accuracy) of one or more characteristics (e.g., dimensions) of the generated 3D object when compared to a model or simulation of the intended 3D object. The build module may accommodate a material bed having at least one (e.g., two or more) FLS (e.g., diameter, width, and/or height) of at most about 200 mm, 250 mm, 300 mm, 350 mm, 400 mm, 450 mm, 500 mm, 550 mm, 600 mm, 650 mm, 700 mm, 800 mm, 900 mm, 1000 mm, 1200 mm, 1500 mm, 2000 mm, 2500 mm, 3000 mm, 3500 mm, 4000 mm, or 4500 mm. The FLS of the material bed accommodated by the build module may have a FLS value between any of the aforementioned values (e.g., from about 100 mm to about 4500 mm, from about 100 mm to about 2000 mm, from about 100 mm to about 700 mm, or from about 300 mm to about 4000 mm). In addition to the material bed, the build module may be configured to accommodate a base (e.g., build platform) and at least one substrate (e.g., piston). The build module may accommodate a build platform having an FLS (e.g., diameter or width) of at least about 100 millimeters (mm), 200 mm, 300 mm, 400 mm, 500 mm, 600 mm, 700 mm, 800 mm, 900 mm, 1000 mm, 1500 mm, or 2000 mm, 2500 mm, 3000 mm, 3500 mm, or 4000 mm. The build module may accommodate a build platform having at least one FLS (e.g., diameter, height and/or width), the FLS being of at most about 200 mm, 250 mm, 300 mm, 350 mm. 400 mm. 450 mm, 500 mm, 550 mm, 600 mm, 650 mm, 700 mm, 800 mm, 900 mm, 1000 mm, 1200 mm, 1500 mm, 2000 mm, 4000 mm, or 4500 mm. The FLS of the build platform accommodated by the build module may have a FLS value between any of the aforementioned values (e.g., from about 100 mm to about 4500 mm, from about 100 mm to about 1200 mm, from about 100 mm to about 1500 mm, or from about 300 mm to about 2000 mm). The build platform assembly may be able to translate in a continuous and/or discrete manner. The build platform assembly may be able to translate in discrete increments of at most about 5 micrometers (μm), 20 μm, 30 μm, 40 μm, 50 μm. 60 μm, 70 μm, or 80 μm. The build platform assembly may be able to translate in discrete increments having a value between any of the aforementioned values (e.g., from about 5 μm to about 80 μm, from about 10 μm to about 60 μm, or from about 40 μm to about 80 μm). The build platform assembly may have a precision (e.g., error +/−) of at most about 0.25 μm, 0.5 μm, 1 μm, 1.5 μm, 2 μm, 2.5 μm, 3 μm, 4 μm, or 5 μm. The build platform assembly may have a precision value between any of the aforementioned precision value (e.g., from about 0.25 μm to about 5 μm, from about 0.25 μm to about 2.5 μm, or from about 1.5 μm to about 5 μm). The build platform assembly may have a precision (e.g., error +/−) of at most about 0.5%, 1%, 2%, 3%, 4%, 5%, 6%, 8% or 10% of its incremental movement. The build platform assembly may have a precision value between any of the aforementioned precision value relative to its incremental movement (e.g., from about 0.5% to about 10%, from about 0.5% to about 5%, or from about 1% to about 10%). The weight of the material bed (e.g., including any printed 3D object therein) may be at least about 300 Kilograms (Kg), 500 Kg, 800 Kg, 1000 Kg, 1200 Kg, 1500 Kg, 1800 Kg, 2000 Kg, 2500 Kg, or 3000 Kg. The weight of the material bed (e.g., including any printed 3D object therein) may be between any of the aforementioned values (e.g., from about 300 Kg to about 3000 Kg, from about 300 Kg to about 1500 Kg, or from about 1000 Kg to about 3000 Kg). The build platform assembly may be configured to translate the build module at a speed of at most 3 millimeters per second (mm/sec). 5 mm/sec, 10 mm/sec, 20 mm/sec. 30 mm/sec, or 50 mm/sec. The build platform assembly may be configured to translate the build module at a speed of at least 1 mm/sec, 3 mm/sec, 5 mm/sec, 10 mm/sec, 20 mm/sec, 30 mm/sec, or 40 mm/sec. The build platform assembly may be configured to translate the build module at a speed between any of the aforementioned speeds (e.g., from about 1 mm/sec to about 50 mm/sec, from about 1 mm/sec to about 20 mm/sec, or from about 5 mm/sec to about 50 mm/sec). The build platform assembly may be configured to translate the build module at a speed of at most 1 millimeter per second squared (mm/sec\hat{ }2). 2.5 mm/sec\hat{ }2, 5 mm/sec\hat{ }2, 7.5 mm/sec\hat{ }2, 10 mm/sec\hat{ }2, or 20 mm/sec\hat{ }2. The build platform assembly may be configured to translate the build module at an acceleration of at least 0.5 mm/sec\hat{ }2, 1 mm/sec\hat{ }2, 2 mm/sec\hat{ }2, 3 mm/sec\hat{ }2, 5 mm/sec\hat{ }2, 10 mm/sec\hat{ }2, or 15 mm/sec\hat{ }2. The build platform assembly may be configured to translate the build module at a speed between any of the aforementioned speeds (e.g., from about 0.5 mm/sec\hat{ }2 to about 20 mm/sec\hat{ }2, from about 0.5 mm/sec\hat{ }2 to about 10 mm/sec\hat{ }2, or from about 4 mm/sec\hat{ }2 to about 20 mm/sec\hat{ }2). The build platform assembly may be configured such that a time to complete a translation of a first portion of the build platform assembly relative to a second portion of the build platform assembly (e.g., to perform a block movement) is at most about 120 seconds (sec), 60 sec, 50 sec, 45 sec, 40 sec, 35 sec, 30 sec, 25 sec, 20 sec, 15 sec, or less. The build platform assembly may be configured such that a time to complete a translation of a first portion of the build platform assembly relative to a second portion of the build platform assembly is any value between the aforementioned values, for example, from about 120 sec to 40 sec, from about 60 sec to 25 sec, or from about 35 sec to 15 sec.

In some embodiments, the energy beam is moveable with respect to a material bed and/or 3D printing system. The energy beam can be moveable such that it can translate relative to the material bed. The energy beam can be moved by an optical system (e.g., comprising a scanner). The movement of the energy beam can comprise utilization of a scanner. In some embodiments, the energy source is stationary. In some embodiments, the energy beam (e.g., laser beam) impinges onto an exposed surface of a material bed to generate at least a portion of a 3D object. The energy beam may be a focused beam. The energy beam may be a dispersed beam. The energy beam may be an aligned beam. The apparatus and/or systems described herein may comprise a focusing coil, a deflection coil, or an energy beam power supply. The optical system may be configured to direct at least one energy beam from the at least one energy source to a position on a target surface such as an exposed surface of a material bed within the enclosure, e.g., to a predetermined position on the target surface. The 3D printing system may comprise a processor (e.g., a central processing unit). The processor can be configured (e.g., programmed) to control a trajectory of the at least one energy beam and/or energy source with the aid of the optical system. The systems and/or the apparatus described herein can comprise a control system in communication with the at least one energy source and/or energy beam. The control system can regulate a supply of energy from the at least one energy source to the material in the container. The control system may control the various components of the optical system. The various components of the optical system may include optical components comprising a mirror(s), a lens (e.g., concave or convex), a fiber, a beam guide, a rotating polygon, or a prism.

In some embodiments, the 3D printer comprises a power supply. The power supply to any of the components described herein can be supplied by a grid, generator, local, or any combination thereof. The power supply can be from renewable or non-renewable sources. The renewable sources may comprise solar, wind, hydroelectric, or biofuel. The power supply can comprise rechargeable batteries.

In some embodiments, the 3D printing system can comprise at least one (e.g., a plurality of) optical windows. The optical window(s) may be arranged on a roof of the processing chamber. The optical window(s) may be arranged on a side wall of the processing chamber. The optical window(s) may be arranged with respect to the processing chamber to allow transmittance of energy beam(s) directed by the array of optical assemblies into the processing chamber. The optical window(s) may be arranged with respect to the processing chamber to allow transmittance of energy beam(s) directed by the array of optical assemblies into the processing chamber and incident on the target surface supported by the build platform. During the 3D printing, a ventilator and/or gas flow may deter (e.g., measurably and/or substantially prevent) debris from accumulating on the surface optical window(s) that are disposed within the enclosure (e.g., within the processing chamber). The debris may comprise soot, spatter, or splatter. The optical window may be supported by (or supportive of) a nozzle that directs debris away from the optical window, e.g., at towards the material bed. The processing cone may assume a shape of a truncated cone within the processing chamber.

In some embodiments, the 3D printing system comprises one or more sensors. The one or more sensors may be at least about 500, 600, 900, or 1000 sensors. At least two of the sensors may be of the same type. At least two of the sensors may be of different type. The 3D printing system includes at least one enclosure. In some embodiments, the 3D printing system (e.g., its enclosure) comprises one or more sensors (alternatively referred to herein as one or more sensors). The enclosure described herein may comprise at least one sensor. The enclosure may comprise, or be operatively coupled to, the build module, the filtering mechanism, gas recycling system, the processing chamber, or the ancillary chamber. The sensor may be connected and/or controlled by the control system (e.g., computer control system, or controller(s)). The control system may be able to receive signals from the at least one sensor. The control system, e.g., through a control scheme, may act upon at least one signal received from the at least one sensor. The control scheme may comprise a feedback and/or a feed forward control scheme, e.g., that has been pre-programmed. The feedback and/or feed forward control may rely on input from at least one sensor that is connected to the controller(s).

In some embodiments, the 3D printer comprises one or more valves. The methods, systems and/or the apparatus described herein may comprise at least one valve. The valve may be shut or opened according to an input from the at least one sensor, or manually. The degree of valve opening or shutting may be regulated by the control system, for example, according to at least one input from at least one sensor. The systems and/or the apparatus described herein can include one or more valves, such as throttle valves. The valve may or may not comprise a sensor sensing the open/shut position of the valve. The valve may be a component of a gas flow mechanism (e.g., also referred to herein as “a gas flow manifold”, “gas flow assembly,” or “gas flow system”), e.g., operable to control a flow of gas of the gas flow mechanism. A valve may be a component of gas flow assembly, e.g., operable to control a flow of gas of the gas flow assembly.

In some embodiments, the 3D printer comprises one or more actuators such as motors. The motor may be controlled by the controller(s) (e.g., by the control system) and/or manually. The motor may alter (e.g., the position of) the substrate and/or to the base. The motor may alter (e.g., the position of) the build platform assembly. The actuator may facilitate translation (e.g., propagation) of the layer dispenser, e.g., the actuator may facilitate reversible translation of the layer dispenser. The motor may after an opening of the enclosure (e.g., its opening or closure). The motor may be a step motor or a servomotor. The actuator (e.g., motor) may alter (e.g., a position of) one or more optical components, e.g., mirrors, lenses, prisms, and the like. The servomotors may comprise actuated linear lead screw drive motors. The motors may comprise belt drive motors. The motors may comprise rotary encoders. The encoder may comprise an absolute encoder. The encoder may comprise an incremental encoder. The apparatuses and/or systems may comprise switches. The switches may comprise homing or limit switches. The motors may comprise actuators. The motors may comprise linear actuators. The motors may comprise belt driven actuators. The motors may comprise lead screw driven actuators. The actuators may comprise linear actuators.

In some embodiments, the 3D printer (e.g., its components) comprises one or more nozzles. The systems and/or the apparatus described herein may comprise at least one nozzle. For example, the material remover (e.g., also referred to herein as a “remover” and “material removal mechanism”) may comprise a nozzle. The nozzle may be regulated according to at least one input from at least one sensor. The nozzle may be controlled automatically or manually. The controller(s) may control the nozzle. The controller(s) may any controller(s) disclosed herein, e.g., as part of the control system of the 3D printer. The nozzle may include jet (e.g., gas jet) nozzle, high velocity nozzle, propelling nozzle, magnetic nozzle, spray nozzle, vacuum nozzle, or shaping nozzle (e.g., a die). The nozzle can be a convergent or a divergent nozzle. The spray nozzle may comprise an atomizer nozzle, an air-aspirating nozzle, or a swirl nozzle. The layer dispensing mechanism can comprise a nozzle, e.g., through which material is removed from the material bed. The gas flow system may comprise a nozzle, e.g., that facilitates adjustment to the gas flow. The optical window may be supported by a nozzle that directs debris away from the optical window, e.g., at towards the material bed. The nozzle may comprise a venturi nozzle.

In some embodiments, the 3D printer comprises at least one filter. The filter may be a ventilation filter. The ventilation filter may capture debris and/or other gas-borne material from the 3D printing system. The filter may comprise a paper filter such as a high-efficiency particulate air (HEPA) filter (a.k.a., high-efficiency particulate arresting filter). The ventilation filter may capture debris comprising soot, splatter, spatter, gas borne pre-transformed material, or gas borne transformed material. The debris may result from the 3D printing process. The ventilator may direct the debris in a requested direction (e.g., by using positive or negative gas pressure). For example, the ventilator may use vacuum. For example, the ventilator may use gas flow.

In some embodiments, the systems, apparatuses, and/or components thereof comprise one or more controllers. The one or more controllers can comprise one or more central processing unit (CPU), input/output (1/O) and/or communications module. The controller may monitor and/or direct (e.g., physical) alteration of the operating conditions of the apparatuses, software, and/or methods described herein. The controller may be a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from a sensor). The controller may deliver an output. The controller may be part of a control system comprising multiple controllers. The controller may receive multiple inputs. The controller may generate multiple outputs. The controller may be a single input single output controller (SISO) or a multiple input multiple output controller (MIMO). The controller may interpret the input signal received. The controller may acquire data from the one or more sensors. Acquire may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open loop control, or closed loop control. The controller may comprise closed loop control. The controller may comprise open loop control. The controller may utilize one or more wired and/or wireless networks for communication, e.g., with other controllers or devices, apparatuses, or systems of the 3D printing system and its components. For example, wired ethernet technologies, e.g., a local area networks (LAN). For example, wireless communication technologies, e.g., a wireless local area network (WLAN). The controller may utilize one or more control protocols for communication, for example, with other controller(s) or one or more devices, apparatuses, or systems of the 3D printing system or any of its components. Control protocols can comprise one or more protocols of an internet protocol suite, e.g., transmission control protocol (TCP) or transmission control protocol/internet protocol (TCP/IP). Control protocols can comprise one or more serial communication protocols. Control protocols can comprise one or more of controller area networks or another message-based protocol, e.g., for communication with microcontrollers and devices. Control protocols can interface with one or more serial bus interfaces for communication with the 3D printing system and its components. The controller may comprise a user interface. The user interface may comprise a keyboard, keypad, mouse, touch screen, microphone, speech recognition package, camera, imaging system, or any combination thereof. The outputs may include a display (e.g., screen), speaker, touch screen, microphone, or printer. Examples of controller, control protocols, control systems, 3D printing systems, apparatuses, devices, and any of their components, and 3D printing processes can be found in International Patent Application Serial No. PCT/US17/18191, filed Feb. 16, 2017, titled “ACCURATE THREE-DIMENSIONAL PRINTING,” which is incorporated herein by reference in its entirety.

Control may comprise regulate, modulate, adjust, maintain, alter, change, govern, manage, restrain, restrict, direct, guide, oversee, manage, preserve, sustain, restrain, temper, or vary.

In some embodiments, the methods, systems, device, software and/or the apparatuses described herein comprise a control system. The control system can be in communication with one or more components of the 3D printing system. The control system can be in communication with one or more components facilitating the 3D printing methodologies. The control system can be in communication with one or more energy sources, optical systems, gas flow system, material flow systems, energy (e.g., energy beams), build platform assembly, and/or with any other component of the 3D printing system.

At times, the methods described herein are performed in an enclosure (e.g., container, processing chamber, and/or build module). One or more 3D objects can be formed (e.g., generated, and/or printed) in the enclosure (e.g., simultaneously, and/or sequentially). The enclosure may have a predetermined and/or controlled pressure. The enclosure may have a predetermined and/or controlled atmosphere. The control may be manual or via a control system.

In some embodiments, the enclosure comprises an atmosphere having an ambient pressure (e.g., one atmosphere), or positive pressure. In some embodiments, the atmosphere may have a negative pressure (i.e., vacuum). In some embodiments, different portions of the enclosure have different atmospheres. The different atmospheres may comprise different gas compositions. The different atmospheres may comprise different atmosphere temperatures. The different atmospheres may comprise ambient pressure (e.g., 1 atmosphere), negative pressure (i.e., vacuum) or positive pressure. The different portions of the enclosure may comprise the processing chamber, build module, or enclosure volume excluding the processing chamber and/or build module. The vacuum may comprise pressure below 1 bar, or below 1 atmosphere. The positively pressurized environment may comprise pressure above 1 bar or above 1 atmosphere. In some cases, the chamber pressure can be standard atmospheric pressure. The pressure may be measured at an ambient temperature (e.g., room temperature such as 20° C., or 25° C.).

In some embodiments, the enclosure comprises an atmosphere. The atmosphere within the enclosure may comprise a positive pressure. The atmosphere within the enclosure may be different that an atmosphere outside the enclosure. At times, a differential atmosphere (e.g., a difference in atmospheres between the inside of the enclosure and the outside of the enclosure) depends in part on a processing conditions of the three-dimensional printing. Processing conditions can include, for example, (i) a composition of the pre-transformed material, (ii) an internal temperature of the material bed during the three-dimensional processing, (iii) a number of energy beams (e.g., an average number of energy beams) transforming (e.g., incident on) the target surface during the three-dimensional processing, (iv) an amount of contamination by debris during the three-dimensional processing, (v) temperature in the material bed during 3D printing. (vi) temperature in the processing chamber during the printing, (vii) amount of energy supplied by the energy beams to the material bed, or (vii) any combination thereof. For example, a differential atmosphere between the interior of the enclosure (e.g., within the processing chamber) and an ambient environment external to the enclosure may depend at least in part on an average number of energy beams utilized during the three-dimensional process.

In some embodiments, the enclosure includes an atmosphere that is greater than (e.g., at a positive pressure with respect to) an ambient atmosphere external to the enclosure. The atmosphere within the enclosure may comprise a positive pressure of at least about 1 Kilopascals (kPa), 10 kPa, 100 kPa, 120 kPa, 150 kPa, 200 kPa, 300 kPa, 400 kPa, 500 kPa, 750 kPa, or 1000 kPa. The atmosphere within the enclosure may comprise a positive pressure of any value between the aforementioned values, for example, from about 1 kPa to about 1000 kPa, from about 1 kPa to about 100 kPa, from about 100 kPa to about 400 kPa, from about 550 kPa to about 900 kPa, or from about 700 kPa to about 1000 kPa. The composition of the atmosphere within the enclosure may comprise any one or more of the gases described herein, for example, clean dry air (CDA), argon, and/or nitrogen. The enclosure may comprise a gas flow, e.g., before, after, and/or during three-dimensional printing. The gas flow within the enclosure may comprise at least about 150 liters per minute (LPM), 200 LPM, 250 LPM, 300 LPM, 350 LPM, 400 LPM, 450 LPM, 500 LPM, 550 LPM, 600 LPM, 650 LPM, 700 LPM, 750 LPM, 800 LPM, 900 LPM, 1000 LPM, or 1200 LPM. The gas flow within the enclosure may comprise any value between the aforementioned values, for example, from about 150 LPM to about 500 LPM, from about 450 LPM to about 750 LPM, or from about 700 LPM to about 1200 LPM. The composition of the gas may comprise any one or more of the gases described herein, for example, clean dry air (CDA), argon, or nitrogen. The gas may comprise a reactive agent (e.g., comprising oxygen or humidity). The atmosphere may comprise a v/v percent of the reactive agent (gas) of at most about 0.05%, 0.1%, 0.2%, 0.3%, 0.4%, 0.5%, 0.6%, 0.7%, 0.8%, 0.9%, 1%. 2%, 3%, 4%, or 5%, at ambient pressure (e.g., and ambient temperature). The atmosphere may comprise any percent of the reactive agent (gas) between the afore-mentioned percentages of hydrogen gas.

In some embodiments, material utilized in the 3D printing undergoes passivation, e.g., using passivation system(s). A passivation system may comprise (A) an in-situ passivation system, (B) an ex-situ passivation system, or (C) a combination thereof. The passivation system may control a level of the oxidizing agent below a threshold. The oxidizing agent in the oxidizing mixture (e.g., oxygen) may be kept below a threshold (e.g., below 2000 ppm), e.g., by using one or more controllers such as the control system disclosed herein.

In some embodiments, humidity levels and/or oxygen levels in at least a portion of the enclosure, (e.g., processing chamber, ancillary chamber, and/or build module) can be regulated such that an oxygenation and/or humidification of powder in the powder conveyance system is controlled. For example, oxygenation and/or humidification levels of recycled pre-transformed material (e.g., recycled powder material) can be about 5 parts per million (ppm) to about 1500 ppm. For example, oxygenation and/or humidification levels of recycled pre-transformed material can be at most about 1500 ppm, 1200 ppm, 1000 ppm, 500 ppm, 250 ppm, or less. For example, oxygenation and/or humidification levels of pre-transformed material can be about zero ppm. For example, oxygen content in pre-transformed material can be about 0 weight percent (wt %), 0.1 wt %, 0.25 wt %, 0.3 wt %, 0.5 wt %, 0.75 wt %, 1.0 wt %, or more. At times, atmospheric conditions can, in part, influence a flowability of pre-transformed material (e.g., powder material) from the layer dispensing mechanism. A dew point of an internal atmosphere of an enclosure (e.g., of the processing chamber) can be (1) below a level in which the powder particles absorb water such that they become reactive under condition of 3D printing process(es) and/or sufficient to cause measurable defects in a 3D object printed from the powder particles and (II) above a level of humidity below which the powder agglomerates, (e.g., electrostatically). In some embodiments, conditions (1) and/or (II) may depend in part on a type of powder material and/or on processing condition(s) of the 3D printing process(es). For example, a dew point of an internal atmosphere of the enclosure (e.g., of the processing chamber) can be from about −80° C. to about −30° C., from about −65° C. to about −40° C., or from about −55° C. to about −45° C., at an atmospheric pressure of at least about 10 kilo-Pascals (kPa), about 12 kPa, about 14 kPa, about 16 kPa, about 18 kPa, about 20 kPa above ambient pressure external to the enclosure. For example, a dew point of an internal atmosphere of the enclosure can be any value within or including the afore-mentioned values. The 3D printing system may comprise an in-situ passivation system, e.g., to passivate filtered debris and/or any other gas borne material before their disposal. Examples of gas conveyance system and components (including control components), in-situ passivation systems, controlled oxidation methods, devices, systems (e.g., 3D printing systems), control systems, software, and other related processes, can be found in International Patent Application Serial Nos. PCT/US17/60035 and PCT/US21/35350, each of which is incorporated herein by reference in its entirety.

In some embodiments, the enclosure includes an atmosphere. The enclosure may comprise a processing chamber, an ancillary chamber, a build module, or any other enclosure disclosed herein, e.g., in relation to the three-dimensional printing system. The enclosure may comprise a (e.g., substantially) inert atmosphere. The atmosphere in the enclosure may be (e.g., substantially) depleted by one or more gases present in the ambient atmosphere. The atmosphere in the enclosure may include a reduced level of one or more gases relative to the ambient atmosphere. For example, the atmosphere may be substantially depleted, or have reduced levels of water (i.e., humidity), oxygen, nitrogen, carbon dioxide, hydrogen sulfide, or any combination thereof. The level of the depleted or reduced level gas may be at most about 50 parts per million (ppm), 100 ppm, 400 ppm, 500 ppm, 1000 ppm, 3000 ppm, or 5000 ppm volume by volume (v/v). The level of the depleted or reduced level gas may be at least about 10 ppm, 50 ppm, 100 ppm, 500 ppm, 1000 ppm, or 5000 ppm (v/v). For example, the level of the oxygen gas may be at most about 10 ppm, 50 ppm, 100 ppm, 400 ppm, 500 ppm, 1000 ppm, or 2000 ppm (v/v). The level of the water vapor may be at most about 1 ppm, 10 ppm, 50 ppm, 100 ppm, 400 ppm, 500 ppm, 700 ppm, 800 ppm, 900 ppm, 1000 ppm, or 2000 ppm (v/v). The level of the gas (e.g., depleted or reduced level gas, oxygen, or water) may be between any of the afore-mentioned levels of gas. The atmosphere may comprise air. The atmosphere may be inert. The atmosphere in the enclosure (e.g., processing chamber) may have reduced reactivity (e.g., be non-reactive) as compared to the ambient atmosphere external to the processing chamber and/or external to the printing system. The atmosphere may have reduced reactivity with the material (e.g., the pre-transformed material deposited in the layer of material (e.g., powder) or with the material comprising the 3D object), which reduced reactivity is compared to the reactivity of the ambient atmosphere. The atmosphere may hinder (e.g., prevent) oxidation of the generated 3D object, e.g., as compared to the oxidation by an ambient atmosphere external to the 3D printer and/or processing chamber. The atmosphere may hinder (e.g., prevent) oxidation of the pre-transformed material within the layer of pre-transformed material before its transformation, during its transformation, after its transformation, before its hardening, after its hardening, or any combination thereof. The atmosphere may comprise an inert gas. For example, the atmosphere may comprise argon or nitrogen gas. The atmosphere may comprise a Nobel gas. The atmosphere can comprise a gas selected from the group consisting of argon, nitrogen, helium, neon, krypton, xenon, hydrogen, carbon monoxide, and carbon dioxide. The atmosphere may comprise hydrogen gas. The atmosphere may comprise a safe amount of hydrogen gas. The atmosphere may comprise a v/v percent of hydrogen gas of at least about 0.05%, 0.1%, 0.2%. 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise a v/v percent of hydrogen gas of at most about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise any percent of hydrogen between the afore-mentioned percentages of hydrogen gas. The atmosphere may comprise a v/v hydrogen gas percent that is at least able to react with the material (e.g., at ambient temperature and/or at ambient pressure), and at most adhere to the prevalent work-safety standards in the jurisdiction (e.g., hydrogen codes and standards). The material may be the material within the layer of pre-transformed material (e.g., powder), the transformed material, the hardened material, or the material within the 3D object. Ambient refers to a condition to which people are generally accustomed. For example, ambient pressure may be about one (1) atmosphere. The concentration of oxygen and/or humidity in the enclosure (e.g., chamber) can be minimized, e.g., below a predetermined threshold value. For example, the gas composition of the chamber can contain a level of oxygen that is at most about 4000 parts per million (ppm), 3000 ppm, 2000 ppm, 1500 ppm, 1000 ppm, 500 ppm, 400 ppm, 100 ppm, or 50 ppm. The gas composition of the chamber can contain an oxygen level between any of the afore-mentioned values (e.g., from about 4000 ppm to about 50 ppm, from about 2000 ppm to about 500 ppm, from about 1500 ppm to about 500 ppm, or from 500 ppm to about 50 ppm). For example, the gas composition of the chamber can contain a level of humidity that correspond to a dew point of at most about −10° C., −15° C., −20° C., −25° C., −30° C., −35° C., or −40° C. The gas composition of the chamber can contain a level of humidity that correspond to a dew point of between any of the aforementioned values, e.g., from about −40° C. to about −10° C., or from about −30° C. to about −20° C. The gas composition may be measures by one or more sensors, e.g., an oxygen and/or humidity sensor. In some cases, the chamber can be opened at or after printing the 3D object. When the processing chamber is opened, ambient air containing oxygen and/or humidity can enter the chamber. Exposure of one or more components inside of the chamber to air can be reduced by, for example, flowing an inert gas while the chamber is open (e.g., to prevent entry of ambient air), or by flowing a heavy gas (e.g., argon) that rests on the surface of the powder bed.

Any of the apparatuses and/or their components disclosed herein may be built by a material disclosed herein. The apparatuses and/or their components comprise a transparent or non-transparent (e.g., opaque) material. For example, the apparatuses and/or their components may comprise an organic or an inorganic material. For example, the apparatuses and/or their components may comprise an elemental metal, metal alloy, ceramic, or an allotrope of elemental carbon. For example, the enclosure, platform, recycling system, or any of their components may comprise an elemental metal, metal alloy, ceramic, or an allotrope of elemental carbon.

The present disclosure provides three-dimensional (3D) printing apparatuses, systems, software, and methods for forming a 3D object. For example, a 3D object may be formed by sequential addition of material or joining of starting material (e.g., pre-transformed material or source material) to form a structure in a controlled manner (e.g., under manual or automated control).

Three-dimensional printing (also “3D printing”) generally refers to a process for generating a 3D object. For example, 3D printing may refer to sequential addition of material layer or joining of material layers (or parts of material layers) to form a 3D structure, in a controlled manner. The controlled manner may include automated control. In the 3D printing process, the deposited pre-transformed material may be transformed (e.g., fused, sintered, melted, bound, or otherwise connected) to (e.g., subsequently) harden and form at least a portion of the requested 3D object. Fusing (e.g., sintering or melting) binding, or otherwise connecting the material is collectively referred to herein as transforming the pre-transformed material (e.g., powder material). Fusing the pre-transformed material may include melting or sintering the pre-transformed material. Binding can comprise chemical bonding. Chemical bonding can comprise covalent bonding. In some embodiments, melting may comprise liquefying the material (i.e., transforming to a liquefied state). A liquefied state refers to a state in which at least a portion of a transformed material may include melting or sintering the pre-transformed material. Melting may comprise liquidizing the material (e.g., transforming to a liquidus state). A liquidus state refers to a state in which (e.g., an entire) transformed material is in a liquid state. Examples of 3D printing may include additive printing (e.g., layer by layer printing, or additive manufacturing). 3D printing may include layered manufacturing. 3D printing may include rapid prototyping. 3D printing may include solid freeform fabrication. 3D printing may include direct material deposition. The 3D printing may further comprise subtractive printing.

In some embodiments, the 3D object comprises a hanging structure. The hanging structure may be a plane like structure (referred to herein as “three-dimensional plane,” or “3D plane”). The 3D plane may have a relatively small width as opposed to a relatively large surface area. For example, the 3D plane may have a small height relative to a large horizontal projection (e.g., plane). The 3D plane may be planar, curved, or assume an amorphous 3D shape. The 3D plane may be a strip, a blade, or a ledge. The 3D plane may comprise a curvature. The 3D plane may be curved. The 3D plane may be planar (e.g., flat). The 3D plane may have a shape of a curving scarf. The 3D object may comprise a wire. The term “3D plane” is understood herein to be a generic (e.g., curved) 3D surface. For example, the 3D plane may be a curved 3D surface. The one or more layers within the 3D object may be (e.g., substantially) planar (e.g., flat). The planarity of a surface or a boundary the layer may be (e.g., substantially) uniform. In some embodiments, substantially uniform may be relative to the intended purpose of the 3D object. The height of the layer at a particular position may be compared to an average layering plane. The layering plane can refer to a plane that a layer of the 3D object is (e.g., substantially) oriented during printing. A boundary between two adjacent (printed) layers of hardened material of the 3D object may define a layering plane. The boundary may be apparent by, for example, one or more melt pool terminuses (e.g., bottom or top). A 3D object may include multiple layering planes (e.g., corresponding to each layer). In some embodiments, the layering planes are (e.g., substantially) parallel to one another. An average layering plane may be defined by a linear regression analysis (e.g., least squares planar fit of the top-most part of the surface of the layer of hardened material). An average layering plane may be a plane calculated by averaging the material height at each selected point on the top surface of the layer of hardened material. The selected points may be within a specified region of the 3D object. The deviation from any point at the surface of the planar layer of hardened material may be at most 20% 15%, 10%, 5%, 3%, 1%, or 0.5% of the height (e.g., thickness) of the layer of hardened material.

In some examples, when the energy source is in operation, the material bed reaches a certain (e.g., average) temperature. The average temperature of the material bed can be an ambient temperature or “room temperature.” The average temperature of the material bed can have an average temperature during the operation of the energy (e.g., beam(s)). The average temperature of the material bed can be an average temperature during the formation of the transformed material, the formation of the hardened material, or the generation of the 3D object. The average temperature can be below or just below the transforming temperature of the material. Just below can refer to a temperature that is by at most about 1° C., 2° C., 3° C. 4° C., 5° C., 6° C., 7° C., 8° C., 9° C., 10 C, 15° C., or 20° C. below the transforming temperature. The average temperature of the material bed (e.g., pre-transformed material) can be by at most about 25° C. (degrees Celsius), 50° C., 100° C., 150° C., 200° C., 250° C., 300° C., 400° C., 500° C., 600° C., 700° C., 800° C. 900° C., 1000° C., 1200° C., 1400° C., 1600° C., 1800° C., or 2000° C. The average temperature of the material bed (e.g., pre-transformed material) can be at least about 20° C., 25° C., 50° C. 100° C., 150° C., 200° C., 250° C., 300° C., 400° C., 500° C., 600° C., 700° C., 800° C., 900° C., 1000° C., 1200° C. 1400° C., 1600° C., or 1800° C. The average temperature of the material bed (e.g., of the pre-transformed material therein) can be any temperature between the afore-mentioned material average temperatures. The temperature of the material bed can be conditioned (e.g., heated or cooled) before, during, or after forming (e.g., printing) the 3D object (e.g., hardened material). The material bed temperature can be controller (e.g., substantially maintained) at a predetermined value. The temperature of the material bed can be monitored. The material temperature can be controlled manually and/or by a control system (e.g., such as any control system disclosed herein).

In some embodiments, 3D printing methodologies comprises extrusion, wire, granular, laminated, light polymerization, or powder-bed-and-inkjet-head-3D-printing. Extrusion 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), arc welding (e.g., powder-based arc welding) electron beam melting (EBM), selective laser melting (SLM), selective heat sintering (SHS), or selective laser sintering (SLS). Powder bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP), or laminated object manufacturing (LOM). 3D printing methodologies can comprise Direct Material Deposition (DMD). The Direct Material Deposition may comprise, Laser Metal Deposition (LMD, also known as, Laser deposition welding). 3D printing methodologies can comprise powder feed, or wire deposition.

In some examples, 3D printing methodologies differ from methods traditionally used in semiconductor device fabrication (e.g., vapor deposition, etching, annealing, masking, or molecular beam epitaxy). In some instances, 3D printing may further comprise one or more printing methodologies that are traditionally used in semiconductor device fabrication. 3D printing methodologies can differ from vapor deposition methods such as chemical vapor deposition, physical vapor deposition, or electrochemical deposition. In some instances. 3D printing may further include vapor deposition methods.

The methods, apparatuses, software, and systems of the present disclosure can be used to form 3D objects for various uses and applications. Such uses and applications include, without limitation, electronics, components of electronics (e.g., casings), machines, parts of machines, tools, implants, prosthetics, fashion items, clothing, shoes, or jewelry. The implants may be directed (e.g., integrated) to a hard, a soft tissue, or to a combination of hard and soft tissues. The implants may form adhesion with hard and/or soft tissue. The machines may include a motor or motor part. The machines may include a vehicle. The machines may comprise aerospace related machines. The machines may comprise airborne machines. The vehicle may include an airplane, drone, car, train, bicycle, boat, or shuttle (e.g., space shuttle). The machine may include a satellite or a missile. The uses and applications may include 3D objects relating to the industries and/or products listed herein.

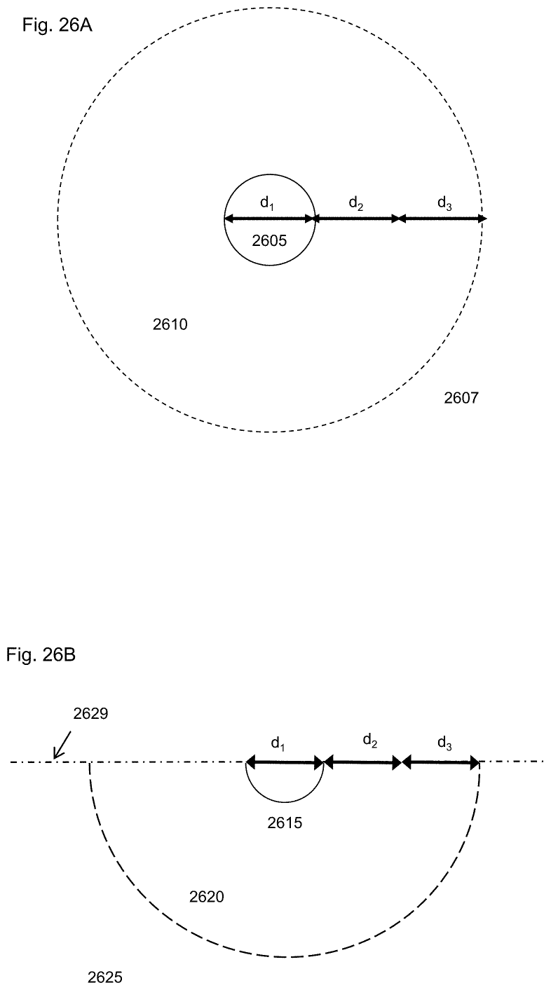

The present disclosure provides systems, apparatuses, software, and/or methods for 3D printing of a requested 3D object from a pre-transformed material (e.g., starting material such as powder material). Pre-transformed material as understood herein is a material before it has been transformed by an energy beam (e.g., transforming energy beam) during the 3D printing process. The pre-transformed material may be a material that was, or was not, transformed prior to its use in the 3D printing process. The object can be pre-ordered, pre-designed, pre-modeled, or designed in real-time (i.e., during the process of 3D printing). The 3D printing method can be an additive method in which a first layer of hardened material is printed, and thereafter a volume of a pre-transformed material is added to the first layer as separate sequential layer (or parts thereof). Each additional sequential layer (or part thereof) can be added to the previous layer of hardened material by transforming (e.g., fusing (e.g., melting)) a fraction of the pre-transformed material into a transformed material. The transformed material may be a hardened material. Alternatively, the transformed material may subsequently harden (e.g., a solid powder may melt and subsequently solidify). The hardened layer may be at least a portion of the (hard) 3D object. The hardening can be actively induced (e.g., by cooling) or can occur without intervention (i.e., naturally). The transformation of the pre-transformed material may be effectuated by using one or more energy beams. The pre-transformed material may be disposed in a material bed prior to its transformation (e.g., by the energy beam). At time, the pre-transformed material is injected onto a build platform and be transform before contacting the build platform (e.g., on its way to the build platform), or just when contacting the build platform. The layer of pre-transformed material may be deposited using a layer dispensing mechanism (e.g., comprising a material dispensing mechanism, leveling mechanism, and/or a material removal mechanism). The temperature of the material bed (e.g., interior, and/or exposed surface thereof) may be controlled by at least one controller. The metrological parameters of the material bed (e.g., exposed surface thereof) may be controlled by at least one controller. The metrological parameters of the layer of hardened material (e.g., exposed surface thereof) may be controlled by at least one controller. The metrological parameters of the 3D object (e.g., exposed surface thereof) may be controlled by at least one controller. Metrological parameters may comprise height, width, or length. In some embodiments, the 3D printing comprises heating at least a portion of a material bed, and/or a previously formed area of hardened material using at least one transforming energy source. In some embodiments, the heated area may comprise an area of transformed material. The heated area may encompass the bottom skin layer. The heated area may comprise a heat affected zone (e.g., FIG. 26A, 2610). The heated area may allow a parallel position at the bottom skin layer to reach an elevated temperature that is above the solidus temperature (e.g., and at or below the liquidus temperature) of the material at the bottom skin layer, transform (e.g., sinter or melt), become liquidus, and/or plastically yield, which parallel position is parallel to the irradiated position at the exposed surface. For example, the heated area may allow the layers comprising the bottom skin layer to reach an elevated temperature that is above the solidus temperature of the material (e.g., and at or below the liquidus temperature of the material at the previously formed layer such as the bottom skin layer), transform, become liquidus, and/or plastically yield. The heating by the transforming energy beam may allow reaching an elevated temperature that is above the: solidus temperature of the material (e.g., and at or below its liquidus temperature), transforming (e.g., melting) temperature, liquefying temperature, temperature of becoming liquidus, and/or plastic yielding temperature of the heated layer of hardened material and/or one or more layers beneath the heated layer (e.g., the bottom skin layer). For example, the heating may penetrate one, two, three, four, five, six, seven, eight, nine, ten, or more layers of the hardened material (e.g., not only the layer that is exposed, but also deeper layers within the 3D object), or the entire 3D object (e.g., or unsupported portion thereof) reaching the bottom skin layer. For example, heating may penetrate one, two, three, four, five, six, seven, eight, nine, ten, or more layers of the pre-transformed material (e.g., not only the layer that is exposed in the material bed, but also deeper layers within the material bed), or the entire depth of the material bed (e.g., fuse the entire depth of the material bed).

The very first formed layer of hardened material in a 3D object is referred to herein as the “bottom skin.” In some embodiments, the bottom skin layer is the very first layer in an unsupported portion of a 3D object. The unsupported portion may not be supported by auxiliary supports. The unsupported portion may be connected to the center (e.g., core) of the 3D object and may not be otherwise supported by, or anchored to, the build platform. For example, the unsupported portion may be a hanging structure (e.g., a ledge) or a cavity ceiling.

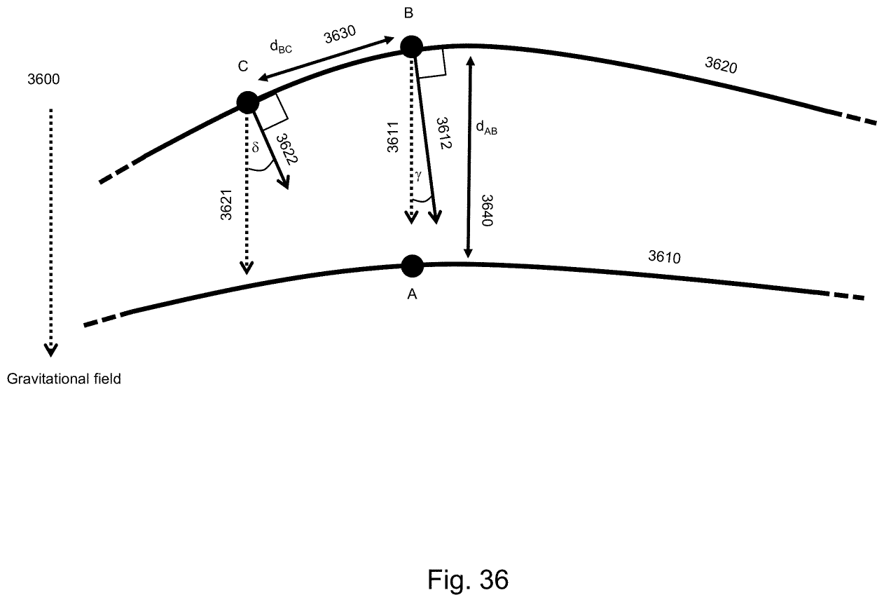

In some embodiments, the 3D object comprises a first portion and a second portion. The first portion may be connected to a sub-structure (e.g., core) at one, two, or three sides (e.g., as viewed from the top). The sub-structure may be the rest of the 3D object. The second portion may be connected to the sub-structure at one, two, or three sides (e.g., as viewed from the top). For example, the first and second portion may be connected to a sub-structure (e.g., column, post, or wall) of the 3D object. For example, the first and second portion may be connected to an external cover that is a part of the 3D object. The first and/or second portion may be a wire or a 3D plane. The first and/or second portion may be different from a wire or 3D plane. The first and/or second portion may be a blade (e.g., turbine or impeller blade). The first and second portions may be (e.g., substantially) identical in terms of structure, geometry, volume, and/or material composition. The first and second portions may be (e.g., substantially) identical in terms of structure, geometry, volume, material composition, or any combination thereof. The first portion may comprise a top surface. Top may be in the direction away from the build platform and/or opposite to the gravitational field. The second portion may comprise a bottom surface (e.g., bottom skin surface). Bottom may be in the direction towards the build platform and/or in the direction of the gravitational field. FIG. 36 shows an example of a first (e.g., top) surface 3610 and a second (e.g., bottom) surface 3620. At least a portion of the first and second surfaces are separated by a gap. At least a portion of the first surface is separated by at least a portion of the second surface (e.g., to constitute a gap). The gap may be filled with pre-transformed or transformed (e.g., and subsequently hardened) material during the formation of the 3D object. The second surface may be a bottom skin layer. FIG. 36 shows an example of a vertical gap distance 3840 that separates the first surface 3610 from the second surface 3620. The vertical gap distance may be equal to the distance disclosed herein between two adjacent 3D planes. The vertical gap distance may be equal to the vertical distance of the gap as disclosed herein. The vertical distance of the gap may be at least about 30 microns (μm), 35 μm, 40 μm, 50 μm, 60 μm, 70 μm, 80 μm, 90 μm, 100 μm. 150 μm, 200 μm, 0.05 mm, 0.1 mm, 0.25 mm, 0.5 mm. 1 mm. 2 mm. 3 mm, 4 mm. 5 mm, 6 mm, 7 mm, 8 mm, 9 mm, or 10 mm. The vertical distance of the gap may be at most about 0.05 mm, 0.1 mm, 0.25 mm, 0.5 mm, 1 mm, 2 mm, 3 mm, 4 mm, 5 mm, 6 mm, 7 mm, 8 mm, 9 mm, 10 mm, or 20 mm. The vertical distance of the gap may be any value between the afore-mentioned values (e.g., from about 30 μm to about 200 μm, from about 100 μm to about 200 μm, from about 30 μm to about 100 mm, from about 80 mm to about 150 mm, from about 0.05 mm to about 20 mm, from about 0.05 mm to about 0.5 mm, from about 0.2 mm to about 3 mm, from about 0.1 mm to about 10 mm, or from about 3 mm to about 20 mm). Point A (e.g., in FIG. 36) may reside on the top surface of the first portion. Point B may reside on the bottom surface of the second portion. The second portion may be a cavity ceiling or hanging structure as part of the 3D object. Point B (e.g., in FIG. 36) may reside above point A. The gap may be the (e.g., shortest) distance (e.g., vertical distance) between points A and B. FIG. 36 shows an example of the gap 3640 that constitutes the shortest distance d_{AB} between points A and B. There may be a first normal to the bottom surface of the second portion at point B. FIG. 36 shows an example of a first normal 3612 to the surface 3620 at point B. The angle between the first normal 3612 and a direction of the gravitational acceleration vector 3600 (e.g., direction of the gravitational field) may be any angle γ. Point C may reside on the bottom surface of the second portion. There may be a second normal to the bottom surface of the second portion at point C. FIG. 36 shows an example of the second normal 3622 to the surface 3620 at point C. The angle between the second normal 3622 and the direction of the gravitational acceleration vector 3600 may be any angle δ. Vectors 3611, and 3621 are parallel to the gravitational acceleration vector 3600. The angles γ and δ may be the same or different. The angle between the first normal 3612 and/or the second normal 3622 to the direction of the gravitational acceleration vector 3600 may be any angle alpha. The angle between the first normal 3612 and/or the second normal 3622 with respect to the normal to the substrate may be any angle alpha. The angles γ and δ may be any angle alpha. For example, alpha may be at most about 45°, 40°, 300, 200° 100, 50, 3°, 2°, 1°, or 0.5°. The shortest distance between points B and C may be any value of the auxiliary support feature spacing distance mentioned herein. For example, the shortest distance BC (e.g., dac) may be at least about 0.1 millimeters (mm), 0.5 mm, 1 mm, 1.5 mm, 2 mm, 3 mm, 4 mm, 5 mm, 10 mm, 15 mm, 20 mm, 25 mm, 30 mm 35 mm, 40 mm, 50 mm, 100 mm, 200 mm, 300 mm, 400 mm, or 500 mm. As another example, the shortest distance BC may be at most about 500 mm, 400 mm, 300 mm, 200 mm, 100 mm, 50 mm, 40 mm, 35 mm, 30 mm, 25 mm, 20 mm, 15 mm, 10 mm, 5 mm, 4 mm, 3 mm, 2 mm, 1.5 mm, 1 mm, 0.5 mm, or 0.1 mm. FIG. 36 shows an example of the shortest distance BC (e.g., 3630, d_{BC}). The bottom skin layer may be the first surface and/or the second surface. The bottom skin layer may be the first formed layer of the 3D object. The bottom skin layer may be the first formed hanging layer in the 3D object (e.g., that is separated by a gap from a previously formed layer of the 3D object).

As understood herein: The solidus temperature of the material is a temperature wherein the material is in a solid state at a given pressure. The liquefying temperature of the material is the temperature at which at least part of the pre-transformed material transitions from a solid to a liquid phase at a given pressure. The liquefying temperature is equal to a liquidus temperature where the entire material is in a liquid state at a given pressure.

In some embodiments, the 3D printer comprises one or more sensors. The sensor may sense, detect, and/or observe a physical attribute during the 3D printing. The physical attribute may correlate to and/or directly detect (i) a temperature at one or more positions at the target surface, a power density of the (e.g., transforming) energy beam, (iii) a power of an energy source that generates the energy beam, or (iv) any combination thereof. The physical attribute may comprise an irradiation (e.g., reflection) of a beam (e.g., electromagnetic beam) from the target surface. For example, the physical attribute may comprise a wavelength, intensity, or duration, of the (e.g., electromagnetic) beam. The physical attribute may be included in a spectroscopic measurement. The physical attribute may be included in an (e.g., optical) image. The physical attribute may include a FLS of a melt pool formed at the target surface with the transforming energy beam (e.g., FIG. 26A, 2605), and/or its vicinity (e.g., 2610). The sensor measurement(s) may be used to: (i) provide quality assurance of the printed 3D object, (ii) provide historical data that may be used to adjust a computer model relating to the 3D printing. (iii) control in real-time one or more aspects of the 3D printing, or (iv) any combination thereof.

In some embodiments, the sensor measurement(s) and/or other 3D printing process parameter(s) may allow a user, client and/or customer to determine if a 3D object passes a performance threshold (e.g., to prevent failure and/or mistakes in the 3D object's performance in its intended purpose). The sensor measurement(s) and/or other 3D printing process parameter(s) may provide confidence that the quality requirements of the 3D object are fulfilled. The sensor measurement(s) and/or other 3D printing process parameter(s) may allow a user, client and/or customer to ensure the quality of a 3D object. The quality assurance may comprise (i) a comparison with a standard, (ii) monitoring of the 3D printing processes, or (iii) feedback and/or closed loop control. The standard may be based on historical data of previously printed and/or otherwise manufactured respective 3D object. The standard may relate to an industrial standard. The quality assurance may comprise a quality control of the 3D object. The quality assurance may comprise a statistical process control of the 3D printing. The quality assurance may provide a fingerprint of the process for printing a resulting 3D object. The process fingerprint may allow a user, client, and/or customer to identify requested 3D object characteristics. The process fingerprint may allow a user, client and/or customer to sort the 3D object based on the process fingerprint. The process fingerprint may correlate to a 3D object build with the detected and/or recorded process parameters.

In some embodiments, a controller of a 3D printing system comprises, or is operatively coupled to, a metrological detection system. The metrological detection system may be used in the control of 3D printing processes of the 3D printing system. The metrological detection system may be configured to detect distance variations such as vertical distance variations, e.g., height variations. The metrological detection system may be configured to detect distance variations such as horizontal distance variations, e.g., variations with respect to an XY plane. For example, a horizontal distance variation along an X-axis that is oriented parallel to a direction of translation of a translatable component (e.g., a translation mechanism). For example, a horizontal distance variation along a Y-axis that is orientated perpendicular to the direction of translation of the translatable component (e.g., the translation mechanism) and perpendicular to a gravitational vector. The metrological detection system may be configured to detect a vertical (e.g., height) variations in a planar surface, e.g., a planar exposed surface of a material bed. The metrological detection system may comprise a height mapper system. The metrological detection system may comprise an interferometric optical system. The metrological detection system may comprise a position sensitive device system. The metrological detection system may comprise an optical detector. The metrological detection system may include, or be operatively coupled to, an image processor. The metrological detection system may comprise an imaging detector to monitor irregularities. The image detector may comprise a camera such as a charged coupled device (CCD) camera. The image detector may comprise detecting a location or an area of the printed 3D object and convert it to a pixel in the X-Y (e.g., horizontal) plane. The image detector may comprise detecting an interference pattern generated by an interferometric beam path. The image detector may comprise detecting position of a beam incident on the image detector relative to an imaging region of the image detector. The controller may comprise one or more computational schemes to convert data (e.g., measurement data) from the metrological detection system to generate a result. The one or more computational schemes may be utilized to determine one or more aspects of the build platform assembly, the optical system, and/or of the target surface, e.g., the exposed surface of the material bed or the build platform surface. The one or more aspects may comprise positional aspects, or localization aspects. The one or more aspects may be absolute or relative. For example, an aspect can include a physical orientation of a moving component of the build module, the moving component comprising a build platform (e.g., base), substrate, or build platform assembly. The build platform assembly may comprise the build platform. For example, an aspect can include a physical orientation of a moving component of the optical system, e.g., of one or more optical assemblies, energy beam paths, or processing cones incident on the target surface. The physical orientation may comprise a relative orientation (e.g., relative to a requested orientation) or an absolute orientation (e.g., relative to a coordinate axis). For example, an aspect may comprise a relative orientation of the target surface or at least one optical assembly (e.g., a plurality of optical assemblies) with respect to an enclosure (e.g., the processing chamber) with respect to a requested orientation, e.g., characterizing offset value(s) of the position (e.g., XY position) of the optical assembly or target surface from the requested value(s). For example, an aspect may include (a) a height (e.g., along a z-axis) of the target surface, (b) an XY position (c) a rotation of the target surface, or (d) any combination of (a), (b), and (c). The orientation may include (A) pitch or roll (e.g., due to movement around the horizontal axis). The controller may utilize one or more computational schemes to measure a height (e.g., along a z-axis) of the target surface (e.g., a phase shift computational scheme). The controller may utilize one or more computational schemes to measure a position (e.g., about the XY plane). The computational scheme may comprise an computational scheme. The controller may utilize a computational scheme comprising a (e.g., digital) modulation scheme that conveys data by changing (e.g., modulating) the phase of a reference signal (e.g., carrier wave). Measurements collected by the metrological detection system may be utilized by one or more controllers, for example, to provide feedback controls to one or more control systems. For example, the one or more controllers may process, or direct processing, the measurements at a time including before, after and/or during the 3D printing process (e.g., in real-time). The one or more controllers may be integrated in a control system that controls the 3D printing process (e.g., the recoater, gas flow system, and/or energy beam(s)). The control system may be any control system disclosed herein. For example, the control system may be a hierarchical control system. For example, the control system may comprise a least three hierarchical control levels.

In some embodiments, the 3D printer comprises a computer model that is based on a requested 3D object. The computer model may comprise 3D printing instructions of the requested 3D object. The computer model may comprise a physical model that correspond to the behavior of the material (e.g., pre-transformed and/or transformed material) during the 3D printing, which at least part of the material forms the 3D object. The physical model may be based on a simulation (e.g., thermos-mechanical simulation). The physical model may comprise an imitation of the physical manifestations that take place during the 3D printing. The physical model may comprise an approximation of the physical manifestations that take place during the 3D printing. The approximation may be a rough approximation. The historical data may be used by the controller system (e.g., comprising the computer model) as a learning tool to form a learning control system. The historical data may be used to vary one or more parameters of the computer model (e.g., of the physical model). The historical data may be used to adjust one or more computer model (e.g., physical model) parameters in response to the sensor measurement(s) (e.g., as correlating to the respective process parameter(s)). The computer model (e.g., the physical model) may be adjusted, corrected, and/or fine-tuned using the historical data provides by the sensor measurement(s) (e.g., that relate to a of process parameter, or a set of process parameters).

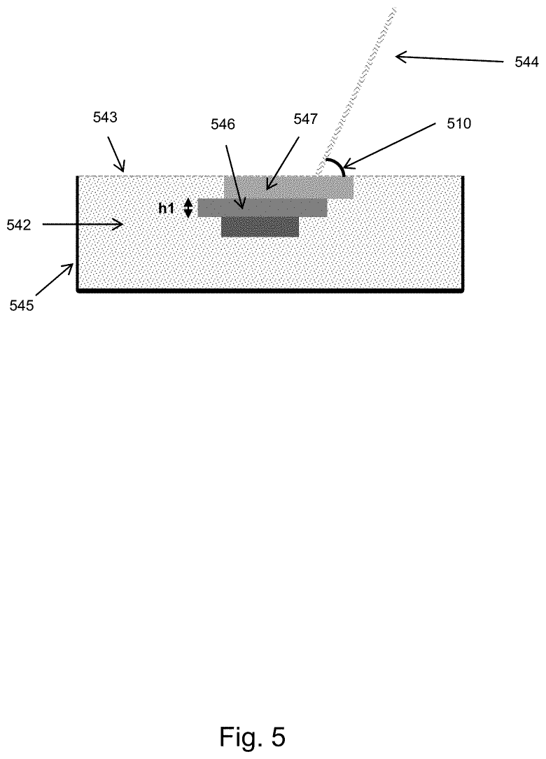

In some embodiments, the 3D printer comprises a control system. The control system may be a real-time control system. The measurement(s) from the one or more sensors may be used to alter the printing instructions for the 3D object in real-time, during its printing. The measurement may comprise (i) a measurement of signals accumulated during printing of one or more layers of the 3D object, (ii) a measurement of signals accumulated during printing of one or more paths (e.g., hatches, or vectors) within a layer of the 3D object, (iii) a measurement of signals accumulated during printing of a plurality of melt pools forming a path (e.g., hatch, or vector) within a layer of the 3D object, or (iv) a measurement of signal(s) during printing of a single of melt pool. The plurality of melt pools can ones (e.g., be less than ten melt pools), tens of melt pools, hundreds of melt pools, or thousands of melt pools. For example, the plurality of melt pools can be at least about 100, 200, 300, 400, or 500 melt pools. The plurality of melt pools can be any number of melt pools between the afore mentioned numbers (e.g., from ones to thousands of melt pool, from tens to hundreds of melt pools, or from 100 to 500 melt pools). The real-time measurement(s) may be used to (i) alter a parameter value prescribed by the 3D printing instruction, (ii) alter the computer model (e.g., alter one or more parameters of the computer model) by using the measured signals, (iii) alter one or more printing parameter in real-time (e.g., using feedback and/or closed loop control). Alter a parameter value prescribed by the 3D printing instruction may comprise observing a systematic deviation from one or more printing parameters (e.g., power of the energy source and/or power density of the energy beam, that is required to reach a certain temperature threshold). For example, the printing instructions (e.g., comprising the computer model) may prescribed a first power value to reach a temperature threshold. During the 3D printing, a sensor indicates that the threshold temperature is reached with a second power value that is (e.g., systematically) lower by a percentage from the first prescribed power. The printing instructions may thus adjust the prescribed power to be lower. The adjustment may be after gaining confidence that the overall adjustment is required. The adjustment may be subsequent to (e.g., a real-time) observation of a systematic deviation from the computer model prediction. The adjustment may be bay a value (e.g., a percentage), or by a function. The function may comprise a linear, polynomial, or logarithmic function. In some embodiments, the computer model parameters may be adjusted based on the measurements. Confidence may relate to the noise level of the sensor measurements. For example, temperature measurements of the target surface may be affected by heating spattered material that parts from the target surface and obstructs the detector. The unreliable measurements may be confined to certain angle (or angle range) of the energy beam with respect to the target surface. For example, to an angle of at least about 80° or 90° with the target surface; to an angle of at most about 90° or 100° with the target surface or to an angle range from about 80° to about 100° of the energy beam with respect to the target surface (e.g., FIG. 5, 510).

In some embodiments, the formation of a melt pool is control in real-time during the time of its formation. In some embodiments, the sensor (e.g., detector) may be coupled to at least one optical fiber (e.g., a fiber coupled to a detector). At times, the detector may comprise a plurality of detectors. Each of the plurality of detectors may be coupled to a different optical fiber respectively. At times, an optical fiber may be coupled to a single detector. At times, at least two detectors may be coupled to an optical fiber. At times, at least two optical fibers may be coupled to a detector. The different optical fibers may form an optical fiber bundle. The optical fiber detector may comprise a magnifier and/or a de-magnifier coupled to a fiber. The optical fiber bundle may be a coherent bundle of fiber. The optical fiber may split to two or more detectors. The optical fiber detector may be positioned prior to the detector and after the optical element (e.g., filter, mirror, or beam splitter, whichever disposed before the optical fiber). At times, the detector may be a single (e.g., pixel) detector. The detector may be devoid of (e.g., not include, or exclude) spatial information.

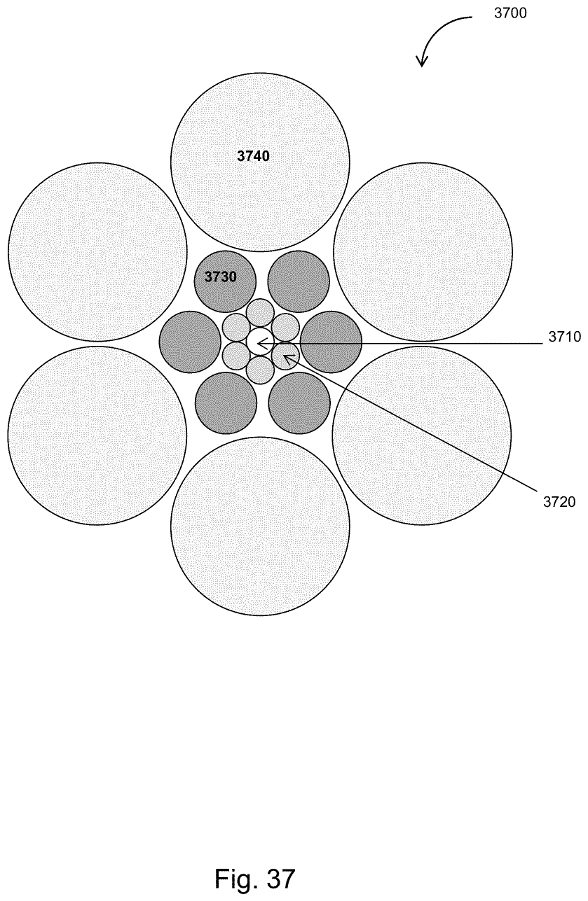

In some embodiments, different fiber groups within the fiber bundle sense different positions in the target surface. For example, the central fiber (e.g., FIG. 37, 3710) may sense the melt pool (e.g., FIG. 26A, 2605), and the surrounding fibers (e.g., FIG. 37, 3720) may sense the vicinity of the melt pool (e.g., FIG. 26A, 2610). FIG. 37 shows an example of an optical fiber bundle (e.g., 3700). In some examples, the central fiber (e.g., 3710) may detect the (e.g., forming) melt pool (e.g., FIG. 26A. 2605), while closely surrounding fibers (e.g., 3720) detect positions in a ring around the melt pool (e.g., that is distanced d₁ away from the center); more distant surrounding fibers (e.g., 3730) detect positions at a ring that is distanced d₂ from the center etc. At least two (e.g., each of the) fibers within the fiber bundle may have different cross sections (e.g., diameters thereof). At least two fibers within the fiber bundle may have (e.g., substantially) the same cross section. For example, at least two fibers within a ring of fibers (e.g., surrounding the central fiber) may have different cross sections (e.g., diameters thereof). At least two fibers within a ring of fibers (e.g., surrounding the central fiber) may have (e.g., substantially) the same cross section. In some embodiments, different fiber groups within the fiber bundle are directed to different detectors. For example, the central optical fiber (e.g., 3710) may be directed to a first detector. The first fiber ring (e.g., 3720) surrounding the central fiber may be directed to a second detector. The second fiber ring (e.g., 3730) surrounding the central fiber may be directed to a third detector. The third fiber ring (e.g., 3740) surrounding the central fiber may be directed to a fourth detector. The different detectors may form a group of detectors. At least two (e.g., each of the) detectors within the group of detectors may detect signals pertaining to different areas of the target surface respectively. For example, at least two (e.g., each of the) detectors within the group of detectors may detect signals pertaining to different distanced rings relative to the melt pool (e.g., center thereof) respectively. The detectors may be connected to the control system that may control one or more 3D printing parameters. For example, the one or more detectors may be used to control the temperature at one or more positions in the material bed.

The optical fiber bundle may include one or more single (e.g., pixel) detectors. Each pixel detector may be optionally coupled to an optical fiber. The optical fiber bundle may comprise a central fiber (e.g., 3710). One or more independent single detectors (e.g., at least 1, 2, 3, 4, 5, 6, 7, 8, 9 or 10 detectors) coupled to one or more independent optical fibers (e.g., at least 1, 2, 3, 4, 5, 6, 7, 8, 9 or 10 optical fibers) respectively may be disposed adjacent to the central fiber. For example, the one or more independent optical fibers may engulf (e.g., surround) the central fiber. The number of independent optical fibers that engulf the central fiber may vary (e.g., the central fiber may be engulfed by at least 1, 2, 3, 4, 5, 6, 7, 8, 9 or 10 optical fibers). The engulfed optical fibers may be engulfed by one or more independent optical fibers (e.g., the first one or more independent fibers adjacent to the central fiber may be engulfed by at least 1, 2, 3, 4, 5, 6, 7, 8, 9 or 10 optical fibers). Engulf may be in at least one cross-sectional circular arrangement (e.g., FIG. 37). In some embodiments, the optical fiber bundle comprises (i) another optical fiber that has a cross section that is (e.g., substantially) the same as the cross section of the central optical fiber, or (ii) another optical fiber that has a cross section that is different (e.g., smaller, or larger) from the cross section of the central optical fiber. In some embodiments, the one or more independent optical fibers have a cross section that is (e.g., substantially) the same (e.g., 3720) as the cross section of the central optical fiber (e.g., 3710). In some embodiments, the one or more independent optical fibers have a cross section that is different than the cross section of the central optical fiber. For example, the one or more independent optical fibers may have a cross section that is larger (e.g., 3730, 3740) than the cross section of the central optical fiber (e.g., 3710). The larger cross section of the optical fiber may facilitate detection of a returning energy beam striking a larger cross section of the optical fiber, and thus allowing for detection of a lower intensity energy beam. The adjacent one or more single detectors may allow detection of energy beam that strikes an area larger than the area detected by the central fiber. For example, the outermost single detector (e.g., 3740) may detect (e.g., collect irradiation from) an area that is larger than the area detected by the central fiber. Larger may comprise at least about 2, 3, 5, 10, 20, 25, 30, 35, 40, 45, 50, 55, 60, 65, 70, 75, 80, 85, 90, 95 or 100 times larger area than the area detected by the central fiber. Larger may comprise at most about 2, 3, 5, 10, 20, 25, 30, 35, 40, 45, 50, 55, 60, 65, 70, 75, 80, 85, 90, 95 or 100 times larger area than the area detected by the central fiber. The outermost single detector may detect an area larger than the area detected by the central fiber, wherein larger can be between any of the afore-mentioned values (e.g., 2 times to 100 times, from about 2 times to about 30 times, from about 35 times to about 70 times, or from about 75 times to about 100 times). The central fiber may detect a pixel at its highest resolution. As the detection area increases amongst the surrounding single detectors, the surrounding fiber may detect one or more lower resolution pixels. The at least one optical fiber in the bundle may be aligned with the portion of the energy beam that has the strongest signal intensity (e.g., radiation energy). The one optical fiber can be aligned (e.g., in real-time) to be the central optical fiber. As the detection area of the fiber detectors increase, the signal intensity may drop. The increasing area of the detector may allow improvement of the signal (e.g., as the signal to noise ratio decreases). The fiber bundle may allow maximizing the collection rate of (e.g., optical) information (e.g., by selecting a sample of optical fiber detectors, by varying the sampling frequency of the detectors). The optical fiber bundle may be a lower cost alternative to thermal imaging detectors (e.g., In GaAs or Ge). The optical fiber bundle (e.g., having varied cross sectional optical fibers), may allow quicker focusing and/or signal detection.

In some embodiments, a first detector (e.g., operatively coupled to fiber FIG. 37, 3710) may sense at least one physical attribute of the melt pool (e.g., FIG. 26A, 2605), for example, during its formation. For example, the first detector may sense the radiation emitted and/or reflected from the melt pool. For example, the first detector may sense the temperature, shape, and/or FLS of the melt pool. The FLS may be of the exposed surface of the melt pool. The shape may be circular, oval, or irregular. The first detector may be coupled to the energy beam footprint on the target surface. In some embodiments, a second detector (e.g., FIG. 37, an equal radius ring of detectors operatively coupled to fibers comprising 3720) may sense at least one physical attribute of the melt pool vicinity (e.g., FIG. 26A, 2610), for example, during its heating. The second detector may comprise a set of sensors. For example, the second detector may comprise a ring of detectors. The second detector may be ring shaped. The second detector may be concentric to the first detector. The detected area of the second detector may be include or exclude the melt pool area. The signal that is detected by the detector set of the second detector may be averaged to produce a physical attribute value (e.g., amplitude value that correlates to a temperature value). The control system may compare the signal of the first detector to the second detector to receive a comparison value of a physical attribute. The comparison value may facilitate estimation of the (i) isotropy of heat distribution within the melt pool, (ii) isotropy of melt pool shape (e.g., the horizontal and/or vertical cross sections of the melt pool), (iii) temperature gradients within the melt pool, or (iv) any combination thereof.

At times, the melt pool may be controlled to reach a first maximum physical attribute (e.g., temperature) threshold value. The first detector may facilitate (e.g., direct, in situ, and/or real-time) controlling the physical attribute (e.g., temperature) of the melt pool. For example, using the melt pool temperature, size, and/or shape, the energy beam and/or source may be attenuated. Attenuated may comprises altering at least one characteristic of the energy beam and/or energy source. For example, reducing (e.g., stopping) the power of the energy source when the temperature of the melt pool reaches a first temperature threshold value. For example, reducing (e.g., stopping) the power density of the energy beam when the temperature of the melt pool reaches the first temperature threshold value. For example, reducing (e.g., stopping) the cross section of the energy beam when the melt pool reaches the melt pool diameter threshold value.

At times, the melt pool may be controlled to reach a second maximum physical attribute r (e.g., temperature) threshold value. The second detector (e.g., detector set) may facilitate (e.g., direct, in situ, and/or real-time) controlling the physical attribute (e.g., temperature) of the melt pool vicinity. For example, using the temperature, size, and/or shape, of the heated vicinity of the melt pool, the energy beam and/or source may be attenuated. Attenuated may comprises altering at least one characteristic of the energy beam and/or energy source. For example, reducing (e.g., stopping) the power of the energy source when the temperature of the melt pool vicinity reaches a second temperature threshold value. For example, reducing (e.g., stopping) the power density of the energy beam when the temperature of the melt pool vicinity reaches the second temperature threshold value. For example, reducing (e.g., stopping) the cross section of the energy beam when the melt pool vicinity reaches the melt pool vicinity diameter threshold value.

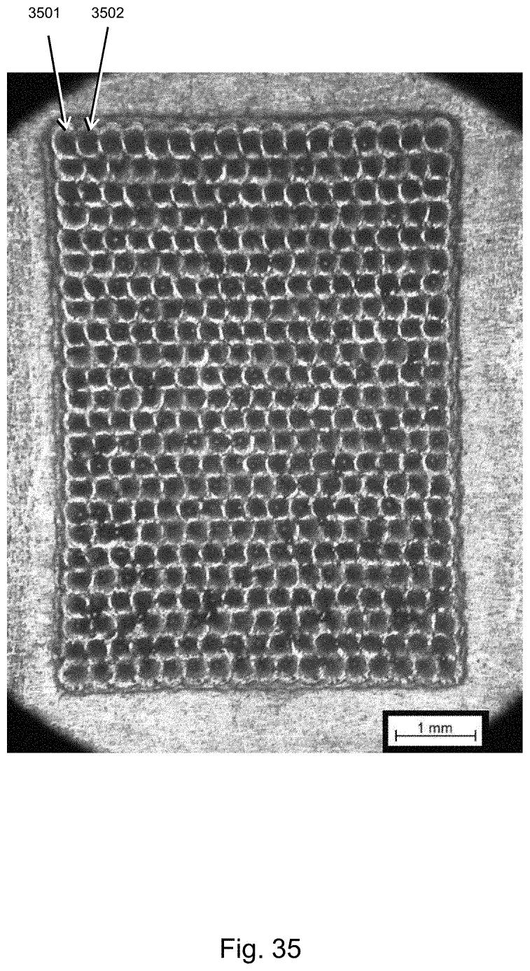

In some embodiments, the first detector (detecting a physical attribute of the melt pool) and the second detector (detecting a physical attribute of the melt pool vicinity) are used. The control system may attenuate the energy beam and/or energy source to allow the melt pool to reach, maintain, and/or not exceed a first physical attribute (e.g., temperature) threshold value, while allowing the vicinity of the melt pool to reach, maintain, and/or not exceed a second physical attribute (e.g., temperature) threshold value. The control may be by altering one or more characteristics of the energy beam and/or source. For example, the first detector (detecting a temperature of the melt pool) and the second detector (detecting a temperature of the melt pool vicinity) may be used. The control system may attenuate the energy beam to allow the melt pool to reach, maintain, and/or not exceed a first temperature threshold value, while allowing the vicinity of the melt pool to reach, maintain, and/or not exceed a second temperature threshold value. For example, by altering (e.g., reducing) the power density of the energy beam, by altering the power of the energy source, by altering the diameter of the energy beam, by altering the focus of the energy beam, by altering the dwell time of the energy beam, or any combination thereof. Altering may comprise, reducing or increasing. Reducing may comprise ceasing. In some embodiments, the resulting melt pool is homogenous in (i) temperature distribution gradient, (ii) shape, (iii) microstructure distribution, or (iv) any combination thereof. The real-time melt pool control (e.g., using the two detectors) may Allow formation of successive (e.g., substantially) homogenous and/or isotropic melt pools (e.g., FIG. 35). The (e.g., substantially) homogenous and/or isotropic melt pools may in a hatch line, path, layer, within the entire 3D object. At times, the usage of the two detectors may allow (e.g., controlled) formation of anisotropic melt pools, whose anisotropy may be requested. For example, at times it may be requested to form melt pools having aspect ratio that is different than 1:1 (in which the vertical cross-sectional radius is equal to the horizontal cross-sectional radius).

In some examples, the transforming energy beam irradiates (e.g., injects) energy into one or more pre-formed layers (e.g., deeper layers) of hardened material that are disposed below the target layer (e.g., layer of pre-transformed material) that is irradiated by the transforming energy beam. The injection of energy into the one or more deeper layers may heat those deeper layers up. Heating of the deeper layers may allow those deeper layers to release stress (e.g., elastically and/or plastically). For example, the heating of the deeper layers may allow those layers to deform beyond the stress point. For example, the heating of the deeper layers may allow a position of the deeper layer that is parallel to the irradiated position to reach an elevated temperature that is above the solidus temperature (e.g., and at or below the liquidus temperature), liquefy (e.g., become partially liquid), transform (e.g., melt), become liquidus (e.g., fully liquid), and/or plastically yield (e.g., stress-yield).

The control of the transforming energy beam may comprise (e.g., substantially) ceasing (e.g., stopping) to irradiate the target area when the temperature at the bottom skin reaches a target temperature. The target temperature may comprise a temperature at which the material (e.g., pre-transformed or hardened) reaches an elevated temperature that is above the solidus temperature, transforms (e.g., re-transforms, e.g., re-melts), become liquidus, and/or plastically yields. The control of the irradiating energy may comprise (e.g., substantially) reducing the energy supplied to (e.g., injected into) the target area when the temperature at the bottom skin reached a target temperature. The control of the irradiated energy may comprise altering the energy profile of the energy beam and/or flux respectively. The control may be different (e.g., may vary) for layers that are closer to the bottom skin layer as compared to layers that are more distant from the bottom skin layer (e.g., beyond the critical layer thickness as disclosed herein). The control may comprise turning the irradiated energy on and off (e.g., at specified and/or controlled times). The control may comprise reducing the power per unit area, cross section, focus, power, of the transforming energy beam. The control may comprise altering at least one property of the transforming energy beam, which property may comprise the power, power per unit area, cross section, energy profile, focus, scanning speed, pulse frequency (when applicable), or dwell time of the irradiated energy. During the intermission (e.g., “off”) times, the power and/or power per unit area of the energy beam may be (e.g., substantially) reduced as compared to its value at the dwell times (e.g., “on” times). Substantially may be in relation to the transformation of the material at the target surface. During the intermission, the irradiated energy may relocate away from the area, which was tiled, to a different area in the material bed that is (e.g., substantially) distant from area which was tiled (see examples 1). During the dwell times, the irradiated energy may relocate back to the position adjacent to the area which was just tiled (e.g., as part of the transforming energy beam path). The control may be real-time control (e.g., during the 3D printing process). The control may be dynamic control. The control may use at least one computational scheme. The control may comprise closed loop control, or open loop control. The control may be closed loop control, open loop control or any combination thereof.

In some embodiments, the 3D printing system comprises a control system. The control system may comprise one or more controllers. The control system may comprise, or be operatively coupled to, one or more devices, apparatuses, and/or systems of the 3D printing system, including any component of the device(s), apparatuses(s), and/or system(s). The controller(s) may comprise, or be operatively coupled to, a hierarchical control system. The hierarchical control system may comprise at least three, four, or five, control levels. In some embodiments, at least two operations are performed, or directed, by the same controller. In some embodiments, at least two operations are each performed, or directed, by a different controller. A control system may comprise a build module control system. A control system may comprise a laser control system. The controller may comprise a feedback control scheme. The feedback control scheme may comprise an open feedback loop control scheme. The feedback loop control scheme may comprise a closed feedback loop control scheme. Feedback control scheme may comprise hardware compensation. Feedback control scheme may comprise software compensation. The control system may comprise, or be operatively coupled to, a metrological detection system and configured to receive measurement data from the metrological detection system. In some embodiments the control system comprises a laser control system. The laser control system may comprise, or be operatively coupled to, a laser system (e.g., optical system) of the 3D printing system. e.g., comprising energy sources, or optical components. At times, the laser control system is operable to control operations of the optical system (e.g., optical assemblies) of the 3D printing system. The laser control system may be operable to adjust operations of the optical system (e.g., of the optical assemblies) in response to a measured positional deviation of one or more aspects of the optical system. The laser control system may be operable to adjust (e.g., calibrate) one or more characteristics of the irradiating energy (e.g., the energy beam) incident on the target surface, e.g., the exposed surface of the material bed), and/or perpendicular to that path. For example, the controller may direct the material dispenser to alter the amount and/or rate of pre-transformed material that is dispensed. Adjusting one or more characteristics of the irradiating energy beam may comprise a software adjustment (e.g., calibration). Adjusting one or more characteristics of the irradiating energy beam may comprise a hardware adjustment (e.g., calibration).

At times, a calibration comprises generated a compensation for one or more characteristics of the laser system. A compensation may be effectuated at least in part by a (e.g., energy beam) calibration. At times, an energy beam calibration comprises formation of one or more (e.g., physically printed or optically projected) alignment markers (e.g., also referred to herein as “optical calibration marks”) using at least one energy beam directed at a target surface. The one or more alignment markers may form an arrangement (e.g., a pattern). The position(s) of the marker(s) may be according to a requested (e.g., pre-determined) arrangement (e.g., a reference pattern). Requested may be according to a commanded arrangement as directed by commands to a guidance system for directing the energy beam(s). The arrangement (e.g., position(s)) of the one or more alignment markers may be detected by a detection system. The detected position(s) (e.g., measured position(s)) of the alignment marker(s) may be compared to commanded (e.g., requested) position(s). The energy beam calibration may comprise correction (e.g., compensation) of any deviation of the detected position(s) from the commanded position(s). The deviation of the detected position(s) from the commanded position(s) may be caused in part by (a) thermal effects on the energy beam and/or optical components, (b) position deviation of the target surface, (c) a non-uniformity of layer deposition, or (d) a combination thereof. Following application of the (e.g., initial) compensation to the energy beam (e.g., to the guidance system directing the energy beam), further (e.g., additional) calibration may be performed. Further calibration may (e.g., iteratively) improve the compensation of the any deviation between the detected position(s) from the commanded position(s) of the energy beam at the target surface. The deviation may depend on the nature and/or geometry of one or more optical elements of the optical system. The calibration may comprise altering the one or more elements (e.g., position thereof) of the optical system. The calibration may comprise altering a command to one or more elements of the optical system and/or to the energy source.

In some embodiments, the control system utilizes data from a metrological detection system. The control system may use the data to control one or more parameters of the 3D printing. For example, the control system may use the metrology data to control one or more positions of the optical system. At times, the control system may utilize a control scheme comprising a feedback control loop that utilizes alignment data, e.g., collected from one or more metrological detection systems to update control parameters of one or more control systems. Data collected from one or more metrological detection systems may comprise alignment data indicative of a position of a component of the optical system, for example, a position of (A) an optical assembly, (B) the array of optical assemblies, (C) energy beam(s) of the optical system incident on the target surface, or (D) any combination of (A) to (E). The data collected from one or more metrological detection systems can be utilized by a feedback control loop to adjust a position of the component of the optical system, for example, a position of (A) an optical assembly, (B) the array of optical assemblies, (C) energy beam(s) of the optical system incident on the target surface, or (E) any combination of (A) to (C). At times, a control scheme comprises a feedforward control loop that utilizes alignment data to update control parameters of one or more control systems. Alignment data may comprise historical data, e.g., data collected after a three-dimensional process performed by a three-dimensional printer. Historical data (e.g., historical measurements) may comprise characterization of three-dimensional objects formed utilizing the three-dimensional printer. The historical data may be utilized in a feedforward control loop to adjust a position of (A) an optical assembly, (B) the array of optical assemblies, (C) energy beam(s) of the optical system incident on the target surface, or (D) any combination of (A) to (C). The control system may use the metrology data to control one or more parameters of the energy source and/or energy beam.

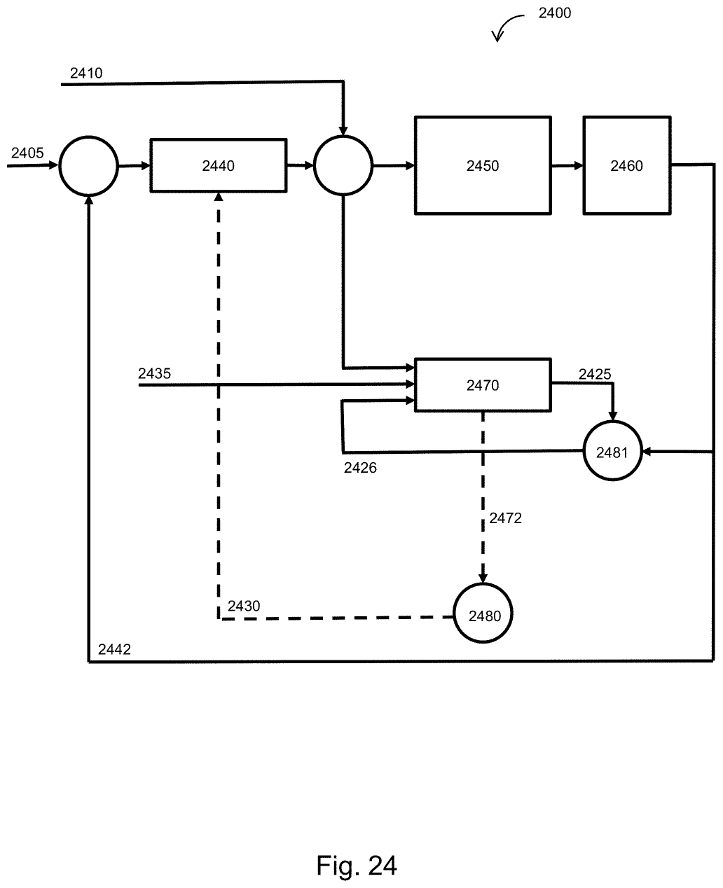

FIG. 24 shows a schematic example of a (e.g., automatic) control system 2400 that is programmed or otherwise configured to facilitate the formation of one or more 3D objects. The control system 2400 includes a (e.g., PID) controller 2440, a forming 3D object 2450, one or more sensors (e.g., temperature sensor) 2460, one or more computer models for the physical process of 3D printing 2470 (e.g., comprising the physical model or the control model). The control system may optionally include a feedback control loop such as 2430 or 2442. The feedback control loop may comprise one or more logical switches (e.g., 2480, and 2481). The logical switch may alter (e.g., turn “on” or “off”) a feedback loop control. The alteration may utilize a calculated variable (e.g., temperature). The calculated variable may comprise a threshold value. The calculated variable may be compared to a respective measured variable. The calculated temperature may derive from the computer model (e.g., which at least part of the computer model may be in 2470). For example, the control scheme (e.g., FIG. 24) may comprise the control-model (e.g., included in 2470) that generates a result (e.g., 2425). The control model may comprise one or more calculations of the control variable (e.g., the temperature). The control model may comprise comparing a measured variable to its respective control variable (e.g., the calculated variable value, threshold variable value, and/or critical variable value).

The control system (e.g., 2400) may be configured to control (e.g., in real-time) a power of the energy source, speed of the energy beam, power density of the energy beam, dwell time of the energy beam, energy beam footprint (e.g., on the exposed surface of the material bed), and/or cross-section of the energy beam, to maintain a target parameter of one or more forming 3D objects. The target parameter may comprise a temperature, or power of the energy beam and/or source. In some examples, maintaining a target temperature for maintaining on one or more characteristics of one or more melt pools. The characteristics of the melt pool may comprise its FLS, temperature, fluidity, viscosity, shape (e.g., of a melt pool cross section), volume, or overall shape. The control system (e.g., 2400) may be configured to control (e.g., in real-time) a temperature, to maintain a target parameter of one or more forming 3D objects, e.g., a target temperature of one or more positions of the material bed to maintain on one or more melt pools. The one or more positions may comprise a position within a melt pool, adjacent to the melt pool, or far from the melt pool. Adjacent to the melt pool may be within a distance (e.g., radius) of at least about 1, 2, 3, 4, or 5 average melt pool diameters. Adjacent to the melt pool may be within a distance of at most about 1, 2, 3, 4, or 5 average melt pool diameters. Adjacent to may be any distance between the afore mentioned distances (e.g., from about 1 to about 5 average melt pool diameters). FIG. 26A shows an example of a melt pool 2605 shown as a top view, having a diameter d₁. The melt pool 2605 in the example shown in FIG. 26A, is surrounded by an area that is centered at the melt pool, and extends (for example) two melt pool diameters after the edge of the melt pool 2605, designated as d₂ and d₃, wherein d₁, d₂ and d₃ are (e.g., substantially) equal. FIG. 26B shows an example of a vertical cross section in a material bed 2625 in which a melt pool 2615 is disposed, which to view of the melt pool 2615 has a diameter d₁. The material bed 2625 has an exposed surface 2629. The area surrounding the melt pool 2620 extends beyond the melt pool (e.g., into the material bed). The area 2620 extends away from the melt pool by (for example) two melt pool top view diameters d₂ and d₃, as measured from the edge of the melt pool 2615, wherein d₁, d₂ and d₃ are (e.g., substantially) equal. The control system may use one or more signals detected from one or more positions at the melt pool and/or from a position adjacent to the melt pool (e.g., FIG. 26A). The signals may be used to determine a temperature at the one or more positions. The one or more signals may be used in forming the physical-model (e.g., operatively coupled to the control-model). The material bed may be a box, a cylinder, or a prism (e.g., a right prism). The cylinder may be an elliptical cylinder (e.g., circular cylinder). The cylinder may be a right cylinder. The prism may have a polygonal cross section. For example, the prism may be a triangular, rectangular, pentagonal, hexagonal, or a heptagonal prism. The FLS (e.g., width, depth, and/or height) of the material bed can be at least about 50 millimeters (mm), 60 mm, 70 mm, 80 mm, 90 mm, 100 mm, 200 mm, 250 mm, 280 mm, 400 mm, 500 mm, 800 mm, 900 mm, 1 meter (m), 2 m or 5 m. The FLS (e.g., width, depth, and/or height) of the material bed can be at most about 50 millimeters (mm), 60 mm, 70 mm, 80 mm, 90 mm, 100 mm, 200 mm, 250 mm, 280 mm, 400 mm, 500 mm, 800 mm, 900 mm, 1 meter (m), 2 m or 5 m. The FLS of the material bed can be between any of the aforementioned values (e.g., from about 50 mm to about 5 m, from about 250 mm to about 500 mm, from about 280 mm to about 1 m, or from about 500 mm to about 5 m).

The one or more forming 3D objects can be formed (e.g., substantially) simultaneously, or sequentially. The one or more 3D objects can be formed in a (e.g., single) material bed. The controller may receive a target parameter (e.g., 2405) (e.g., temperature) to maintain at least one characteristic of the forming 3D object. Examples of characteristics of forming 3D objects include temperature and/or metrological attribute(s) (e.g., information) of a melt pool. The metrological attribute(s) (e.g., information) of the melt pool may comprise its FLS. Examples of characteristics of forming 3D objects include metrological attribute(s) (e.g., information) of the forming 3D object. For example, geometry attribute(s) (e.g., information. E.g., height) of the forming 3D object. Examples of characteristics of forming 3D objects include material characteristic such as hard, soft and/or fluid (e.g., liquidus) state of the forming 3D object. The target parameter may be time varying or location varying or a series of values per location or time. The target parameter may vary in time and/or location. The controller may (e.g., further) receive a pre-determined control variable (e.g., power per unit area of the energy beam) target value from a control loop such as, for example, a feed forward control (e.g., 2410, and 2435). In some examples, the control variable controls the value of the target parameter of the forming 3D object. For example, a predetermined (e.g., threshold) value of power per unit area of the energy beam may control the temperature (e.g., range) of the melt pool forming the 3D object.

At times, multiple of tuning schemes can be generated for the one or more controllers, each tuning scheme selectable for a set of operating conditions and/or powder characteristics. For example, tuning scheme may utilize (i) a look-up table (LUT), (ii) historical data, (iii) experiments, (iv) physics simulation, (v) artificial intelligence, (vi) data analysis, and/or (vii) the like. The artificial intelligence may comprise training a plant model (a machine-leamed model). The artificial intelligence may comprise data analysis. The training model may be trained utilizing (i) a look-up table (LUT), (ii) historical data, (iii) experiments. (iv) synthesized results from physics simulation, or (v) the like. In some embodiments, control scheme(s) can use a single plant model and project changes due to the temperature based on previously identified models. The control scheme(s) may be inscribed as program instructions (e.g., software).

In some embodiments, the control scheme used the controller(s) disclosed herein involve data analysis. The data analysis techniques involve one or more regression analysis(es) and/or calculation(s). The regression analysis and/or calculation may comprise linear regression, least squares fit, Gaussian process regression, kernel regression, nonparametric multiplicative regression (NPMR), regression trees, local regression, semiparametric regression, isotonic regression, multivariate adaptive regression splines (MARS), logistic regression, robust regression, polynomial regression, stepwise regression, ridge regression, lasso regression, elasticnet regression, principal component analysis (PCA), singular value decomposition (SVD)), probability measure techniques (e.g., fuzzy measure theory, Borel measure, Harr measure, risk-neutral measure, Lebesgue measure), predictive modeling techniques (e.g., group method of data handling (GMDH), Naive Bayes classifiers, k-nearest neighbors algorithm (k-NN), support vector machines (SVMs), neural networks, support vector machines, classification and regression trees (CART), random forest, gradient boosting, generalized linear model (GLM)), or any other suitable probability and/or statistical analysis(es). The learning scheme may comprise neural networks. The leaning scheme may comprise machine learning. The learning scheme may comprise pattern recognition. The learning scheme may comprise artificial intelligence, data miming, computational statistics, mathematical optimization, predictive analytics, discrete calculus, or differential geometry. The learning schemes may comprise supervised learning, reinforcement learning, unsupervised learning, semi-supervised learning. The learning scheme may comprise bias-variance decomposition. The learning scheme may comprise decision tree learning, associated rule learning, artificial neural networks, deep learning, inductive logic programming, support vector machines, clustering, Bayesian networks, reinforcement learning, representation learning, similarity and metric learning, sparse dictionary learning, or genetic algorithms (e.g., evolutional algorithm). The non-transitory computer media may comprise any of the computational schemes (e.g., algorithms) disclosed herein. The controller and/or processor may comprise the non-transitory computer media. The software may comprise any of the computational schemes disclosed herein. The controller and/or processor may comprise the software. The learning scheme may comprise random forest scheme.

In some embodiments, the control system utilizes a physics simulation in, e.g., in a computer model (e.g., comprising a prediction model, statistical model, a thermal model, or a thermo-mechanical model). The computer model may provide feedforward information to the control system. The computer model may provide the feed forward control scheme. There may be more than one computer models (e.g., at least 1, 2, 3, 4, 5, 6, 7, 8, 9 or 10 different computer models). The controller may (e.g., dynamically) switch between the computer models to predict and/or estimate the behavior of the optical elements. Dynamic includes changing computer models (e.g., in real-time) based at least in part on a sensor input or based on a controller system's decision that may in turn be based at least in part on monitored target temperature. The dynamic switch may be performed in real-time, e.g., during operation of the optical system and/or during printing 3D object(s). The controller may be configured (e.g., reconfigured) to include additional one or more computer models and/or readjust the existing one or more computer models. A computer model (e.g., comprising a prediction model, statistical model, a thermal model, or a thermo-mechanical model) may predict and/or estimate one or more physical parameters of the forming 3D object. The computer model may comprise a geometric model (e.g., comprising OPC), or a physical model. The computer model may provide feedforward information to the controller. The computer model may provide the open loop control. There may be more than one computer models (e.g., at least 1, 2, 3, 4, 5, 6, 7, 8, 9 or 10 different computer models). The controller may (e.g., dynamically) switch between the computer models to predict and/or estimate the one or more physical parameters of the forming 3D object. Dynamic includes changing computer models (e.g., in real-time) based on a user input, or based on a controller system's decision that may in turn be based on monitored target variables of the forming 3D object. The dynamic switch may be performed in real-time (e.g., during the forming of the 3D object). Real-time may be, for example, during the formation of a layer of transformed material, during the formation of a layer of hardened material, during formation of a portion of a 3D object, during formation of a melt pool, during formation of an entire 3D object, or any combination thereof. A prediction of the one or more parameters of the forming 3D object may be done offline (e.g., predetermined) and/or in real-time. The at least one computer model may receive sensed parameter(s) value(s) from one or more sensors. The sensed parameter(s) value(s) may comprise temperature sensed within and/or in the vicinity of one or more melt pools. Vicinity may be within a radius of at least about 1, 2, 3, 4, or 5 average melt pool FLS from a forming melt pool. The computer model may use (e.g., in real-time) the sensed parameter(s) value(s) for a prediction and/or adjustment of the target parameter. The computer model may use (e.g., in real-time) geometric information associated with the requested and/or forming 3D object (e.g., melt pool geometry). The use may be in real-time, and/or off-line. Real-time may comprise during the operation of the energy beam and/or source. Off-line may be during the time a 3D object is not printed and/or during “off” time of the energy beam and/or source. The computer model may compare a sensed value (e.g., by the one or more sensors) to an estimated value of the target parameter. The computer model may (e.g., further) calculate an error term (e.g., 2426) and readjust the at least one computer model to achieve convergence (e.g., of a requested or requested 3D model with the printed 3D object).

The computer model may estimate a target variable (e.g., 2472). The target variable may be of a physical attribute that may or may not be (e.g., directly) detectable. For example, the target variable may be of a temperature that may or may not be (e.g., directly) measurable. For example, the target variable may be of a physical location that may or may not be (e.g., directly) measurable. For example, a physical location may be inside the 3D object at a depth that may not be directly measured by the one or more sensors. An estimated value of the target variable may be (e.g., further) compared to a critical value of the target variable. At times, the target value exceeds the critical value, and the computer model may provide feedback to the controller to attenuate (e.g., turn off, or reduce the intensity of) the energy beam (e.g., for a specific amount of time). The computer model may set up a feedback control loop (e.g., 2430), for example, by providing feedforward information. The feedback control loop may be for the purpose of adjusting one or more target parameters to achieve convergence (e.g., of a requested or requested 3D model with the printed 3D object). In some embodiments, the computer model may predict (i) an estimated temperature of the melt pool, (ii) local deformation within the forming 3D object, (iii) global deformation and/or (iv) temperature fields. The computer model may (e.g., further) predict corrective energy beam adjustments (e.g., in relation to a temperature target threshold). The adjustment predictions may be based on the (i) measured and/or monitored temperature information at a first location on the forming 3D object (e.g., a forming melt pool) and/or (ii) at a second location (e.g., in the vicinity of the forming melt pool) and/or (iii) geometric information (e.g., height) of the forming 3D object. The energy beam adjustment may comprise adjusting at least one control variable pertaining to a characteristics of the energy beam (e.g., power per unit area, dwell time, cross-sectional diameter, and/or speed). In some embodiments, the control system may comprise a closed loop (e.g., and feed forward) control, that may override one or more (e.g., any) corrections and/or predictions by the computer model. The override may be effectuated by forcing a predefined amount of energy (e.g., power per unit area) to supply to the portion (e.g., of the material bed and/or of the 3D object). Real-time may be during formation of at least one: 3D object, layer within the 3D object, dwell time of an energy beam along a path, dwell time of an energy beam along a hatch line, dwell time of an energy beam forming a melt pool, or any combination thereof. The control may comprise controlling a cooling rate (e.g., of the material bed, the 3D object, or a portion thereof), control the microstructure of a transformed material portion, or control the microstructure of at least a portion of the 3D object. Controlling the microstructure may comprise controlling the phase, morphology, FLS, volume, or overall shape of the transformed (e.g., and subsequently solidified) material portion. The material portion may be a melt pool.

In some embodiments, the control system comprises a first temperature sensor and a second temperature sensor. The first temperature sensor may provide sensed information to the control system (e.g., to the PID controller). The second temperature sensor may be compared to a critical temperature threshold in the control model. The control model may change based on the input from the second and/or first temperature sensor. The first temperature sensor may sense a temperature designated for the melt pool (e.g., FIG. 26A, 2605). The second temperature sensor may sense a temperature designated for the melt pool vicinity (e.g., FIG. 26A, 2610). In some embodiments, when a temperature sensed by the first and/or second sensor reaches and/or exceeds a certain (e.g., respective) threshold value, the irradiation of that area by the transforming energy beam may alter (e.g., reduce, e.g., cease). Altered irradiation may comprise irradiation with an altered power density, cross section, dwell time, and/or focus. The temperature sensed by the two sensors may be used to evaluate (e.g., calculate) the temperature gradient in the vicinity of the area designated for the melt pool (e.g., temperature gradient between 2605 and 2610). The control model may be operatively coupled (e.g., inform) the controller (e.g., comprising close loop or feedback control loop). (E.g., 2442, 2426 and/or 2430).

The 3D object may be generated by providing a first layer of pre-transformed material (e.g., powder) in an enclosure; transforming at least a portion of the pre-transformed material in the first layer to form a transformed material. The 3D object may be generated by providing a pre-transformed material (e.g., stream) to a target surface (e.g., platform); transforming at least a portion of the pre-transformed material (i) prior to reaching the target surface or (ii) at the target surface, to form a transformed material. The stream can be a stream of a particulate material. The transforming may be effectuated (e.g., conducted) with the aid of an energy beam. The energy beam may travel along a path. The path may comprise hatching. The path may comprise a vector or a raster path.

In some embodiments, a plurality of energy beams incident on a target surface may increase (i) the (e.g., total) processing field available for printing (e.g., in a X-Y plane) and/or (ii) the rate of 3D printing completion for a given print cycle (as compared to using a single energy beam). A plurality of energy beams (e.g., at least two energy beams) may be useful in providing a relatively larger processing area in which one or more 3D objects may be generated. A relatively larger processing area may be useful in generating a larger 3D object, or a plurality of (e.g., laterally) adjacent 3D objects. The larger 3D object may be larger in at least one dimension (e.g., in a X-Y plane), compared to a 3D object formed using a single energy beam. The build platform and/or material bed may be larger in at least one dimension (e.g., in a X-Y plane), compared to a build platform and/or a material bed used for 3D printing with a single energy beam. A relatively larger processing field may be larger in relation to a 3D printing system that comprises (e.g., only) a single energy beam, which processing area is limited to the areal extent (e.g., the processing field) of the single energy beam (e.g., as guided by an optical assembly), which is not arbitrarily sized.

At times, an energy beam from a first and/or second energy source is incident on, and/or is directed to, a target surface (e.g., the exposed surface of the material bed). The energy beam may be directed to and/or impinge on the pre-transformed material. The energy beam can be directed to the pre-transformed or transformed material for a specified period. The pre-transformed or transformed material can absorb the energy from the energy source (e.g., energy beam, diffused energy, and/or dispersed energy), and as a result, a localized region of that pre-transformed or transformed material can increase in temperature (e.g., and at least partially transform). The energy source and/or energy beam can be moveable such that it can translate relative to the surface (e.g., the target surface).

The method for generating the 3D object may further comprise hardening the transformed material to form a hardened material as part of the 3D object. In some embodiments, the transformed material may be the hardened material as part of the 3D object. The method may further comprise providing a second layer of pre-transformed material adjacent to (e.g., above) the first layer and repeating the transformation process delineated herein (e.g., above). The method may further comprise providing pre-transformed material adjacent to (e.g., above) the first layer of hardened material (as part of the 3D object) and repeating the transformation process delineated herein.

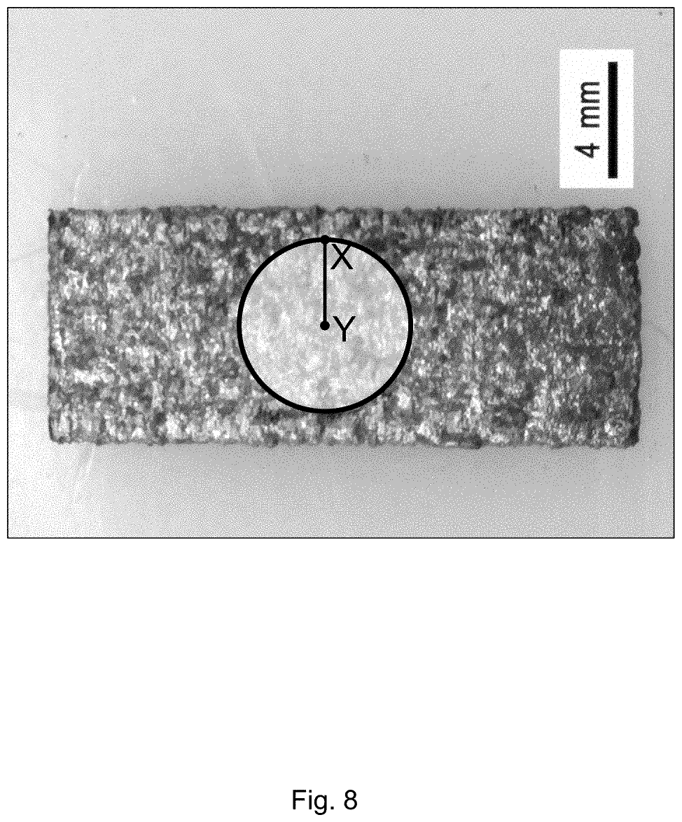

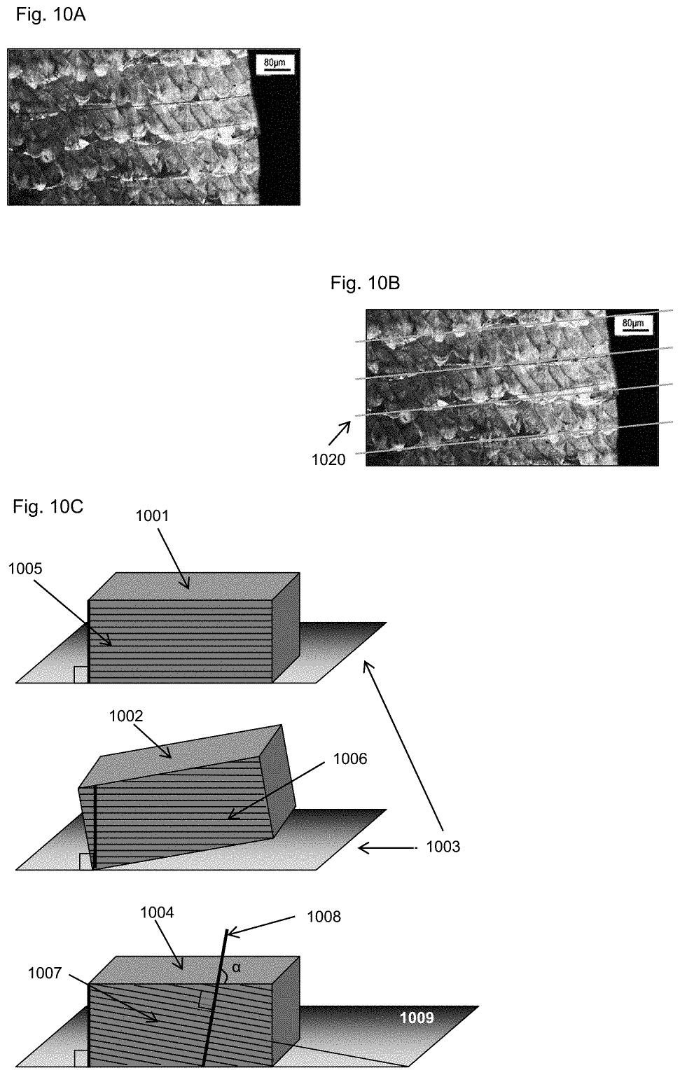

The 3D object can be an extensive and/or complex 3D object. The 3D object can be a large 3D object. The 3D object may comprise a large hanging structure (e.g., wire, ledge, or shelf). Large may be a 3D object having a fundamental length scale of at least about 1 centimeter (cm), 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, or 100 m. In some instances. The fundamental length scale (e.g., the diameter, spherical equivalent diameter, diameter of a bounding circle, or largest of height, width and length; abbreviated herein as “FLS”) of the printed 3D object can be at least about 25 micrometers (μm), 50 μm, 80 μm, 100 μm, 120 μm, 150 μm, 170 μm, 200 μm, 230 μm, 250 μm, 270 μm, 300 μm, 400 μm, 500 μm, 600 μm, 700 μm, 800 μm, 1 millimeter (mm), 1.5 mm, 2 mm, 5 mm, 1 centimeter (cm), 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, or 100 m. The FLS of the printed 3D object can be at most about 1000 m, 500 m, 100 m, 80 m, 50 m, 10 m, 5 m, 4 m, 3 m, 2 m, 1 m, 90 cm, 80 cm, 60 cm, 50 cm, 40 cm, 30 cm, 20 cm, 10 cm, or 5 cm. In some cases, the FLS of the printed 3D object may be in between any of the afore-mentioned FLSs (e.g., from about 50 μm to about 1000 m, from about 120 μm to about 1000 m, from about 120 μm to about 10 m, from about 200 μm to about 1 m, from about 1 cm to about 100 m, from about 1 cm to about 1 m, from about 1 m to about 100 m, or from about 150 μm to about 10 m). The FLS (e.g., horizontal FLS) of the layer of hardened material may have any value listed herein for the FLS of the 3D object (e.g., from about 25 μm to about 2000 μm). The example in FIG. 10C shows a horizontal portion 1001 of the layer of hardened material (e.g., the top layer in the 10C scheme). The example in FIG. 8 shows a top view of the layer of hardened material, which is a horizontal portion of the layer of hardened material. The example in FIG. 5 shows a vertical portion “h 1” of the layer of hardened material 546, indicating its height.

The methods, systems, software and/or apparatuses may include measuring, controlling and/or monitoring the deformation (e.g., curvature) of the forming and/or formed layer of hardened material (e.g., as it forms). The methods, systems, software and/or apparatuses may include measuring, controlling and/or monitoring the deformation of the forming and/or formed layer of hardened material or portion thereof (e.g., during formation of the 3D object). During the formation of the 3D object may comprise during formation of the layer or a portion thereof. During the formation of the 3D object may in some instances include subsequent to the formation of the entire 3D object (e.g., a hardening period). During the formation of the 3D object may in some instances exclude subsequent to the formation of the entire 3D object (e.g., exclude a period at which the 3D object has been formed, and it is left for complete hardening).

At times, some portions of the 3D object may deform during its formation (e.g., during the transformation and/or hardening). The deformation may comprise an unrequested or a requested deformation. In some instances, the deformation is unrequested. The deformation may cause the 3D object to (e.g., substantially) deviate from the requested (e.g., requested) 3D object. For example, at least some portions of the 3D object may deform. Deform may comprise warp, buckle, bend, twist, shrink, or expand (e.g., during formation or subsequent thereto) in a substantial and/or undesirable manner. Substantial may be relative to the intended purpose of the 3D object. For example, some portions of the 3D object may form warped, buckled, bent, twisted, shrunk, or expanded portions that are substantial and/or not desirable. In some instances, it is desirable to control (e.g., regulate and/or manipulate) the manner in which at least a portion of the 3D object is formed (e.g., regarding any deformation and/or deviation from the requested 3D object). Control may comprise regulate, manipulate, restrict, direct, monitor, adjust, or manage. In some instances, it is desirable to control the manner in which at least a portion of the 3D object is formed (e.g., hardened). In some instances, it is requested to control at least one characteristic of the at least a portion of the 3D object as it is formed (e.g. and hardened). The portion may be at least a portion of a layer of the 3D object. The portion may be a portion of the layer of the 3D object or the entire layer thereof. The at least one characteristic of the at least portion of the 3D object may comprise a curvature. The curvature may be of the at least one layer (or portion thereof) that forms the 3D object. The curvature may be a positive or negative curvature. The curvature may have a radius of curvature.

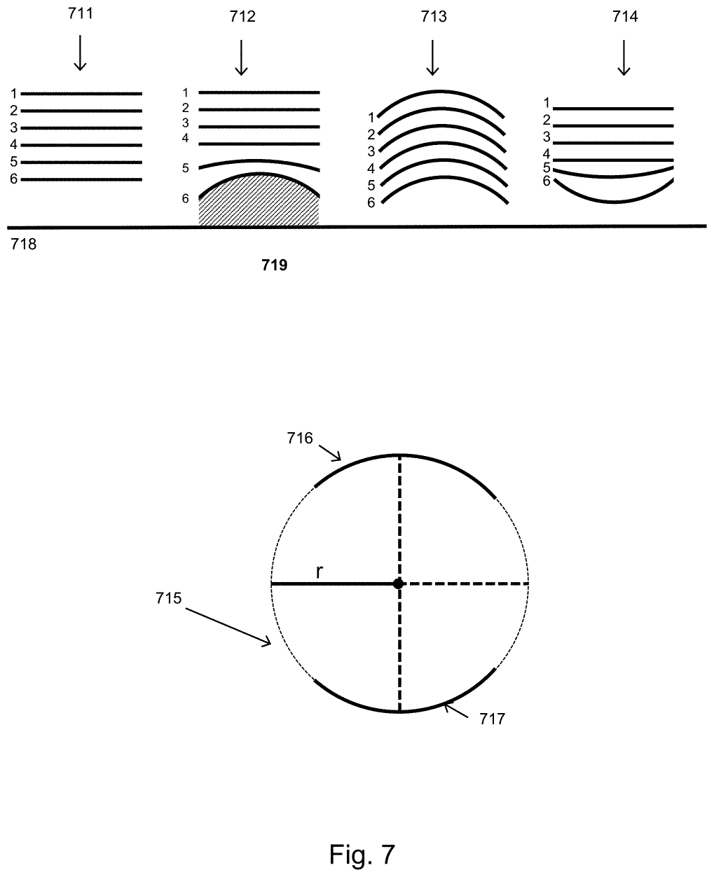

The radius of curvature, “r,” of a curve at a point can be a measure of the radius of the circular arc (e.g., FIG. 7, 716) which best approximates the curve at that point. The radius of curvature can be the inverse of the curvature. In the case of a 3D curve (also herein a “space curve”), the radius of curvature may be the length of the curvature vector. The curvature vector can comprise of a curvature (e.g., the inverse of the radius of curvature) having a particular direction. For example, the particular direction can be the direction towards the build platform (e.g., designated herein as negative curvature), or away from the build platform (e.g., designated herein as positive curvature). For example, the particular direction can be the direction towards the direction of the gravitational field (e.g., designated herein as negative curvature), or opposite to the direction of the gravitational field (e.g., designated herein as positive curvature). A curve (also herein a “curved line”) can be an object similar to a line that is not required to be straight. A straight line can be a special case of curved line wherein the curvature is (e.g., substantially) zero. A line of (e.g., substantially) zero curvature has an (e.g., substantially) infinite radius of curvature. A curve can be in two-dimensions (e.g., vertical cross section of a plane), or in three-dimension (e.g., curvature of a plane). The curve may represent a cross section of a curved plane. A straight line may represent a cross section of a flat (e.g., planar) plane. The build platform may also be referred to herein as a “platform” or a “base”. The build platform may comprise the substrate, base, or bottom of the enclosure. The material bed may be operatively coupled and/or disposed adjacent to (e.g., on) the build platform.

The methods, systems, software, and/or apparatus may comprise anticipating (e.g., calculating) the deformation. Anticipation may consider a position and/or temperature measurements from at least one sensor. The sensor may measure at least one position of a target surface (e.g., an exposed surface of the material bed) (e.g., as described herein).

In some embodiments, the energy beam irradiates (e.g., flash, flare, shine, or stream) energy on a position of the exposed surface of the material bed for a period of time (e.g., predetermined period of time) to transform at least a portion of the pre-transformed material in the material bed into a transformed material. The remainder of the material bed that has not been irradiated, may be at an average (or mean) ambient temperature. The remainder of the material bed that has not been irradiated, may be cooled (e.g., using a cooling member). The remainder of the material bed that has not been irradiated, may not be actively heated (e.g., using a radiative heater). The energy beam that transforms a pre-transformed material into a transformed material is designated as “transforming energy beam.” The transforming energy beam may travel along a path (e.g., vector or raster path). The transformed material may be a welded material. The transformed material may be a fused material. Fused may comprise molten (e.g., completely molten) or sintered. The time during which the transforming energy beam irradiates the material bed may be referred to as a dwell time of the (transforming) energy beam. The irradiation of the material bed by the transforming energy beam may form a transformed portion of the pre-transformed material within the material bed. For example, the irradiation of the powder bed by the transforming energy beam (e.g., laser) may form a fused portion of the powder material within the powder bed. During this period of time (i.e., dwell time) the energy flux of the transforming energy beam may be (e.g., substantially) homogenous. Without wishing to be bound to theory, Energy flux may refer to the transfer rate of energy per unit area (e.g., having SI units: Wm-²=J·m⁻²·s¹). Homogenous may refer to the flux of energy during the dwell time. Homogenous may refer to the distribution of energy density across the cross section of the energy beam. In some instances, the distribution of energy density across the cross section of the energy beam may (e.g., substantially) resemble a Gaussian distribution.

In some embodiments, at a certain period of time, the distribution of energy across the cross section of the energy beam may (e.g., substantially) differ from a Gaussian distribution. During this period of time, the transforming energy beam may (e.g., substantially) not translate (e.g., neither in a raster form nor in a vector form). During this period of time the energy density across the cross section of the transforming energy beam may be (e.g., substantially) constant. In some embodiments, (e.g., during this period of time) the energy density of the transforming energy beam may vary. In some embodiments, (e.g., during this period of time) the power of the energy source generating of transforming energy beam, may vary. The variation may be predetermined. The variation may be controlled (e.g., by at least one controller). The controller may determine the variation based on a signal received by one or more sensors (e.g., temperature and/or positional sensors). The controller may determine the variation based on a computational scheme (e.g., algorithm).

In some embodiments, at least one controller is employed to effectuate (e.g., using control) a requested behavior of an apparatus and/or system (e.g., using at least one sensor). The control may comprise closed loop control. The control may comprise feedback control. The control may comprise feed forward control. The closed loop control may be based on data obtained from one or more sensors. The closed loop control may comprise closed loop control while processing one or more layers disposed within the material bed (e.g., build planes). The closed loop control may comprise closed loop control while processing at least a portion of the one or more build planes (e.g., the entire build). The controlled variation may be based on closed loop and/or open loop control. For example, the controlled variation may be based on (e.g., utilizes) closed loop control. The closed loop control may be performed during the 3D printing process. The closed loop control may rely on in situ measurements (e.g., of an exposed surface). The in situ measurements may be in the chamber where the 3D object is generated (e.g., processing chamber). The closed loop control may rely on real-time measurements (e.g., during the 3D printing process of the at least one 3D object). The closed loop control may rely on real-time measurements (e.g., during formation of a layer of the 3D object). The variation may be determined based on one or more signals obtained from a temperature sensor and/or positional sensor (e.g., imaging). The positional sensor may be a metrology sensor (e.g., as described herein). The variation may be determined based on height variation measurements. The variation may be determined by height evaluation of the exposed surface of the material bed, portions thereof, or any protruding object therefrom. The variation may be determined by temperature measurements of the exposed surface of the material bed, portions thereof, or any protruding object therefrom. The variation may be determined by temperature measurements of the transformed material (e.g., a melt pool therein). The variation may be determined by melt pool size (e.g., FLS) evaluation of the transformed material.

In some embodiments, the control system evolves during at least a portion of the 3D printing (e.g., in real-time, e.g., as delineated herein). The evolution may utilize one or more parameters which vary in real-time (e.g., during formation of a melt pool, or two successive melt pools). The evolution may use uncertain parameter values (e.g., which uncertain parameter values may be roughly estimated). The (e.g., real-time) evolution may rely on at least one changing condition during at least a portion of the 3D printing. The changing conditions may comprise a temperature of a portion at the target surface (e.g., target surface area of a footprint of the energy beam, and/or its vicinity), at least one characteristic of the energy beam, and/or power of the energy source. The changing condition may comprise amount of plasma, oxygen, and/or moisture above the target surface (e.g., in the atmosphere of the processing chamber). The control system may comprise adaptive control. The adaptive control may comprise feed forward adaptive control, or feedback adaptive control. The adaptive control may comprise a direct adaptive control method (e.g., the estimated parameters are directly used in the adaptive controller), or an indirect adaptive control method (e.g., the estimated parameters are used to calculate the controller parameters). The adaptive control may comprise parameter estimation. For example, the computer-model may comprise an initial parameter estimation. For example, the physical-model and/or control-model may comprise an initial parameter estimation. The estimated parameter may be geometric, temperature (e.g., emitted from the target surface), power of the energy source, and/or power density of the energy beam. The adaptive control may comprise recursive parameter estimation. The adaptive control may comprise reference adaptive control scheme (MRAC). The MRAC may comprise one-step-ahead adaptive control (OSAAC) scheme. In some embodiments, the control system may comprise a control scheme that evolves (e.g., changes) during the (e.g., real-time) control. The control scheme may comprise a computational scheme. The adaptive control may comprise a parametric control scheme.

In some embodiments, the control system comprises a model predictive control. The model predictive control may comprise the adaptive control. The control system may alter the physical model in real-time. The physical model may comprise an electronic circuit. The physical model may comprise changing the electronic circuit in real-time. For example, (i) changing the electronic connectivity in the electronic circuit in real-time, and/or (ii) changing the components (e.g., in type, number, and/or configuration) of the electronic circuit in real-time. The control system may comprise changing the physical model (e.g., in real-time) based on the timing of measured one or more events in the 3D printing (e.g., as sensed and/or detected, e.g., in real-time). The computer model (e.g., physical model) may be a coarse prediction of one or more aspects of the 3D printing. The measured (e.g., sensed and/or detected) one or more parameters may allow fine tuning of that coarse prediction (e.g., in real-time) to predict the 3D printing more accurately. The model predictive control may comprise an arbitrary model (e.g., any physical model, e.g., the electronic circuitry model). The arbitrary model may comprise imitation of the 3D printing process. The arbitrary model may comprise simulation of the 3D printing process. The imitation and/or prediction may be a coarse (e.g., rough, or simplistic) prediction. Measured one or more parameters may allow fine tuning of the arbitrary model to better imitate and/or predict the 3D printing. The physical model may change dynamically in real-time (e.g., during printing of a layer of the 3D object).

In some embodiments, the control system comprises robust control. The control system may comprise bounds to one or more variables. In some embodiments, the control system comprises a computational scheme that is unchanging during the (e.g., real-time) control. The robust control may comprise a non-parametric control scheme.

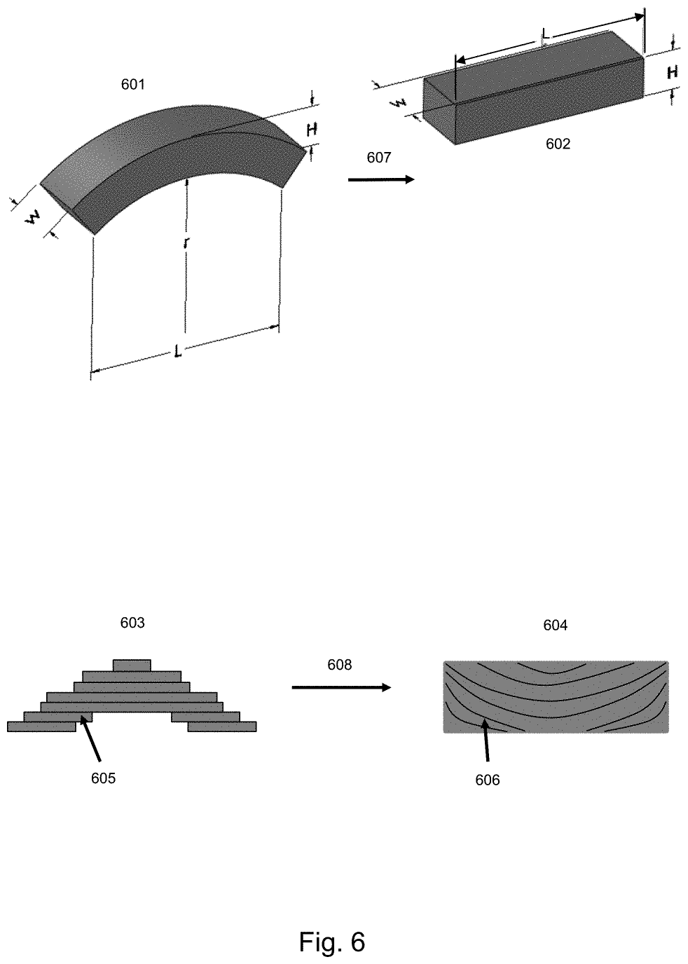

In some embodiments, the control comprises a closed loop control, or an open loop control (e.g., based on energy calculations comprising a computational scheme). The closed loop control may comprise feedback or feed forward control. The control may comprise generating a slicing plan of a requested model of the 3D object. The control may comprise generating a path plan (e.g., comprising a hatching plan) of a particular 3D model slice, along which path the energy beam (e.g., transforming energy beam) may travel. Examples of path plans, 3D printers, related control system, related methods, apparatuses, systems, and program instructions (e.g., software), can be found in U.S. patent application Ser. No. 17/881,797, filed on Aug. 5, 2022, and in international patent application number PCT/US16/66000 filed on Dec. 9, 2016, each of which is incorporated by reference in its entirety. The path plan may be used to generate at least one 3D printing direction according to which the 3D printing is conducted and/or controlled. The control may comprise using a computational scheme (e.g., comprised in a script). The computational scheme may be embedded in a script. In some examples, a script is a language specific computer readable media (e.g., software) implementation of the computational scheme. For example, the model may combine feedback or feed-forward control based at least in part on a computational scheme. The computational scheme may consider one or more temperature measurements (e.g., as delineated herein), one or more power measurements, one or more power density measurements, geometry of at least part of the 3D object, heat depletion/conductance profile of at least part of the 3D object, or any combination thereof. The controller may modulate the energy beam (e.g., transforming energy beam). The computational scheme may consider geometric pre-correction of an object (i.e., object pre-print correction. OPC) to compensate for any distortion of the final 3D object (e.g., after its hardening). FIG. 6 shows various examples of OPC. The computational scheme may comprise an instruction to form a correctively deformed object. The computational scheme may comprise modification applied to the model of a requested 3D object. Examples of modifications, related control system, related methods, apparatuses, systems, and program instructions (e.g., software), can be found in International Patent Application Serial No. PCT/US16/0384857, that was filed on May 27, 2016, which is incorporated herein by reference in its entirety. The computational scheme may consider the geometry of one or two different portion of the 3D object. The computational scheme may be different for at least two (e.g., geometrically different) portion of the 3D object. The different portions of the 3D object may comprise a bulk (e.g., interior) of the 3D object, bottom skin layer, surface of the 3D object, interior of the 3D object immediately close to the surface. The computational scheme may be differ depending on the angle of the bottom skin layer, with respect to the build platform. The bulk of the 3D object may comprise transformed (e.g. and hardened) material that is thick enough to withstand stress deformation upon adding transformed material to it (e.g., additional layer of transformed material). For example, the control may comprise a thermoplastic simulation. The thermo-mechanical simulation can comprise elastic or plastic simulation. The thermoplastic simulation may comprise metrological and/or temperature measurements taken during the 3D printing process (e.g., of a previously formed layer of hardened material). The thermoplastic simulation may be used to revise the 3D printing plan, path plan, and/or path directionality. The analysis (e.g., thermoplastic simulation) may be performed before, during, and/or after a layer of hardened material is formed. Examples of energy beams such as transforming energy beams, 3D printers, related control system, related methods, apparatuses, systems, and program instructions (e.g., software), can be found in U.S. patent application Ser. No. 17/881,797 filed on Aug. 5, 2022 that is entirely incorporated by reference herein.

In some embodiments, the printing instructions for two geometrically different portions of the 3D object may be different. Different may be by at least one printing parameters. For example, different may be by at least one characteristic of the transforming energy beam and/or energy source. The printing instructions be different for at least two (e.g., geometrically different) portion of the 3D object. The different portions of the 3D object may comprise a bulk (e.g., interior) of the 3D object, bottom skin layer, surface of the 3D object, interior of the 3D object immediately close to the surface. The printing instruction may be differ depending on the angle of the bottom skin layer, with respect to the build platform.

At times, one or more 3D model slices are adjusted by the operation comprising a computational scheme to form an adjusted 3D model slice (e.g., a computational scheme comprising OPC). A slice is a virtual portion of the requested model of the 3D object that is materialized as a layer in the printed (e.g., physical) 3D object. The slice may be a cross section of the model of the requested 3D object. The adjusted 3D model slice may be fed into the controller to control the printing of the 3D object. For example, the adjusted 3D model slice may be fed into the controller to control at least one apparatus within the 3D printing system (e.g., the energy source and/or beam).

In some embodiments, the control (e.g., open loop control) comprises a calculation. The control may comprise using a computational scheme. The control may comprise feedback loop control. In some examples, the control may comprise open loop (e.g., empirical calculations). closed loop (e.g., feed forward and/or feedback loop) control, or any combination thereof. The control setpoint may comprise a calculated (e.g., predicted) setpoint value. The setpoint may comprise adjustment according to the closed loop control. The controller may use metrological and/or temperature measurements. The controller may use material measurements. For example, the controller may use porosity and/or roughness measurements (e.g., of the layer of hardened material). The controller may direct adjustment of one or more systems, software module, and/or apparatuses in the 3D printing system. For example, the controller may direct adjustment of the force exerted by the material removal mechanism (e.g., force of vacuum suction).

At times, a portion of the material within the material bed (e.g., FIG. 1, 104) or a portion of the exposed material of the material bed (e.g., FIG. 1, 106) may part from the material bed (e.g., due to heating). The energy beam may irradiate the material bed and cause the at least a portion to heat (e.g., overheat). Parting of the at least a portion may form a suspended material in the atmosphere above the exposed surface. (e.g., in the enclosure 126). Parting from the material bed may cause the at least a portion to become airborne. Heating may cause the at least a portion to undergo phase transformation. The phase transformation may comprise transformation into a gas or into plasma. The phase transformation may occur during the formation of the one or more 3D objects (e.g., during the transformation and/or hardening). The parting from the material bed (e.g., evaporation) may lead to generation of debris (e.g., upon reaction and/or condensation). For example, the 3D printing process may comprise transforming a pre-transformed material to a transformed material by exposing it to a transforming energy beam for a (e.g., predefined) time period. The time at which the energy source emits a transforming energy beam may be referred herein as “dwell time”. The dwell time may be at least about 1 μsec, 2 μsec, 3 μsec, 4 μsec, 5 μsec, 10 μsec, 20 μsec, 30 μsec, 40 μsec, 50 μsec, 60 μsec, 70 μsecs, 80 μsec, 90 μsec, 100 μsec, 200 μsec, 500 μsec, 1 millisecond (msec). 3 msec, 5 msec, or 10 msec. The dwell time may be any value between the aforementioned values (e.g., from about 1 μsec to about 60 μsec, from about 1 μsec to about 500 μsec, from about 1 μsec to about 10 msec, from about 500 μsec to about 5 msec, or from about 60 μsec to about 1001 μsec). The power per unit area of the energy beam may be at least about 100 Watt per millimeter square (W/mm²), 200 W/mm², 300 W/mm², 400 W/mm², 500 W/mm², 600 W/mm², 700 W/mm², 800 W/mm², 900 W/mm², 1000 W/mm², 2000 W/mm², 3000 W/mm², 5000 W/mm², 7000 W/mm², or 10000 W/mm². The power per unit area of the energy beam may be any value between the afore-mentioned values (e.g., from about 100 W/mm² to about 3000 W/mm², from about 100 W/mm² to about 5000 W/mm², from about 100 W/mm² to about 10000 W/mm², from about 100 W/mm² to about 500 W/mm², from about 1000 W/mm² to about 3000 W/mm², from about 1000 W/mm² to about 3000 W/mm², or from about 500 W/mm² to about 1000 W/mm²). The power per unit area of the energy beam may be any power per unit are disclosed herein. The dwell time or the amount of heat deposited by the energy beam may be used to transform the pre-transformed material to a transformed material. The transformation may occur at a temperature that may cause one or more phase transformation of the at least a portion of the material bed (e.g., forming liquid, evaporation, and/or plasma formation). In some instances, the at least a portion that is heated (e.g., by the energy beam) may comprise a pre-transformed material or a transformed material. At times, the at least a portion that is heated (e.g., by the energy beam) may comprise a hardened material.

Some materials (e.g., pre-transformed and/or transformed) comprise elements (e.g., chromium) which materials have a different vapor pressure in their elemental state (e.g., metallic state) relative to their oxide state. When a pre-transformed material is being transformed, the element (as part of the pre-transformed material), may evaporate and/or form plasma. The evaporated material and/or its plasma may chemically react. The chemical reaction may comprise oxidation (e.g., form an oxide). The chemical reaction may comprise reacting with a gas (e.g., in the enclosure). The chemical reaction may comprise reacting with a residual chemical (e.g., in the enclosure). The chemical reaction may comprise reacting with oxygen (e.g., molecule or radical). The chemical reaction may comprise reacting with an oxygen and/or water molecule. The evaporation and/or plasma formation of such (e.g., metallic) material, as well as its (e.g., subsequent) condensation and/or chemical reaction, may lead to generation of debris (e.g., in the form of soot). Without wishing to be bound to theory, the generation of debris may be a result of condensation and/or chemical reaction (e.g., oxidation). At times, the reaction product of the material may have a higher vapor pressure relative to its respective elemental state. For example, the oxide of the element may have a higher vapor pressure relative to its respective elemental state. At times, the material at its elemental state will tend to evaporate and/or form plasma quicker than its respective reaction product (e.g., oxide). Material examples comprise Molybdenum or Tungsten, which have a low vapor pressure in their elemental state (e.g., metallic) as compared to their respective oxides. Metal may comprise an elemental metal or metal alloy.

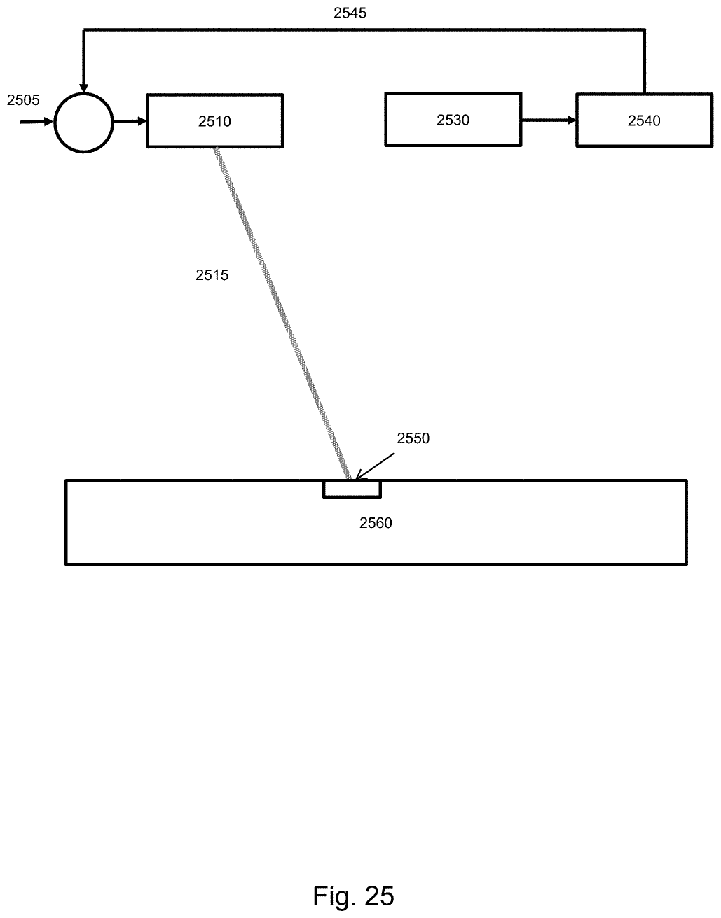

To reduce (e.g., avoid) evaporation and/or plasma formation of materials (e.g., and thus formation of debris) the temperature of the heated area (e.g., by the energy beam) may be controlled using at least one controller (e.g., comprising a GPU, CPU, FPGA or any other such computing element, e.g., as described herein). FIG. 25 shows a schematic example of a system for adjusting a temperature of a heated area 2550 using a controller 2540 (e.g., a control system, e.g., as shown in FIG. 24). The heated area (e.g., a melt pool) may be in the material bed (e.g., 2560), and/or on a target surface. The heated area may comprise a portion of the exposed surface of the material bed. The temperature of the heated area (e.g., a location of the transformation) may be monitored using one or more sensors 2530 (e.g., optical sensors, and/or thermal sensors). In some examples, the monitored temperature is compared (e.g., by the controller) to a predetermined threshold temperature value (or range) as a control parameter. The predetermined threshold value may be provided by a feed forward control element (e.g., 2505). The control parameter may comprise a specific location, and/or a specific time, of the transformation. As the monitored temperature deviates from the predetermined threshold value (or range), the temperature may be adjusted (e.g., using a feed-back control) to alter (e.g., reduce) the temperature deviation. In an analogous manner to the temperature adjustment, the power of the energy source generating the energy beam, and/or at least one characteristic of the energy beam (e.g., power density thereof) may be adjusted additionally or alternatively thereto.

In some examples, the control comprises a closed loop control. The closed loop control may comprise feedback, or feed-forward control. The control variable (e.g., power per unit area) of the energy beam (e.g., 2515) may be adjusted, e.g., by adjusting the energy source (e.g., 2510) parameters (e.g., by the controller). The control variable (e.g., power per unit area) of the energy beam may be pre-programmed. Pre-programing may be for a particular path of the energy beam. In some embodiments, both feed forward and feedback control may be used in combination. The control variable (e.g., power per unit area) of the energy beam may be adjusted locally. Locally may refer to a particular heated area, adjacent to a particular heated area, a hatching within a path, a path of the energy beam, or a layer. The control variable (e.g., temperature) may be controlled by a closed loop control (e.g., 2545). The control may rely on the temperature measurements (e.g., by the one or more sensors).

The control may comprise pre-defining a value, or a set of values, for the control variable (e.g., power per unit area profile, power profile, and/or a temperature profile). The control variable may be pre-defined for one or more transformation locations on the target surface. The control may comprise controlling the control variable (e.g., temperature, power, and/or power per unit area) in relation to a transformation location, in real-time. Controlling may comprise regulating, monitoring, modulating, varying, altering, restraining, managing, checking, and/or guiding. Real-time may be during transforming at least a portion of a material within the energy beam footprint, hatch, path, or slice. Real-time may be during the formation of the 3D object or portion thereof. In some embodiments, the control may comprise adjusting (e.g., correcting) for at least one deviation of the temperature at the heated area, power of the energy source generating the energy beam, and/or power per unit area of the energy beam directed to the heated area. The adjustment may be relative to a pre-defined power, power per unit area (e.g., value and/or profile), or temperature (e.g., value and/or profile) at the heated area respectively. The feed forward controller may pre-identify one or more locations at the (virtual) model of the requested 3D object that may be more challenging to correct using feedback control (e.g., U-turns, long hatches, and/or short hatches). The pre-identification locations (e.g., and operation) may comprise performing geometry analysis of a 3D printing model associated with the requested 3D object. The printing model may comprise an OPC of the requested 3D object.

In some embodiments, the control comprises generating a physical model. In some embodiments, the control-model comprises the physical model. In some embodiments, the computer-model comprises the physical model. In some embodiments, the control-model excludes the physical model. In some embodiments, the computer-model excludes the physical model. The physical model may imitate and/or be analogous to a thermo-mechanical model (e.g., of the 3D printing). The physical model may comprise one or more elements that represent (e.g., are analogous to, or imitate) one or more physical properties (e.g., heat profile of an energy beam, thermal history of an energy beam, dwell time sequence of an energy beam, power profile over time of an energy beam, energy beam distribution (i.e., spot size)) associated with one or more components involved in the process of building a 3D object (e.g., energy beam, pre-transformed, or transformed material). The physical model may be used to pre-determine one or more target parameters (e.g., a temperature threshold at one or more points on the target surface, a power density of the energy beam, a FLS of the energy beam footprint on the target surface, a focus of the energy beam footprint, a dwell time of the energy beam, an intermission time of the energy beam).

In some embodiments, the physical model is a complex model. The complex model may include a high order model (e.g., a high dimension mathematical model, and/or a high polynomial order model). High dimension refers to a dimension that is greater than one. For example, a mathematical polynomial with a power of two, three, four, or more. The complex model may comprise information related to (i) one or more metrological properties of the forming 3D object (or portion thereof), (ii) physical properties of the pre-transformed and/or transformed material, or (iii) thermal properties of the energy beam (e.g., along at least a portion of the path used for building a 3D object). The complex model may include properties associated with more than one dimension of the 3D object. The complex model may include properties related to one or more layers of the 3D object (e.g., previously formed and/or to be formed layers). The complex model may include geometry parameters (e.g., contours, curves, slices) of the requested 3D object to be build. The complex model may include one or more prediction models. The prediction may pertain to the way at least a portion of the 3D object is hardened during and/or subsequent to the transformation of the pre-transformed material which forms at least a portion of the 3D object. A prediction model may predict at least one physical property (e.g., thermal map of the 3D object) during its formation (e.g., during building one or more layers of a 3D object), and/or a dwell time sequence of the energy beam (e.g., across one or more layers forming the 3D object).

In some embodiments, the physical model is a simplified (e.g., simple) model. A simplified model may include one or more properties related to at least a building portion of the 3D object (e.g., a single dimension of the 3D object, or two dimensions of the 3D object). The simplified model may include one or more assumptions. The assumptions may comprise pre-determining values (e.g., assuming stable values) for one or more properties of the 3D object. The assumptions may include simplifying the geometry of the 3D object (e.g., a single dimension of a portion of the 3D object). The assumptions may include predicting at least one physical property (e.g., temperature over time, temperature distribution within at least a portion of the 3D object (e.g., over time), power density of the energy beam overtime, heat profile of the material bed over time, and/or heat distribution within the material bed (e.g., over time)). The simplified model may be a discretized version of the complex model (e.g., may include predictions for a portion of the geometry of the 3D object). The simplified model may be a subset of the complex model (e.g., may include a single property). The complex model may comprise a plurality of simplified models.

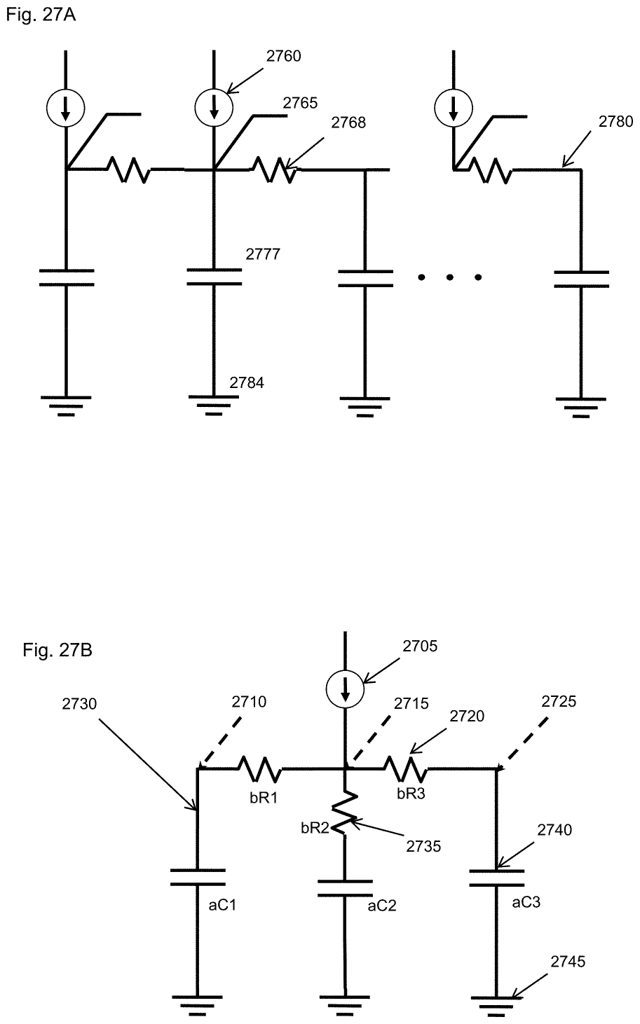

In some embodiments, the physical model is represented by an analogous model (e.g., an electrical model, an electronic model, and/or a mechanical model). FIGS. 27A-27B illustrate examples of an electrical analogous model. FIG. 27A illustrates an example of a simplified electrical analogous model (e.g., a first order of complexity model). The electrical model may include one or more basic elements, for example, a current source (e.g., FIG. 27A, 2760), a resistor (e.g., FIG. 27A, 2768), a capacitor (e.g., FIG. 27A, 2777), an inductor, and/or a ground component (e.g., FIG. 27A, 2784). The basic elements may represent one or more physical properties of building a 3D object. At times, the basic elements may represent one or more components of the 3D printer. For example, the energy beam may be represented by a current source. In some examples, the angle of at least a portion of the 3D object (e.g., an overhang thereof) may affect the capacitance and/or resistor values representing a point on the edge of that at least a portion of the 3D object (e.g., this overhang). For example, the larger the overhang angle with respect to the target (e.g., exposed) surface (e.g., the stepper the overhang), the smaller the resistor will be in the physical-model, and the larger the capacitance in the physical-model. The value of at least one resistor and/or capacitance may be related to (i) the discretization distance and/or (ii) the fundamental material properties forming the 3D object. The discretization distance may be the physical length of a unit element (e.g., electrical element) which is represented by the basic discrete elements. The fundamental material properties of the build material may comprise the thermal conductivity, the heat capacity, or the density of the build material (e.g., material forming the 3D object). In some examples, the measured voltage probe points (in the physical-model), such as 2765, represent a measurement of the surface temperature (in the forming/formed 3D object). Closed loop and/or feedback control may be modeled by a change of the current source as a response to a change in the measured voltage, at the probe point (e.g., 2765). The model can also predict the measured voltages (e.g., that can represent measured temperature). Measuring the temperature levels during the build and/or comparing them to the modeled voltage, may allow (i) a (e.g., systematic) study of the error in the physical-model, (ii) fine tuning of the model, (iii) finding a relationship between the physical process of 3D printing and the (e.g., simplified) physical-model representing it, or (iv) any combination thereof. The voltage may be measured at the intersection of the current source and the branch of a resistor and/or capacitor (e.g., FIG. 27A, 2765). The simplified (e.g., reduced) model may not be limited to simple and/or constant value components. As an example, the capacitors and/or resistors can depend on the voltage C(V) and/or R(V) respectively. Additional components that can be used are, for example, current multiplier. The value of the current multiplier can represent in the physical-model a change in the absorption efficiency of the energy beam by the material in the 3D printing. For example, as the value of the current multiplier can depend on the voltage (imitating the physical property of the absorption that can depend on the temperature). The voltage may be used to simulate a dependence (e.g., a temperature) of the capacitor and/or the resistor (e.g., C(V), and/or R(V)). The analogous model may include input from at least one sensor and/or detector. The sensor and/or detector may detect a physical property of at least one position on the target surface (e.g., temperature of a position at the target surface, power of the energy beam, and/or thermal map of the path of the energy beam). The sensor input may be fed into one or more branches of the physical model.

In some embodiments, the physical model comprises an analog or digital model. The model may comprise an electronic model. The model may comprise a basic element. The basic element may be an electrical (e.g., electronic) element. The electrical element may comprise active, passive, or electromechanical components. The active components may comprise a diode, transistor, an integrated circuit, an optoelectronic device, display device, vacuum tube, discharge device, or a power source. The passive components may comprise a resistor, a capacitor, a magnetic (inductive) device, a memristor, a network, a transducer, a sensor, a detector, an antenna, an oscillator, a display device, a filter (e.g., electronic filter), a wire-wrap, or a breadboard. The electromechanical components may comprise a mechanical accessory, a (e.g., printed) circuit board, or a memristor. The basic elements may be variable devices and/or have a variable value (for example, a variable resistor, and/or a variable capacitor). The resistor may be a linear resistor, non-linear resistor, carbon composition resistor, wire wound resistor, thin film resistor, carbon film resistor, metal film resistor, thick film resistor, metal oxide resistor, cermet oxide resistor, fusible resistor, variable resistor, potentiometer, rheostat, trimmer, thermistor, varistor, light dependent resistor, photo resistor, photo conductive cell, or a surface mount resistor. The capacitor may be a ceramic, film, paper, polarized, non-polarized, aluminum electrolytic, a tantalum electrolytic, niobium electrolytic, polymer, double layer, pseudo, hybrid, silver, mica, silicon, airgap, or a vacuum capacitor. The inductor may be an air core inductor, ferro magnetic core inductor, iron core inductor, ferrite core inductor, toroidal core inductor, bobbin-based inductor, multi-layer inductor, thin film inductor, coupled inductor, plastic molded inductor, ceramic molded inductor, power inductor, high frequency inductor, radio frequency inductor, choke, surface mount inductor, or a laminated core inductor. The physical model may be incorporated in a processor (e.g., computer). The physical model may comprise a circuit analog (e.g., in a processor). For example, the physical model may comprise a virtual circuit analog. The physical model may comprise a tangible circuit. The physical model may comprise a circuit board. The circuit boards may comprise the one or more electrical elements.

FIG. 27B illustrates an example of a more complex electrical analogous model (e.g., a second order of complexity model) relative to the one in FIG. 27A. The more complex electrical analogous model may include one or more basic electrical elements (e.g., a current source 2705, a resistor 2720, a capacitor 2740, and/or a ground element 2745). The basic element may include a multiplier (e.g., a constant value represented in the FIG. 27B, as “a” for the capacitor or “b” for the resistor). The multiplier may be variable. The multiplier may be adjusted. Adjustment may be done before, after, or during build of the 3D object (e.g., in real-time). Adjustment may be done manually and/or automatically (e.g., by at least one controller). At times, the complex electrical analogous model may be (e.g., substantially) complete (e.g., include representation for all dimensions, and/or properties of a physical model of the 3D object). Substantially may be relative to the intended purpose of the 3D object. The complex (e.g., more complex) electrical analogous model may include input from one or more sensors and/or detectors. A sensor or detector may sense or detect (respectively) a physical property of at least one position on the target surface (e.g., temperature of the target surface (e.g., temperature distribution thereof), power density of the energy beam, thermal map of the path of the energy beam, thermal map of the forming 3D object, and/or thermal map of the material bed). The sensor/detector input may be fed (e.g., FIG. 27B, 2710, 2715, 2725) into one or more branches (e.g., FIG. 27B, 2730) of the analogous electrical model (for example, a single branch may receive input from a single sensor, a single branch may receive input from more than one sensor, or multiple branches may receive input from a single sensor). The one or more sensor inputs may provide an (e.g., substantially) accurate measurements of the process of building the 3D object. The sensor input may use a signal sensed using at least one optical fiber (e.g., fiber bundle). Examples of at least one fiber (e.g., fiber bundle) that is connected to a sensor/detector, 3D printers, related control system, related methods, apparatuses, systems, and program instructions (e.g., software), can be found in U.S. patent application Ser. No. 17/874,447, filed on Jul. 27, 2022 that is incorporated herein by reference in its entirety.

In some embodiments, the measurements (e.g., thermal, or power density) based on the sensor/detector input are detailed (e.g., accurate measurements from one or more sensors, smaller number of assumptions than a first order complexity model). The detailed measurements may allow observation of complex physical properties (e.g., diffusion of the heat through the forming 3D object and/or material bed). Detailed (e.g., accurate, and/or pertaining to more than one physical property) adjustments may be made based on the detailed measurements. The detailed adjustments may minimize uncertainties (e.g., uncertainties related to assumptions of physical properties, uncertainties such as location of the energy beam, uncertainties related to temperature profile of the energy beam, uncertainties related to geometry of the forming 3D object). The adjustments may be done by at least one controller. The analogous model (e.g., physical model) may act as a state observer. The analogous model may provide one or more measurements to the controller. Based on the measurements, the controller may adjust one or more components of the 3D printer. For example, the controller may adjust one or more characteristics of the energy beam. The controller may adjust one or more physical properties (e.g., electrical charge, e.g., position of an optical element). Adjustment may be done before, after and/or during 3D printing. The controller may be a part of a processing (e.g., computer) system. The controller may comprise a processor. The controller may be any controller described herein. The processor and/or processing system may be any computer and/or computer system described herein.

In some examples, one or more sensors/detectors are used to sense/detect (respectively) one or more physical parameters within the 3D printer system. Sensing and/or detecting may be done in real-time (e.g., during build of the 3D object). Sensing and/or detecting may be done offline (e.g., before and/or after building the 3D object). The sensor may be any sensor described herein. The detector may be a detector array. The sensor and/or detector may be coupled to an optical fiber. A detector array and/or sensor array may be coupled to an optical fiber bundle. Examples of sensors and/or detectors, 3D printers, related control system, related methods, apparatuses, systems, and program instructions (e.g., software), can be found in U.S. patent application Ser. No. 17/953,506 filed on Sep. 27, 2022, which is incorporated herein by reference in its entirety. The sensor and/or detector may sense and/or detect (respectively) one or more physical parameters of at least one layer of a forming 3D object. The sensor and/or detector may be translatable (e.g., movable, e.g., attached to a gimbal). The sensor and/or detector may move back and forth (e.g., along a path of an energy beam). The movement may be controlled (e.g., manually, or automatically, e.g., using at least one controller).

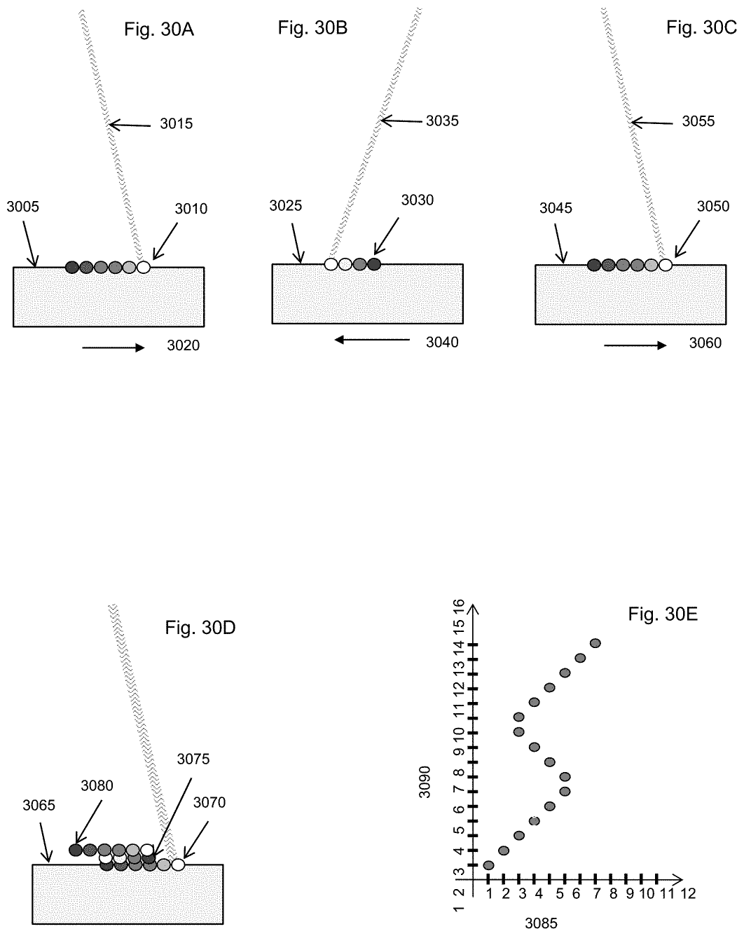

FIGS. 30A-30E illustrate an example of retro scan. A retro scan may include moving the irradiated energy back and forth in the same general plane (e.g., of the target surface) along a path (e.g., line). Moving the irradiated energy may include moving one or more steps in the forward direction. The steps may be continuous or discontinuous. The steps may be isolated. For example, the steps may be tiles (e.g., overlapping, or non-overlapping tiles). For example, FIG. 30A illustrates an example of moving the irradiated energy (e.g., 3015) in six steps (e.g., 3010) in a forward direction (e.g., 3020) on a target surface (e.g., 3005) along a line. FIG. 30B illustrates an example of moving the irradiated energy (e.g., 3035) four steps (e.g., 3030) in a backward direction (e.g., 3040) on the target surface (e.g., 3025) along the line. FIG. 30C illustrates an example of moving the irradiated energy beam (e.g., 3055) six steps (e.g., 3050) in the forward direction (e.g., 3060), on the target surface (e.g., 3045) along the line. In the retro scan procedure, the operation illustrated in FIG. 30A is executed, followed by the operation illustrated in FIG. 30B, which is subsequently followed by the operation in FIG. 30C. Moving the irradiated energy may include moving one or more steps selected from (i) moving in a forward direction to form a first forward path, (ii) irradiating to at least partially overlap the first forward path in a backwards direction to form a backwards path, and (iii) irradiating to at least partially overlap the backwards path in a forward direction. Operations (i) to (iii) can be conducted sequentially. In some embodiments, the backwards path overlaps the first forward path (at least) in part. In some embodiments, the second forward path overlaps the backwards path (at least) in part. Moving the energy beam may include overall moving in the forward direction (e.g., two steps forward and one step backward). For example, when the non-overlapping second forward path exceeds the first forward path in the direction of forward movement (e.g., difference between positions 7-8 on the target surface irradiated at time 15-16 in FIG. 30E). For example, FIG. 30D illustrates an example of moving the energy beam in three iterations, which circles (e.g., 3080) show an expansion of a superposition of irradiated positions on the target surface 3065. In the first iteration, the energy beam moves six steps in the forward direction (e.g., 3080). In the second iteration, the energy beam moves four steps in the backward direction (e.g., 3075) from the previous iteration. In the third step, the energy beam moves six steps in the forward direction (e.g., 3070) from the earlier iteration, thus overall moving eight steps in the forward direction on the target surface (e.g., 3025). In the illustrated example, the earliest irradiation position (e.g., first step) is indicated by the darkest gray circle. The shades of gray are lightened to indicate the subsequent steps (from the earliest to the most recent irradiated position, e.g., step two to step six) in the iteration, and the last irradiation position is indicated by a white circle. FIG. 30E illustrates the graphical representation of the retro scan, wherein the graphical representation illustrates the position of the irradiated energy on the target surface (e.g., 3085. E.g., position along an X axis) as time (e.g., 3090) progresses. The retro scan may be performed with the transforming energy beam having an elliptical (e.g., circular) cross section. The retro scan may be performed with the transforming energy beam having an oval (e.g., Cartesian oval) cross section. The retro scan may be performed continuously (e.g., during the 3D printing transformation operation, or a portion thereof). The retro scan may be performed during printing of the 3D object. The movement of the energy beam may be controlled statically (e.g., before or after printing of the 3D object). The movement of the energy beam may be controlled dynamically (e.g., during printing of the 3D object). The retro scan can be performed with any cross section of the irradiated energy (e.g., transforming energy) disclosed herein. For example, the retro scan can be performed using a circular cross sectional energy beam (e.g., focused, defocused, having small or large FLS), or an elliptical cross sectional energy beam (e.g., using the astigmatism mechanism). The energy beam used for the retro scan can be any transforming energy beam disclosed herein (e.g., focused, defocused, having small or large FLS).

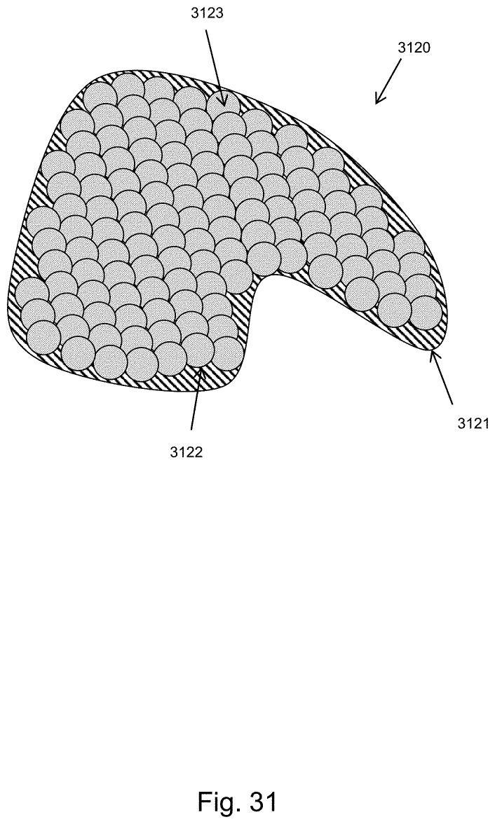

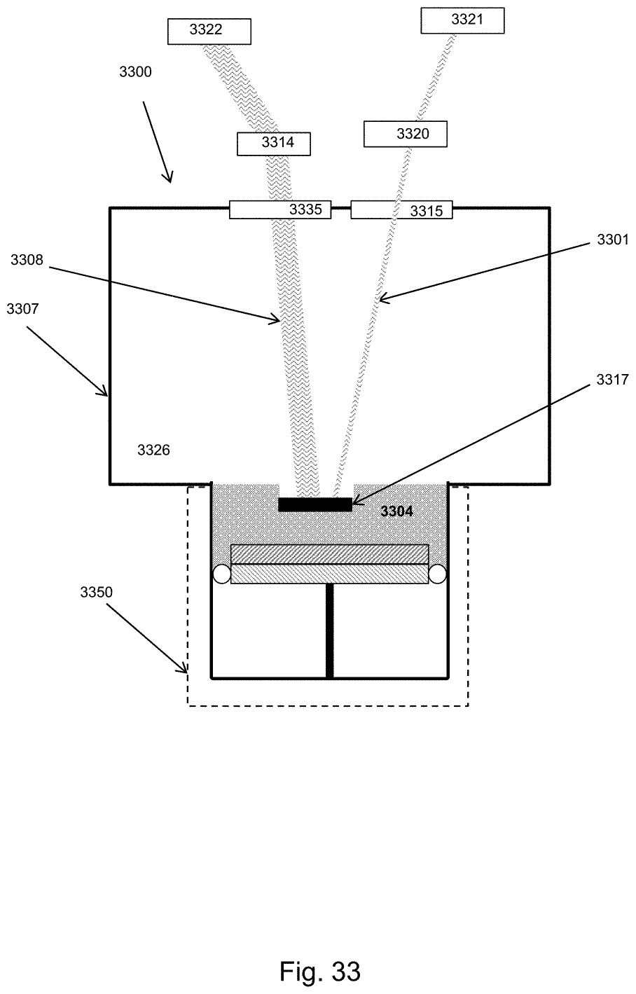

In some embodiments, the layer of hardened material (as part of the 3D object) is formed with a scanning energy beam, tiling energy beam, or any combination thereof. The tiling energy beam can have a cross section that is larger than the scanning energy beam. Larger may be by at least about 1.5*, 2*. 5*, 10*, 25*, 50*, or 100*. The symbol “*” designates the mathematical operation “times.” The scanning energy beam may have a power per unit area that is larger than the power per unit area of the tiling energy beam. The tiling energy beam may have a dwell time that is longer than the one of the scanning energy beams. The scanning energy beam may form feature that have a smaller FLS as compared to the features formed by the tiling energy beam. FIG. 31 shows an example of a layer 3120 that is at least a part of a 3D object. The layer is formed using a tiling energy beam that form tiles (e.g., 3123), and a scanning energy beam that form hatches (e.g., 3122) and a rim (e.g., 3121). FIG. 33 shows an example of a 3D printer comprising a build module 3350 and a processing chamber comprising atmosphere 3326. The 3D printer 3300 comprises a scanning energy source 3321 generating a scanning energy beam 3301 that travels through a scanner 3320, through an optical window 3315 to transform a portion of a material bed 3304 to a transformed material 3317 (e.g., to form a 3D object). The 3D printer 3300 comprises a tiling energy source 3322 generating a tiling energy beam 3308 that travels through a scanner 3314, through an optical window 3335 to transform a portion of a material bed 3304 to a transformed material 3317 (e.g., to form a 3D object). The 3D printer may comprise one or more energy sources. The energy source may generate one or more energy beams. The energy beams may travel through the same or different optical window. The energy beams may be directed by the same or different scanners. Tiles may be formed by a (e.g., substantially) stationary tiling energy beam, which periodically moves along a path (e.g., path of tiles). The tiling energy beam may be of a lower power density than the scanning energy beam. Hatches may be formed by a continuously moving scanning energy beam. The dwell time of the tiling energy beam at a position of the target surface that forms the tile, may be longer than the dwell time of the scanning energy beam at a position of the target surface which forms the hatch. The cross section of the tiling energy beam may be larger than the cross section of the scanning energy beam.

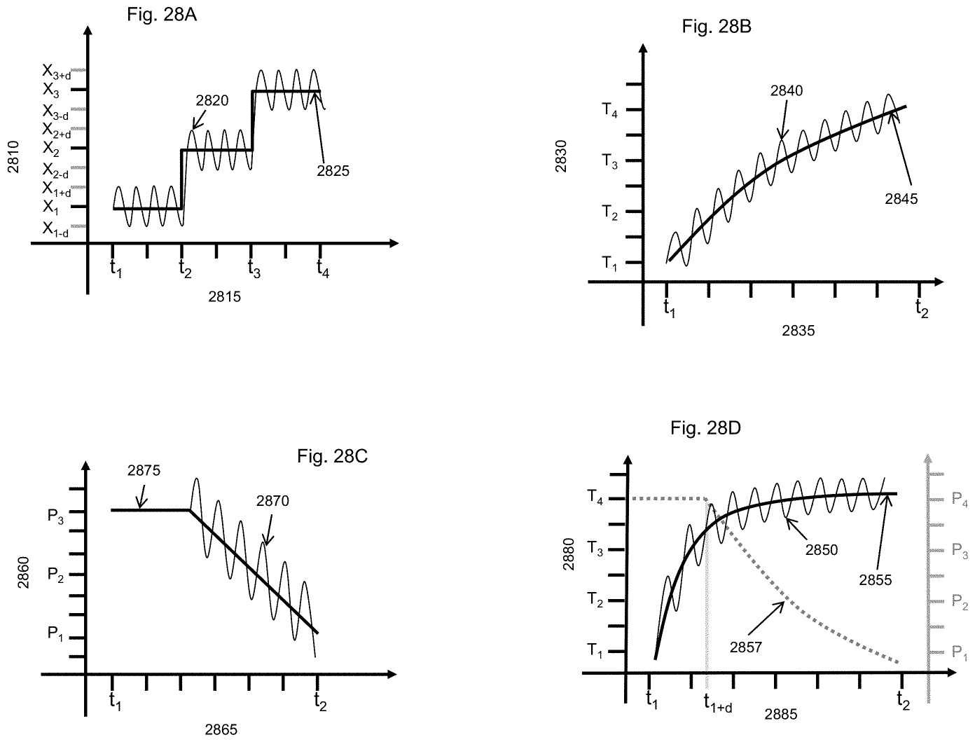

At times, a single sensor and/or detector may be used to sense and/or detect (respectively) a plurality of physical attributes (e.g., parameters), for example, power density over time of an energy beam, temperature over time of an energy beam, and/or energy source power over time. At times, a single pixel sensor and/or detector may be used to sense and/or detect (respectively) a physical attribute (e.g., power density (e.g., over time) of an energy beam, temperature (e.g., over time) of an energy beam, and/or energy source power (e.g., over time). FIG. 28A shows an example of irradiating an energy beam at three positions X₁, X₂ and X₃. The irradiations at the positions may form three melt pools. The irradiations at the position may form three tiles. The irradiations at the portions may be by a non-oscillating energy beam (e.g., traveling along path 2825). The irradiation may be by an oscillating (e.g., retro scanning, dithering) energy using an energy beam that travels along an oscillating path, 2820. The energy beam can be the transforming energy beam. For example, the energy beam can be a tiling energy beam. A position of the energy beam (e.g., FIG. 28A, 2810) may be measured as a function of time (e.g., FIG. 28A, 2815), e.g., as the oscillating (e.g., retro scan) energy beam performs oscillations 2820, or as the non-oscillating energy beam travel along its path 2810. The oscillating energy beam can perform oscillations that comprise a back-and-forth movement along the path of the non-oscillating energy beam. The oscillations can have an amplitude that is equal to, or smaller than, a melt pool diameter. The oscillations can have an amplitude that is equal to, or smaller than, a melt pool diameter smaller than the diameter of the cross section of the energy beam. As compared to the non-oscillating energy beam (e.g., 2825), irradiating at position X₁ during the period t₁-t₂, the oscillating beam (e.g., 2820) travels back and forth between X_{1-d} and X_{1+d}, as shown in the example of FIG. 28A. FIG. 28B illustrates an example that depicts temperature measurements 2830 as a function of time 2835, while forming tiles (e.g., having center positions FIG. 28A, X₁, X₂ and X₃). In the example shown in FIG. 28B, during the spatial oscillations of the energy beam (e.g., 2820), the temperature measured 2840 that is emitted from the target surface at the footprint of the energy beam, oscillates as well. As the footprint of the oscillating energy beam at the target surface physically oscillates between the center of the area that is heated by the energy beam (e.g., FIG. 28A, X₁, e.g., tile center) and the outskirts of that center (e.g., FIG. 28A, X_{1-d}, or X_{1+d}, e.g., tile outskirts), the measured temperature emitted from the target surface at the footprint fluctuate between a maximum temperature value (e.g., at the tile center) and a minimum temperature value (at the tile outskirts). FIG. 28B shows temperature measurement profile 2845 as a function of time, of a non-oscillatory energy beam that travels along path 2825 (in FIG. 28A), during t₁ to t₂. In the example shown in FIG. 28B, the power stays (e.g., substantially) constant during the period from t₁ to t₂. FIG. 28D illustrates an example that depicts temperature measurements 2880 as a function of time 2885, while forming a tile that is centered at X₁ (in FIG. 28A). In the example shown in FIG. 28D, during the spatial oscillations of the energy beam, the measured temperature from the target surface at the footprint of the energy beam oscillates as well 2850. As the oscillating energy beam footprint at the target surface physically oscillates between the center of the area heated by the energy beam (e.g., FIG. 28A, X₁, e.g., tile center) and the outskirts of that center (e.g., FIG. 28A, X_{1-d}, or X_{1+d}, e.g., tile outskirts), the measured temperature from the target surface at the energy beam footprint 2850 fluctuates between a local maximum temperature value (e.g., at the tile center) and a minimum temperature value (at the tile outskirts). FIG. 28B shows temperature measurement profile 2855 as a function of time, of a non-oscillatory energy beam that travels along path 2825 during t₁ to t₂. In the example shown in FIG. 28B, the power 2857 of the energy source that generates the energy beam is kept (e.g., substantially) constant during the period from t₁ to t_{1+d}, until the temperature approaches a (e.g., predetermined) value of T₄; and decreases in order to keep the temperature at a (e.g., substantially) constant value T₄ during the period from t_{1+d} to t₂. One or more detectors may measure the temperature distribution along the path (e.g., of the scanning and/or non-scanning energy beam), by detecting the temperature. The speed (e.g., moving speed) and/or amplitude of the backwards and forwards movements of the oscillating beam can be (e.g., substantially) similar or different with respect to each other. The speed and/or amplitude of at least two of the forwards movements of the oscillating beam may be different along the path. The speed and/or amplitude of at least two of the backwards movements of the oscillating beam may be (e.g., substantially) similar along the path.

In some embodiments, the footprint of the oscillation energy beam on the target surface translates back and forth around a position of the target surface (e.g., center of the tile). The amplitude of the oscillation may be smaller than, or equal to the FLS (e.g., diameter) of a tile. In some embodiments, at least one characteristic of the energy beam is held at a (e.g., substantially) constant value using close loop control during the oscillation, using a measured value (e.g., of the same, or another characteristics). For example, the power of the energy source that generates the energy beam may be held at a constant value, use measurements of temperature at one or more locations at the target surface (e.g., at a location and/or as the energy beam travels along the path). For example, the temperature at the irradiation location (e.g., energy beam footprint) is held at a (e.g., substantially) constant maximum value (e.g., using at least one controller), and the power of the energy source generating the energy beam is measured and/or observed. The temperature may be held at a constant maximum value by altering the power of the energy source. The energy source power may be held at a constant value, resulting in an alteration of the temperature at the target surface location of the energy beam footprint. The areal extent of the heated area may be extrapolated from (e.g., fluctuations of) the power and/or temperature measurements. The heated area may comprise a melt pool (e.g., FIG. 26A, 2605) or its vicinity (e.g., 2610). In some embodiments, the oscillating energy beam that is held in closed loop control may facilitate controlling at least one characteristic of the melt pool (e.g., temperature and FLS). In some embodiments, the variation in power of the energy beam may be cycling and/or may drop during the irradiation of the energy beam (e.g., during the 3D printing) at the target surface. FIG. 28C illustrates an example method of measuring power (e.g., 2860) of the energy source as a function of time (e.g., 2865), e.g., using a single sensor/detector. In this example method, a threshold temperature (e.g., temperature to be maintained at the target surface) may be specified. The threshold temperature may be kept (e.g., substantially) constant. The sensor/detector may monitor the temperature at discrete time points. The control system may adjust at least one characteristic of the energy source generating the energy beam (e.g., its power) to maintain the threshold temperature by comparing a monitored temperature to the threshold temperature. The control system may adjust at least one characteristic of the energy beam to maintain the threshold temperature by comparing a monitored temperature to the threshold temperature. For example, the control system may adjust the power of the energy source and/or the power density of the energy beam to maintain the threshold temperature by comparing a monitored temperature to the threshold temperature. Thus, the power over time may vary to maintain a threshold temperature value. FIG. 28C illustrates an example of varying power over time, as the energy beam spatially oscillates (FIG. 28A, 2820) over time in the period from t₁ to t₂. The power over time may be cyclic and dropping over time (e.g., 2875 and 2870) to maintain a constant temperature value of an oscillating energy beam during the period from t₁ to t₂. FIG. 28D shows an example of both the power profile over time 2857 and its respective temperature profile over time 2855 of a non-oscillating energy beam, that aims to maintain the temperature value at T₄. At times, one or more physical properties (e.g., melt pool characteristics) of the target surface may be sensed and/or detected by a single sensor and/or detector respectively. For example, the control system may adjust the at least one characteristic of the energy beam and/or energy source by comparing (i) a monitored temperature to the threshold temperature, (ii) a monitored power density to a threshold power density, (iii) a monitored power to a threshold power, (iv) or any combination thereof. The power may be of the energy source that generates the energy beam. The power density may be of the energy beam. The temperature may be of a position at the target surface (e.g., at the footprint of the energy beam).

The reduction of debris may allow reducing use of (e.g., eliminate) at least one mechanism that maintains the 3D printer (or any of its components) at a reduced debris level (e.g., free of debris). For example, the reduction of debris may reduce (e.g., eliminate) the utilization of an optical window (e.g., FIG. 1, 115) cleaning mechanism.

In some embodiments, the control system may comprise, or be operatively coupled to, a metrological detection system and configured to receive measurement data from the metrological detection system. At times, the generated 3D object (e.g., the hardened cover) is (e.g., substantially) smooth. The generated 3D object may have a deviation from an ideal (e.g., requested) planar surface (e.g., atomically flat or molecularly flat) of at most about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm. 50 μm, or less. The generated 3D object may have a deviation from an ideal planar surface between any of the afore-mentioned deviation values. The hardened material (e.g., of a 3D object) may have a porosity of at most about 0.05 percent (%), 0.1% 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The hardened material (e.g., of the 3D object) may have a porosity of at least about 0.05 percent (%), 0.1%. 0.2%, 0.3%, 0.4%, 0.5%, 0.6%, 0.7%, 0.8%, 0.9%, 1%, 2%, 3%. 4%, 5%, 6%, 7%, 8%, 9%, 10%, 20%, 30%, 40%, 50%, 60%, 70%, or 80%. The hardened material may have a porosity between any of the afore-mentioned porosity percentages (e.g., from about 0.05% to about 0.2%, from about 0.05% to about 0.5%, from about 0.05% to about 20%, from about from about 0.05% to about 50%, or from about 30% to about 80%). In some instances, a pore may transverse the formed object. For example, the pore may start at a face of the planar object and end at the opposing face (e.g., bottom skin) of the hardened material. The pore may comprise a passageway extending from one face of the planar object and ending on the opposing face of that hardened material. In some instances, the pore may not transverse the formed object. The pore may form a cavity in the formed 3D object. The pore may form a cavity on a face of the formed 3D object (e.g., the face of the 3D object). For example, pore may start on a face of a 3D plane and not extend to the opposing face of that 3D plane. The first formed layer of hardened material in the 3D object may be referred to herein as the “bottom skin.” The term “bottom skin” may also refer to the first form layer (e.g., bottom most layer) of a hanging structure or cavity ceiling.

At times, the 3D printing object is printed with a minimal a resolution. The (e.g., minimal) resolution of the printed 3D object may be at most about 1 micrometer, 1.3 micrometers (μm), 1.5 μm, 1.8 μm, 1.9 μm, 2.0 μm, 2.2 μm, 2.4 μm, 2.5 μm. 2.6 μm, 2.7 μm, 3 μm, 4 μm, 5 μm, 10 μm, 20 μm, 30 μm, 40 μm, 50 μm, 60 μm, 70 μm, 80 μm, 90 μm, 100 μm, or less. The resolution of the printed 3D object may be any value between the above-mentioned resolution values (e.g., from about 1 micrometer to about 100 micrometers). At times, the 3D object may have a material density of at least about 99.9%, 99.8%, 99.7%, 99.6%, 99.5%, 99.4%, 99.3%, 99.2% 99.1%, 99%, 98%, 96%. 95%, 94%, 93%, 92%, 91%, 90%, 8%, or 70%. At times, the 3D object may have a material density of at most about 99.5%, 99%, 98%, 96%, 95%, 94%, 93%, 92%, 91%, 90%, 8%, or 70%. At times, the 3D object may have a material density between the afore-mentioned material densities. The resolution of the 3D object may be at least about 100 dots per inch (dpi). 300 dpi, 600 dpi, 1200 dpi, 2400 dpi, 3600 dpi, or 4800 dpi. The resolution of the 3D object may be at most about 100 dpi, 300 dpi, 600 dpi, 1200 dpi, 2400 dpi, 3600 dpi, or 4800dip. The resolution of the 3D object may be any value between the afore-mentioned values (e.g., from 100 dpi to 4800 dpi, from 300 dpi to 2400 dpi, or from 600 dpi to 4800 dpi). The height uniformity (e.g., deviation from average surface height) of a planar surface of the 3D object may be at least about 100 μm, 90 μm, 80 μm, 70 μm, 60 μm, 50 μm, 40 μm, 30 μm, 20 μm, 10 μm, or 5 μm. The height uniformity of the planar surface may be at most about 100 μm, 90 μm, 80 μm, 70 μm, 60 μm, 50 μm, 40 μm. 30 μm, 20 μm, 10 μm, or 5 μm. The height uniformity of the planar surface of the 3D object may be any value between the afore-mentioned height deviation values (e.g., from about 100 μm to about 5 μm, from about 50 μm to about 5 μm, from about 30 μm to about 5 μm, or from about 20 μm to about 5 μm). The height uniformity may comprise high precision uniformity.

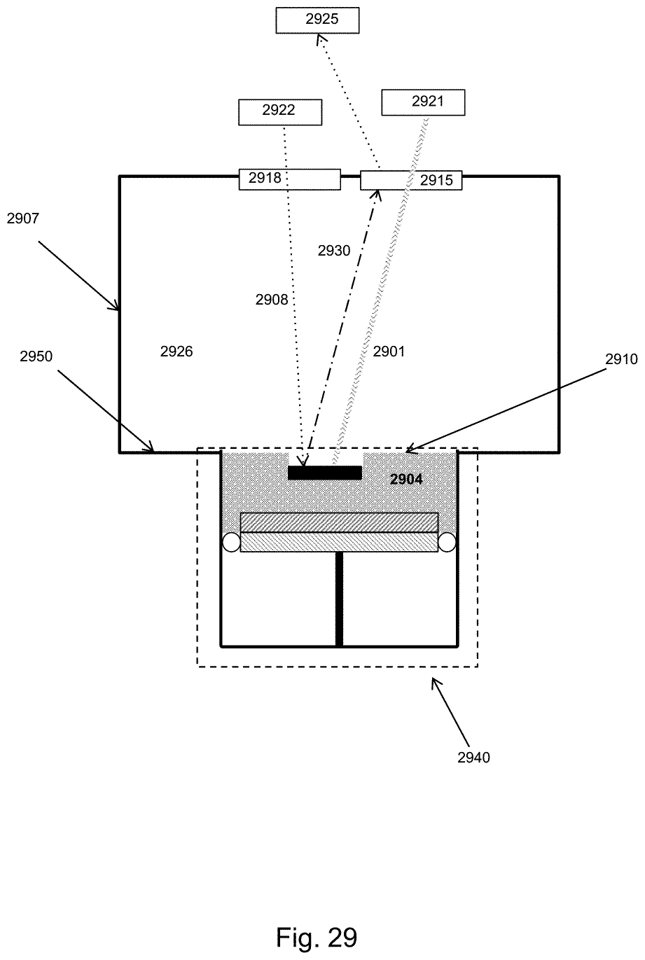

In some embodiments, the control may be effectuated by at least one controller (e.g., as disclosed herein). The controller may control the energy beam, and/or sensor(s) (e.g., gas sensor). The controller may control the enclosure comprising its pressure, humidity, oxygen, or temperature. The controller may control safety related parameters, systems and/or apparatuses (e.g., interlocks, and/or load locks). The interlocks and/or load locks may separate the processing chamber (e.g., comprising atmosphere 2926) from the build module (e.g., FIG. 29, 2940). The controller may control the “health” (e.g., proper operation) of the system(s) and/or apparatus(es). The controller may control the designated (e.g., proper) operation of the system and/or apparatuses (e.g., their proper movement (e.g., jam, or flow), any gas leak, and/or power stability). The controller may control a connection to communication systems (e.g., internet). The controller may comprise two or more processors that are connected via the cloud (e.g., internet). The controller may alert of any errors in storing information, logging, imaging, process signals, or any combination thereof. The controller may comprise a user interface software. The software may be a non-transitory computer-readable medium (e.g., in which program instructions are stored). The controller may control the system and/or apparatuses (e.g., in real-time). For example, the controller may control (e.g., operate, and/or regulate) the system and/or apparatuses in test and/or 3D print mode. The controller may control one or more 3D printing parameters. The controller may save and/or load files. The controller (e.g., software thereof) may identify portions of the requested object that are difficult to build (e.g., cannot be built). The controller may recommend a scheme to design around printing of difficult portions. The controller may recommend an alternate design scheme for the 3D printing. The controller (e.g., software) may perform a risk evaluation of 3D objects (or portions thereof). The controller (e.g., software) may comprise visualization of the slicing, and/or hatching scheme (e.g., in real-time, before printing the 3D object, and/or after printing the 3D object). The systems and/or apparatuses may effectuate visualization of the printed 3D object (e.g., in real-time, before printing the 3D object, and/or after printing the 3D object). The visualization may comprise the way the layers of hardened material are going to be formed from their respective (e.g., virtual) slices. The controller (e.g., software thereof) may evaluate (e.g., check for) any errors in the 3D printing process. The controller (e.g., software) may evaluate (e.g., check for) any deviations of the 3D object from the requested (e.g., requested) 3D object. The evaluation may be before, during, and/or after formation of the 3D object. The evaluation may be real-time evaluation during the 3D printing process. The controller may control the energy beam, temperature of at least one position of the exposed surface of the material bed, temperature of at least one position of the interior of the material bed (e.g., based on a predictive model), or any combination thereof (e.g., in real-time during the 3D printing process).

In some embodiments, the controller comprises one or more components. The controller may comprise a processor. The controller may comprise a specialized hardware (e.g., electronic circuit). The controller may be a proportional-integral-derivative controller (PID controller). The control may comprise dynamic control (e.g., in real-time during the 3D printing process). For example, the control of the (e.g., transforming) energy beam may be a dynamic control (e.g., during the 3D printing process). The PID controller may comprise a PID tuning software. The PID control may comprise constant and/or dynamic PID control parameters. The PID parameters may relate a variable to the required power needed to maintain and/or achieve a setpoint of the variable at any given time. The calculation may comprise calculating a process value. The process value may be the value of the variable to be controlled at a given moment in time. For example, the process controller may control a temperature by altering the power of the energy beam, wherein the temperature is the variable, and the power of the energy beam is the process value. For example, the process controller may control a height of at least one portion of the layer of hardened material that deviates from the average surface of the target surface (e.g., exposed surface of the material bed) by altering the power of the energy source and/or power density of the energy beam, wherein the height measurement is the variable, and the power of the energy source and/or power density of the energy beam are the process value(s). The variable may comprise a temperature or metrological value. The parameters may be obtained and/or calculated using a historical (e.g., past) 3D printing process. The parameters may be obtained in real-time, during a 3D printing process. During a 3D printing process, may comprise during the formation of a 3D object, during the formation of a layer of hardened material, or during the formation of a portion of a layer of hardened material. The output of the calculation may be the power of the energy source and/or power density of the energy beam. The calculation output may be a relative distance (e.g., height) of the material bed (e.g., from a cooling mechanism, bottom of the enclosure, optical window, energy source, or any combination thereof).

In some embodiments, the controller comprises a PID controller. The PID controller (e.g., control scheme) may comprise a proportional-integral controller (i.e., PI controller), deadband, setpoint step alteration, feed forward control, bumpless operation, PID gain scheduling, fuzzy logic, or computational verb logic. The setpoint may be a target value (e.g., target temperature, target height of the exposed surface of the material bed, or target power of the energy source). In some embodiments, the controller may comprise a plurality of setpoints (e.g., that are of different types).

In some examples, the calculations may consider historical data (e.g., of certain types of 3D object geometries), existing 3D structure (e.g., 3D object), future 3D portion of the requested 3D object to be printed, or any combination thereof. Future portion of the requested 3D object to be printed may comprise a portion of the 3D object that should be printed later in time (e.g., a layer to be printed in the future during the 3D printing process of the requested 3D object). The calculations may utilize chemical modeling (oxides, chemical interaction). The chemical modeling may be used to understand the effect of various reaction products (e.g., oxides) and chemical interactions on the 3D printing of a 3D object. For example, understanding a reduced wetting (e.g., lack thereof) due to oxidation of the layer. The 3D printing may utilize etching (e.g., plasma etching) to reduce the amount of oxides (e.g., oxide layer) on the forming 3D object. The etching may be performed during the 3D printing.

In some embodiments, the setpoint is altered (e.g., dynamically). Altering the setpoint may comprise setpoint ramping, setpoint weighting, or derivative of the process variable. The bumpless operation may comprise a “bumpless” initialization feature that recalculates the integral accumulator term to maintain a consistent process output through parameter changes. The control may comprise high sampling rate, measurement precision, or measurement accuracy that achieve(s) (individually or in combination) adequate control performance of the method, system, and/or apparatus of the 3D printing. The control (e.g., control scheme) may comprise increasing a degree of freedom by using fractional order of the integrator and/or differentiator.

In some embodiments, the controller comprises a temperature controller (e.g., temperature PID controller), or a metrology controller (e.g., metrology PID controller). The controller may be a nested controller. Nested may be a first controller controlled within a second controller. For example, a temperature PID controller may comprise a metrology PID controller. For example, a metrology PID controller may comprise a temperature PID controller. For example, a first temperature PID controller may comprise a second temperature PID controller. For example, a first metrology PID controller may comprise a second metrology PID controller. The metrology controller may use input from the temperature controller and/or vice versa. The temperature controller may receive input from the metrology detector (e.g., in case it comprises a nested metrology controller) and/or from the temperature detector. The metrology detector may be also referred herein as a “metrological detector.” The temperature controller may consider any corrective deformation. The temperature controller may consider object pre-correction (OPC, e.g., FIG. 6). The nested controller may incorporate data of corrective deformation (e.g., OPC), from the metrology detector, and/or from the temperature detector. The nested controller may control the degree of deformation of the forming 3D object. The metrological detector and/or temperature detector (e.g., and controller) may resolve irregularities (e.g., of height less than about 1 μm, 5 μm. 8 μm, 10 μm, 15 μm, 20 μm, 30 μm, or 40 μm) of a forming 3D object. The irregularities may comprise material bed irregularities, and/or height irregularities.

In some embodiments, a metrological detector is used in the control of the 3D printing. The metrological detector may comprise, or be operatively coupled to, a metrological detection system. The metrological detector may include an imaging detector (e.g., CCD, camera) to monitor irregularities. The imaging device (e.g., as disclosed herein) may comprise an imaging detector. The imaging detector is also referred to herein as “image detector.” The image detector may comprise detecting an area of the forming 3D object and convert it to a pixel in the X-Y (e.g., horizontal) plane. The height (Z-plane) of the area may be measured using one or more computer computational schemes (e.g., a phase shift algorithm). The computational scheme may comprise a (e.g., digital) modulation scheme that conveys data by changing (e.g., modulating) the phase of a reference signal (e.g., carrier wave). The imaging detector may capture an area of a FLS of at least about 40 μm, 50 μm, 60 μm. 70 μm, 80 μm, 90 μm, 100 μm, 200 μm. 500 μm, 1 millimeter or 2 millimeter. The FLS of the captured area by an imaging detector, may be between any of the afore-mentioned sizes (e.g., from about 40 μm to about 2 millimeter, from about 100 μm, to about 1 millimeter, from about 40 μm to about 70 μm, or from about 70 μm to about 80 μm). A pixel (X, Y) of the imaging detector may detect at least one FLS (e.g., a length or width) of at least about 40 μm, 50 μm, 60 μm, 70 μm, 80 μm, 90 μm, 100 μm. 200 μm, 500 μm, 1 millimeter, 2 millimeter, 10 millimeter, 20 millimeter, 50 millimeter, 100 millimeter, 200 millimeter, 250 millimeters, 300 millimeter or 500 millimeter. At least one FLS (e.g., length or width) of the captured area within a pixel of an imaging detector, may be between any of the aforementioned FLS values (e.g., from about 40 μm to about 200 millimeter, from about 100 μm, to about 300 millimeter, from about 40 μm to about 500 millimeter, or from about 100 to about 300 millimeters, from about 150 millimeter to about 170 millimeter). The imaging detector may operate at a frequency of at least about 0.1 Hertz (Hz), 0.2 Hz, 0.5 Hz, 0.7 Hz, 1 Hz, 1.5 Hz, 2 Hz, 3 Hz, 4 Hz, 5 Hz, 6 Hz, 7 Hz, 8 Hz, 10 Hz, 20 Hz, 50 Hz, 100 Hz, 200 Hz, 300 Hz, 400 Hz, or 500 Hz. The frequency of the imaging detector may be between any of the afore-mentioned frequencies (e.g., from about 0.1 Hz to about 500 Hz, from about 1 Hz to about 500 Hz, from about 1 Hz to about 100 Hz, from about 0.1 Hz to about 100 Hz, from about 0.1 Hz, to about 1 Hz, from about 0.5 Hz to about 8 Hz, or from about 1 Hz to about 8 Hz). The metrological detector may perform positional detection. To perform positional detection, the metrological detector may be mounted on a stage (e.g., elevator or calibration plates). The stage may be movable, and/or controlled (e.g., manually and/or automatically; before, after, and/or during the 3D printing). Alternatively, or additionally, the metrological detector may receive metrology and/or calibration information from one or more apparatuses of the 3D printer. The one or more apparatuses may comprise the stage. Natively or additionally, the metrological detector may use absolute calibration information.

In some embodiments, the control system uses data from the metrological detector (e.g., the metrological detection system). The control system may use the data to control one or more parameters of the 3D printing. For example, the control system may use the metrology data to control one or more parameters of the layer dispensing mechanism (e.g., the material dispenser, the leveling mechanism, and/or the material removal mechanism). For example, the metrological measurement(s) may facilitate determination and/or subsequent compensation for a roughness and/or inclination of the exposed surface of the material bed with respect to the build platform and/or horizon. The inclination may comprise leaning, slanting, or skewing. The inclination may comprise deviating from a planar surface that is parallel to the build platform and/or horizon. The roughness may comprise random, or systematic deviation. The systematic deviation may comprise waviness. The systematic deviation may be along the path of the material dispensing mechanism (e.g., along the build platform and/or the exposed surface of the material bed), and/or perpendicular to that path. For example, the controller may direct the material dispenser to alter the amount and/or rate of pre-transformed material that is dispensed. For example, the controller may direct alteration of a target height according to which the leveling mechanism planarizes the exposed surface of the material bed. For example, the controller may direct the material removal member to after the amount and/or rate of pre-transformed material that is removed from the material bed (e.g., during its planarization). The control system may use the metrology data to control one or more parameters of the energy source and/or energy beam. The one or more measurements from the metrological detector may be used to after (e.g., in real-time, and/or offline) the computer model. For example, the metrological detector measurement(s) may be used to after the OPC data. For example, the metrological detector measurement(s) may be used to alter the printing instruction of one or more successive layers (e.g., during the printing of the 3D object).

In some embodiments, the metrological detector and/or controller averages at least a portion of the detected signal over time (e.g., period). In some embodiments, the metrological detector and/or controller reduces (at least in part) noise from the detected signal (e.g., over time). The noise may comprise detector noise, sensor noise, noise from the target surface, or any combination thereof. The noise from the target surface may arise from a deviation from planarity of the target surface (e.g., when a target surface comprises particulate material (e.g., powder)). The reduction of the noise may comprise using a filter, noise reduction computational scheme, averaging of the signal over time, or any combination thereof.

In some embodiments, the metrological detector is calibrated. For example, the metrological detector may be detected and/or calibrated in situ in the enclosure (e.g., in the processing chamber, e.g., comprising atmosphere FIG. 29, 2926). The metrological detector may use a stationary structure to calibrate at least one height position. For example, the metrological detector may use the floor of the processing chamber (e.g., FIG. 29, 2950) as a metrological (e.g., height) reference point. The metrological detector may use one or more positions at the side wall of the processing chamber as metrological reference point. The processing chamber may comprise one or more reference stationary points that are not disposed on the wall and/or floor of the processing chamber. For example, the processing chamber may comprise a stationary ruler comprising slits and/or steps at designated locations to be used as reference point for metrological calibration.

In some embodiments, an object protrudes from the exposed surface of a material bed, e.g., during printing. Such protrusion may damage the layer dispensing mechanism. It would be beneficial to evaluate an extent of the protrusion and any possible damage. The evaluation may aid in assessing (i) whether the printing process should be stopped to prevent possible damage to the layer dispensing mechanism, or (ii) whether the printing process can continue without damage to the layer dispensing mechanism. The evaluation may aid in assessing whether or not an adjustment the printing parameters is recommended, and if so, what this adjustment should be. The extent of protrusion comprises vertical and/or horizontal deviation of the protruding object from the exposed surface of the material bed. A metrological detector may aid in assessing the extent of protrusion and/or its location, e.g., relative to the build platform, the one or more reference stationary points, and/or any other internal components of the processing chamber.

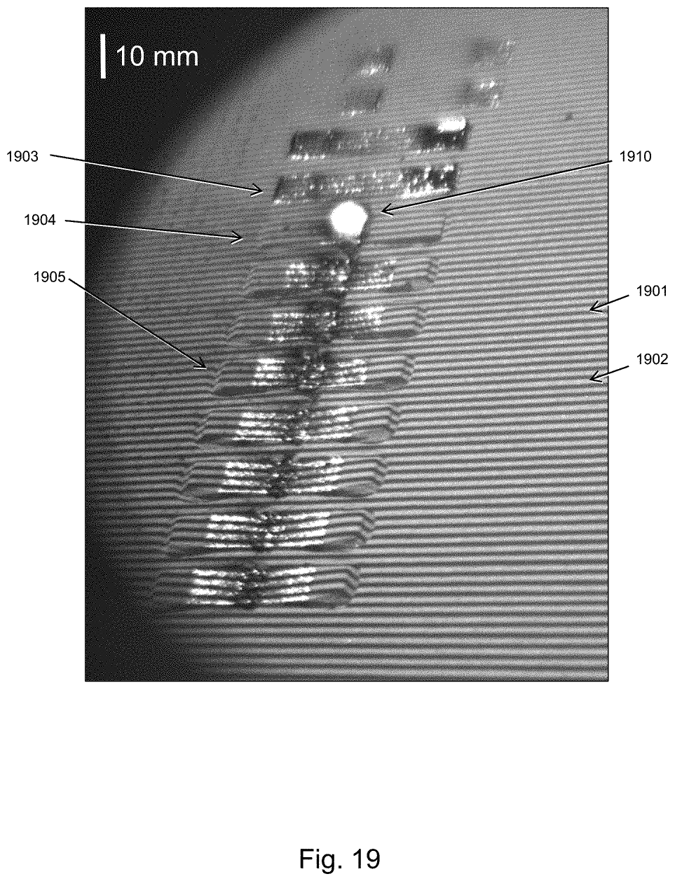

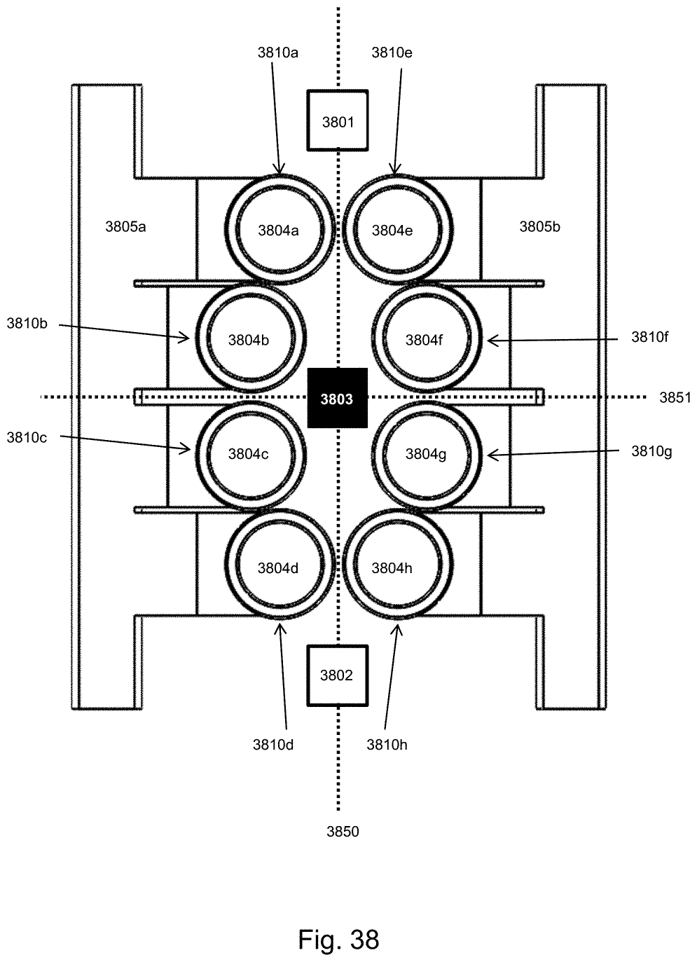

FIG. 19 shows an example of a metrological detector (e.g., included in a height mapper system) which projects a detectable optical image (e.g., a striped image) on the exposed surface of a material bed (e.g., powder bed), which image comprises a repetitive pattern including darker stripes 1901 and lighter stripes 1902. The metrological detector may operate during at least a portion of the 3D printing. For example, the metrological detector can project its image before, after, and/or during the operation of the transforming energy beam. The projected image may comprise a shape. The shape may be a geometrical shape. The shape may be a rectangular shape. The shape may comprise a line. The shape may scan the target surface (e.g., exposed surface of the material bed) laterally, for example, from one side of the target surface to its opposing side. The shape may scan at least a portion of the target surface (e.g., in a lateral scan). The scan may be along the length of the exposed surface. The projected shape may span (e.g., occupy) at least a portion of the width of the target surface. For example, the shape may span a portion of the width of the target surface, the width of the target surface, or exceed the width of the target surface. The shape may scan the at least a portion of the target surface before, after and/or during the 3D printing. The scan may be controlled manually and/or automatically (e.g., by at least one controller). The control may be before, after and/or during the 3D printing. For example, the shape may scan the exposed surface before, after and/or during the operation of the transforming energy beam. The shape may be detectable (e.g., using an optical and/or spectroscopic sensor). The scanning energy beam may comprise the shape. The projected shape may be of an electromagnetic radiation (e.g., visible light). The projected shape may be detectable. The projected shape may scan the target surface at a frequency of at least about 0.1 Hertz (Hz), 0.2 Hz. 0.5 Hz, 0.7 Hz, 1 Hz, 1.5 Hz, 2 Hz, 3 Hz. 4 Hz, 5 Hz, 6 Hz, 7 Hz, 8 Hz, 10 Hz, 20 Hz, 50 Hz, 100 Hz, 200 Hz, 300 Hz, 400 Hz, or 500 Hz. The projected shape may scan the target surface at a frequency between any of the afore-mentioned frequencies (e.g., from about 0.1 Hz to about 500 Hz, from about 1 Hz to about 500 Hz, from about 1 Hz to about 100 Hz, from about 0.1 Hz to about 100 Hz, from about 0.1 Hz, to about 1 Hz, from about 0.5 Hz to about 8 Hz, or from about 1 Hz to about 8 Hz). The image may comprise (e.g., alternating) stripes. The distance between the stripes may be constant. The distance between the stripes may be variable. The distance between the stripes may be varied (e.g., manually or by at least one controller) in real-time. Real-time may be when performing metrological detection. Real-time may be when building (e.g., printing) the 3D object. The deviation from the regularity (e.g., linearity) of the stripes may reveal a height deviation from the average (or mean) exposed surface (e.g., of the material bed) height. The material bed in the example of FIG. 19 shows an example of an Inconel 718 powder bed. In the example shown in FIG. 19, a 3D object 1905 is partially buried in the material bed and lifts a portion of the pre-transformed material (e.g., powder) of the material bed such that a deviation from the linearity of the stripes is visible. The shape of the deviation from regularity (e.g., linearity) may reveal a shape characteristic of the buried 3D object portion (that is buried in the material bed). For example, the lines above the 3D object 1904 are (e.g., substantially) linear, whereas the lines above the 3D object 1905 curve. The deviated (e.g., curved) lines above a 3D object may relate to a warping of the 3D object (e.g., 1905) that is (immediately) underneath. The regularity (e.g., linearity) of the lines detected above the 3D object may relate to the planarity of the top surface of the 3D object (e.g., 1904) that is (immediately) underneath. For example, lines above the 3D object (whether buried in the material bed, or exposed) that match the regularity of the projected image, may reveal a planar top surface of a 3D object. For example, a deviation from the regularity of the projected image above the 3D object (whether buried in the material bed, or exposed), may reveal a deformation in the top surface of a 3D object. For example, linear lines above the 3D object may reveal a planar top surface of a 3D object, when the metrology projector projects stripes. For example, non-linear (e.g., curved) lines above the 3D object may reveal a non-planar (e.g., curved) top surface of a 3D object, when the metrology projector projects stripes. The reflectivity of the target surface may indicate the planar uniformity of the exposed surface. FIG. 19, 1903 shows a 3D object in a material bed, which 3D object is reflective, whereas the material bed is substantially less reflective. At times, the printed object comprises a reflective surface with respect to the detector. For example, when a first projector projects light on the reflective surface, the light reflects from the surface in a specular reflection (e.g., FIG. 19, 1910). The specular reflection may cause the first detector of the metrology detection system (e.g., height mapper) to become saturated. Such specular reflection may be filtered out using physical or virtual fitter(s). The virtual filter(s) may comprise a computational scheme. At times, a second projector and/or a second detector may be added to the metrology system to facilitate to detection the object, e.g., without being subject to detector saturation. See for example FIG. 38. For example, the second detector may be disposed at a distance from the first detector, such that the specular reflection is not detected by the second detector. For example, the second projector may be disposed at a distance from the first projector, such that the second projector project lights that does not cause a specular reflection, and may be detected by the first detector without causing it to become saturated.

At times, formation of the 3D object by the 3D printing methodology causes one or more portions of the 3D object to deform. The deformation may comprise bending, warping, arching, curving, twisting, balling, cracking, dislocating, or any combination thereof. The deformation may occur in the layer that is currently being generated. The deformation may occur in at least a portion of the 3D object that was previously build (e.g., as it hardens). The deformation may occur during the 3D printing. The previously build portion may be disposed within the material bed. For example, the portion may be buried in the material bed. The portion may not be visible (e.g., optically) from the exposed surface of the material bed. A displacement of the layer being built may be visible (e.g., optically). The visibility may be direct using an optical sensor (e.g., a camera). The camera may be a high-resolution camera. The visibility may be indirect (e.g., using a metrological detector such as one included in a height mapper system (e.g., FIG. 19)).

In some embodiments, the controller comprises a PID controller. The controller may comprise a cascade control (e.g., usage of a plurality of PID controllers). The control may comprise using a plurality (e.g., two) PID controllers. The usage of the plurality of PID controllers may yield better dynamic performance as compared to the usage of a single PID controller. The cascade control may comprise a first PID controller that controls the setpoint of a second PID controller. The first PID controller may be an outer loop controller. The second PID controller may be an inner loop controller.

At times, the controller samples the measured process variable. The controller may perform computations (e.g., calculations) utilizing the measured process variable. The controller may transmit controller output signal(s) (e.g., resulting from the computation). The controller may have a loop sample time. The loop sample time may (i) comprise the time at which the controller samples the measured process variable, (ii) perform the computation using the measured process variable, (iii) transmit a new controller output signal, or (iv) any combination or permutation thereof. The loop sample time may be at most about 1 microsecond (μsec), 2 μsec, 3 μsec, 4 μsec, 5 μsec, 6 μsec, 7 μsec, 8 μsec, 9 μsec, 10 μsec, 11 μsec, 12 μsec, 13 μsec, 14 μsec, 15 μsec, 20 μsec, 25 μsec, 30 μsec, 40 μsec, 50 μsec, 60 μsec, 70 μsec, 80 μsec, 90 μsec, 1 millisecond (msec), 5 msec, or 10 msec. The loop sample time may be between any of the afore-mentioned sample times (e.g., from about 1 μsec to about 90 μsec, from about 1 μsec to about 5 μsec, from about 5 μsec to about 15 μsec, from about 15 μsec to about 30 μsec, from about 30 μsec to about 90 μsec, from about 1 μsec to about 10 msec, or from 50 μsec to 10 msec). The calculations may be performed at a time that is (e.g., substantially) equal to any of the afore-mentioned loop sample times. The calculations may be performed during the dwell time of the (e.g., transforming) energy beam, the intermission time of the (e.g., transforming) energy beam, or any combination thereof. The calculation may be performed during the formation of one or more (e.g., successive) melt pools, between the formation of two (e.g., successive) melt pools (e.g., “between” may be inclusive or exclusive), or any combination thereof. For example, the calculation may be performed during the formation of a single melt pool. The calculation may be performed during a transformation of at least a portion of the material bed. The calculation may be performed between formation of two layers of hardened material, during formation of a layer of hardened material, during formation of the 3D object, during the 3D printing process, or any combination thereof. Examples of dwell time, intermission time, transforming energy beam (e.g., scanning energy beam and/or tiling energy beam), 3D printers, related control system, related methods, apparatuses, systems, and program instructions (e.g., software), can be found in International Patent Application serial number PCT/US16/66000, and in U.S. patent application Ser. No. 17/881,797 filed on Aug. 5, 2022, each of which is incorporated herein by reference in its entirety. During the intermission time, the energy beam may have a reduced power density that does not elevate the pre-transformed material and/or target surface to at least a transformation temperature or higher. For example, during the intermission, the energy beam may have a power density that allows the irradiated position at the target surface to heat up, but not transform. For example, during the intermission, the energy beam may have a power density that negligibly heats up the irradiated position at the target surface. Negligibly is relative to the 3D printing process. For example, during the intermission, the energy beam may be turned off.

In some instances, the controller comprises a control loop bandwidth. The control loop bandwidth may be the frequency at which the closed loop response of the controlled variable is attenuated by about 3 dB from the setpoint (e.g., the closed-loop magnitude response). The control loop bandwidth may be approximated as the point at which the open loop gain of the system is unity (also referred herein as the “crossover” frequency). The bandwidth of the closed-loop control system may be the frequency range where the magnitude of the closed loop gain does not drop below about −3 decibels (dB). The bandwidth of the control system, ω_{B}, may be the frequency range in which the magnitude of the closed-loop frequency response is greater than about −3 dB. The frequency we may be the cutoff frequency. At frequencies greater than We, the closed-loop frequency response may be attenuated by more than about −3 dB. The frequency of the control loop bandwidth, we, may be at least about 0.1 Hertz (Hz), 0.2 Hz, 0.5 Hz, 0.7 Hz, 1 Hz, 1.5 Hz, 2 Hz, 3 Hz, or 5 Hz. The frequency of the control loop bandwidth, ω_{B}, may be between any of the afore-mentioned frequencies (e.g., from about 0.1 Hz to about 5 Hz, from about 0.1 Hz, to about 1 Hz, from about 0.5 Hz to about 1.5 Hz, or from about 1 Hz to about 5 Hz).

In some examples, the second PID controller reads an output of the first (e.g., outer loop) controller as a setpoint. The first PID controller may control a more rapidly changing, or a less rapidly changing parameter (e.g., parameter characteristics) as compared to the parameter controlled by the second PID controller. In some examples, the second and the first PID controllers may control a parameter that changes in (e.g., substantially) identical speed. In some embodiments, the working frequency of the cascade controller is increased as compared to using a single PID controller. At times, the time constant may be reduced by using cascaded PID controllers, as compared to using a single PID controller. Instead of controlling the parameter (e.g., temperature parameter, power parameter, and/or power density parameter) directly, the outer PID controller may set a parameter setpoint for the inner PID controller. The inner PID controller may control the parameter directly. An error term of the inner controller may comprise a difference between the parameter setpoint and the directly measured parameter characteristics (e.g., temperature). The outer PID controller may comprise a long time constant (e.g., may have a lengthy response time). The inner loop may respond at a shorter timescale. The parameter characteristics may comprise position, height, power, power density, or temperature. The parameter characteristics may comprise a dwell time, pulse pattern, pulse frequency, footprint, acceleration, cross section, fluence, and/or velocity of the energy beam. The footprint may be a footprint of the energy beam on the target surface (e.g., exposed layer of the material bed).

In some embodiments, the controller continuously (e.g., or intermittently) calculates an error value during the control time. The intermittent calculation may or may not be periodic. The error value may be the difference between a requested setpoint and a measured process variable. The control may be continuous control (e.g., during the 3D printing process, during formation of the 3D object, and/or during formation of a layer of hardened material). The control may be discontinuous. For example, the control may cause the occurrence of a sequence of discrete events. The control scheme may comprise a continuous, discrete, or batch control. The requested setpoint may comprise a temperature, power, power density, or a metrological (e.g., height) setpoint. The metrological setpoint may relate to the target surface (e.g., the exposed surface of the material bed). The metrological setpoints may relate to one or more height setpoints of the target surface (e.g., the exposed (e.g., top) surface of the material bed). The temperature setpoint may relate to (e.g., may be) the temperature of the material bed (e.g., at or adjacent to the exposed surface of the material bed). The temperature setpoint may relate to (e.g., may be) the temperature of or adjacent to a transformed material (e.g., melt pool). The controller may attempt to minimize an error (e.g., temperature and/or metrological error) over time by adjustment of a control variable. The control variable may comprise a direction and/or (electrical) power supplied to any component of the 3D printing apparatus and/or system. For example, direction and/or power supplied to the: energy beam, scanner, motor translating the build platform, optical system component, optical diffuser, or any combination thereof.

In some embodiments, the setpoint (also herein “set point,” or “set-point”) is a requested or target value for an essential variable of the 3D printing system, method, computational scheme, software and/or apparatus. The setpoint may be used to describe a standard configuration or norm for the system, method, computational scheme, software, and/or apparatus. Departure of the variable from its setpoint may be a basis for an error-controlled regulation. The error-controlled regulation may comprise feedback and/or feed forward loop to alter (e.g., return) the system, method, computational scheme, software and/or apparatus to its requested (e.g., normal) status (e.g., condition).

In some embodiments, the transforming energy beam irradiates at a first power P₁ (e.g., at its maximum power) on a position of the target surface (e.g., exposed surface of the material bed). A temperature of that (first) position can be sensed by a temperature sensor. A temperature of that (first) position can be controlled by the controller. A temperature of a subsequently irradiated (second) position can be controlled by the controller (e.g. and influence the temperature in the first position). When a target temperature of the position is reached (e.g., as measured by the temperature sensor), the controller may be used to hold that target temperature at a (e.g., substantially) constant value, for example, by reducing the power of the transforming energy beam (e.g., to value P₂, which is less than P₁). The power of the energy beam may be measured as the power density of the energy beam. In some embodiments, as a result of the temperature control by the controller, the power of the energy beam reaches a minimum power Pₘᵢₙ (e.g., predetermined minimum power). At times, the power of the transforming energy beam may reach a minimum power; at about that time: the power of the transforming energy beam may be (e.g., substantially) turned off, the power of the transforming energy beam may be (e.g., substantially) reduced to a non-transforming power, the transforming energy beam may relocate to another (e.g., distant) position, or any combination thereof.

In some examples, the control is an active control. The control may comprise controlling the FLS of the energy beam (e.g., footprint, or spot size). The control may comprise controlling the beam (e.g., energy) profile. The beam profile control may comprise using diffusive, micro lens, refractive, or diffractive elements (e.g., optical elements). The beam profile control may comprise controlling the energy profile of the energy beam (e.g., flat top, Gaussian, or any combination thereof). The beam profile (e.g., FLS of the cross section and/or energy profile) may be altered during the 3D printing (e.g., during the formation of the 3D object). During the formation of the 3D object may comprise during formation of the layer of hardened material or a portion thereof.

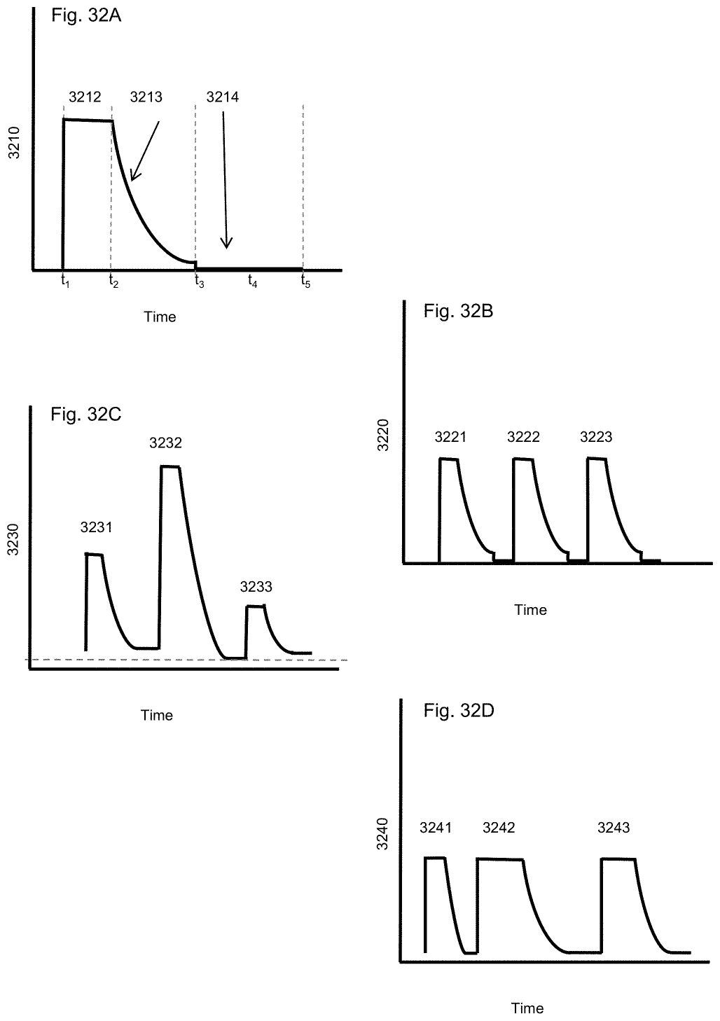

In some examples, the transforming energy beam travels along the target surface in a trajectory (e.g., path). The transforming energy beam may irradiate the target surface with a varied and/or constant power density. The transforming energy beam may be generated by a power source having a varied and/or constant power. FIG. 32A shows an example of energy source power or a power density of the energy beam (collectively designated as 3210), as a function of time; wherein the physical attribute profile pertains to the power of the energy source or the power density of the energy beam respectively. For example, FIG. 32A shows an example of an initial increase in power density (e.g., on turning the energy beam) at t₁, followed by a plateau during a period from t₁ to t₂ (e.g., when irradiating at a constant power density), followed by a decrease during a period from t₂ to t₃ (e.g., while decreasing the power density as the transformed/transforming material heats beyond a threshold temperature), followed by a second plateau during a period from t₃ to t_{U}(e.g., during an intermission when the energy beam is turned off). For example, FIG. 32A shows an example of an initial increase in the power of the energy source (e.g., on turning the energy source to generate the energy beam) at t₁, followed by a plateau during a period from t₁ to t₂ (e.g., when generating the energy beam at a constant power), followed by a decrease during a period from t₂ to t₃ (e.g., while decreasing the power as the transformed/transforming material heats beyond a threshold temperature), followed by a second plateau during a period from t₃ to t₄ (e.g., during an intermission when the energy source is turned off). The transforming energy beam may travel along the target (e.g., exposed) surface while having a (e.g., substantially) constant or variable power density (i.e., power per unit area). The variation may comprise initial increase in power density, followed by a decrease in the power density, or any combination thereof. The variation may comprise initial increase in power density, followed by a plateau, followed by a subsequent decrease in the power density, or any combination thereof. The increase may be linear, logarithmic, exponential, polynomial, or any combination or permutation thereof. The decrease and/or increase may be linear, logarithmic, exponential, polynomial, or any combination or permutation thereof. The plateau may comprise of a (e.g., substantially) constant energy density. FIG. 32B shows an example of energy source power, or a power density of the energy beam (collectively designated as 3220) as a function of time; wherein the physical attribute profile pertains to the power of the energy source, or the power density of the energy beam respectively. For example, FIG. 32B shows a variation (e.g., oscillation) in the power density of the energy beam, with three peak plateau power densities 3221, 3222, and 3223, wherein each peak (plateau) is followed by a decrease (e.g., following the example in FIG. 32A) with three valleys (valley plateaus). For example, FIG. 32B shows a variation in the power of the energy source, with three peak (plateau) power values 3221, 3222, and 3223, wherein each peak is followed by a decrease (e.g., following the example in FIG. 32A) with three valleys (valley plateaus). In the example shown in FIG. 32B, all peak values correspond to the same maximum physical attribute (e.g., power) value, and all valley plateaus correspond to the same minimum physical attribute value, and the manner of variation in the physical attribute profile over time is the same (e.g., the manner and time of onset, peak plateau period, manner of decline, and valley plateau period, are the same). The manner of (e.g., function used in) the variation in power density of the transforming energy beam may be influenced by (i) a measurement (e.g., a signal of the one or more sensors), (ii) theoretically (e.g., by simulations), (iii) or any combination thereof. The duration and peak of the power density plateau of the transforming energy beam may be influenced by (i) a measurement (e.g., a signal of the one or more sensors), (ii) theoretically (e.g., by simulations), (iii) or any combination thereof. The power density of the energy beam may fluctuate as a function of a sensor measurement (e.g., of a temperature at the irradiated position or close thereto) forming a sequence (e.g., of intermission times and dwell times). The fluctuated power density may comprise dwell times and intermission times. At least two of the intermission times in the sequence may be (e.g., substantially) of the same duration or of different duration. At least two of the intermission times in the sequence may be (e.g., substantially) of the same or different minimal power density value. At least two of the dwell times in the sequence may be (e.g., substantially) of the same duration or of different duration. At least two of the intermission times in the sequence may be (e.g., substantially) of the same or different maximal power density value. The power of the energy source may fluctuate as a function of a sensor measurement (e.g., of a temperature at the irradiated position or close thereto) forming a power sequence (e.g., of minimal power (e.g., off) times and maximal power times). At least two of the minimal power times in the sequence may be (e.g., substantially) of the same duration or of different duration. At least two of the minimal power times in the sequence may be (e.g., substantially) of the same or different minimal power density value. At least two of the maximal power times in the sequence may be (e.g., substantially) of the same duration or of different duration. At least two of the maximal power times in the sequence may be (e.g., substantially) of the same or different maximal power density value. FIG. 32C shows an example of energy source power, or a power density of the energy beam (collectively designated as 3230) as a function of time; wherein the physical attribute profile pertains to the power of the energy source or the power density of the energy beam respectively. For example, FIG. 32C shows a variation (e.g., fluctuation, oscillation, or pulse) in the power density of the energy beam, with three peaks (peak plateaus) 3231, 3232, and 3233, wherein each peak is followed by a decrease (e.g., following the example in FIG. 32A) with three valleys (valley plateaus). For example, FIG. 32C shows a variation in the power of the energy source generating the energy beam, with three peak (plateau) power values 3231, 3232, and 3233, wherein each peak is followed by a decrease (e.g., following the example in FIG. 32A) with three valleys (valley plateaus). In the example shown in FIG. 33C, the peak values correspond to different maximum physical attribute values, the valley values correspond to different minimum physical attribute values, and the time-period of each physical attribute pulse is the same (e.g., the time-period during peak plateau, valley plateau, and transition between them is respectively the same among all the physical attribute pulses). FIG. 32D shows an example of energy source power, or a power density of the energy beam (collectively designated as 3240) as a function of time; wherein the physical attribute profile pertains to the power of the energy source or the power density of the energy beam respectively. For example, FIG. 32D shows a variation (e.g., oscillation) in the power density of the energy beam, with three peak (plateau) power densities 3241, 3242, and 3243, wherein each peak is followed by a decrease (e.g., following the example in FIG. 32A) with three valleys (valley plateaus). For example, FIG. 32D shows a variation in the power of the energy source generating the energy beam, with three peak (plateau) power values 3241, 3242, and 3243, wherein each peak is followed by a decrease (e.g., following the example in FIG. 32A) with three valleys (valley plateaus). In the example shown in FIG. 33D, the peak values correspond to the same maximum physical attribute value (e.g., power density of the energy beam, or power of the energy source respectively), the valley values correspond to the same minimum physical attribute value, and the time periods of the physical attribute pulses varies (e.g., the time-period during peak plateau, valley plateau, and transition between them varies among the physical attribute pulses). The physical attribute pulses may correspond to forming melt pools. For example, each physical attribute pulse, may correspond to the formation of a melt pool. The physical attribute pulses may correspond to forming tiles. For example, each physical attribute pulse, may correspond to the formation of a tile.

In one example of additive manufacturing, a layer of pre-transformed material (e.g., powder material) is operatively coupled and/or disposed adjacent to (e.g., supported by) the build platform using the layer dispensing mechanism. For example, a pre-transformed material dispensing mechanism (e.g., 116) dispenses pre-transformed material to form a layer; the layer is leveled using a leveling mechanism (e.g., leveler 117) and remover (e.g., remover 118); an energy beam 101 is directed towards the material bed to transform at least a portion of the material bed to form a transformed material; the build platform is lowered; a new layer of pre-transformed material is disposed into the material bed; and that new layer is leveled and subsequently irradiated. The process may be repeated sequentially until the requested 3D object is formed from a successive generation of layers of transformed material (e.g., relating to a virtual model of a requested 3D object). In some examples, as the layers of transformed material harden, they may deform upon hardening (e.g., upon cooling). The methods, systems, apparatuses, and/or software disclosed herein may control at least one characteristic of the layer of hardened material (or a portion thereof), such as their planarity, resolution, and/or deformation. For example, the methods, systems, apparatuses, and/or software disclosed herein may control the degree of deformation. The control may be an in situ control. The control may be control during formation of the at least a portion of the 3D object. The control may comprise closed loop control. The portion may be a surface, layer, plurality of layers, portion of a layer, and/or portion of a plurality of layers. The layer of hardened material within the 3D object may comprise a plurality of melt pools. The layers' characteristics may comprise planarity, curvature, or radius of curvature of the layer (or a portion thereof). The characteristics may comprise the thickness of the layer (or a portion thereof). The characteristics may comprise the smoothness (e.g., planarity) of the layer (or a portion thereof).

The methods, systems, apparatuses, and/or software described herein may comprise providing a first layer of pre-transformed material (e.g., powder) in an enclosure to form a material bed (e.g., powder bed). The first layer may be provided on a substrate or a base. The first layer may be provided on a previously formed material bed (e.g., layer of pre-transformed material). At least a portion of the first layer of pre-transformed material may be transformed by using an energy beam. For example, an energy beam may irradiate the at least a portion of the first layer of pre-transformed material to form a first transformed material. The first transformed material may comprise a fused material. The methods, systems, apparatuses, and/or software may further comprise disposing a second layer of pre-transformed material adjacent to (e.g., above) the first layer. At least a portion of the second layer may be transformed (e.g., with the aid of the energy beam) to form a second transformed material. The second transformed material may at least in part connect to the first transformed material to form a multi-layered object (e.g., a 3D object). Connect may comprise fuse, weld, bond, and/or attach. The first and/or second layer of transformed material may comprise a first and/or second layer of hardened material respectively. The first and/or second layer of transformed material may harden into a first and/or second layer of hardened material respectively.

The methods, systems, apparatuses, and/or software may comprise controlling at least a portion of the deformation of at least the first or second layers of hardened material. The methods, systems, apparatuses, and/or software may comprise controlling at least a portion of the deformation of at least a portion of the first and/or second layers of hardened material. The methods, systems, apparatuses, and/or software may comprise controlling the deformation of at least the first or second layers of hardened material. The methods, systems, apparatuses, and/or software may comprise controlling the deformation of the multi-layered material. The deformation may comprise a curvature (or planarity).

In some embodiments, the deformation may be measured and/or controlled (e.g., regulated) during the formation of the 3D object (e.g., formation of a portion of a layer of the 3D object). In some embodiments, the curvature (or planarity) may be measured and/or controlled during the formation of the 3D object. In some embodiments, the deformation may be measured and/or controlled during the transformation operation. In some embodiments, the curvature (or planarity) may be measured and/or controlled during the transformation operation (e.g., in real-time). In some embodiments, the curvature (or planarity) may be measured and/or controlled during transforming one portion of a first layer and/or transforming a second portion of a second layer. The first and second layers can be different layers.

In some embodiments, at least one characteristic of the energy beam and/or source is controlled (e.g., regulated) and/or monitored. The control may be during the formation of the 3D object. For example, the control may be during the transformation operation (e.g., transforming at least a portion of the layer of pre-transformed material). The control may comprise controlling the deformation. The control may comprise controlling the planarity (e.g., of at least a portion of a layer). The control may comprise controlling the curvature (e.g., of at least a portion of a layer). The control may comprise controlling the degree and/or direction of deformation (e.g., of at least a portion of a layer). The control may result in reduced deformation as compared to a non-controlled process. For example, the control may result in reduced curvature as compared to a non-controlled process. The control may result in an increased radius of curvature as compared to a non-controlled process. The control may result (e.g., substantially) no deformation as compared to a non-controlled process which results in a deformation. The control may result in (e.g., substantial) lack of curvature as compared to a non-controlled process which results in curvature. The control may result in at least a portion of the layer being planar (e.g., flat), as compared to a non-controlled process generating the at least a portion of the layer as non-planar. The control may result in a (e.g., substantially) smooth surface as compared to a non-controlled process (generating a respective surface that is (e.g., substantially) rough).

The control may include controlling (e.g., regulating) the energy, energy flux, dwell time, pulse pattern, pulse frequency, footprint, acceleration, and/or velocity of the energy beam. The control may include controlling (e.g., regulating) the power of the energy source. The footprint may be a footprint of the energy beam on the target surface (e.g., exposed layer of the material bed). The acceleration and/or velocity may be the acceleration and/or velocity (respectively) in which the energy travels (e.g., laterally) along the target surface (e.g., exposed surface of the material bed). The energy beam may travel along a path. The energy beam may be a pulsing energy beam. The control may include controlling the pattern of the pulses, dwell time within each pulse, and/or the delay length (e.g., intermission time, or beam off time) between pulses.

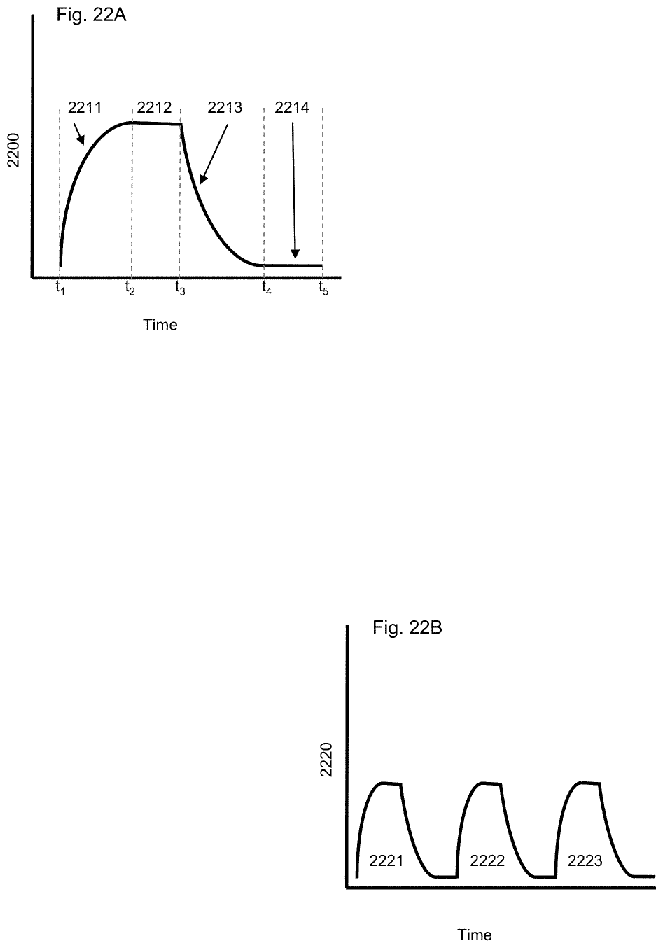

In some embodiments, an energy profile of the (e.g., transforming) energy beam may be controlled (e.g., in real-time and/or in situ). In some embodiments, a measured (e.g., detectable) energy profile may be controlled (e.g., in real-time and/or in situ). In some embodiments, a measured physical attribute profile may be controlled (e.g., in real-time and/or in situ). The physical attribute may be artificially induced (e.g., using an energy source). The physical attribute profile may be a measurement signal profile. The physical attribute profile may comprise (i) temperature, (ii) FLS of an energy beam footprint (on the target surface), (iii) metrology (of the target surface), (iv) power of the energy source generating the transforming energy beam, (v) energy density of the transforming energy beam, (vi) radiation from the target surface (e.g., at or adjacent to the footprint) or (vii) light reflection. The light reflection may comprise scattered light reflection or specular light reflection. The irradiation may be heat irradiation (e.g., IR irradiation). The physical attribute may be of (e.g., correspond to), for example, a melt pool, or transformed portion of the material bed. The control may be any control disclosed herein. For example, the control may comprise a closed loop control. The control may comprise a feedback control. The control may be during the 3D printing (e.g., in real-time). The energy beam may comprise a pulsing energy beam comprising one or more pulses (e.g., two or more pulses). The pulse may be a pulse in terms of (e.g., in correlation with and/or affecting) the physical attribute (e.g., detectable energy). The pulse in terms of (e.g., pertaining to) the physical attribute (termed also herein as “physical attribute pulse”) may comprise one or more pulses of the (e.g., transforming) energy beam. For example, a physical attribute pulse may be a result of a single energy beam pulse, or of a plurality of pulses of the energy beam. The physical attribute pulse may be effectuated by pulse-width modulation (abbreviated as “PWM”) of the energy beam. The physical attribute pulses may correspond to formation of melt pools, wherein each physical attribute pulse corresponds to formation of a melt pool. FIG. 22B shows an example of a pulsing (measured) physical attribute profile over time. In the example shown in FIG. 22B, the physical attribute may be temperature 2220. FIG. 32B shows an example of a pulsing physical attribute profile over time. In the example shown in FIG. 32B, the physical attribute may be a power of the energy source generating the energy beam, or a power density of the energy beam. The measured physical attribute profile may be controlled within the physical attribute pulse (e.g., over the physical attribute pulse time-period). The energy profile of the energy beam may be controlled within the physical attribute pulse in real-time (e.g., in situ) during the 3D printing process. In some embodiments, one or more individual pulses may be controlled during their pulsing time (e.g., in real-time). For example, the shape of physical attribute pulse or any of its portions may be controlled. The portions may be controlled individually (e.g., in real-time). The physical attribute pulse portions may comprise a leading edge, plateau (if any), trailing edge, dwell time, intermission, or any combination thereof. In some embodiments, the physical attribute pulse does not include all of the following components: a leading edge, plateau (if any), trailing edge, dwell time, and intermission. FIG. 22A shows an example of a measured physical attribute pulse (e.g., temperature 2200 variation) profile as a function of time, having a dwell time from t₁ to t₄ and an intermission time from t₄ to t₅. The dwell time in example shown in FIG. 22A is divided into a leading edge 2211, a plateau 2212, and a trailing edge 2213. The intermission in the example shown in FIG. 22A is 2214. The physical attribute profile (e.g., temperature profile) over time may be along a trajectory of the transforming energy beam on the target surface. The physical attribute profile may be derived from sensor measurements. The sensor may be any sensor or detector described herein (e.g., a temperature sensor). The temperature sensor may sense a radiation (or a radiation range) that is emitted from an area at the target surface that coincides with the transforming energy beam footprint, or adjacent thereto (e.g., within a radius equal to at most about 2, 3, 4, 5, or 6 footprint diameters measured from the center of the footprint). The radiation may be IR radiation. The intensity and/or wavelength of a radiation emitted from an area may correlate to the temperature at that area. The

The control may rely on at least one measurement of at least one physical attribute (e.g., aspect, circumstance, event, experience, incident, reality, fact, incident, situation, circumstance, or any combination thereof). The physical attribute may be susceptible to the amount and/or density of energy emitted by the energy beam. The physical attribute may vary depending on the amount and/or density of energy emitted by the energy beam. In some embodiments, at least one physical attribute type may be controlled (e.g., regulated, monitored, modulated, varied, altered, restrained, managed, checked, and/or guided) in real-time during the physical attribute pulse. Real-time may be during the formation of the 3D object, during the formation of the layer of hardened material, during formation of a wire (e.g., forming at least a portion of a layer of hardened material), during formation of a hatch line (e.g., while forming at least a portion of a layer of hardened material), during formation of a melt pool, during the physical attribute pulse, or any combination thereof.

In some embodiments, the physical attribute controlled during the physical attribute pulse (e.g., in real-time during the 3D printing process) comprises a temperature, FLS (e.g., of a melt pool), crystal phase, solid morphologies (e.g., metallurgical phase), stress, strain, defect, surface roughness, light scattering (e.g., from a surface), specular reflection (e.g., from a surface), change in polarization of reflected light (e.g., from a surface), surface morphology, or surface topography. The surface can be the target surface. The physical attribute may correspond to at least one melt pool. The surface can be the exposed surface of the material bed, 3D object, melt pool, portion of transformed material, or any combination thereof. The defect may comprise cracking or deformation. The deformation may comprise bending, buckling, and/or warping. The physical attribute (e.g., detectable energy) may arise at the material bed, melt pool, area just adjacent to the melt pool, target surface (e.g., exposed surface of the material bed), or any combination thereof. For example, the temperature (physical attribute) may comprise temperature of the material bed, melt pool, area (e.g., just) adjacent to the melt pool, exposed surface of the material bed, or any combination thereof. Adjacent may be within a distance that is (e.g., substantially) equal to or equal to at most about 5%, 10%, 20%, 30%, 40% or 50% of the FLS of the melt pool. Adjacent may be within any distance between the afore-mentioned percentages of the melt pool FLS (e.g., from about 5% to about 50%, from about 5% to about 30%, or from about 5% to about 10% of the respective FLS of the melt pool). The FLS physical attribute may comprise a FLS of the melt pool, hatch line, hatch spacing, layer of pre-transformed material (e.g., powder material), or any combination thereof. For example, the FLS of the melt pool may comprise the diameter or depth of the melt pool. In some embodiments, the heating profile and/or the cooling profile (e.g., of the material bed, melt pool, area just adjacent to the melt pool, exposed surface of the material bed, or any combination thereof) may be controlled during the physical attribute pulse as a result of the amount of energy radiated into the material bed during different time-portions within the physical attribute pulse. In some embodiments, the expansion and/or contraction profile (e.g., of the melt pool, of the hatch line, of the hatch spacing, or of the layer of pre-transformed material (e.g., powder material), or any combination thereof) may be controlled during different time-portions within the physical attribute pulse. The shape of the physical attribute pulse may be controlled (e.g., in real-time and/or in situ during the 3D printing process). The physical attribute pulse may comprise a dwell time and an intermission. The dwell time may comprise a time interval. In some examples, at least one-time interval of the physical attribute pulse may be controlled. The time interval may be a portion of the physical attribute pulse dwell time (e.g., from t₁ to t₂ in FIG. 22A), or the entire physical attribute pulse dwell time (e.g., from t₁ to t₅ in FIG. 22A).

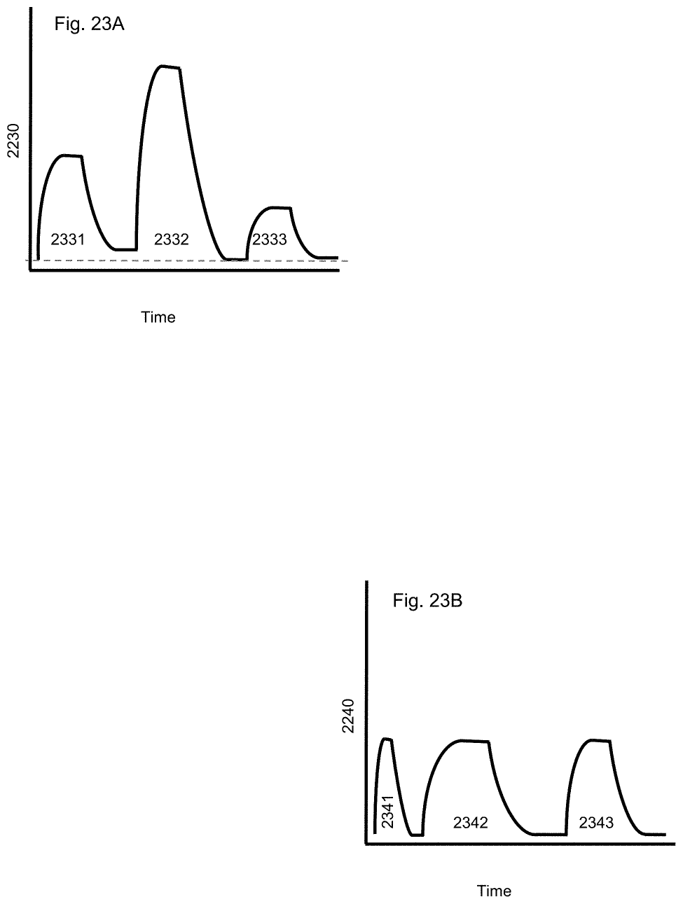

The control may comprise forming at least two physical attribute pulses (e.g., all the physical attribute pulses) that are (e.g., substantially) identical (e.g., completely identical, or almost identical) in terms of the measured physical attribute profile (as a function of time). FIG. 22B shows an example of three physical attribute pulses (2221, 2222, and 2223, wherein the physical attribute correlates to temperature as a function of time) that are identical with respect to the measured energy (as a function of time). The control may comprise forming at least two physical attribute pulses that are different from one another with respect to the physical attribute profile (as a function of time), in a controlled manner (e.g., by keeping the temperature physical attribute and/or FLS physical attribute controlled). Different may be with respect to the physical attribute amplitude, its duration, or any combination thereof (e.g., within the pulse). Different may be with respect to way in which the physical attribute reaches its maximum, way it reaches its minimum, or any combination thereof (e.g., within the pulse). Different may be with respect to peak maximum, and/or peak minimum of the physical attribute (e.g., a measured energy). FIG. 23A shows an example of measured temperature 2330 over time of three pulses (2331, 2332, and 2333) that are different with respect to the physical attribute amplitude and (e.g., substantially) identical with respect to time-period of the pulse. FIG. 23B shows an example of measured temperature 2340 over time of three physical attribute pulses (2341, 2342, and 2343) that are different in their pulse duration of the physical attribute pulse and (e.g., substantially) identical with respect to their maximum and minimum peak intensities (e.g., minimum, and maximum temperatures). FIG. 23A shows an example of two pulses (2331, and 2332) that are different in their minimum peak intensity position (e.g., minimum temperature).

The control may comprise forming at least two physical attribute pulses (e.g., all the physical attribute pulses) that are (e.g., substantially) identical in terms of temperature profile as a function of time. The control may comprise forming at least two phenomenon pulses that are different in terms of temperature profile versus time in a controlled manner (e.g., by keeping the energy profile of the energy beam and/or the FLS physical attribute controlled). The FLS physical attribute may comprise a FLS of the melt pool, hatch line, hatch spacing, layer of pre-transformed material (e.g., powder material), or any combination thereof. The control may comprise forming at least two physical attribute pulses (e.g., all the pulses) that are identical in terms of FLS profile (e.g., of a melt pool) versus (e.g., as a function of) time. The control may comprise forming at least two physical attribute pulses (e.g., all the pulses) that are different in terms of temperature profile versus (e.g., as a function of) time in a controlled manner (e.g., by keeping the energy profile of the energy beam and/or the temperature physical attribute controlled). The temperature physical attribute may comprise temperature of the material bed, melt pool, area just adjacent to the melt pool, exposed surface of the material bed (e.g., position(s) therein), or any combination thereof. The physical attribute may comprise a physical attribute, occurrence, or event.

The physical attribute profile may comprise a temperature profile of a melt pool. A physical attribute pulse may be a temperature pulse of the exposed surface of the material bed (e.g., an area therein). For example, at time t₁ (e.g., in FIG. 22A), the temperature of a position in the powder bed in which a melt pool is to be formed, begins to raise, and reaches a maximum level at t₂ (e.g., in FIG. 22A); the temperature of the melt pool is then held in (e.g., substantially) the same maximum level until time t₃ (e.g., in FIG. 22A); after which it begins to decline (e.g., as the melt pool cools down) until it reaches a certain minimum level at t₄ (e.g., in FIG. 22A). The temperature of the exposed surface of the material bed may be held in an (e.g., substantially) identical temperature until time t₅ (e.g., in FIG. 22A), in which a new melt pool is being formed and a new physical attribute pulse is generated. The designation t₁₋₅ can refer to those in FIG. 22A.

In some embodiments, the physical attribute profile comprises a power pulse profile of an energy source that generates the energy beam. For example, at time t₁ (e.g., in FIG. 32A), the power of the energy source may be turned on to reach a maximum power threshold value; the power may be held at that maximum power value until a different physical attribute that is affected by the energy beam (e.g., corresponding to the temperature at the irradiated position) reaches a requested threshold value of that different physical attribute (e.g., corresponding to the temperature), at time t₂ (e.g., in FIG. 32A); in order to (e.g., substantially) keep that different physical attribute at its requested threshold value, the power of the energy source may be reduced until it reaches a minimum level is reached at t₄ (e.g., in FIG. 32A). The power may be held at that minimum value, or entirely turn off until time t₅ (e.g., in FIG. 32A), in which a new power pulse may be generated. The times t₁-t₅ in FIG. 22A may be the same as the times t₁-t₅ in FIG. 32A.

In some embodiments, the physical attribute profile comprises a power density pulse profile of an energy beam that generates a transformed material. For example, at time t₁ (e.g., in FIG. 32A), the power density of the energy beam may be turned on to reach a maximum power density threshold value; the power density may be held at that maximum value until a different physical attribute that is affected by the energy beam radiation (e.g., temperature at the irradiated position) reaches a requested threshold at time t₂ (e.g., in FIG. 32A); in order to (e.g., substantially) keep that different physical attribute at a requested threshold value of that different physical attribute, the power density of the energy beam may be reduced until it reaches a minimum level is reached at t₄ (e.g., in FIG. 32A). The power density may be held at that minimum value, or entirely turn off until time t₅ (e.g., in FIG. 32A), in which a new power density pulse may be generated. The times t₁-t₅ FIG. 22A may be the same as the times t₁-t₅ in FIG. 32A.

The physical attribute profile may comprise a diameter profile of a melt pool. The physical attribute may be an artificially induced phenomenon. A physical attribute pulse may be a diameter pulse of a melt pool. For example, at time t₁ (e.g., in FIG. 22A), an area at a position of a target surface (e.g., an exposed surface of a material bed) begins to transform into a melt pool; the diameter of the melt pool may begin to expand, and reaches a maximum level at t₂ (e.g., in FIG. 22A, wherein 2200 represents the diameter of the melt pool); the diameter of the melt pool is then held in (e.g., substantially) the same maximum diameter until time t₃ (e.g., in FIG. 22A); after which it begins to shrink (e.g., as the melt pool cools down) until it reaches a certain minimum level at t₄ (e.g., in FIG. 22A). The diameter of the melt pool may be held in an (e.g., substantially) identical temperature until time t₅ (e.g., in FIG. 22A), in which a new melt pool is being formed and a new physical attribute pulse is generated. By controlling the shape of one or more portions of the physical attribute pulse (e.g., by controlling the temperature at the target surface, at least one characteristic of the energy beam, and/or at least one characteristic of the energy source such as its power), the size of the melt pool can be controlled. For example, the size of a plurality of melt pools can be controlled (e.g., to be (e.g., substantially) identical, see FIG. 35). The designation t₁₋₅ can refer to those in FIG. 22A. The control may comprise directly (e.g., gradually) adjusting the power of the energy beam. Additionally or alternatively, the control may comprise modulating the energy beam by using pulse width modulation (PWM). The control may comprise generating (e.g., irradiating) pulses of the energy beam that are short relative to the duration of the physical attribute pulse. The control may alter one or more functions of the 3D printing. For example, the control may vary the size of transformed area. The size may be the volume and/or the FLS. The transformed area may be on the surface of at least a portion of the layer as part of the 3D object. The transformed area may be a transformed area in the material bed. The transformed area may be a transformed area in the target surface. The transformed area may comprise a melt pool. The transformed area may be the melt pool. The transformed area may include an adjacent area to the afore-mentioned areas (e.g., within at least about 2, 3, 4, 5, 6, 7, or 8 melt pool diameters). The control may consider at least one temperature measurement at the irradiation position and/or adjacent thereto. The irradiation position may be a position in which the energy beam interacts with the target surface (e.g., to transfer a portion of it into a transformed material). Adjacent may be within at least about 0.1 micrometer (μm), 0.5 μm, 1 μm, 1.5 μm, 2 μm, 3 μm, 4 μm, 5 μm, 6 μm, 7 μm, 8 μm, 9 μm, or 10 μm from the irradiation position (e.g., center or rim of the irradiation position). Adjacent may be within at most about 50 μm, 10 μm, 9 μm, 8 μm, 7 μm, 6 μm, 5 μm, 4.5 μm, 4 μm, 3.5 μm, 3 μm, 2.5 μm, 2 μm, 1.5 μm, 1 μm, 0.75 μm, 0.5 μm, 0.4 μm, 0.3 μm, 0.2 μm, or 0.1 μm from the irradiation position. Adjacent may be of any value between the afore-mentioned values (e.g., from about 0.1 μm to about 1 μm, from about 1 μm to about 10 μm, or from about 0.1 μm to about 50 μm). These values may correspond to “adjacent to the irradiation position”, or to “adjacent to the transformed area.”

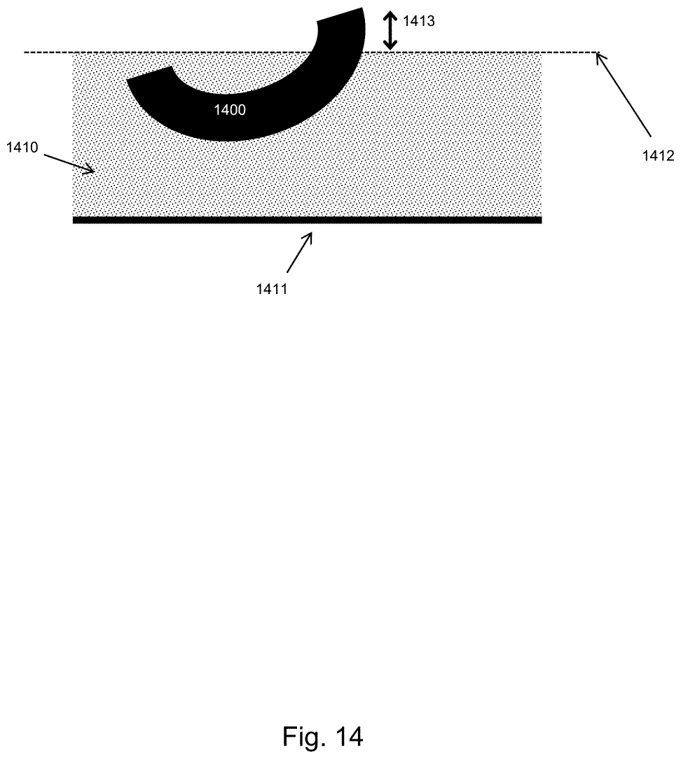

In an aspect, the one or more sensors sense one or more positions of the target (e.g., exposed) surface. The exposed surface may be of the material bed, of the transformed material, of the 3D object, or any combination thereof. The exposed surface of the material bed may comprise a layer of material disposed prior to the formation of the 3D object. The exposed surface of the material bed may comprise a layer of material that was used to form the last (e.g., previously) formed hardened layer of the 3D object. The exposed surface of the material bed may comprise a layer of material that was disposed subsequent to the formation of the last formed hardened layer of the 3D object. FIG. 14 shows an example of a material bed 1410 having an exposed surface 1412; and the exposed surface 1412 is disposed before formation of the last hardened layer of 3D object 1400. The exposed surface of the material bed may comprise a newly dispensed layer of pre-transformed material in the material bed. In some instances, the 3D object may protrude from the newly dispensed layer of pre-transformed material. In some instances, the 3D object may be completely covered by the newly dispensed layer of pre-transformed material.

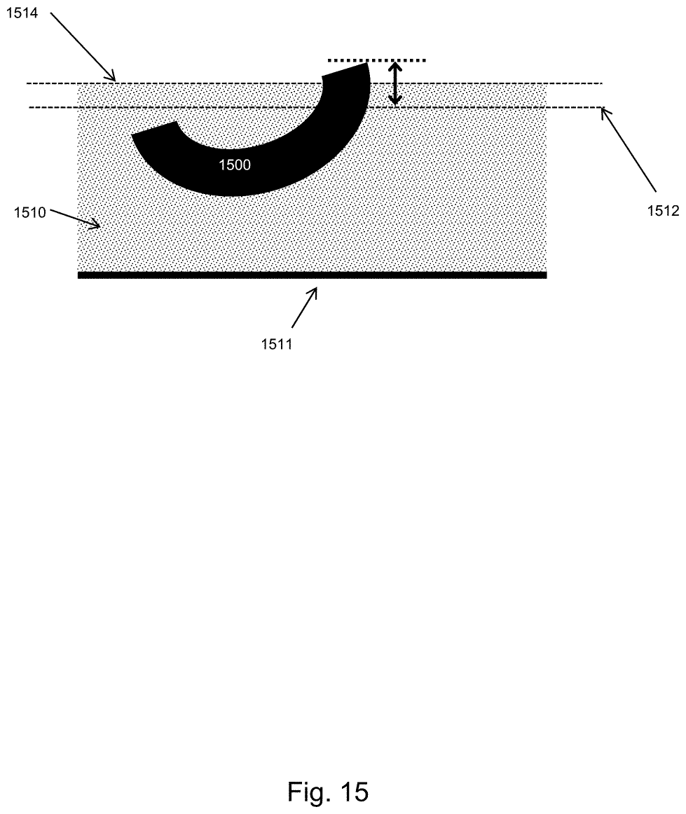

FIG. 15 shows an example of a material bed 1510, with an exposed surface 1514; the surface 1512 is of a previously dispensed layer of pre-transformed material; and the exposed surface 1514 is of a newly dispensed layer of pre-transformed material (e.g., subsequent to the formation of the last layer of hardened material of the 3D object 1500). In the example of FIG. 15, the 3D object protrudes the newly dispensed layer of pre-transformed (e.g., powder) material. The data from the one or more sensors may be used (e.g., by the controller and/or a processing unit) to provide a map of at least a portion of the target surface. The map may be generated during the process of printing (e.g., forming) the 3D object. The processing unit may be a part of the controller. The processing unit may be separate from the controller. The map may be generated during the 3D printing process. The map may be altered during the 3D printing process (e.g., based on sensor input). The map may be generated and/or altered during the 3D printing process. The map may be generated with a relatively high frequency and/or resolution. For example, the frequency may (e.g., substantially) equal any of the frequencies recited herein for the sensor measurement frequency. The resolution may be any resolution mentioned herein. For example, the resolution of the sensor may be from about 10% to about 190% of the average or mean FLS of the particulate material in the material bed.

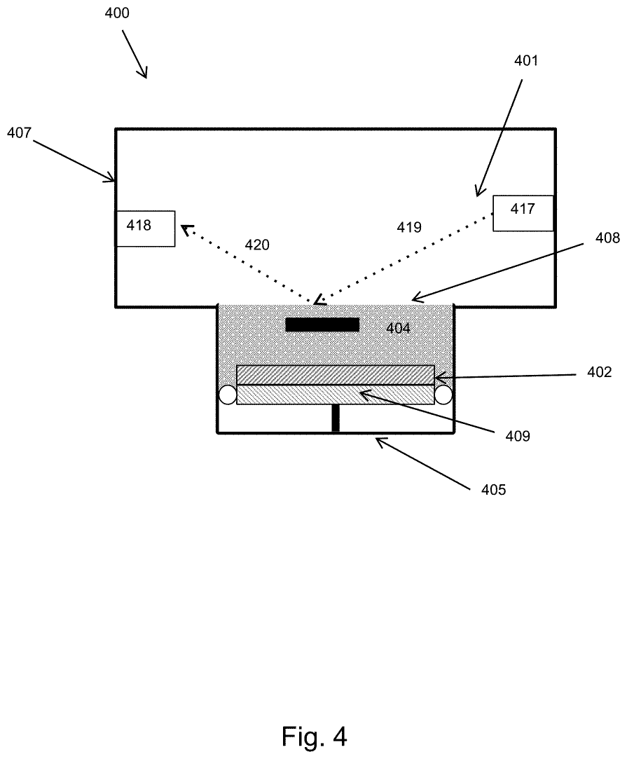

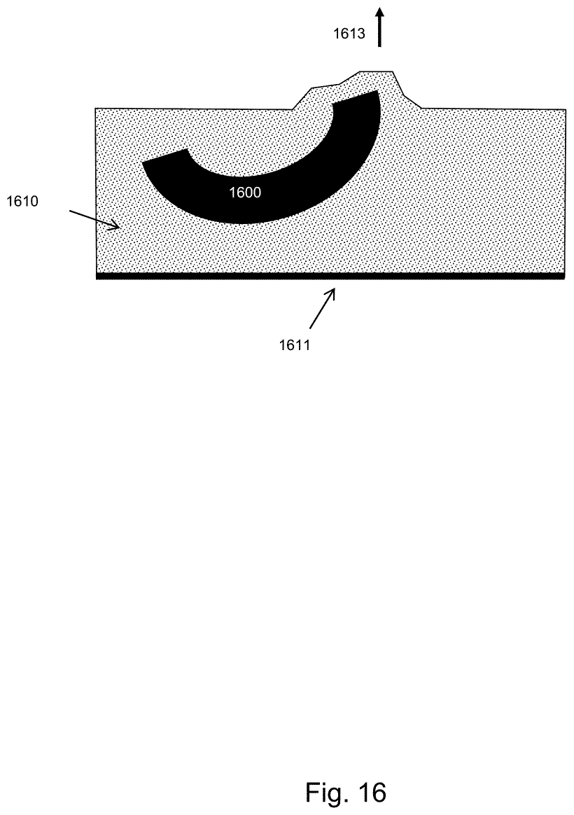

In some embodiments, the one or more sensors sense one or more positions of at least a portion of the 3D object. The one or more sensors may sense one or more positions of at least a portion of the 3D object that protrudes from the exposed surface of the material bed. FIG. 14 shows an example of a 3D object 1400 that protrudes from the exposed surface 1412 of the material bed 1410 that is operatively coupled and/or disposed adjacent to a build platform 1411. In the example of FIG. 14, the 3D object protrudes by a height 1413 from the exposed surfaced 1412 of the material bed 1410. The one or more sensors may measure the one or more positions of the exposed surface using a contact method, non-contact method, or any combination thereof. The one or more positions of the exposed surface may comprise vertical, horizontal, and/or angular positions. The angular position may include compound or planar angle. The measurement may comprise the height (e.g., thickness) of the pre-transformed material disposed above a layer of hardened material. The sensors may sense an energy beam. The positions sensed by the one or more sensors may be effectuated by sensing an energy beam. The energy beam may comprise the transforming energy beam or the sensing energy beam. The energy beam may be reflected from the target (e.g., exposed) surface. The reflected energy beam may be sensed by the one or more sensors. FIG. 4 shows an example of an energy beam 420 that is reflected from the target surface 408 and is sensed by the sensor receiver part 418. The exposed surface may comprise the exposed surface of the material bed, or of the at least a portion of the 3D object. The exposed surface may be of a transformed portion of the material bed that is not a portion of the 3D object (e.g., debris, or auxiliary support). The exposed surface may comprise an exposed surface of the material bed that has altered its position due to the formation of at least a portion of the 3D object, which portion is covered by pre-transformed material as part of (e.g., within) the material bed. For example, the exposed surface may comprise an exposed surface of the powder bed that has altered its position due to the formation of at least a portion of the 3D object, which 3D object is covered by powder material within the powder bed. FIG. 16 shows an example of a 3D object 1600 that is covered by a material bed 1610 disposed on a platform 1611, which formation of the 3D object caused a portion of the exposed surface of the material bed to alter in the direction of the arrow 1613.

At times, a new layer of hardened material is deposited on a portion of a 3D object. The portion of the 3D object may include one or more layers (e.g., of hardened material). The portion of the 3D object may (e.g., substantially) adhere to (e.g., not substantially deviate from) a model of the requested 3D object. The one or more layers within the portion of the 3D object may (e.g., substantially) adhere to (e.g., not substantially deviate from) a model of the requested 3D object. The one or more layers of the 3D object may be (e.g., substantially) non-deformed. Substantially may be relative to the intended purpose of the 3D object.

In certain instances, the portion of the 3D object deviates from the model of the requested 3D object. The deviation may comprise a corrective deviation. The deviation may comprise a corrective deformation. The portion of the 3D object may deviate from a model of the requested 3D object. The one or more layers within the portion of the 3D object may deviate from a model of the requested 3D object. The one or more layers of the 3D object may be (e.g., substantially) deformed as compared to the respective one or more slices in the model of the requested 3D object. The manner of forming (e.g., printing) the one or more layers may deviate from a model of the requested 3D object. The path in which the transforming energy beam progresses, may deviate from a slice of the model of the requested 3D object. The model of the requested 3D object may be a requested model. In some examples, a deviated model may be used to provide (3D printing) instructions for the transformation of at least a portion of the material bed (e.g., to form the 3D object). In some examples, a deviated model may be used to provide instructions for the energy beam path. The deviated model may allow the transformed material to take a shape that (e.g., substantially) corresponds to the requested 3D object (e.g., upon hardening, e.g., upon solidifying). At least a portion of the requested model (e.g., slice thereof) may undergo a deviation conversion to form the deviated model. The deviation may be a corrective deviation. The deviation may be substantial (e.g., measurable). The deviation may be controlled (e.g., by at least one function used in the 3D printing). The deviation of the portion of transformed material that is materialized during the printing (e.g., material transformation) operation, may (e.g., substantially) correspond to the deviation that is recommended by the deviated model. The (virtual) model of the requested 3D object that underwent the deviation may be referred herein as the “deviated model.” A requested deviation of the portion (e.g., layer) may be effectuated when a portion of transformed material (e.g., layer), which was generated according to the deviated model (e.g., slice thereof), hardens (e.g., cools). The requested deviation of the portion of transformed material may be referred to herein as a “target deviation.” The target deviation may be measured, anticipated by modeling (e.g., thermo-mechanical modeling), anticipated according to historical data, or any combination or permutation thereof. The target deviation may be reached generating the transformed material. The target deviation may be reached upon hardening (and/or cooling) the portion of transformed material. The deviation of the portion of transformed material may be controlled (e.g., in spatial orientation and/or magnitude). The controlling operation may comprise controlling the portion of transformed material such that it will (e.g., substantially) correspond to the target deformation (e.g., upon hardening and/or cooling). FIG. 6 shows examples of a 3D object before and after hardening (by cooling). 3D Object 601 represents an intermediate 3D object that has not completely hardened, whereas 3D object 602 represents the object 601 that has completely hardened. In some embodiments, object 603 may represent an example of a vertical cross section in a virtual model of a requested 3D object depicting the slices (e.g., layer instructions for printing the 3D object). In some embodiments, 603 may represent an example of a cross section of a 3D object that was printed but did not completely harden. Object 604 represents an example of a cross section in a completely hardened 3D object (e.g., final 3D object). Object 604 represents an example of a vertical cross section in the printed 3D object that (e.g., substantially) corresponds (e.g., match) the requested 3D object, with the lines depicting layer boundaries. Slice 605 was printed as a layer that deviates from the requested 3D object model, which printing was according to instructions from the deviated model. Upon complete hardening, the layer assumed a shape (e.g., 606) that allowed the printed 3D object to (e.g., substantially) correspond to the requested 3D object. The assumed shape may (e.g., substantially) correspond to a modeling of the hardening of the transformed material (e.g., transformed material layer). The target deformation may be determined using historical data and/or modeling (e.g., of the hardening and/or cooling). The assumed shape may (e.g., substantially) correspond to the target deformation (e.g., target shape). The manner of assuming the final shape of the at least one layer may be controlled. The control may be any of the control method disclosed herein. The control may be control of at least one function involved in 3D printing. For example, the control may be control of at least one characteristic of the energy beam. For example, the control may be control of a temperature of the hardened material and/or material bed (e.g., during the 3D printing).

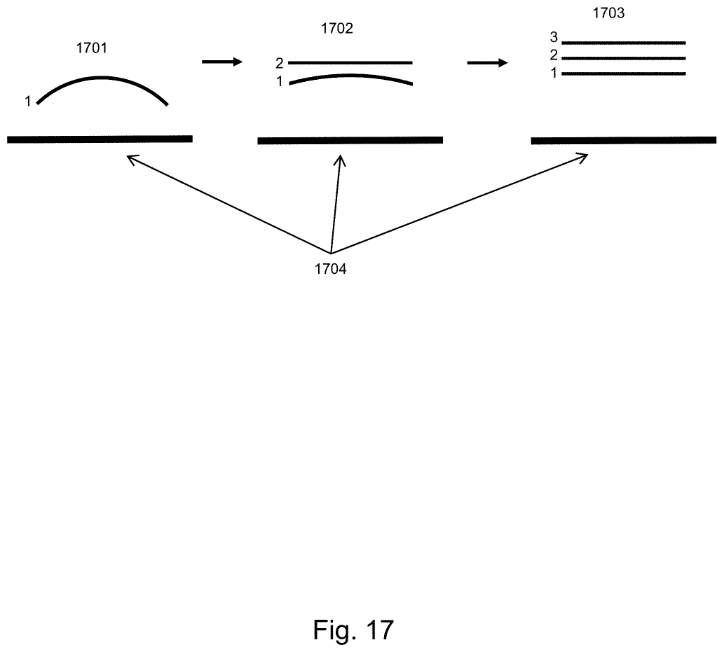

The methods, software, and systems described herein may comprise corrective deformation of a 3D model of the requested 3D structure, that (e.g., substantially) result in the requested 3D structure. The corrective deformation may consider features comprising (i) stress within the forming structure, (ii) deformation of material as it hardens to form at least a portion of the 3D object, (iii) the manner of temperature depletion during the 3D printing process, or (iv) the manner of deformation of the transformed material as a function of the density of the material within the material bed (e.g., powder material within a powder bed). The modification may comprise alteration of a path of a layer (or portion thereof) in the 3D model. The alteration of the path may comprise alteration of the path filling at least a portion of the layer (e.g., cross section of the 3D object), e.g., which path may comprise hatching. The alteration of the path (e.g., hatching) may comprise alteration of the direction of path (e.g., hatching), the density of the path (e.g., hatch) lines, the length of the path (e.g., hatch) lines, or the shape of the path (e.g., hatch) lines. The modification may comprise alteration of the thickness of the 3D object (or a portion thereof, e.g., layer), for example, during its transformed state (e.g., before complete hardening). The modification may comprise varying at least a portion of a cross section (e.g., slice) of the 3D model by an angle (e.g., planer or compound angle), or inflicting to at least a portion of a cross section a radius of curvature (i.e., bending at least a portion of the cross section of a 3D model). Examples of corrective deformation, 3D printers, related control system, related methods, apparatuses, systems, and program instructions (e.g., software), can be found in International Patent Application Serial No. PCT/US16/34857 filed on May 27, 2016, which is incorporated herein by reference in its entirety. The corrective deviation from the intended 3D structure may be termed herein as “geometric correction.” FIG. 17 shows examples of various stages in formation of a 3D object 1703 represented as three layers (e.g., numbered 1-3 in object 1703), which is shown as a vertical cross section and is situated on a build platform 1704. The first formed layer is formed as a negatively curved layer #1 of object 1701. Once the second layer (#2 of object 1702) is formed, the first layer #1 may flatten out (e.g., its radius of curvature is increased, its curvature is reduced (e.g., approaches zero)). Once the third layer (#3 of object 1703) is formed, the layers of the 3D object become (e.g., substantially) flat (e.g., planar). Layer #1 may be said to be formed as a correctively deformed layer. The corrective deformation may enable a formation of a (e.g., substantially) non-deformed 3D object. The manner of printing one or more subsequent layers to the correctively deformed layers may consider the (e.g., in situ and/or real-time) measurements from the one or more sensors. The corrective deformation may be of an entire layer of hardened material, or a portion thereof. The corrective deformation may be of at least a portion of the layer of hardened material as part of a 3D object.

In some embodiments, the sensor comprises an imaging device. The imaging device may comprise multi-spectral imaging, single spectral imaging, or non-spectral imaging. The non-spectral imaging may comprise acoustic, electro, or magnetic imaging (e.g., electromagnetic imaging). The multi-spectral imaging may comprise detecting red body radiation (e.g., emitted from the target surface). The imaging device may comprise a camera. The imaging device may image a target surface (e.g., exposed surface of the material bed, 3D object, or melt pool). The imaging device may image the temperature and/or metrology (e.g., dimensionality). The imaging device may image a melt-pool temperature, shape and/or FLS (e.g., diameter, or depth). The imaging device may image a vicinity of melt-pool temperature, shape and/or FLS (e.g., diameter, or depth). The imaging device may image a zone affected by the melt pool (e.g., heat thereof). The zone affected by the heat of the melt pool is termed herein “heat affected zone” (e.g., FIG. 26A, 2610). The imaging device may image the generation and/or hardening of at least a portion of the melt pool.

In some embodiments, the non-contact measurement includes at least one optical measurement. The optical measurement (e.g., by the optical sensor) may comprise measurement by an image sensor (e.g., CCD camera), optical fiber (e.g., optical fiber bundle), laser scanner, or interferometer. The interferometer may comprise a white light or a partial coherence interferometer.

In some embodiments, the optical measurement and/or the analysis thereof comprise (e.g., superimposed) waves (e.g., electromagnetic waves). The superimposed waves may be used to extract information about a reflection(s) of these waves from the target surface. The information may comprise relative location, location alteration (e.g., displacement), refractive index alteration, or surface changes (e.g., irregularities). The optical measurement of the reflection(s) and/or the analysis thereof may comprise using Fourier transform spectroscopy (e.g., of continuous waves). The optical measurement of the reflection(s) and/or the analysis thereof may comprise combining two or more waves (e.g., super positioning waves). The optical sensor may comprise a mirror or a beam splitter. The mirror may be (e.g., substantially) fully reflective, or partially reflective (e.g., a half-silvered mirror). The mirror may be (e.g., controllable) translating (e.g., horizontally, vertically, and/or rotationally, e.g., along an axis). The partially reflective mirror may be a beam splitter. The interferometer may comprise homodyne or heterodyne detection. The interferometer may comprise a double path or common path interferometer. The interferometer may comprise wave front splitting or amplitude splitting. The interferometer may comprise a Michelson, Twyman-Green, Mach-Zehnder, Sagnac (e.g., zero-area Sagnac), point diffraction, lateral shearing, Fresnel's biprism, scatter plate, Fizeau, Mach-Zehnder, Fabry-Pérot, Laser Unequal Path, or Linnik interferometer. The interferometer may comprise a fiber optic gyroscope, or a Zernike phase contrast microscope. Examples of sensors (e.g., optical, or temperature), 3D printers, related control system, related methods, apparatuses, systems, and program instructions (e.g., software), can be found in International patent application number PCT/US15/65297, filed on Dec. 11, 2015, titled “FEEDBACK CONTROL SYSTEMS FOR THREE-DIMENSIONAL PRINTING,” which is incorporated by reference in its entirety.

In some embodiments, the 3D object is supported during the 3D printing. For example, the 3D object may be supported by the build platform (e.g., by the base). For example, the 3D object may be anchored to the enclosure (e.g., to the base). The 3D object may comprise auxiliary supports. The auxiliary support may be the enclosure (e.g., the base) and/or structures that connect the 3D object to the enclosure (e.g., the base) and are not part of the intended (e.g., requested) 3D object. The 3D object may be devoid of auxiliary supports. The 3D object may be supported by at least a portion of a fused material bed. The fused material bed (or a portion thereof) may or may not fully enclose (e.g., surround) the 3D object. The 3D object may be suspended in a material bed, which material bed comprises flowable material (e.g., powder and/or liquid). The 3D object (e.g., with or without auxiliary supports) may be floating in the material bed without being anchored to the enclosure (e.g., to the base). In some embodiments, the 3D object is devoid of auxiliary supports.

In some embodiments, the 3D object may comprise a reduced number of constraints (e.g., supports) during the 3D printing. The reduced amount may be relative to prevailing 3D printing methodologies (e.g., respective methodologies). The 3D object may be less constraint (e.g., relative to prevailing 3D printing methodologies). The 3D object may be constraint-free (e.g., supportless) during the 3D printing.

In some embodiments, the control includes imaging a surface. The imaging may include stills or video imaging. The imaging may be at a direction perpendicular to the average or median plane of the exposed layer of the material bed. The imaging may be at a non-perpendicular direction to the average or median plane of the exposed layer of the material bed. The imaging may be at a grazing angle with respect to the average or median plane of the exposed layer of the material bed. The imaging may be detected at an acute angle of at least about 1°, 5°, 10°, 15°, 20°, 30°, 40°. 50°, 60°, 70°, or 80° relative to the average or mean plane of the exposed surface of the material bed. The symbol ° ° designates the word degrees. The imaging may be detected at an acute angle of at most about 1°, 5°, 10°, 15°, 20°, 30°, 40°, 50°, 60°, 70°, or 80° relative to the average or mean plane of the exposed surface of the material bed. The imaging may be detected at an acute angle between any of the above-mentioned angles (e.g., from about 1° to about 80°, from about 1° to about 40°, or from about 40° to about 80°) relative to the average or mean plane of the exposed surface of the material bed.

In some examples, the imaging is performed during the formation of the 3D object. The control may include processing the images obtained from the one or more sensors. The processing may comprise image processing. The image processing may reveal a variation in the surface (e.g., planarity thereof). The revealed variation may trigger a modulation of at least one function of (e.g., component participating in) the 3D printing process. The at least one functions of the 3D printing process may comprise one or more characteristics of the energy beam as disclosed herein.

In some embodiments, the imaging comprises use of one or more imaging devices (e.g., cameras). The control may comprise use of a position sensor. The position sensor may comprise an absolute position sensor. The position sensor may comprise a relative position sensor. The position sensor may be a metrological sensor. The relative position sensor may consider a comparison between two or more images of the surface, which images are taken at different (e.g., known) times.

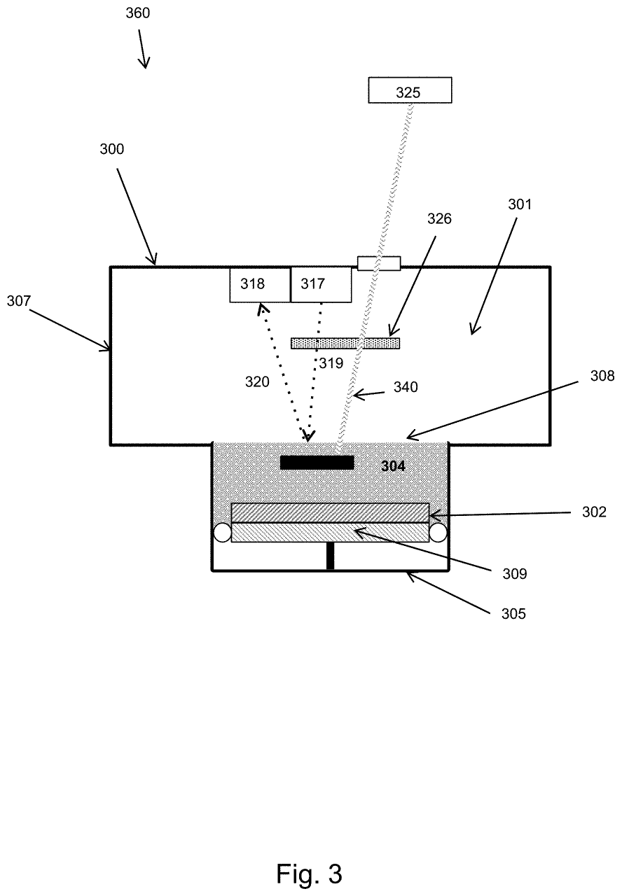

In some embodiments, the sensor comprises projecting a sensing energy beam. FIG. 3 shows an example of a 3D printer 360 that includes a sensor that includes parts 317 (emitter) and 318 (receiver), which sensor (e.g., part 317) emits a sensing energy beam towards the exposed surface 308 of the material bed 304. The sensing energy beam may be projected from a direction above the exposed layer of the material bed (e.g., from part 317). Above may be in a direction opposite to the direction of the gravitational force, platform (e.g., substrate 309 and/or base 302), and/or bottom of the enclosure (e.g., 305). The direction above the exposed layer may form an angle with the exposed layer. The angle may be (e.g., substantially) perpendicular. The angle may be acute. In some examples, the sensor is disposed above the exposed layer of the material bed (e.g., FIG. 3, sensor parts 317 (emitter) and 318 (receiver)). In some embodiments, the sensor is disposed at the sides of the enclosure (e.g., FIG. 4, sensor parts 417 and 418). The sensor may be disposed at the ceiling of the enclosure (e.g., FIG. 3, sensor parts 317 and 318). In some embodiments, parts of the sensor may be disposed at the sides of the enclosure, and other parts may be disposed at the ceiling of the enclosure. The sensor may be disposed within the enclosure (e.g., FIG. 3, sensor parts 317 and 318). The sensor may be disposed outside of the enclosure. At least a part of the sensor may be disposed within and/or outside the walls of the enclosure. At least a part of the sensor may be disposed within the enclosure. Within the walls of the enclosure may refer to a situation where the part may form an integral part of the wall(s). The walls may comprise the side walls, the ceiling, or the bottom of the enclosure. Within the enclosure may refer to within the interior of the enclosure. The sensing energy beam may be projected from a direction on the sides of the enclosure (e.g., 407). FIG. 4 shows an example of a 3D printer 400 that includes a sensor comprising parts 417 (emitter) and 418 (receiver). In the example of FIG. 4, the sensing energy beam is emitted from the side of the enclosure (e.g., from part 417). The sensing energy beam may be projected from a direction residing on the ceiling of the enclosure (e.g., FIG. 3, from part 317). The ceiling may or may not be (e.g., substantially) parallel to the exposed layer of the material bed, to the substrate, and/or to the bottom of the enclosure. The sensing energy beam may be projected from a direction residing on the sides of the enclosure (e.g., FIG. 4, from part 417). The sides may be (e.g., substantially) perpendicular to the exposed layer of the material bed, to the substrate, and/or to the bottom of the enclosure.

In some embodiments, the sensor may sense radiation (e.g., electromagnetic radiation) from a surface (e.g., exposed surface of the material bed, or of the 3D object), which radiation progresses to a direction above the exposed layer of the material bed. FIG. 3 shows an example of a 3D printer 360, where the radiation 320 is projected from the exposed surface 308 of the material bed 304 towards the ceiling of the enclosure 300 and detected in the sensor part 318 (e.g., the receiver). The direction above the exposed layer may be at an angle relative to the exposed layer of the material bed. The angle may be (e.g., substantially) perpendicular. The angle may be acute. The sensor may sense radiation from a surface, which radiation progresses towards the sides of the enclosure. FIG. 4 shows an example where the radiation 420 is projected from the exposed surface 408 of the material bed 404 towards the side of the enclosure 407 and detected in the sensor part 418 (e.g., the receiver). The sensor may sense radiation from a surface, which radiation progresses towards the ceiling of the enclosure.

In some embodiments, the radiation sensed by the sensor is that of the transforming energy, which is reflected from the target surface. The enclosure may comprise a window. The window may be an optical window. FIG. 1 shows an example of an 3D printer 100 having an enclosure comprising an optical window 115. The optical window may allow radiation from the surface to pass through (e.g., without substantial alteration and/or loss). The optical window may allow the sensing energy beam and/or the transforming energy beam to travel through (e.g., without substantial alteration and/or loss).

In some embodiments, the sensor has an associated imaging resolution. The resolution of the sensor may be lower (e.g., coarser) than the average or mean FLS of the particulate material forming the material bed (e.g., powder particles in the powder bed). Lower may be by at least about 1%, 5%, 10%, 20%, 30%, 40%, 50%, 60%, 70%, 80%, or 90% of the average or mean FLS of the particulate material in the material bed. Lower may be by at most about 1%, 5%, 10%, 20%, 30%, 40%, 50%, 60%, 70%, 80%, or 90% of the average or mean FLS of the particulate material in the material bed. Lower may be by any value between the afore-mentioned percentage values (e.g., from about 1% to about 90%, from about 1% to about 50%, or from about 40% to about 90%) of the average or mean FLS of the particulate material in the material bed. Lower by a value from about 1% to about 90% of the average or mean FLS of the particulate material in the material bed, means that the resolution of the sensor may be from 101% to 190% of the average or mean FLS of the particulate material in the material bed respectively.

In some embodiments, the sensor detects one or more movements that are a fraction of the average or mean FLS of the particular material in the material bed (e.g., powder particles in the powder bed). The fraction may be at least about 1%, 5%, 10%, 20%. 30%, 40%, 50%, 60%, 70%, 80%, or 90% of the average or mean FLS of the particulate material in the material bed. The fraction may be at most about 1%, 5%, 10%, 20%, 30%, 40%, 50%, 60%, 70%, 80%, or 90% of the average or mean FLS of the particulate material in the material bed. The fraction may be any value between the afore-mentioned percentage values (e.g., from about 1% to about 90%, from about 1% to about 50%, or from about 40% to about 90%) of the average or mean FLS of the particulate material.

In some embodiments, the control system (e.g., computing device) tracks the position alteration that is detected at the surface. As a reaction to the position alteration, the controller may direct adjustment of one or more functions of the 3D printing (e.g., using a software). For example, the controller may direct adjustment (e.g., alteration) of one or more characteristics of the transformation (e.g., fusion) operation. The controller may direct adjustment (e.g., alteration) of at least one function of at least one mechanism based on the position alteration. The adjustment may be before or during formation of a subsequent portion of the 3D object. For example, the controller may direct adjustment of one or more characteristics of the transforming energy beam.

In some embodiments, the sensor measures a fraction of the surface. In some embodiments, the sensor measures the entire surface (e.g., entire protruding surface, entire exposed surface of the material bed, and/or entire target surface). The controller may consider the positions (whether altered or non-altered) in the entire surface. The controller may consider the sensor measurement of a fraction of the surface. The fraction may comprise an area of at least about 1 mm², 2 mm², 3 mm², 4 mm², 5 mm², 6 mm², 8 mm², 9 mm², 10 mm², 50 mm², 100 mm², or 1000 mm². The fraction may comprise an area of at most about 1 mm², 2 mm², 3 mm², 4 mm², 5 mm², 6 mm², 8 mm², 9 mm², 10 mm², 50 mm², 100 mm², 1000 mm², or of at least the entire exposed are of the material bed. The fraction may comprise an area of any value between the afore mentioned values (e.g., from about 1 mm² to about 1000 mm², from about 1 mm² to about 5 mm², from about 5 mm² to about 10 mm², from about 10 mm² to about 50 mm², from about 50 mm² to about 1000 mm², or from about 1 mm² to about the entire exposed surface area of the material bed).

In some embodiments, the controller considers sensor measurements that are distant from the position at which the transforming energy beam interacts with the material bed (e.g., the irradiated position). Distant can be at most about the edge of the last formed layer of hardened material. Distant can be at the vicinity of the edge of the last formed layer of transformed (e.g., and/or hardened) material. Distant can be at least about 1 mm, 2 mm, 3 mm, 4 mm, 5 mm, 6 mm, 7 mm, 8 mm, 9 mm, or 10 mm from the center of the transforming energy beam footprint on the exposed surface of the material bed. Distant can be at most about 1 mm, 2 mm, 3 mm, 4 mm, 5 mm, 6 mm, 7 mm, 8 mm, 9 mm, or 10 mm from the center of the transforming energy beam footprint on the exposed surface of the material bed. Distant can be any value between the afore-mentioned values (e.g., from about 1 mm to about 10 mm, from about 1 mm to about 5 mm, or from about 5 mm to about 10 mm) relative to the center of the transforming energy beam footprint on the exposed surface of the material bed.

In some embodiments, the controller may consider one or more sensor measurements that are in the vicinity of a position of an edge of the last formed layer of hardened material. In the vicinity of the position of the edge of the last formed layer of hardened material can be at least about 1 mm, 2 mm, 3 mm, 4 mm, 5 mm, 6 mm, 7 mm, 8 mm, 9 mm, or 10 mm. In the vicinity of the position of the edge of the last formed layer of hardened material can be at most about 1 mm. 2 mm, 3 mm, 4 mm, 5 mm, 6 mm, 7 mm, 8 mm, 9 mm, or 10 mm. In the vicinity of the position of the edge of the last formed layer of hardened material can be any value between the afore-mentioned values (e.g., from about 1 mm to about 10 mm, from about 1 mm to about 5 mm, or from about 5 mm to about 10 mm). The sensor may sense the positions and/or areas that are considered by the controller.

In some embodiments, the sensor conducts frequent measurements. The sensor may conduct measurements at a frequency of at least about every 1 second (sec), 2 sec, 3 sec, 4 sec, 4 sec, 5 sec, 6 sec, 7 sec, 8 sec, 9 sec, 10 sec, 15 sec, 20 sec, 25 sec, 30 sec, 35 sec, 40 sec, 45 sec, 50 sec, 60 sec, 70 sec, 75 sec, 80 sec, 90 sec, 95 sec, or 100 sec. The sensor may conduct measurements at a frequency of at most about every 1 sec. 2 sec, 3 sec, 4 sec, 4 sec, 5 sec, 6 sec, 7 sec, 8 sec, 9 sec, 10 sec, 15 sec, 20 sec, 25 sec, 30 sec, 35 sec, 40 sec, 45 sec, 50 sec, 60 sec, 70 sec, 75 sec, 80 sec, 90 sec, 95 sec, or 100 sec. The sensor may conduct measurements at a frequency of any of the above-mentioned frequencies (e.g., from about every 1 sec to about every 100 sec, from about every 5 sec, to about every 50 sec, from about every 5 sec to about every 30 sec, from about every 30 sec to about every 50 sec, from about every 20 sec to about every 40 sec, or from about every 50 sec to about every 100 sec). The controller may be programmed to direct considering the measurements at a corresponding frequency. The controller may be programmed to direct performing an image processing of the measurements at a corresponding frequency. The controller may be programmed to direct changing one or more functions of the 3D printing process (e.g., transforming energy beam characteristics) at a corresponding frequency.

In some embodiments, the image processing provides a positional map of at least a fraction of the surface. The positional map may comprise vertical, horizontal, or angular (e.g., planar or compound) positions. The positional map may be provided at any of the frequencies mentioned herein. The positional map may be provided at a frequency of at least about 5 times/second (*/sec), 10*/sec, 20*/sec, 30*/sec, 40*/sec, 50*/sec, 60*/sec, 70*/sec, 80*/sec, 90*/sec, or 100*/sec. The positional map may be provided at a frequency of at most about 5*/sec, 10*/sec, 20*/sec, 30*/sec, 40*/sec, 50*/sec, 60*/sec, 70*/sec, 80*/sec, 90*/sec, or 100*/sec. The positional map may be provided at a frequency between any of the afore-mentioned frequencies (e.g., from about 5*/sec to about 100*/sec, from about 5*/sec to about 50*/sec, from about 50*/sec to about 100*/sec, or from about 10*/sec to about 1000*/sec). The character “*” designates the mathematical operation “times.”

In some embodiments, the radiative energy is reflected from a target surface (e.g., exposed surface of at least a portion of the material bed, or exposed surface of at least a portion of a 3D object). The 3D object may be embedded (e.g., buried) in the material bed. FIG. 16 shows an example of a 3D object 1600 that is completely embedded in the material bed 1610. FIG. 14 shows an example of a 3D object 1400 that is partially embedded in the material bed 1410, and includes a portion that protrudes (e.g., sticks out) of the exposed surface 1412 of the material bed by a distance 1413.

In some embodiments, the radiative energy can be detected by an optical detector (e.g., a component of a metrological detection system). The radiative energy can be detected by an imaging device (e.g., camera) and/or by a spectrum analyzer. The controller may vary one or more characteristics of the transforming energy beam based on an output of the sensor. The controller may vary one or more functions (e.g., characteristics) of at least one mechanism involved in the 3D printing (e.g., transforming energy source, scanner, layer dispensing mechanism, or any combination thereof) based on an output of the sensor. The characteristics of the transforming energy beam may comprise power per unit area, speed, cross section, or average footprint on the exposed surface of the material bed. The controller may comprise performing image analysis (e.g., image processing) using the output of the sensor (e.g., optical sensor, and/or imaging device), to provide a result. The image analysis may be conducted by a non-transitory computer readable medium. The radiative energy may be sensed (e.g., imaged) from one or more angles (e.g., sequentially, simultaneously, or at random). The result may be used in the control of at least one functions of the 3D printing (e.g., altering the transforming energy beam (e.g., to alter the at least one of its characteristics)), and/or altering at least one mechanism associated with the transforming energy beam. The mechanism associated with the transforming energy beam may be an optical mechanism (e.g., comprising a scanner, lens, or a mirror), and/or an energy source. The result may be used in evaluating one or more positions at the target surface. The result may be used in evaluating the height at various positions of the target surface. The height may be relative to a known height (e.g., height baseline, or predetermined height), to the build platform, the floor of the processing chamber, or to other positions within the 3D object or within the target surface. The result may be used in the evaluation of the deviation from planarity of the target surface. The result may provide a vertical and/or horizontal height profile of the target surface. The result may provide a height and/or planarity profile of the target surface. The resolution of the height and/or planarity profile may correspond to the FLS of a cross section of the sensing energy beam, or the FLS of a footprint of the sensing energy beam on the target surface. The resolution of the height and/or planarity profile may correspond to the sensor resolution. The resolution of the height and/or planarity profile may correspond to the FLS of a cross section of the transforming energy beam, or the FLS of a footprint of the transforming energy beam on the target surface.

In some embodiments, the radiative energy beam sensed by the metrology (e.g., position) sensor is the reflection of the transforming energy beam from the target surface. In some examples, the radiative energy sensed by the metrology sensor is an energy beam different from a reflection of the transforming energy beam. For example, the radiative energy may reflect the sensing energy beam from the target surface. The detector (e.g., FIG. 3, 318) may be coupled to the controller. For example, the detector (e.g., FIG. 3, 318) may be coupled to the computer (e.g., through a communication channel). The controller may analyze the signal detected by the detector. The output of the detector may be considered by the systems, software, and/or apparatuses (e.g., by the controller) to direct alteration of at least one function of the 3D printing as a result of an analysis of the detector output. The at least one function may include at least one characteristic of the transforming energy beam.

In some embodiments, the optical detector (e.g., temperature detector) comprises an optical setup. The optical setup may comprise a lens arrangement. The optical setup may comprise a beam splitter. The detector may comprise a focusing lens. The detector may view (e.g., detect) a focused point (e.g., of the exposed surface of the material bed). The optical setup may be the same optical setup used by the transforming energy beam (e.g., through which the transforming energy beam travels). The optical setup may be different from the optical setup used by the transforming energy beam. The sensing (e.g. and detecting) energy beam and the transforming energy beam may be confocal. The sensing energy beam and the transforming energy beam may travel in different paths. The sensing energy beam and transforming energy beam may travel through the same different optical windows. The sensing energy beam and the transforming energy beam may be translated by the same or by different scanners. For example, the transforming energy beam may be translated by a first scanner, and the sensing energy beam may be translated by a second scanner, wherein the second scanner tracks (e.g., chases) the first energy beam. The detector (e.g., optical detector) may control (e.g., monitor and/or regulate) the reflected energy from the target surface (e.g., exposed surface of the material bed). The detector energy beam (e.g., the reflected sensing energy beam from the target surface) may be coaxial or non-coaxial with a reflection of the transforming energy beam. The detected energy beam that is reflected from the target surface (e.g., from the exposed surface of the material bed and/or forming layer of hardened material) may be used to image these respective exposed surfaces.

In some embodiments, the optical sensor is used for temperature measurements and/or for metrological measurements. The temperature sensor and/or positional sensor may comprise the optical sensor. The optical sensor may include an analogue device (e.g., CCD). The optical sensor may include a p-doped metal-oxide-semiconductor (MOS) capacitor, charge-coupled device (CCD), active-pixel sensor (APS), micro/nano-electro-mechanical-system (MEMS/NEMS) based sensor, or any combination thereof. The APS may be a complementary metal-oxide-semiconductor (CMOS) sensor. The MEMS/NEMS sensor may include a MEMS/NEMS inertial sensor. The MEMS/NEMS sensor may be based on silicon, polymer, metal, ceramics, or any combination thereof. The optical sensor may comprise laser scanner, or an interferometer. The interferometer may comprise a coherent (e.g., white) light, or partial coherence interferometer. The temperature sensor (e.g., thermal sensor) may sense an IR radiation (e.g., photons). The thermal sensor may sense a temperature of at least one melt pool. The metrology sensor may comprise a sensor that measures the FLS (e.g., depth) of at least one melt pool. The transforming energy beam and the sensing energy beam (e.g., thermal sensor beam and/or metrology sensor energy beam) may be focused on (e.g., substantially) the same position. The transforming energy beam and the sensing energy beam (e.g., thermal sensor beam and/or metrology sensor energy beam) may be confocal.

The methods, systems, software, and/or apparatuses described herein may consider (e.g., by at least one controller) sensor signals from at least a portion of the surface (e.g., of the exposed material bed, and/or of the protruding 3D object from the material bed). The signals may correspond to positional signals. The positions may include vertical, horizontal, and/or angular positions. The signals may correspond to height and/or lateral differences of corresponding surface positions.

In some embodiments, the methods, systems, apparatuses, and/or software described herein may consider at least one or more sensor measurements. As a consequence of the measurements, the controller may direct alteration of one or more functions of the 3D printing process (e.g., of the transforming energy beam). The direction may include the use of a software that is coupled to the sensor through a first communication channel. The software may be coupled to at least one function of the 3D printer through a second communication channel. The first and second communication channels may be the same communication channel or different communication channels.

In some embodiments, the methods, systems, apparatuses, and/or software described herein may consider at least one or more temperature sensor measurements. As a consequence of the temperature measurements, the controller may direct alteration of one or more functions of the 3D printing process (e.g., of the transforming energy beam). The temperature measurements may comprise temperature measurements of the surface (e.g., target surface. e.g., exposed surface of the material bed, and/or of the 3D object). The temperature measurements may include contact or non-contact temperature measurements. The controller may consider both the positional sensor measurements and the temperature sensor measurements. As a consequence of the temperature measurements, one or more functions of the 3D printing process (e.g., of the transforming energy beam) may be altered (e.g., directed by the controller). The temperature measurements may comprise temperature measurements of one or more positions of the surface.

In some embodiments, the methods, systems, software, and/or apparatuses described herein may consider at least one or more measurements of the transforming energy beam. The measurements may comprise measuring the cross section of the energy beam (e.g., in a direction perpendicular to its propagation), footprint on the exposed surface of the material bed, energy flux, energy per unit area, dwell time, delay time (e.g., beam off time), pulsing beam frequency, wavelength, or velocity at which the transforming energy beam travels on the exposed surface of the material bed. The measurements may comprise measuring the path (e.g., hatch) spacing of the transforming energy beam path traveled on the target surface (e.g., exposed surface of the material bed). For example, the controller may consider at least one or more measurements of the transforming energy beam characteristics. As a consequence of the transforming energy beam characteristics measurement(s), the controller may direct alteration of one or more functions of the 3D printing process (e.g., of and/or associated with the transforming energy beam). The controller may consider two or more of (i) positional sensor measurements, (ii) temperature sensor measurements, (iii) energy-source power measurement, and (iv) measurement of at least one characteristic of the transforming energy beam. For example, the methods, systems, software and/or apparatuses may consider both the positional sensor measurements and the transforming energy beam characteristics measurements. As a consequence of the transforming energy beam characteristics measurements, one or more functions of the 3D printing process (e.g., of the and/or associated with the transforming energy beam) may be altered. The alteration may be directed by the controller. For example, the alteration may be using a software. For example, the alteration may be through a communication channel.

The methods, systems, apparatuses, and/or software described herein may control (e.g., regulate) the deformation of at least a portion of the 3D object by controlling at least one function of the 3D printing (e.g., at least one characteristic of the transforming energy beam and/or its energy source) while measuring a position of the surface and/or while measuring the temperature of the surface. The control may be during the formation of the 3D object. The control may be during the 3D printing process. The control may be real-time control. The control may be in situ control. The control may be at least during the transforming operation. The control may be at least during the hardening of the transformed material. The control may be at least during the formation of a hardened layer (or a portion thereof) as part of the 3D object.

In some embodiments, the material (e.g., pre-transformed material, transformed material, or hardened material) comprises elemental metal, metal alloy, ceramics, or an allotrope of elemental carbon. In some embodiments, the deposited pre-transformed material within the enclosure comprises a liquid material, semi-solid material (e.g., gel), or a solid material (e.g., powder). The deposited pre-transformed material within the enclosure can be in the form of a powder, wires, sheets, or droplets. The allotrope of elemental carbon may comprise amorphous carbon, graphite, graphene, diamond, amorphous carbon, carbon fiber, carbon nanotube, or fullerene. The fullerene may be selected from the group consisting of a spherical, elliptical, linear, and tubular fullerene. The fullerene may comprise a buckyball or a carbon nanotube. The ceramic material may comprise cement. The ceramic material may comprise alumina, zirconia, or carbide (e.g., silicon carbide, or tungsten carbide). The ceramic material may include high performance material (HPM). The ceramic material may include a nitride (e.g., boron nitride or aluminum nitride). The material may comprise sand, glass, or stone. In some embodiments, the material may comprise an organic material, for example, a polymer or a resin (e.g., 114 W resin). The organic material may comprise a hydrocarbon. The polymer may comprise styrene or nylon (e.g., nylon 11). The polymer may comprise a thermoplast. The organic material may comprise carbon and hydrogen atoms. The organic material may comprise carbon and oxygen atoms. The organic material may comprise carbon and nitrogen atoms. The organic material may comprise carbon and sulfur atoms. In some embodiments, the material may exclude an organic material. The material may comprise a solid or a liquid. In some embodiments, the material may comprise a silicon-based material, for example, silicon-based polymer or a resin. The material may comprise an organosilicon-based material. The material may comprise silicon and hydrogen atoms, silicon and carbon atoms, or any combination thereof. In some embodiments, the material may exclude a silicon-based material. The material may comprise a particulate material. The particulate material may comprise solid or semi-solid (e.g., gel). The particulate material may comprise powder. The powder material may comprise a solid. The powder material may be coated by a coating (e.g., organic coating such as the organic material (e.g., plastic coating)). The material may be devoid of organic material. In some examples, the material may not be coated by organic and/or silicon-based materials. The liquid material may be compartmentalized into reactors, vesicles, or droplets. The compartmentalized material may be compartmentalized in one or more layers. The material may be a composite material comprising a secondary material. The secondary material can be a reinforcing material (e.g., a material that forms a fiber). The reinforcing material may comprise a carbon fiber, Kevlar®, Twaron®, ultra-high-molecular-weight polyethylene, or glass fiber. The material can comprise powder (e.g., granular material, pulverous material) and/or wires. The bound material can comprise chemical bonding. Transforming can comprise chemical bonding. Chemical bonding can comprise covalent bonding. The pre-transformed material may be pulverous. The printed 3D object can be made of a single material (e.g., single material type) or a plurality of materials (e.g., a plurality of material types). Sometimes one portion of the 3D object and/or of the material bed may comprise one material, and another portion may comprise a second material different from the first material. The material may be a single material type (e.g., a single alloy or a single elemental metal). The material may comprise one or more material types. For example, the material may comprise two alloys, an alloy and an elemental metal, an alloy and a ceramic, or an alloy and an elemental carbon. The material may comprise an alloy and alloying elements (e.g., for inoculation). The material may comprise blends of material types. The material may comprise blends with elemental metal or with metal alloy. The material may comprise blends excluding (e.g., without) elemental metal or including (e.g., with) metal alloy. The material may comprise a stainless steel. The material may comprise a titanium alloy, aluminum alloy, and/or nickel alloy.

In some embodiments, the pre-transformed material comprises a powder material. The pre-transformed material may comprise a solid material. The pre-transformed material may comprise one or more particles or clusters. The term “powder,” as used herein, generally refers to a solid having fine particles. Powders may be granular materials. The powder particles may comprise micro particles. The powder particles may comprise nanoparticles. In some examples, a powder comprising particles having an average FLS of at least about 5 nanometers (nm), 10 nm, 20 nm, 30 nm, 40 nm, 50 nm, 100 nm, 200 nm, 300 nm, 400 nm, 500 nm, 1 μm, 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, or 100 μm. The particles comprising the powder may have an average FLS of at most about 100 μm, 80 μm, 75 μm, 70 μm, 65 μm, 60 μm, 55 μm, 50 μm, 45 μm, 40 μm, 35 μm, 30 μm, 25 μm, 20 μm, 15 μm, 10 μm, 5 μm, 1 μm, 500 nm, 400 nm, 300 nm, 200 nm, 100 nm, 50 nm, 40 nm, 30 nm, 20 nm, 10 nm, or 5 nm. In some cases, the powder may have an average fundamental length scale between any of the values of the average particle fundamental length scale listed above (e.g., from about 5 nm to about 100 μm, from about 1 μm to about 100 μm, from about 15 μm to about 45 μm, from about 5 μm to about 80 μm, from about 20 μm to about 80 μm, or from about 500 nm to about 50 μm). The powder can be composed of individual particles. The individual particles can be spherical, oval, prismatic, cubic, wires, or irregularly shaped. The particles can have a FLS. The powder can be composed of a homogenously shaped particle mixture such that all of the particles have (e.g., substantially) the same shape and FLS magnitude within at most 1%, 5%, 8%, 10%, 15%, 20%, 25%, 30%, 35%, 40%, 50%, 60%, or 70%, distribution of FLS. In some cases, the powder can be a heterogeneous mixture such that the particles have variable shape and/or FLS magnitude.

In some embodiments, at least a portion of the layer can be transformed to a transformed material (e.g., using an energy beam) that may subsequently form at least a fraction (also used herein “a portion,” or “a part”) of a hardened (e.g., solidified) 3D object. At times a layer of transformed or hardened material may comprise a cross section of a 3D object (e.g., a horizontal cross section). The layer may correspond to a cross section of a requested 3D object. At times a layer of transformed or hardened material may comprise a deviation from a cross section of a model of a requested 3D object. The deviation may include vertical and/or horizontal deviation. A pre-transformed material may be a powder material. In some embodiments, the pre-transformed material is deposited above a build platform in (e.g., planar) one or more planar layers. A pre-transformed material layer (or a portion thereof) can have a thickness (e.g., layer height) of at least about 0.1 micrometer (μm), 0.5 μm, 1.0 μm, 10 μm, 50 μm, 100 μm, 150 μm, 200 μm, 300 μm, 400 μm, 500 μm, 600 μm, 700 μm, 800 μm, 900 μm, or 1000 μm. A pre-transformed material layer (or a portion thereof) can have a thickness of at most about 1000 μm, 900 μm, 800 μm, 700 μm, 600 μm, 500 μm, 450 μm, 400 μm, 350 μm, 300 μm, 250 μm, 200 μm, 150 μm, 100 μm, 75 μm, 50 μm, 40 μm, 30 μm, 20 μm, 10 μm, 5 μm, 1 μm, or 0.5 μm. A pre-transformed material layer (or a portion thereof) may have any value in between the afore-mentioned layer thickness values (e.g., from about 1000 μm to about 0.1 μm, 800 μm to about 1 μm, from about 600 μm to about 20 μm, from about 300 μm to about 30 μm, or from about 1000 μm to about 10 μm). At times, the controller directs adjustment of the thickness (e.g., height), for example, FIG. 15, the distance from surface 1512 to surface 1514, of a layer of pre-transformed material (e.g., that is disposed to form the material bed). The material composition of at least one layer within the material bed may differ from the material composition within at least one other layer in the material bed. The difference (e.g., variation) may comprise difference in crystal or grain structure. The variation may comprise variation in grain orientation, material density, degree of compound segregation to grain boundaries, degree of element segregation to grain boundaries, material phase, metallurgical phase, material porosity, crystal phase, or crystal structure. The microstructure of the printed object may comprise planar structure, cellular structure, columnar dendritic structure, or equiaxed dendritic structure. The controller may direct formation of a certain type of metallurgical microstructure to be (e.g., predominantly) formed during the 3D printing. The systems, apparatuses, and/or methods may form a requested metallurgical structure during (e.g., a specific stage of) the 3D printing.

In some embodiments, the pre-transformed material in one or more layers of the material bed, differs from the pre-transformed material in a different one or more layers of the material bed. For example, the pre-transformed materials of at least one layer in the material bed may differ in the FLS of its particles (e.g., powder particles) from the FLS of the pre-transformed material within at least one other layer in the material bed. For example, the pre-transformed materials of at least one layer in the material bed may differ in material type and/or composition from the material type and/or composition (respectively) of the pre-transformed material within at least one other layer in the material bed. A layer may comprise two or more material types at any combination. For example, two or more elemental metals, two or more metal alloys, two or more ceramics, two or more allotropes of elemental carbon. For example, an elemental metal and a metal alloy, an elemental metal and a ceramic, an elemental metal and an allotrope of elemental carbon, a metal alloy and a ceramic, a metal alloy and an allotrope of elemental carbon, or a ceramic and an allotrope of elemental carbon. All the layers of pre-transformed material deposited during the 3D printing process may be of (e.g., substantially) the same material type and/or composition. In some instances, a metal alloy is formed in situ during the process of transforming at least a portion of the material bed. In some instances, a metal alloy is not formed in situ during the process of transforming at least a portion of the material bed. In some instances, a metal alloy is formed prior to the process of transforming at least a portion of the material bed. In a plurality (e.g., mixture) of pre-transformed (e.g., powder) materials, one pre-transformed material may be used as support (i.e., supportive powder), as an insulator, as a cooling member (e.g., heat sink), or as any combination thereof.

In some instances, adjacent components in the material bed are separated from one another by one or more intervening layers. In an example, a first layer is adjacent to a second layer when the first layer is in direct contact with the second layer. In another example, a first layer is adjacent to a second layer when the first layer is separated from the second layer by at least one layer (e.g., a third layer). The intervening layer may be of any layer size.

In some embodiments, the pre-transformed material (e.g., powder material) is chosen such that the material is (or forms in situ) the requested and/or otherwise predetermined material for the 3D object. A layer of the 3D object may comprise a single type of material. For example, a layer of the 3D object may comprise a single elemental metal type, or a single alloy type. In some examples, a layer within the 3D object may include several types of material (e.g., an elemental metal and an alloy, an alloy and a ceramic, or an alloy and/or an allotrope of elemental carbon). In certain embodiments, each type of material comprises only a single member of that type. For example: a single member of elemental metal (e.g., iron), a single member of metal alloy (e.g., stainless steel), a single member of ceramic material (e.g., silicon carbide or tungsten carbide), or a single member (e.g., an allotrope) of elemental carbon (e.g., graphite). In some cases, a layer of the 3D object comprises more than one type of material. In some cases, a layer of the 3D object comprises more than one member of a material type.

In some embodiments, the elemental metal comprises an alkali metal, an alkaline earth metal, a transition metal, a rare-earth element metal, or another metal. The alkali metal can be Lithium, Sodium. Potassium, Rubidium. Cesium, or Francium. The alkali earth metal can be Beryllium, Magnesium, Calcium, Strontium, Barium, or Radium. The transition metal can be Scandium, Titanium, Vanadium, Chromium, Manganese, Iron, Cobalt, Nickel, Copper. Zinc, Yttrium, Zirconium, Platinum, Gold, Rutherfordium, Dubnium, Seaborgium, Bohrium, Hassium, Meitnerium, Ununbium, Niobium, Iridium, Molybdenum, Technetium, Ruthenium, Rhodium, Palladium, Silver, Cadmium, Hafnium, Tantalum, Tungsten, Rhenium, or Osmium. The transition metal can be mercury. The rare-earth metal can be a lanthanide, or an actinide. The lanthanide metal can be Lanthanum, Cerium. Praseodymium. Neodymium, Promethium, Samarium, Europium, Gadolinium, Terbium, Dysprosium, Holmium, Erbium, Thulium, Ytterbium, or Lutetium. The actinide metal can be Actinium, Thorium, Protactinium, Uranium, Neptunium, Plutonium, Americium, Curium, Berkelium, Californium, Einsteinium, Fermium, Mendelevium, Nobelium, or Lawrencium. The other metal can be Aluminum, Gallium, Indium, Tin, Thallium, Lead, or Bismuth.

In some embodiments, the metal alloy comprises an iron-based alloy, nickel-based alloy, cobalt-based alloy, chrome-based alloy, cobalt chrome-based alloy, titanium-based alloy, magnesium-based alloy, copper-based alloy, or any combination thereof. The alloy may comprise an oxidation or corrosion resistant alloy. The alloy may comprise a super alloy (e.g., Inconel). The super alloy may comprise Inconel. For example, the super alloy may comprise Inconel 600, 617, 625, 690, 718, or X-750. The nickel base alloy may comprise MAR-246. The metal (e.g., alloy or elemental) may comprise an alloy used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The metal (e.g., alloy or elemental) may comprise an alloy used for products comprising, devices, impellers, medical devices (human & veterinary), machinery, cell phones, semiconductor equipment, generators, engines, pistons, electronics (e.g., circuits), electronic equipment, agriculture equipment, motor, gear, transmission, communication equipment, computing equipment (e.g., laptop, cell phone, i-pad), air conditioning, generators, furniture, musical equipment, art, jewelry, cooking equipment, or sport gear. The metal (e.g., alloy or elemental) may comprise an alloy used for products for human and/or veterinary applications comprising implants, or prosthetics. The metal alloy may comprise an alloy used for applications in the fields comprising human and/or veterinary surgery, implants (e.g., dental), or prosthetics. The metal (e.g., alloy or elemental) may comprise an alloy used for products comprising a rotating part. The rotating part may be of a centrifugal pump, compressor, or other machine designed to move a fluid (e.g., fuel) by rotation.

In some embodiments, the alloy comprises a superalloy. The alloy may comprise a high-performance alloy. The alloy may comprise an alloy exhibiting excellent mechanical strength, resistance to thermal creep deformation, good surface stability, resistance to corrosion, resistance to oxidation, or any combination thereof. The alloy may comprise a face-centered cubic austenitic crystal structure. The alloy may comprise Hastelloy (e.g., Hastelloy-X), Inconel, In718, Ti64, Waspaloy, Rene alloy (e.g., Rene-80, Rene-77, Rene-220, or Rene-41), Haynes alloy (e.g., Haynes 282, Haynes 214), C18150, CA6NM, C22, GRCop-42. F357, Incoloy, MP98T, TMS alloy, MTEK (e.g., MTEK grade MAR-M-247, MAR-M-509, MAR-M-R41, or MAR-M-X-45), or CMSX (e.g., CMSX-3, or CMSX-4). The alloy can be a single crystal alloy.

In some instances, the iron alloy comprises Elinvar, Femico, Ferroalloys, Invar, Iron hydride, Kovar, Spiegeleisen, Staballoy (stainless steel), or Steel. In some instances, the metal alloy is steel. The Ferroalloy may comprise Ferroboron, Ferrocerium, Ferrochrome, Ferromagnesium, Ferromanganese, Ferromolybdenum, Ferronickel, Ferrophosphorus, Ferrosilicon, Ferrotitanium. Ferrouranium, or Ferrovanadium. The iron alloy may comprise cast iron, or pig iron. The steel may comprise Bulat steel, Chromoly, Crucible steel, Damascus steel, Hadfield steel, High speed steel, HSLA steel, Maraging steel, Reynolds 531, Silicon steel, Spring steel, Stainless steel, Tool steel, Weathering steel, or Wootz steel. The high-speed steel may comprise Mushet steel. The steel may comprise M300. The stainless steel may comprise AL-6XN, Alloy 20, celestrium, marine grade stainless, Martensitic stainless steel, surgical stainless steel, or Zeron 100. The tool steel may comprise Silver steel. The steel may comprise stainless steel, Nickel steel, Nickel-chromium steel, Molybdenum steel, Chromium steel, Chromium-vanadium steel, Tungsten steel, Nickel-chromium-molybdenum steel, or Silicon-manganese steel. The steel may be comprised of any Society of Automotive Engineers (SAE) grade steel such as 440F, 410, 312, 430, 440A, 440B, 440C, 304, 305, 304L, 304L, 301, 304LN, 301LN. 2304, 316, 316L. 316LN, 316, 316LN, 316L, 316L, 316, 317L, 2205, 409, 904L, 321, 254SMO, 316Ti, 321H, or 304H. The steel may comprise stainless steel of at least one crystalline structure selected from the group consisting of austenitic, super-austenitic, ferritic, martensitic, duplex, and precipitation-hardening martensitic, or any combination thereof. Duplex stainless steel may comprise lean duplex, standard duplex, super duplex, or hyper duplex. The stainless steel may comprise surgical grade stainless steel (e.g., austenitic 316, martensitic 420, or martensitic 440). The austenitic 316 stainless steel may comprise 316L, or 316LVM. The steel may comprise 17-4 Precipitation Hardening steel (e.g., type 630, a chromium-copper precipitation hardening stainless steel, or 17-4PH steel).

The titanium-based alloy may comprise alpha alloy, near alpha alloy, alpha and beta alloy, or beta alloy. The titanium alloy may comprise grade 1, 2, 2H, 3, 4, 5, 6, 7, 7H, 8, 9, 10, 11, 12, 13, 14, 15, 16, 16H, 17, 18, 19, 20, 21, 2, 23, 24, 25, 26, 26H. 27, 28, 29, 30, 31, 32, 33, 34, 35, 36, 37, 38, or higher. In some instances, the titanium base alloy comprises Ti-6Al-4V or Ti-6Al-7Nb.

The Nickel alloy may comprise Alnico, Alumel, Chromel, Cupronickel, Ferronickel, German silver, Hastelloy, Inconel, Monel metal, Nichrome, Nickel-carbon, Nicrosil, Nisil, Nitinol, or Magnetically “soft” alloys. The magnetically “soft” alloys may comprise Mu-metal, Permalloy, Supermalloy, or Brass. The brass may comprise Nickel hydride, Stainless or Coin silver. The cobalt alloy may comprise Megallium, Stellite (e.g. Talonite), Ultimet, or Vitallium. The chromium alloy may comprise chromium hydroxide, or Nichrome.

The aluminum alloy may comprise AA-8000, Al—Li (aluminum-lithium), Alnico, Duralumin, Hiduminium, Kryron Magnalium, Nambe. Scandium-aluminum, or Y alloy. The magnesium alloy may comprise Elektron, Magnox, or T-Mg-AI-Zn (Bergman phase) alloy.

The copper alloy may comprise Arsenical copper. Beryllium copper, Billon, Brass, Bronze, Constantan, Copper hydride, Copper-tungsten, Corinthian bronze, Cunife, Cupronickel, Cymbal alloys, Devarda's alloy, Electrum, Hepatizon, Heusler alloy, Manganin, Molybdochalkos, Nickel silver, Nordic gold, Shakudo, or Tumbaga. The Brass may comprise Calamine brass, Chinese silver, Dutch metal, Gilding metal, Muntz metal, Pinchbeck, Prince's metal, or Tombac. The Bronze may comprise Aluminum bronze. Arsenical bronze, Bell metal, Florentine bronze, Guanin, Gunmetal, Glucydur, Phosphor bronze, Ormolu, or Speculum metal.

In some examples, the material (e.g., powder material) comprises a material, wherein the constituents of that material (e.g., atoms or molecules) readily lose their outer shell electrons, resulting in a free-flowing cloud of electrons within their otherwise solid arrangement. In some examples the material is characterized in having high electrical conductivity, low electrical resistivity, high thermal conductivity, and/or high density (e.g., as measured at ambient temperature (e.g., R.T., or 20° C.)). The high electrical conductivity can be at least about 1*10⁵ Siemens per meter (S/m), 5*10⁵ S/m, 1*10⁸ S/m, 5*10⁶ S/m, 1*10⁷ S/m, 5*10⁷ S/m, or 1*10⁸ S/m. The symbol “*” designates the mathematical operation “times,” or “multiplied by.” The high electrical conductivity can be any value between the afore-mentioned electrical conductivity values (e.g., from about 1*10⁵ S/m to about 1*10⁸ S/m). The low electrical resistivity may be at most about 1*10⁻⁵ ohm times meter (Ω*m), 5*10⁻⁶ Ω*m, 1*10⁻⁶ Ω*m, 5*10⁻⁷ Ω*m, 1*10⁻⁷ Ω*m, 5*10⁻⁸, or 1*10⁻⁸ Ω*m. The low electrical resistivity can be any value between the afore-mentioned electrical resistivity values (e.g., from about 1×10⁻⁵ Ω*m to about 1×10⁻⁸ Ω*m). The high thermal conductivity may be at least about 20 Watts per meters times degrees Kelvin (W/mK), 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK. 800 W/mK, 900 W/mK, or 1000 W/mK. The high thermal conductivity can be any value between the afore-mentioned thermal conductivity values (e.g., from about 20 W/mK to about 1000 W/mK). The high density may be at least about 1.5 grams per cubic centimeter (g/cm³), 2 g/cm³, 3 g/cm³, 4 g/cm³, 5 g/cm³, 6 g/cm³, 7 g/cm³, 8 g/cm³, 9 g/cm³, 10 g/cm³, 11 g/cm³, 12 g/cm³, 13 g/cm³, 14 g/cm³, 15 g/cm³, 16 g/cm³, 17 g/cm³, 18 g/cm³. 19 g/cm³, 20 g/cm³, or 25 g/cm³. The high density can be any value between the afore-mentioned density values (e.g., from about 1 g/cm³ to about 25 g/cm³).

A metallic material (e.g., elemental metal or metal alloy) can comprise small amounts of non-metallic materials, such as, for example, comprising the elements oxygen, sulfur, or nitrogen. In some cases, the metallic material can comprise the non-metallic material (e.g., and/or elements) in a trace amount. A trace amount can be at most about 100000 parts per million (ppm), 10000 ppm, 1000 ppm, 500 ppm, 400 ppm, 200 ppm, 100 ppm, 50 ppm, 10 ppm, 5 ppm, or 1 ppm (on the basis of weight, w/w) of non-metallic material. A trace amount can comprise at least about 10 ppt, 100 ppt, 1 ppb, 5 ppb, 10 ppb, 50 ppb, 100 ppb, 200 ppb, 400 ppb, 500 ppb, 1000 ppb, 1 ppm, 10 ppm, 100 ppm, 500 ppm, 1000 ppm, or 10000 ppm (based on weight, w/w) of non-metallic material (and/or elements). A trace amount can be any value between the afore-mentioned trace amounts (e.g., from about 10 parts per trillion (ppt) to about 100000 ppm, from about 1 ppb to about 100000 ppm, from about 1 ppm to about 10000 ppm, or from about 1 ppb to about 1000 ppm).

The one or more layers within the 3D object may be (e.g., substantially) planar (e.g., flat). The planarity of the layer may be (e.g., substantially) uniform. The height of the layer at a position may be compared to a plane of that layer having a central tendency (e.g., an average) of planarity. The central tendency of planarity may be defined by a least squares planar fit of the top-most part of the surface of the layer of hardened material. The central tendency of planarity may be calculated by averaging the material height at each point on the top surface of the layer of hardened material. The deviation from any point at the surface of the planar layer of hardened material may be at most 20% 15%, 10%, 5%, 3%, 1%, or 0.5% of the height (e.g., thickness) of the layer of hardened material. The (e.g., substantially) planar one or more layers may have a large radius of curvature. FIG. 7 shows an example of a vertical cross section of a 3D object 712 comprising planar layers (layers numbers 1-4) and non-planar layers (e.g., layers numbers 5-6) that have a radius of curvature. FIGS. 7, 716 and 717 are super-positions of curved layer on a circle 715 having a radius of curvature “r.” The one or more layers may have a radius of curvature (e.g., substantially) equal to the radius of curvature of the layer surface. The radius of curvature may equal infinity (e.g., when the layer is planar). The radius of curvature of the layer surface (e.g., all the layers of the 3D object) may have a value of at least about 0.1 centimeter (cm), 0.2 cm, 0.3 cm, 0.4 cm, 0.5 cm, 0.6 cm, 0.7 cm, 0.8 cm, 0.9 cm, 1 cm, 3 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, or 100 m. The radius of curvature of the layer surface (e.g., all the layers of the 3D object) may have any value between any of the afore-mentioned values of the radius of curvature (e.g., from about 0.1 cm to about 100 m, from about 10 cm to about 90 m, from about 50 cm to about 10 m, from about 5 cm to about 1 m, from about 50 cm to about 5 m, from about 5 cm to infinity, or from about 40 cm to about 50 m). In some examples, the one or more layers may be included in a planar section of the 3D object, or may be a planar 3D object (e.g., a flat plane). In some instances, part of at least one layer within the 3D object may have any of the radii of curvature mentioned herein, which will designate the radius of curvature of that layer portion.

The 3D object may comprise a layering plane N of the layered structure. FIG. 10C shows an example of a 3D object having a layered structure, wherein 1005 shows an example of a side view of a plane, wherein 1001 shows an example of a layering plane. The layering plane may be the average or mean plane of a layer of hardened material (as part of the 3D object). FIG. 8 shows an example of points X and Y on the surface of a 3D object. In some embodiments, X is spaced apart from Y by the auxiliary feature spacing distance (e.g., as described herein). A sphere of radius XY that is centered at X may lack one or more auxiliary supports or one or more auxiliary support marks that are indicative of a presence or removal of the one or more auxiliary support features (e.g., after completion of the 3D printing). An acute angle between the straight line XY and the direction normal to N may be from about 45 degrees to about 90 degrees. The acute angle between the straight line XY and the direction normal to the layering plane may be of the value of the acute angle alpha (e.g., as described herein). When the angle between the straight line XY and the direction of normal to N is greater than 90 degrees, one can consider the complementary acute angle. The layer structure may comprise any material(s) used for 3D printing. A layer of the 3D structure can be made of a single material or of multiple materials. Sometimes one part of the layer may comprise one material, and another part may comprise a second material different than the first material. A layer of the 3D object may be composed of a composite material. The 3D object may be composed of a composite material. The 3D object may comprise a functionally graded material (e.g., comprising a functionally graded microstructure).

In some embodiments, the generated 3D object may be generated with the accuracy of at least about 5 μm, 10 μm. 15 μm. 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 150 μm, 200 μm, 250 μm, 300 μm, 400 μm, 500 μm, 600 μm, 700 μm, 800 μm, 900 μm, 1000 μm, 1100 μm, or 1500 μm, with respect to a model of the 3D object (e.g., the requested 3D object) with respect to the (virtual) model of a requested 3D object. With respect to a model of the 3D object, the generated 3D object may be generated with the accuracy of any accuracy value between the afore-mentioned values (e.g., from about 5 μm to about 100 μm, from about 15 μm to about 35 μm, from about 100 μm to about 1500 μm, from about 5 μm to about 1500 μm, or from about 400 μm to about 600 μm).

The hardened layer of transformed material may deform. The deformation may cause a vertical (e.g., height) and/or horizontal (e.g., width and/or length) deviation from a requested uniformly planar layer. The vertical and/or horizontal deviation of the surface of the layer of hardened material from planarity may be at least about 100 μm, 90 μm, 80 μm, 70 μm, 60 μm, 50 μm, 40 μm, 30 μm, 20 μm, 10 μm, or 5 μm. The horizontal and/or vertical deviation of the surface of the layer of hardened material from planarity may be at most about 100 μm, 90 μm, 80 μm, 70 μm, 60 μm, 50 μm, 40 μm, 30 μm, 20 μm, 10 μm, or 5 μm. The horizontal and/or vertical deviation of the surface of the layer of hardened material from planarity may be any value between the afore-mentioned height deviation values (e.g., from about 100 μm to about 5 μm, from about 50 μm to about 5 μm, from about 30 μm to about 5 μm, or from about 20 μm to about 5 μm). The height uniformity may comprise high precision uniformity. The resolution of the 3D object may be at least about 100 dots per inch (dpi), 300 dpi, 600 dpi, 1200 dpi, 2400 dpi, 3600 dpi, or 4800 dpi. The resolution of the 3D object may be any value between the afore-mentioned values (e.g., from 100 dpi to 4800 dpi, from 300 dpi to 2400 dpi, or from 600 dpi to 4800 dpi). A dot may be a melt pool. A dot may be a step (e.g., layer height). A dot may be a height of the layer of hardened material. A step may have a value of at most the height of the layer of hardened material. The vertical (e.g., height) uniformity of a layer of hardened material may persist across a portion of the layer surface that has a FLS (e.g., a width and/or a length) of at least about 1 mm, 2 mm, 3 mm, 4 mm, 5 mm, or 10 mm; and have a height deviation of at least about 10 mm, 9 mm, 8 mm, 7 mm, 6 mm, 5 mm, 4 mm, 3 mm, 2 mm, 1 mm, 500 μm, 400 μm, 300 μm, 200 μm, 100 μm, 90 μm, 80 μm. 70 μm. 60 μm, 50 μm, 40 μm, 30 μm, 20 μm, or 10 μm, The height uniformity of a layer of hardened material may persist across a portion of the target surface that has a FLS (e.g., a width and/or a length) of any value between the afore-mentioned width and/or length values (e.g., from about 10 mm to about 10 μm, from about 10 mm to about 100 μm, or from about 5 mm to about 500 μm). The target surface may be a layer of hardened material (e.g., as part of the 3D object).

Characteristics of the 3D object (e.g., hardened material) and/or any of its parts (e.g., layer of hardened material) can be measured by any of the following measurement methodologies. For example, the FLS values (e.g., of the width, height uniformity, auxiliary support space, and/or radius of curvature) of the layer of the 3D object and any of its components (e.g., layer of hardened material) may be measured by any of the following measuring methodologies. The measurement methodologies may comprise a microscopy method (e.g., any microscopy method described herein). The measurement methodologies may comprise a coordinate measuring machine (CMM), measuring projector, vision measuring system, and/or a gauge. The gauge can be a gauge distometer (e.g., caliper). The gauge can be a go-no-go gauge. The measurement methodologies may comprise a caliper (e.g., vernier caliper), positive lens, interferometer, or laser (e.g., tracker). The measurement methodologies may comprise a contact or by a non-contact method. The measurement methodologies may comprise one or more sensors (e.g., optical sensors and/or metrological sensors). The measurement methodologies may comprise a metrological measurement device (e.g., using metrological sensor(s)). The measurements may comprise a motor encoder (e.g., rotary, incremental, and/or linear). The measurement methodologies may comprise using an electromagnetic beam (e.g., visible or IR). The microscopy method may comprise ultrasound or nuclear magnetic resonance. The microscopy method may comprise optical microscopy. The microscopy method may comprise electromagnetic, electron, or proximal probe microscopy. The electron microscopy may comprise scanning, tunneling, X-ray photo-, or Auger electron microscopy. The electromagnetic microscopy may comprise confocal, stereoscope, or compound microscopy. The microscopy method may comprise an inverted or non-inverted microscope. The proximal probe microscopy may comprise atomic force, scanning tunneling microscopy, or any other microscopy method. The microscopy measurements may comprise using an image analysis system. The measurements may be conducted at ambient temperatures (e.g., R.T.), melting point temperature (e.g., of the pre-transformed material) or cryogenic temperatures.

The microstructures (e.g., of melt pools) of the 3D object may be measured by a microscopy method (e.g., any microscopy method described herein). The microstructures may be measured by a contact or by a non-contact method. The microstructures may be measured by using an electromagnetic beam (e.g., visible or IR). The microstructure measurements may comprise evaluating the dendritic arm spacing and/or the secondary dendritic arm spacing (e.g., using microscopy). The microscopy measurements may comprise an image analysis system. The measurements may be conducted at ambient temperatures (e.g., R.T.), melting point temperature (e.g., of the pre-transformed material), or cryogenic temperatures.

Various distances relating to the chamber can be measured using any of the measurement techniques. For example, the gap distance (e.g., from the cooling member to the exposed surface of the material bed) may be measured using any of the measurement techniques. For example, the measurements techniques may comprise interferometry and/or confocal chromatic measurements. The measurements techniques may comprise at least one motor encoder (rotary, linear). The measurement techniques may comprise one or more sensors (e.g., optical sensors and/or metrological sensors). The measurement techniques may comprise at least one inductive sensor. The measurement techniques may include an electromagnetic beam (e.g., visible or IR). The measurements may be conducted at ambient temperatures (e.g., R.T.), melting point temperature (e.g., of the pre-transformed material) or cryogenic temperatures.

In some embodiments, the methods described herein provide surface uniformity across the exposed surface of the material bed (e.g., top of a powder bed). For example, the surface uniformity may be such that portions of the exposed surface that comprises the dispensed material, which are separated from one another by a distance of from about 1 mm to about 10 mm, have a vertical (e.g., height) deviation from about 100 μm to about 5 μm. The methods described herein may achieve a deviation from a planar uniformity of the layer of pre-transformed material (e.g., powder) in at least one plane (e.g., horizontal plane) of at most about 20%, 10%, 5%, 2%, 1% or 0.5%, as compared to the average or mean plane (e.g., horizontal plane) created (e.g., formed) at the exposed surface of the material bed (e.g., top of a powder bed) and/or as compared to the build platform (e.g., building platform). The vertical deviation can be measured by using one or more sensors (e.g., optical sensors).

The 3D object can have various surface roughness profiles, which may be suitable for various applications. In some examples, the surface roughness is the deviations in the direction of the normal vector of a real surface (e.g., average, or mean planarity of an exposed surface of the 3D object), from its ideal form. The surface may be the exposed top or bottom surface of a layer of hardened material. The surface may be the exposed top or bottom surface of a ledge of hardened material. The ledge may be (e.g., substantially) planar, or comprising an angle with respect to the platform (e.g., a rising or declining ledge). The surface roughness may be measured as the arithmetic average of the roughness profile (hereinafter “Ra”). The 3D object can have a Ra value of at least about 300 μm, 200 μm, 100 μm, 75 μm, 50 μm, 45 μm, 40 μm, 35 μm, 30 μm, 25 μm, 20 μm, 15 μm, 10 μm, 7 μm, 5 μm, 3 μm, 1 μm, 500 nm, 400 nm, 300 nm, 200 nm, 100 nm, 50 nm, 40 nm, or 30 nm. The formed object can have a Ra value of at most about 300 μm, 200 μm, 100 μm, 75 μm, 50 μm, 45 μm, 40 μm, 35 μm, 30 μm, 25 μm, 20 μm, 15 μm, 10 μm, 7 μm, 5 μm, 3 μm. 1 μm, 500 nm, 400 nm. 300 nm. 200 nm. 100 nm, 50 nm, 40 nm, or 30 nm. The 3D object can have a Ra value between any of the afore-mentioned Ra values (e.g., from about 300 μm to about 50 μm, from about 50 μm to about 5 μm, from about 5 μm to about 300 nm, from about 300 nm to about 30 nm, or from about 300 μm to about 30 nm). The Ra values may be measured by a roughness tester and/or by a microscopy method (e.g., any microscopy method described herein). The measurements may be conducted at ambient temperatures (e.g., R.T.), melting point temperature (e.g., of the pre-transformed material) or cryogenic temperatures. The roughness (e.g., Ra value) may be measured by a contact or by a non-contact method. The roughness measurement may comprise one or more sensors (e.g., optical sensors). The roughness measurement may comprise using a metrological measurement device (e.g., using metrological sensor(s)). The roughness may be measured using an electromagnetic beam (e.g., visible or IR).

The 3D object may be composed of successive layers of solid material that originated from a transformed material (e.g., that subsequently hardened). The successive layers of solid material may correspond to successive cross sections of a requested 3D object (e.g., virtual slices). The transformed material may connect (e.g., weld) to a hardened (e.g., solidified) material. The hardened material may reside within the same layer as the transformed material, or in another layer (e.g., a previous layer). In some examples, the hardened material comprises disconnected parts of the 3D object, that are subsequently connected by newly transformed material (e.g., in a subsequently formed layer). Transforming may comprise fusing, binding or otherwise connecting the pre-transformed material (e.g., connecting the particulate material). Fusing may comprise sintering or melting.

A cross section (e.g., vertical cross section) of the generated (i.e., formed) 3D object may reveal a microstructure or a grain structure indicative of a layered deposition. Without wishing to be bound to theory, the microstructure or grain structure may arise due to the solidification of transformed (e.g., powder) material that is typical to and/or indicative of the 3D printing method. For example, a cross section may reveal a microstructure resembling ripples or waves that are indicative of (e.g., successive) solidified melt pools that may be formed during the 3D printing process. FIGS. 10A and 10B show examples of successive melt pool in a 3D object that are arranged in rows (e.g., layers).

The repetitive layered structure of the solidified melt pools relative to an external plane of the 3D object may reveal the orientation at which the part was printed, as the deposition of the melt pools is in a (e.g., substantially) horizontal plane. FIG. 10C shows examples of 3D objects that are formed by layerwise deposition, which layer orientation with respect to an external plane of the 3D object reveals the orientation of the object during its 3D printing. For example, a 3D object having an external plane 1001 was formed in a manner that both the external plane 1001 and the layers of hardened material (e.g., 1005) were formed (e.g., substantially) parallel to the build platform 1003. For example, a 3D object having an external plane 1002 was formed in a way that the external plane 1002 formed an angle with the build platform 1003, whereas the layers of hardened material (e.g., 1006) were formed (e.g., substantially) parallel to the build platform 1003 (e.g., in accordance with a layerwise deposition technique). The 3D object having an external plane 1004 shows an example of a 3D object that was generated such that its external plane 1004 formed an angle (e.g., alpha) with the build platform 1003; which printed 3D object was placed on the build platform 1003 after its generation was complete (e.g., in its natural orientation); wherein during its generation (e.g., build), the layers of hardened material (e.g., 1007) were oriented (e.g., substantially) parallel to the build platform 1003. The natural orientation is an orientation in which the 3D object would be expected to reside in during everyday use. FIGS. 10A and 10B show 3D objects comprising layers of solidified melt pools that are arranged in layers having layering planes (e.g., 1020).

In some embodiments, the (e.g., vertical and/or horizontal) cross section of the 3D object reveals a (e.g., substantially) repetitive microstructure (or grain structure). The microstructure (or grain structure) may comprise (e.g., substantially) repetitive variations in material composition, grain orientation, material density, degree of compound segregation or of element segregation to grain boundaries, material phase, metallurgical phase, crystal phase, crystal structure, material porosity, or any combination thereof. The microstructure (or grain structure) may comprise (e.g., substantially) repetitive solidification of layered melt pools. (e.g., FIGS. 10A-10B). The (e.g., substantially) repetitive microstructure may have an average height of at least about 0.5 μm, 1 μm, 5 μm, 10 μm, 20 μm, 30 μm, 40 μm. 50 μm. 60 μm, 70 μm, 80 μm, 90 μm, 100 μm, 150 μm, 200 μm, 250 μm, 300 μm, 350 μm, 400 μm, 450 μm, 500 μm, or 1000 μm. The (e.g., substantially) repetitive microstructure may have an average height of at most about 1000 μm, 500 μm, 450 μm, 400 μm, 350 μm, 300 μm, 250 μm, 200 μm, 150 μm, 100 μm, 90 μm, 80 μm, 70 μm, 60 μm, 50 μm, 40 μm, 30 μm, 20 μm, or 10 μm. The (e.g., substantially) repetitive microstructure may have an average height of any value between the afore-mentioned values (e.g., from about 0.5 μm to about 1000 μm, from about 15 μm to about 50 μm, from about 5 μm to about 150 μm, from about 20 μm to about 100 μm, or from about 10 μm to about 80 μm). The microstructure (e.g., melt pool) height may correspond to the height of a layer of hardened material. The layer height can be seen in the example of FIG. 5. FIG. 5 depicts a layer of hardened material 546 with a height that is designated by “h1” in a material bed 542 having an exposed surface 543 and supported by a build module 545. An angle of incidence 510 on the exposed surface 543 of the material bed is utilized to form (e.g., fuse) a portion of the exposed surface 543 to form a top layer 547 of hardened material.

In some examples, the pre-transformed material within the material bed (e.g., that was not transformed to form the 3D object) can be configured to provide support to the 3D object. For example, the supportive pre-transformed material (e.g., powder) may be of the same type of pre-transformed material from which the 3D object is generated, of a different type, or any combination thereof. The pre-transformed material may be a particulate material (e.g., powder). The pre-transformed material may be flowable during at least a portion of the 3D printing (e.g., during the entire 3D printing). The material bed may be at a (e.g., substantially) constant pressure during the 3D printing. The material bed may lack a pressure gradient during the 3D printing. The pre-transformed material within the material bed (e.g., that was not transformed to form the 3D object) can be at an ambient temperature during the 3D printing. The pre-transformed material in any of the layers in the material bed may be flowable. Before, during and/or at the end of the 3D printing process, the pre-transformed material (e.g., powder) that did not transform to form the 3D object may be flowable. The pre-transformed material that did not transform to form the 3D object (or a portion thereof) may be referred to as a “remainder.” In some instances, a low flowability pre-transformed material can be capable of supporting a 3D object better than a high flowability pre-transformed material. A low flowability particulate material can be achieved inter alia with a particulate material composed of relatively small particles, with particles of non-uniform size or with particles that attract each other. The pre-transformed material may be of low, medium, or high flowability. The pre-transformed material may have compressibility of at least about 1%, 2%, 3%, 4%, 5%, 6%, 7%, 8%, 9%, or 10% in response to an applied force of 15 kilo Pascals (kPa). The pre-transformed material may have a compressibility of at most about 9%, 8%, 7%, 6%, 5%, 4.5%, 4.0%, 3.5%, 3.0%, 2.5%, 2.0%, 1.5%, 1.0%, or 0.5% in response to an applied force of 15 kilo Pascals (kPa). The pre-transformed material may have basic flow energy of at least about 100 milli-Joule (mJ), 200 mJ, 300 mJ. 400 mJ, 450 mJ, 500 mJ. 550 mJ, 600 mJ, 650 mJ. 700 mJ, 750 mJ, 800 mJ, or 900 mJ. The pre-transformed material may have basic flow energy of at most about 200 mJ, 300 mJ, 400 mJ, 450 mJ, 500 mJ, 550 mJ. 600 mJ, 650 mJ, 700 mJ. 750 mJ, 800 mJ, 900 mJ, or 1000 mJ. The pre-transformed material may have basic flow energy in between the above listed values of basic flow energy values (e.g., from about 100 mj to about 1000 mJ, from about 100 mj to about 600 mJ, or from about 500 mj to about 1000 mJ). The pre-transformed material may have a specific energy of at least about 1.0 milli-Joule per gram (mJ/g), 1.5 mJ/g, 2.0 mJ/g, 2.5 mJ/g, 3.0 mJ/g, 3.5 mJ/g, 4.0 mJ/g, 4.5 mJ/g, or 5.0 mJ/g. The powder may have a specific energy of at most 5.0 mJ/g, 4.5 mJ/g, 4.0 mJ/g, 3.5 mJ/g, 3.0 mJ/g, 2.5 mJ/g, 2.0 mJ/g, 1.5 mJ/g, or 1.0 mJ/g. The pre-transformed material may have a specific energy in between any of the above values of specific energy (e.g., from about 1.0 mJ/g to about 5.0 mJ/g, from about 3.0 mJ/g to about 5 mJ/g, or from about 1.0 mJ/g to about 3.5 mJ/g).

In some embodiments, during its formation (e.g., layerwise generation), the 3D object has one or more auxiliary features. In some embodiments, during its formation (e.g., layerwise generation), the 3D object is devoid of any auxiliary features. The auxiliary feature(s) can be supported by the material (e.g., powder) bed and/or by the enclosure. In some instances, the auxiliary supports may connect (e.g., anchor) to the enclosure (e.g., the build platform). In some instances, the auxiliary supports may not connect (e.g., not be anchored) to the enclosure (e.g., the build platform). In some instances, the auxiliary supports may not connect to the enclosure, but contact the enclosure. The 3D object comprising one or more auxiliary supports, or devoid of auxiliary support, may be suspended (e.g., float anchorlessly) in the material bed. The floating 3D object (with or without the one or more auxiliary supports) may contact the enclosure.

The term “auxiliary feature,” or “auxiliary support” as used herein, generally refers to a feature that is part of a printed 3D object, but is not part of the requested, intended, designed, ordered, modeled, requested or final 3D object delivered to the requesting entity. Auxiliary feature(s) (e.g., auxiliary supports) may provide structural support during and/or subsequent to the formation of the 3D object. Auxiliary feature(s) may enable the removal of energy from the 3D object while it is being formed. Examples of an auxiliary feature comprise (heat) fin, wire, anchor, handle, support, pillar, column, frame, footing, scaffold, flange, projection, protrusion, mold, platform (e.g., base), or any other stabilization feature. In some instances, the auxiliary support is a scaffold that encloses the 3D object or part thereof. The scaffold may comprise lightly sintered or lightly fused pre-transformed material. The scaffold may comprise a continuously sintered (e.g., lightly sintered) structure that spans at most about 1 millimeter (mm), 2 mm, 5 mm or 10 mm. The scaffold may comprise a continuously sintered structure that spans at least about 1 millimeter (mm), 2 mm, 5 mm or 10 mm. The scaffold may comprise a continuously sintered structure having a FLS between any of the afore-mentioned dimensions (e.g., from about 1 mm to about 10 mm, or from about 1 mm to about 5 mm). In some examples, the 3D object may be printed without a supporting scaffold. The supporting scaffold may engulf at least a portion of the 3D object (e.g., the entire 3D object). For example, a supporting scaffold that floats anchorlessly in the material bed, or that is connected to at least a portion of the enclosure. The supporting scaffold may comprise a dense arrangement (e.g., array) of support structures. The support(s) or support mark(s) can stem from or appear on the surface of the 3D object. The auxiliary supports or support marks can stem from or appear on an external surface and/or on an internal surface (e.g., a cavity within the 3D object). The 3D object can have auxiliary features that are supported by the material bed (e.g., powder bed) and not touch the base, substrate, container accommodating the material bed, and/or the bottom of the enclosure. The 3D part (3D object) in a complete or partially formed state, can be completely supported by the material bed (e.g., without being anchored to the substrate, base, container accommodating the powder bed, or otherwise to the enclosure). The 3D object in a complete or partially formed state can be (completely) supported by the material bed (e.g., without touching anything except the material constituting the material bed). The 3D object in a complete or partially formed state can be suspended anchorlessly in the material bed without resting on any additional support structures. In some cases, the 3D object in a complete or partially formed state can freely float (e.g., anchorlessly) in the material bed (e.g., during at least a portion of the 3D printing (e.g., during the entire 3D printing)). Suspended may comprise floating, disconnected, anchorless, detached, non-adhered, or free. In some examples, the 3D object may not be anchored (e.g., connected) to at least a part of the enclosure (e.g., during formation of the 3D object, and/or during formation of at least one layer of the 3D object). The enclosure may comprise a build platform or wall that define the material bed. The 3D object may not touch and/or not contact enclosure (e.g., during formation of at least one layer of the 3D object).

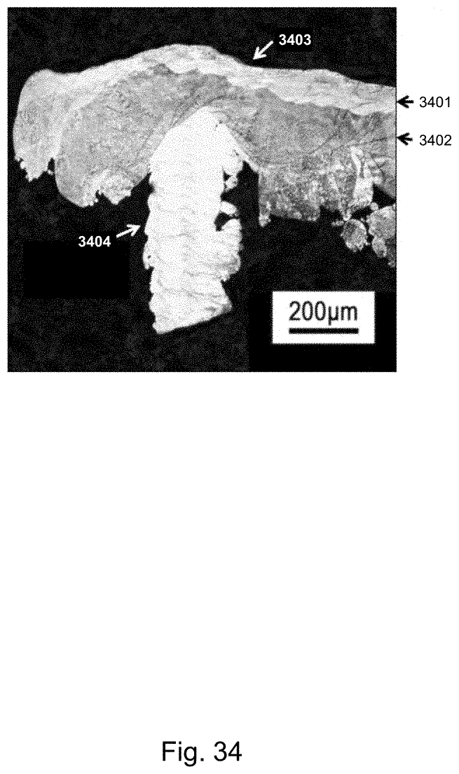

The printed 3D object may be printed without the use of auxiliary features, may be printed using a reduced number of auxiliary features, or printed using spaced apart auxiliary features. In some embodiments, the printed 3D object may be devoid of (one or more) auxiliary support features or auxiliary support feature marks that are indicative of a (e.g., prior) presence and/or removal of the auxiliary support feature(s). The 3D object may be devoid of one or more auxiliary support features and of one or more marks of an auxiliary feature (including a base structure) that was removed (e.g., subsequent to, or contemporaneous with, the generation of the 3D object). The printed 3D object may comprise a single auxiliary support mark. The single auxiliary feature (e.g., auxiliary support or auxiliary structure) may be a platform (e.g., a building platform such as a base or substrate), or a mold. The auxiliary support may adhere to the build platform and/or mold. The 3D object may comprise marks belonging to one or more (e.g., previously present) auxiliary structures. The 3D object may comprise two or more marks belonging to auxiliary feature(s). The 3D object may be devoid of marks pertaining to at least one auxiliary support. The 3D object may be devoid of one or more auxiliary support. The mark may comprise variation in grain orientation, variation in layering orientation, layering thickness, material density, the degree of compound segregation to grain boundaries, material porosity, the degree of element segregation to grain boundaries, material phase, metallurgical phase, crystal phase, crystal structure, or any combination thereof; wherein the variation may not have been created by the geometry of the 3D object alone, and may thus be indicative of a prior existing auxiliary support that was removed. The variation may be forced upon the generated 3D object by the geometry of the support. In some instances, the 3D structure of the printed object may be forced by the auxiliary support(s) (e.g., by a mold). For example, a mark may be a point and/or area of discontinuity that is not explained by the geometry of the 3D object, which does not include any auxiliary support(s). The point and/or area of discontinuity may arise form a (e.g., mechanical and/or optical) trimming of the auxiliary support(s). FIG. 34 shows an example of a vertical cross section of 3D object comprising two (e.g., substantially) horizontal layers (e.g., 3401 and 3402), and a vertical auxiliary support that comprises an area of discontinuity 3404 and introduces a geometrical deformation (e.g., 3403) in layers 3401 and 3402 which is caused by the presence of auxiliary support, and cannot be otherwise explained (and thus indicates its presence). A mark may be a surface feature that cannot be explained by the geometry of a 3D object, if it did not include any auxiliary support(s) (e.g., a mold). The two or more auxiliary features or auxiliary support feature marks may be spaced apart by a spacing distance (e.g., XY) of at least 1.5 millimeters (mm), 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm, 20 mm, 20.5 mm, 21 mm, 25 mm, 30 mm, 30.5 mm, 31 mm, 35 mm, 40 mm, 40.5 mm, 41 mm, 45 mm, 50 mm, 80 mm, 100 mm, 200 mm 300 mm, or 500 mm. The two or more auxiliary support features or auxiliary support feature marks may be spaced apart by a spacing distance of any value between the afore-mentioned auxiliary support space values (e.g., from 1.5 mm to 500 mm, from 2 mm to 100 mm, from 15 mm to 50 mm, or from 45 mm to 200 mm). This distance is collectively referred to herein as the “auxiliary feature spacing distance.”

The 3D object may comprise an impeller such as, for example, a shrouded (e.g., covered) impeller that is produced as one piece (e.g., comprising blades and cover) during one 3D printing process. The impeller may be used for pumps (e.g., turbo pumps). The 3D object may comprise a turbine, stator, motor, or rotor. The 3D object may comprise a blade (e.g., 3D plane) that is formed in the material bed such that at least one blade (e.g., all blades) is (e.g., substantially) parallel (e.g., completely parallel, or almost parallel), or at an angle of at most about 10°, 20°, 30°, 40°, 45°, or 90° with respect to the build platform during the formation of the 3D object. The 3D object may comprise a blade (e.g., 3D plane) that is formed in the material bed such that the blade is at any angle between the afore-mentioned angles (e.g., from about 0° to about 10°, from about 0° to about 20°, from about 0° to about 30°, from about 0° to about 40°, from about 0° to about 45°, or from about 0° to about 90° with respect to the build platform) during the formation of the 3D object. The 3D object may comprise a blade (e.g., 3D plane) that is formed in the material bed such that the blade is (e.g., substantially) perpendicular (e.g., completely perpendicular, or almost perpendicular) or at an angle of at most 80°, 70°, 60°, 50°, or 0° with respect to the rotational axis of the 3D object (e.g., when the 3D object is an impeller, turbine, stator, motor, or rotor). The 3D object may comprise a blade (e.g., 3D plane) that is formed in the material bed such that the blade is at any angle between the afore-mentioned angles (e.g., from about 90° to about 80°, from about 90° to about 70°, from about 90° to about 60°, from about 90° to about 50°, from about 90° to about 0°, with respect to the rotational axis of the 3D object). In some examples, the hanging structure (e.g., blade) does not comprise auxiliary support (e.g., except for the rotational axis). In some examples, the hanging structure (e.g., blade) comprises at least one auxiliary support, wherein the distance between every two auxiliary supports, or a distance between an auxiliary support and the rotational axis, is of a value equating the auxiliary feature spacing distance (e.g., disclosed herein). The 3D object may comprise a complex internal structure. The 3D object may comprise a plurality of blades. A distance between two blades may be at most about 0.1 mm, 0.2 mm, 0.5 mm, 1 mm, 2 mm, 3 mm, 4 mm, 5 mm, 6 mm, 7 mm, 8 mm, 10 mm, 20 mm, 50 mm, or 100 mm. A distance between two blades may be any value between the afore-mentioned values (e.g., from about 0.1 mm to about 100 mm, from about 0.1 mm to about 5 mm, from about 0.1 mm to about 10 mm, from about 0.1 mm to about 50 mm, or from about 10 mm to about 100 mm). The distance between the blades may refer to a vertical distance. The distance between the blades may constitute an atmospheric gap.

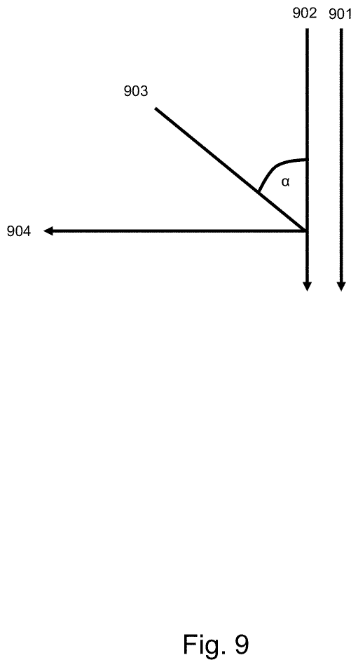

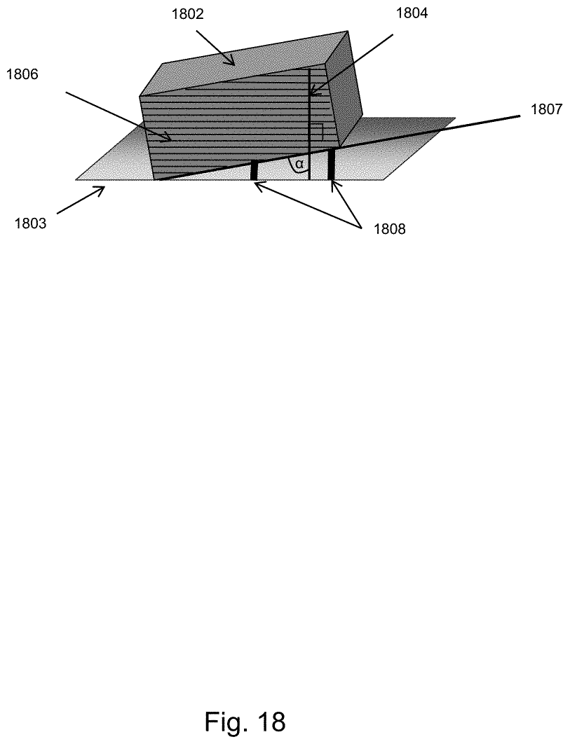

FIG. 9 shows an example of a coordinate system. Line 904 represents a vertical cross section of a layering plane. Line 903 represents the (e.g., shortest) straight line connecting the two auxiliary supports or auxiliary support marks. Line 902 represent the normal to the layering plane. Line 901 represents the direction of the gravitational field. The acute (i.e., sharp) angle alpha between the straight (e.g., shortest) line connecting the two auxiliary supports or auxiliary support marks and the direction of normal to the layering plane may be at least about 45 degrees (°), 50°, 55°, 60°, 65°, 70°, 75°, 80°, or 85°. The acute angle alpha between the straight line connecting the two auxiliary supports or auxiliary support marks and the direction of normal to the layering plane may be at most about 90°, 85°, 80°, 75°, 70°, 65°, 60°, 55°, 50°, or 45°. The acute angle alpha between the straight line connecting the two auxiliary supports or auxiliary support marks and the direction of normal to the layering plane may be any angle range between the afore-mentioned angles (e.g., from about 45 degrees (°), to about 90°, from about 60° to about 90°, from about 75° to about 90°, from about 80° to about 90°, or from about 85° to about 90°). FIG. 18 shows an example of a 3D object comprising successive layers of material. Each of the layers has a (e.g., average) layering plane (e.g., 1806). The layering planes may be (e.g., substantially) parallel to each other. The 3D object has a top surface 1802, and is disposed above (e.g., and on) a build platform 1803. The 3D object comprises two auxiliary supports 1808. The 3D object comprises an external (e.g., bottom) surface to which the auxiliary supports 1808 are connected. The shortest distance between the two auxiliary supports resides on line 1807. The line 1807 forms an acute angle alpha with the normal 1804 to the layering plane (e.g., 1806). The acute angle alpha between the shortest line connecting the two auxiliary supports (or auxiliary support marks) and the direction normal to the layering plane may be from about 87° to about 90°. An example of a layering plane can be seen in FIG. 7 showing a vertical cross section of a 3D object 711 that comprises layers 1 to 6, each of which is (e.g., substantially) planar. In the schematic example in FIG. 7, the layering plane of the layers can be the layer. For example, layer 1 could correspond to both the layer and the layering plane of layer 1. When the layer is not planar (e.g., FIG. 7, layer 5 of 3D object 712), the layering plane would be the average or mean plane of the layer. The two auxiliary supports, or auxiliary support feature marks can be on the same surface (e.g., external surface of the 3D object). The same surface can be an external surface or an internal surface (e.g., a surface of a cavity within the 3D object). When the angle between the shortest straight line connecting the two auxiliary supports or auxiliary support marks and the direction of normal to the layering plane is greater than 90 degrees, one can consider the complementary acute angle. In some embodiments, any two auxiliary supports, or auxiliary support marks are spaced apart by at least about 10.5 millimeters or more. In some embodiments, any two auxiliary supports, or auxiliary support marks are spaced apart by at least about 40.5 millimeters or more. In some embodiments, any two auxiliary supports, or auxiliary support marks are spaced apart by the auxiliary feature spacing distance

In some embodiments, the one or more auxiliary features (which may include a base support) are used to hold and/or restrain the 3D object during formation of the 3D object. Such restraint may prevent deformation of the 3D object during its formation and/or during its (e.g., complete) hardening. In some cases, auxiliary features can be used to anchor and/or hold a 3D object or a portion of a 3D object in a material bed (e.g., with or without contacting the enclosure, and/or with or without connecting to the enclosure). The one or more auxiliary features can be specific to a 3D object and can increase the time, energy, material and/or cost required to form the 3D object. The one or more auxiliary features can be removed prior to use or delivery (e.g., distribution) of the 3D object. The longest dimension of a (e.g., horizontal) cross-section of an auxiliary feature can be at most about 50 nm, 100 nm, 200 nm, 300 nm, 400 nm, 500 nm, 600 nm, 700 nm, 800 nm, 900 nm, or 1000 nm, 1 μm, 3 μm, 10 μm, 20 μm, 30 μm, 100 μm, 200 μm, 300 μm, 400 μm, 500 μm, 700 μm, 1 mm, 3 mm, 5 mm, 10 mm, 20 mm, 30 mm, 50 mm, 100 mm, or 300 mm. The longest dimension (e.g., FLS) of a (e.g., horizontal) cross-section of an auxiliary feature can be at least about 50 nm, 100 nm, 200 nm, 300 nm, 400 nm, 500 nm, 600 nm, 700 nm, 800 nm, 900 nm, or 1000 nm, 1 μm, 3 μm, 10 μm, 20 μm, 30 μm, 100 μm, 200 μm, 300 μm, 400 μm, 500 μm, 700 μm, 1 mm, 3 mm, 5 mm, 10 mm, 20 mm. 30 mm, 50 mm, 100 mm, or 300 mm. The longest dimension of a (e.g., horizontal) cross-section of an auxiliary feature can be any value between the above-mentioned values (e.g., from about 50 nm to about 300 mm, from about 5 μm to about 10 mm, from about 50 nm to about 10 mm, or from about 5 mm to about 300 mm). Eliminating the need for auxiliary features can decrease the time, energy, material, and/or cost associated with generating the 3D object (e.g., 3D part). In some examples, the 3D object may be formed with auxiliary features. In some examples, the 3D object may be formed while connecting to the container that accommodates the material bed (e.g., side(s) and/or bottom of the container).

In some examples, the diminished number of auxiliary supports or lack of one or more auxiliary supports, will provide a 3D printing process that requires a smaller amount of material, energy, material, and/or cost as compared to commercially available 3D printing processes. In some examples, the diminished number of auxiliary supports or lack of one or more auxiliary supports, will provide a 3D printing process that produces a smaller amount of material waste as compared to commercially available 3D printing processes. The smaller amount can be smaller by at least about 1.1, 1.3, 1.5, 2, 3, 4, 5, 6, 7, 8, 9, or 10. The smaller amount may be smaller by any value between the aforesaid values (e.g., from about 1.1 to about 10, or from about 1.5 to about 5).

In some embodiments, at least a portion of the 3D object can be vertically displaced (e.g., sink) in the material bed during the 3D printing. During the 3D printing: At least a portion of the 3D object can be surrounded by pre-transformed material within the material bed (e.g., submerged). At least a portion of the 3D object can rest in the pre-transformed material without (e.g., substantial) vertical movement (e.g., displacement). Lack of (e.g., substantial) vertical displacement can amount to a vertical movement (e.g., sinking) of at most about 40%, 20%, 10%, 5%, or 1% of the layer thickness. Lack of (e.g., substantial) sinking can amount to at most about 100 □m, 30□m, 10□m, 3□m, or 1 □m. Substantial may be relative to the effect on the 3D printing process. Lack of substantial sinking and/or vertical movement may refer to a negligible effect of the sinking and/or vertical movement on the 3D printing. At least a portion of the 3D object can rest in the pre-transformed material without substantial movement (e.g., horizontal, vertical, and/or angular). Lack of substantial movement can amount to a movement of at most 100 μm, 30 μm, 10 μm, 3 μm, or 1 μm. The 3D object can rest above (e.g., on) the build platform (e.g., base) when the 3D object is vertically displaced (e.g., sunk) or submerged in the material bed.

FIG. 1 depicts an example of a three-dimensional printing system that can be used to generate a 3D object using a 3D printing process disclosed herein (e.g., a 3D printer). The system may comprise an enclosure. The enclosure may comprise a chamber (e.g., also referred to herein as “processing chamber”), for example, a chamber 107 comprising a wall. At least a fraction of the components in the system (e.g., components of the 3D printer) can be enclosed in the chamber. At least a fraction of the chamber can be filled with a gas to create a gaseous environment (i.e., an atmosphere of enclosure 126). The gas can be an inert gas (e.g., Argon, Neon, Helium, Nitrogen). The chamber can be filled with at least one other gas (e.g., a mixture of gases). The gas can be a non-reactive gas (e.g., an inert gas). The gaseous environment can comprise argon, nitrogen, helium, neon, krypton, Xenon, hydrogen, carbon monoxide, or carbon dioxide. At times, the (gas) composition of the atmosphere may vary be controlled. The control may be before, during, and/or after the 3D printing. The control may be automatically (e.g., using at least one controller) or manual. During the 3D printing, may comprise before, after, and/or during the irradiation of the target surface by the energy beam. Varying the atmosphere may comprise reducing the oxygen and/or water content. Varying the atmosphere may comprise introducing a reactive agent (e.g., hydrogen). The reactive agent may be a reducing agent. The reactive agent may react with oxygen and/or water in the atmosphere to reduce its concentration therein. The agent may be an absorbing agent (e.g., or oxygen and/or water). The 3D printer may comprise a cryogenic apparatus (e.g., cryogenic finger) that may reduce the content of hydrogen and/or oxygen from the atmosphere (e.g., on which water and/or oxygen can condense and/or crystalize). For example, the atmosphere may comprise a forming gas. The (volume per volume) percentage of reducing agent (e.g., hydrogen) in the atmosphere may be at most about 10%, 8%, 5%, 2%. 1%, 0.5%, 0.1%, or 0.05%. The (volume per volume) percentage of reducing agent in the atmosphere may be of any value between the afore-mentioned values (e.g., from about 10% to about 0.1%, from about 2% to about 0.1%, or from about 5%, to about 0.05%). In some embodiments, the processing chamber may be pressurized above ambient atmospheric pressure. The pressure in the chamber can be at least about 10⁻⁷ Torr, 10⁻⁸ Torr, 10⁻⁵ Torr, 10V Torr. 10⁻⁴ Torr, 10⁻² Torr, 10⁻¹ Torr, 1 Torr, 10 Torr, 100 Torr, 1 bar, 2 bar, 3 bar, 4 bar, 5 bar, 10 bar, 20 bar, 30 bar, 40 bar. 50 bar, 100 bar, 200 bar, 300 bar. 400 bar, 500 bar, or 1000 bar. The pressure in the chamber can be at least about 100 Torr, 200 Torr, 300 Torr, 400 Torr, 500 Torr, 600 Torr, 700 Torr, 720 Torr, 740 Torr, 750 Torr, 760 Torr, 900 Torr, 1000 Torr, 1100 Torr, or 1200 Torr. The pressure in the chamber can be at most about 10. Torr, 10⁻⁷ Torr, 10⁻⁸ Torr, 10⁻⁵ Torr, or 10⁻⁴ Torr, 10⁻³ Torr, 10⁻² Torr, 10⁻² Torr, 1 Torr, 10 Torr, 100 Torr, 200 Torr, 300 Torr, 400 Torr, 500 Torr, 600 Torr, 700 Torr, 720 Torr, 740 Torr. 750 Torr, 760 Torr, 900 Torr, 1000 Torr, 1100 Torr, or 1200 Torr. The pressure in the chamber can be of any value at a range between any of the afore-mentioned pressure values (e.g., from about 10⁻⁷ Torr to about 1200 Torr, from about 10⁻⁷ Torr to about 1 Torr, from about 1 Torr to about 1200 Torr, from about 10⁻² Torr to about 10 Torr, from about 10⁻⁷ Torr to about 10 bar, from about 10⁻⁷ Torr to about 1 bar, or from about 1 bar to about 10 bar). The pressure can be measured by a pressure gauge. The pressure can be measured at ambient temperature (e.g., R.T.), cryogenic temperature, or at the temperature of the melting point of the pre-transformed material. In some cases, the pressure in the chamber can be standard atmospheric pressure. In some cases, the pressure in the chamber can be ambient pressure (e.g., neutral pressure). In some examples, the chamber can be under vacuum pressure. In some examples, the chamber can be under a positive pressure (e.g., above ambient pressure). The pressure may be ambient pressure during the 3D printing process. The chamber pressures mentioned herein may be during at least a portion of the 3D printing. In some examples, the enclosure and/or any portion thereof (e.g., the material bed) may be at a (e.g., substantially) constant pressure value during the 3D printing process. In some embodiments, the enclosure and/or any portion thereof (e.g., the material bed) may be at a non-varied (e.g., non-gradual) pressure during the 3D printing process. The ambient pressure may be standard atmospheric pressure. The enclosure and/or any portion thereof (e.g., material bed) may experience (e.g., substantial) homogenous pressure distribution throughout the enclosure during at least a portion of the (e.g., the entire) 3D printing process. The chamber can comprise two or more gaseous layers as disclosed, for example, in U.S. patent application Ser. No. 17/849,866 filed on Jun. 27, 2022, which is incorporated herein in its entirety. In some embodiments, the pre-transformed material is pre-treated to remove oxygen and/or water. The pre-transformed material may be kept in a (e.g., substantially) dry and/or oxygen free environment during at least one 3D printing cycle. The atmosphere within the enclosure may comprise a positive pressure of at least about 1 Kilopascals (kPa), 10 kPa, 100 kPa. 120 kPa, 150 kPa, 200 kPa, 300 kPa. 400 kPa, 500 kPa, 750 kPa, or 1000 kPa. The atmosphere within the enclosure may comprise a positive pressure of any value between the aforementioned values, for example, from about 1 kPa to about 1000 kPa, from about 1 kPa to about 100 kPa, from about 100 kPa to about 400 kPa, from about 550 kPa to about 900 kPa, or from about 700 kPa to about 1000 kPa. The composition of the atmosphere within the enclosure may comprise any one or more of the gases described herein, for example, clean dry air (CDA), argon, and/or nitrogen. The enclosure may comprise a gas flow, e.g., before, after, and/or during three-dimensional printing. The gas flow within the enclosure may comprise at least about 150 liters per minute (LPM), 200 LPM, 250 LPM, 300 LPM, 350 LPM. 400 LPM, 450 LPM, 500 LPM, 550 LPM, 600 LPM, 650 LPM, 700 LPM. 750 LPM, 800 LPM, 900 LPM, 1000 LPM, or 1200 LPM. The gas flow within the enclosure may comprise any value between the aforementioned values, for example, from about 150 LPM to about 500 LPM, from about 450 LPM to about 750 LPM, or from about 700 LPM to about 1200 LPM. The composition of the gas may comprise any one or more of the gases described herein, for example, clean dry air (CDA), argon, or nitrogen. The gas may comprise a reactive agent (e.g., comprising oxygen or humidity). The atmosphere may comprise a v/v percent of the reactive agent (gas) of at most about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise any percent of the reactive agent (gas) between the afore-mentioned percentages of hydrogen gas

The gaseous environment can comprise a gas selected from the group consisting of argon, nitrogen, helium, neon, krypton, xenon, hydrogen, carbon monoxide, carbon dioxide, and oxygen. The gaseous environment can comprise air. The gas can be an ultrahigh purity gas. The ultrahigh purity gas can be at least about 99%, 99.9%, 99.99%, or 99.999% pure. The gas may comprise less than about 2 ppm oxygen, less than about 3 ppm moisture, less than about 1 ppm hydrocarbons, or less than about 6 ppm nitrogen. In some embodiments, the pre-transformed material (e.g., in the material bed) may be degassed before the 3D printing initiates (e.g., before its first irradiation by the transforming energy beam). The enclosure can be maintained under vacuum or under an inert, dry, non-reactive and/or oxygen reduced (or otherwise controlled) atmosphere. In some examples, the enclosure is under vacuum. The atmosphere can be furnished by providing an inert, dry, non-reactive, and/or oxygen reduced gas (e.g., Ar). The atmosphere can be furnished by flowing the gas through the enclosure (e.g., chamber).

In some embodiments, one or more material layers (e.g., also referred to herein as “material bed”) can be supported on a build platform. The platform may comprise a substrate and a build platform (e.g., a base). The platform may comprise a substrate (e.g., substrate 109). The substrate can have a circular, rectangular, square, or irregularly shaped cross-section. The platform may comprise a base (e.g., build platform 102) disposed above the substrate. The platform may comprise a base (e.g., build platform 102) disposed between the substrate and a material layer (or a space to be occupied by a material layer). One or more material-bed-seals (e.g., seal 103) may prevent leakage of the material from the material bed (e.g., material bed 104). A thermal control unit (e.g., a cooling member such as a heat sink or a cooling plate, or a heating plate 113) can be provided inside of the region where the 3D object is formed or adjacent to (e.g., above) the region where the 3D object is formed. The thermal control unit may comprise a thermostat. Additionally, or alternatively, the thermal control unit can be provided outside of the region where the 3D object is formed (e.g., at a predetermined distance). In some cases, the thermal control unit can form at least one section of a boundary region where the 3D object is formed (e.g., the container accommodating the material bed). Examples of thermal control unit (e.g., cooling member), 3D printers, related control system, related methods, apparatuses, systems, and program instructions (e.g., software), can be found in International Patent Application Serial No. PCT/US15/36802, which is incorporated herein by reference in its entirety.

In some embodiments, one or more of the 3D printer components are contained in the enclosure (e.g., chamber). The enclosure can include a reaction space that is suitable for introducing precursor to form a 3D object, such as pre-transformed (e.g., powder) material. The enclosure can be a vacuum chamber, a positive pressure chamber, or an ambient pressure chamber. The enclosure can comprise a gaseous environment with a controlled pressure, temperature, and/or gas composition. The control may be before, during, and/or after the 3D printing. The control may be automatic and/or manual.

In some embodiments, the concentration of oxygen and/or humidity in the enclosure (e.g., chamber) is minimized (e.g., below a predetermined threshold value). The gas composition of the chamber may contain a level of oxygen and/or humidity that is at most about 100 parts per billion (ppb), 10 ppb, 1 ppb, 0.1 ppb, 0.01 ppb, 0.001 ppb, 100 parts per million (ppm), 10 ppm, 1 ppm, 0.1 ppm, 0.01 ppm, or 0.001 ppm. The gas composition of the chamber can contain an oxygen and/or humidity level between any of the afore-mentioned values (e.g., from about 100 ppb to about 0.001 ppm, from about 1 ppb to about 0.01 ppm, or from about 1 ppm to about 0.1 ppm). The gas composition in the environment in the enclosure can comprise a (e.g., substantially) oxygen free environment. Substantially may be relative to the effect of oxygen on the 3D printing, wherein substantially free may refer to a negligible effect on the 3D printing. For example, the gas composition can contain at most about 100,000 parts per million (ppm), 10,000 ppm, 1000 ppm, 500 ppm, 400 ppm, 300 ppm, 200 ppm, 100 ppm, 50 ppm, 30 ppm, 10 ppm, 5 ppm, 1 ppm, 100,000 parts per billion (ppb), or 10,000 ppb of oxygen. The gas composition in the environment contained within the enclosure can comprise a (e.g., substantially) moisture (e.g., water) free environment. The gaseous environment can comprise at most about 100,000 ppm, 10,000 ppm, 1000 ppm, 500 ppm, 400 ppm, 300 ppm, 200 ppm, 100 ppm, 50 ppm, 30 ppm, 10 ppm, 5 ppm, 1 ppm, 100,000 ppb, or 10,000 ppb of water.

The gas composition may be measures by one or more sensors (e.g., an oxygen and/or humidity sensor), before, during, and/or after the 3D printing. The chamber can be opened at the completion of a formation of a 3D object. When the chamber is opened, ambient air containing oxygen and/or humidity can enter the chamber. In some embodiments, the processing chamber is accessed through a load lock mechanism that reduces the contamination of the processing chamber (comprising atmosphere of enclosure 126) with the ambient atmosphere (e.g., containing oxygen and/or humidity). Exposure of one or more components in the chamber to ambient atmosphere (e.g., air) can be reduced by, for example, flowing an inert gas while the chamber is open (e.g., to prevent entry of ambient air), or by flowing a heavy gas (e.g., argon) that rests on the surface of the target surface (e.g., the exposed surface of the material bed). In some cases, components that absorb oxygen and/or humidity on to their surface(s) can be sealed while the enclosure (e.g., chamber) is open (e.g., to the ambient environment).

In some embodiments, the chamber is configured such that gas inside the chamber (e.g., 126) has a relatively low leak rate from the chamber to an environment outside of the chamber. In some cases, the leak rate can be at most about 100 milliTorr/minute (mTorr/min), 50 mTorr/min, 25 mTorr/min, 15 mTorr/min, 10 mTorr/min, 5 mTorr/min, 1 mTorr/min, 0.5 mTorr/min, 0.1 mTorr/min, 0.05 mTorr/min, 0.01 mTorr/min, 0.005 mTorr/min, 0.001 mTorr/min, 0.0005 mTorr/min, or 0.0001 mTorr/min. The leak rate may be between any of the afore-mentioned leak rates (e.g., from about 0.0001 mTorr/min to about, 100 mTorr/min, from about 1 mTorr/min to about, 100 mTorr/min, or from about 1 mTorr/min to about, 100 mTorr/min). The leak rate may be measured by one or more pressure gauges and/or sensors (e.g., at ambient temperature) before, during, and/or after the 3D printing. The enclosure can be sealed (e.g., using at least one gas-seal) such that the leak rate of the gas from inside the chamber to the environment outside of the chamber is low (e.g., below a threshold level). The gas-seal can comprise an O-ring, rubber seal, metal seal, load-lock, or bellow on a piston. In some cases, the chamber can have at least one controller configured to detect leaks above a specified leak rate (e.g., by using at least one sensor) before, during, and/or after the 3D printing. The detection may be using at least one sensor. The sensor may be operatively coupled to the controller. In some instances, the controller can identify and/or control (e.g., direct and/or regulate) the gas-leak. For example, the controller may be able to identify a gas-leak by detecting a decrease in pressure inside of the chamber over a given time interval. The controller may further notify (e.g., a user and/or software) of the detected leak and/or perform an emergency shut-off of the 3D printer.

In some embodiments, the system and/or apparatus components described herein are adapted and/or configured to generate a 3D object. The 3D object can be generated through a 3D printing process. A first layer of pre-transformed material (e.g., powder) can be provided adjacent to a build platform. A build platform (e.g., base) can be a previously formed layer of the 3D object or any other surface above (e.g., on) which a layer or material bed comprising the pre-transformed material is spread, held, placed, adhered, attached, or supported. When the first layer of the 3D object is generated, this first material layer can be formed in the material bed without a build platform (e.g., base), without one or more auxiliary support features (e.g., rods), and/or without other supporting structure other than the pre-transformed material (e.g., within the material bed). Subsequent layers or hardened material can be formed such that at least one portion of the subsequent layer fused (e.g., melts or sinters), binds and/or otherwise connects to the at least a portion of a previously formed layer of hardened material (or portion thereof). The at least a portion of the previously formed layer of hardened material (e.g., a complete layer of hardened material) can act as a build platform (e.g., base) for formation of the (e.g., rest of the) 3D object. In some cases, the first formed layer of hardened material comprises and/or forms at least a portion of the build platform (e.g., base). This platform may be a sacrificial layer or form the bottom skin layer of the 3D object. The pre-transformed material layer can comprise particles of homogeneous or heterogeneous size and/or shape. The first formed layer of hardened material may float anchorlessly in the material bed during its formation and/or during the formation of the 3D object. The first formed layer of hardened material may or may not be planar.

In some embodiments, the system, methods, and/or apparatus described herein may comprise at least one energy source (e.g., the transforming energy source generating the transforming energy beam, and/or the sensing energy source generating the sensing energy beam). Examples of transforming energy beam (e.g., scanning energy beam or tiling energy beam), 3D printers, related control system, related methods, apparatuses, systems, and program instructions (e.g., software), can be found in U.S. patent application Ser. No. 17/881,797 filed on Aug. 5, 2022, which is incorporated herein by reference in its entirety (in those applications the tiling energy beam may be referred to as the “tiling energy”, “tiling energy flux” or “energy flux”). The energy beam may travel (e.g., scan) along a path. The path may be predetermined (e.g., by the controller). The methods, systems and/or apparatuses may comprise at least a second energy source. The second energy source may generate a second energy (e.g., second energy beam). The first and/or second energy beams (e.g., scanning and/or tiling energy beams) may transform at least a portion of the pre-transformed material in the material bed to a transformed material. In some embodiments, the first and/or second energy source may heat but not transform at least a portion of the pre-transformed material in the material bed. In some cases, the system can comprise 1, 2, 3, 4, 5, 6, 7, 8, 9, 10, 16, 24, 30, 32, 36, 100, 300, 1000 or more energy beams and/or energy sources. The system can comprise an array of energy sources (e.g., laser diode array). Alternatively, or additionally the surface, material bed, 3D object (or part thereof), or any combination thereof may be heated by a heating mechanism. The heating mechanism may comprise dispersed energy beams. In some cases, the at least one energy source is a single (e.g., first) energy source.

In some embodiments, the energy source is a source configured to deliver energy to a target area (e.g., a confined area). An energy source can deliver energy (e.g., radiation, e.g., beam) to the confined area through radiative heat transfer. The energy source can project energy (e.g., heat energy). The generated energy (e.g., beam) can interact with at least a portion of the material in the material bed. The energy can heat the material in the material bed before, during and/or after the pre-transformed (e.g., powder) material is being transformed (e.g., melted). The energy can heat (e.g., and not transform) at least a fraction of a 3D object at any point during formation of the 3D object. The material bed may be heated by a heating mechanism projecting energy (e.g., using radiative heat and/or energy beam). The energy may include an energy beam and/or dispersed energy (e.g., radiator or lamp). The energy may include radiative heat. The radiative heat may be projected by a dispersive energy source (e.g., a heating mechanism) comprising a lamp, a strip heater (e.g., mica strip heater, or any combination thereof), a heating rod (e.g., quartz rod), or a radiator (e.g., a panel radiator). The heating mechanism may comprise an inductance heater. The heating mechanism may comprise a resistor (e.g., variable resistor). The resistor may comprise a varistor or rheostat. A plurality of resistors may be configured in series, parallel, or any combination thereof. In some cases, the system can have a single (e.g., first) energy source that is used to transform at least a portion of the material bed.

In some embodiments, the energy beam includes a radiation comprising an electromagnetic, or charged particle beam. The energy beam may include radiation comprising electromagnetic, electron, positron, proton, plasma, radical or ionic radiation. The electromagnetic beam may comprise microwave, infrared, ultraviolet, or visible radiation. The energy beam may include an electromagnetic energy beam, electron beam, particle beam, or ion beam. An ion beam may include a cation or an anion. A particle beam may include radicals. The electromagnetic beam may comprise a laser beam. The energy beam may comprise plasma. The energy source may include a laser source. The energy source may include an electron gun. The energy source may include an energy source capable of delivering energy to a point or to an area (e.g., confined area). In some embodiments, the energy source can be a laser source. The laser source may comprise a CO₂, Neodymium (e.g., neodymium-glass or Nd:YAG), an Ytterbium, or an excimer laser. The laser may comprise a fiber laser. The laser beam may comprise a corona laser beam, e.g., a laser beam having a footprint similar to a doughnut shape. The energy source may include an energy source capable of delivering energy to a point or to an area. The energy source (e.g., transforming energy source) can provide an energy beam having an energy density of at least about 50 joules/cm² (J/cm²), 100 J/cm², 200 J/cm², 300 J/cm², 400 J/cm², 500 J/cm², 600 J/cm², 700 J/cm², 800 J/cm², 1000 J/cm², 1500 J/cm², 2000 J/cm², 2500 J/cm², 3000 J/cm², 3500 J/cm², 4000 J/cm², 4500 J/cm², or 5000 J/cm². The energy source can provide an energy beam having an energy density of at most about 50 J/cm², 100 J/cm², 200 J/cm², 300 J/cm², 400 J/cm², 500 J/cm², 600 J/cm², 700 J/cm², 800 J/cm². 1000 J/cm², 500 J/cm², 1000 J/cm², 1500 J/cm². 2000 J/cm², 2500 J/cm², 3000 J/cm², 3500 J/cm², 4000 J/cm², 4500 J/cm², or 5000 J/cm². The energy source can provide an energy beam having an energy density of a value between the afore-mentioned values (e.g., from about 50 J/cm² to about 5000 J/cm², from about 200 J/cm² to about 1500 J/cm², from about 1500 J/cm² to about 2500 J/cm², from about 100 J/cm² to about 3000 J/cm², or from about 2500 J/cm² to about 5000 J/cm²). In an example, a laser can provide light energy at a peak wavelength of at least about 100 nanometer (nm), 500 nm, 750 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. In an example a laser can provide light energy at a peak wavelength of at most about 2000 nm, 1900 nm, 1800 nm, 1700 nm, 1600 nm, 1500 nm, 1200 nm, 1100 nm, 1090 nm, 1080 nm, 1070 nm. 1060 nm, 1050 nm. 1040 nm, 1030 nm, 1020 nm, 1010 nm, 1000 nm, 750 nm, 500 nm, or 100 nm. The laser can provide light energy at a peak wavelength between any of the afore-mentioned peak wavelength values (e.g., from about 100 nm to about 2000 nm, from about 500 nm to about 1500 nm, or from about 1000 nm to about 1100 nm). The energy source (e.g., laser) may have a power of at least about 0.5 Watt (W), 1 W, 2 W, 3 W. 4 W, S W, 10 W, 20 W, 30 W, 40 W, 50 W. 60 W, 70 W, 80 W, 90 W, 100 W, 120 W, 150 W, 200 W, 250 W, 300 W, 350 W, 400 W, 500 W, 750 W, 800 W, 900 W, 1000 W, 1500 W, 2000 W, 3000 W, or 4000 W. The energy source may have a power of at most about 0.5 W. 1 W, 2 W, 3 W, 4 W, 5 W, 10 W, 20 W, 30 W, 40 W, 50 W, 60 W, 70 W, 80 W, 90 W, 100 W, 120 W, 150 W, 200 W, 250 W, 300 W, 350 W, 400 W. 500 W, 750 W, 800 W, 900 W, 1000 W, 1500, 2000 W, 3000 W, or 4000 W. The energy source may have a power between any of the afore-mentioned laser power values (e.g., from about 0.5 W to about 100 W, from about 1 W to about 10 W, from about 100 W to about 1000 W, or from about 1000 W to about 4000 W). The first energy source (e.g., producing the transforming energy beam) may have at least one of the characteristics of the second energy source. The first energy source (e.g., producing the transforming energy beam) may differ in at least one of the characteristics from the second energy source.

An energy beam generated by the energy source can be incident on, or be directed perpendicular to, the target surface. The target surface may comprise an exposed surface of the material bed or an exposed surface of a hardened material. The hardened material may be a 3D object or a portion thereof. The energy beam can be directed at an acute angle within a value ranging from being parallel to being perpendicular with respect to the average or mean plane of the target surface and/or the build platform. The energy beam can be directed onto a specified area of at least a portion of the target surface for a specified time-period (e.g., dwell time). The material in target surface (e.g., powder material such as in a top surface of a powder bed) can absorb the energy from the energy beam and, and as a result, a localized region of at least the material at the target surface can increase in temperature. The energy beam can be moveable such that it may translate (e.g., horizontally, vertically, and/or in an angle). The energy source may be movable such that it can translate relative to the target surface. The energy beam can be moved via a scanner (e.g., as disclosed herein). A least two (e.g., all) of the energy beams can be movable with the same scanner. At least two of the energy source(s) and/or beam(s) can be translated independently of each other. In some cases, at least two of the energy source(s) and/or beam(s) can be translated at different rates (e.g., velocities). In some cases, at least two of the energy beams can be comprise at least one different characteristic. The characteristics may comprise wavelength, charge, power density, amplitude, trajectory, footprint, cross-section, focus, intensity, energy, path, or hatching scheme. The charge can be electrical and/or magnetic charge. In some embodiments, the energy source may be non-translatory (e.g., during the 3D printing). The energy source may be (e.g., substantially) stationary (e.g., before, after and/or during the 3D printing). In some embodiments, the energy source may translate (e.g., before, after and/or during the 3D printing).

In some embodiments, the energy source includes an array, or a matrix, of energy sources (e.g., laser diodes). At least two (e.g., each) of the energy sources in the array or matrix, can be independently controlled (e.g., by a control mechanism) such that the energy beams can be turned off and on independently. At least two of the energy sources (e.g., in the array or matrix) can be collectively controlled such that the at least two (e.g., all) of the energy sources can be turned off and on simultaneously. The energy per unit area or intensity of at least two energy sources in the matrix or array can be modulated independently (e.g., by at least one controller). At times, the energy per unit area or intensity of at least two (e.g., all) of the energy sources (e.g., in the matrix or array) can be modulated collectively (e.g., by at least one controller). The control may be manual or automatic. The control may be before, after, and/or during the 3D printing.

In some embodiments, the energy beam translates with respect to the target surface. An optical mechanism (e.g., scanner) may facilitate a translation of the energy beam can along the target surface. The energy beam can scan along the target surface by mechanical movement of the energy source(s), one or more adjustable reflective mirrors, one or more polygon light scanners, or any combination or permutation thereof. The energy source(s) can project energy to the target surface using a DLP modulator, a one-dimensional scanner, a two-dimensional scanner, or any combination thereof. The energy source(s) can be stationary. The material bed (e.g., target surface) may translate vertically, horizontally, or in an angle (e.g., planar or compound). The translation may be effectuated using one or more motors. The translation may be effectuated using a mechanically moving stage.

In some embodiments, the energy source and/or beam is moveable such that it can translate relative to the target surface (e.g., material bed). In some instances, the energy source and/or beam may be movable such that it can translate across (e.g., laterally) the exposed (e.g., top) surface of the material bed. The energy beam(s) can be moved via a scanner. The scanner may comprise a galvanometer scanner, a polygon, a mechanical stage (e.g., X-Y stage), a piezoelectric device, gimble, or any combination of thereof. The galvanometer may comprise a mirror. The scanner may comprise a modulator. The scanner may comprise a polygonal mirror. The scanner can be the same scanner for two or more energy sources and/or beams. The scanner may comprise an optical setup. At least two (e.g., each) energy beams may have a separate scanner. The energy sources can be translated independently of each other. In some cases, at least two energy sources and/or beams can be translated at different rates, and/or along different paths. For example, the movement of the first energy source may be faster (e.g., greater rate) as compared to the movement of the second energy source. For example, the movement of the first energy beam may be faster (e.g., greater rate) as compared to the movement of the second energy beam. The systems and/or apparatuses disclosed herein may comprise one or more shutters (e.g., safety shutters). The energy beam(s), energy source(s), and/or the build platform can be moved (as applicable, e.g., by a motor, e.g., by the scanner.). The galvanometer scanner may comprise a two-axis galvanometer scanner. The scanner may comprise a modulator (e.g., as described herein). The energy source(s) can project energy using a DLP modulator, a one-dimensional scanner, a two-dimensional scanner, or any combination thereof. The energy source(s) can be stationary or translatable. The energy source(s) can translate vertically, horizontally, or in an angle (e.g., planar or compound angle). The translation may be before, after, and/or during at least a portion of the 3D printing. The translation may be controlled manually and/or automatically (e.g., by at least one controller). The energy source(s) can be modulated. The scanner can be included in, and/or can comprise, an optical system (e.g., optical setup, or optical mechanism) that is configured to direct energy from the energy source to a predetermined position on the target surface (e.g., exposed surface of the material bed). The controller can be programmed to control a trajectory of the energy source(s) with the aid of the optical system. The controller can regulate a supply of energy from the energy source to the material (e.g., at the target surface) to form a transformed material. The controller may operate before, after, and/or during at least a portion of the 3D printing (e.g., in real-time).

In some embodiments, the energy source is modulated. The energy beam emitted by the energy source can be modulated. The modulator can include amplitude modulator, phase modulator, or polarization modulator. The modulation may alter the intensity and/or power density of the energy beam. The modulation may after the current supplied to the energy source (e.g., direct modulation). The modulation may affect the energy beam (e.g., external modulation such as external light modulator). The modulation may include direct modulation (e.g., by a modulator). The modulation may include an external modulator. The modulator can include an acousto-optic modulator or an electro-optic modulator. The modulator can comprise an absorptive modulator or a refractive modulator. The modulation may alter the absorption coefficient the material that is used to modulate the energy beam. The modulator may alter the refractive index of the material that is used to modulate the energy beam. The focus of the energy beam may be controlled (e.g., modulated). The modulation may be controlled (e.g., manually and/or automatically). The modulation may be controlled before, after, and/or during at least a portion of the 3D printing (e.g., in real-time).

In some embodiments, the apparatus and/or systems disclosed herein may include an optical diffuser. The optical diffuser may diffuse light (e.g., substantially) homogenously. The optical diffuser may remove high intensity energy (e.g., light) distribution and form a more even distribution of light across the footprint of the (e.g., transforming) energy beam. The optical diffuser may reduce the intensity of the energy beam (e.g., act as a screen). For example, the optical diffuser may after an energy beam with Gaussian profile, to an energy beam having a top-hat profile. The optical diffuser may comprise a diffuser wheel assembly. The energy profile alteration device may comprise a diffuser-wheel (a.k.a., diffusion-wheel). The diffuser-wheel may comprise a filter wheel. The diffuser-wheel may comprise a filter or diffuser. The diffuser-wheel may comprise multiple filters and/or multiple diffusers. The filters and/or diffusers in the diffuser-wheel may be arranged linearly, non-linearly, or any combination thereof. The energy profile alteration device and/or any of its components may be controlled (e.g., monitored and/or regulated), and be operatively coupled thereto. The control may be manual and/or automatic (e.g., by at least one controller). The control may be before, after, and/or during at least a portion of the 3D printing. The diffuser-wheel may comprise one or more ports (e.g., opening and/or exit ports) from/to which an energy ray (e.g., beam and/or flux) may travel. The diffuser-wheel may comprise a panel. The panel may block (e.g., entirely, or partially) the energy beam. The energy profile alteration device may comprise a shutter wheel. In some examples, the diffuser-wheel (e.g., controllably) rotates. In some examples, the diffuser-wheel may (e.g., controllably) switch (e.g., alternate) between several positions. A position of the diffuser-wheel may correspond to a filter. The filter may be maintained during the formation of a layer of hardened material or a portion thereof. The filter may change during the formation of a layer of hardened material or a portion thereof. The diffuser-wheel may change between positions during the formation of a layer of hardened material or a portion thereof (e.g., change between at least 2, 3, 4, 5, 6, 7 positions). The diffuser-wheel may maintain a position during the formation of a layer of hardened material or a portion thereof. Sometimes, during the formation of a 3D object, some positions of the diffuser-wheel may not be used. At times, during the formation of a 3D object, all the positions of the diffuser-wheel may be used.

The energy beam has one or more characteristics. The energy beam (e.g., transforming energy beam) may comprise a Gaussian energy beam. The energy beam may have any cross-sectional shape comprising an ellipse (e.g., circle), or a polygon The energy beam may have a cross section with a FLS of any value between the afore-mentioned values (e.g., from about 50 μm to about 250 μm, from about 50 μm to about 150 μm, or from about 150 μm to about 250 μm). The energy beam may be continuous or non-continuous (e.g., pulsing). The energy beam may be modulated before and/or during the formation of a transformed material as part of the 3D object. The energy beam may be modulated before and/or during the 3D printing process.

The tiling energy flux may comprise (i) an extended exposure area, (ii) extended exposure time, (iii) low power density (e.g., power per unit area) or (iv) an intensity profile that can fill an area with a flat (e.g., top head) energy profile. Extended may be in comparison with the scanning energy beam. The extended exposure time may be at least about 1 millisecond and at most 100 milliseconds. In some embodiments, an energy profile of the tiling energy source may exclude a Gaussian beam or round top beam. In some embodiments, an energy profile of the tiling energy source may include a Gaussian beam or round top beam. In some embodiments, the 3D printer comprises a first and/or second scanning energy beams. In some embodiments, an energy profile of the first and/or second scanning energy may comprise a Gaussian energy beam. In some embodiments, an energy profile of the first and/or second scanning energy beam may exclude a Gaussian energy beam. The first and/or second scanning energy beam may have any cross-sectional shape comprising an ellipse (e.g., circle), or a polygon (e.g., as disclosed herein). The scanning energy beam may have a cross section with a diameter of at least about 50 micrometers (μm), 100 μm, 150 μm, 200 μm, or 250 μm. The scanning energy beam may have a cross section with a diameter of at most about 60 micrometers (μm), 100 μm, 150 μm, 200 μm, or 250 μm. The scanning energy beam may have a cross section with a diameter of any value between the afore-mentioned values (e.g., from about 50 μm to about 250 μm, from about 50 μm to about 150 μm, or from about 150 μm to about 250 μm). The power density (e.g., power per unit area) of the scanning energy beam may at least about 5000 W/mm², 10000 W/mm², 20000 W/mm², 30000 W/mm², 50000 W/mm², 60000 W/mm², 70000 W/mm², 80000 W/mm², 90000 W/mm², or 100000 W/mm². The power density of the scanning energy beam may be at most about 5000 W/mm², 10000 W/mm², 20000 W/mm², 30000 W/mm², 50000 W/mm², 60000 W/mm², 70000 W/mm², 80000 W/mm², 90000 W/mm², or 100000 W/mm². The power density of the scanning energy beam may be any value between the afore-mentioned values (e.g., from about 5000 W/mm² to about 100000 W/mm², from about 10000 W/mm² to about 50000 W/mm², or from about 50000 W/mm² to about 100000 W/mm²). The scanning speed of the scanning energy beam may be at least about 50 millimeters per second (mm/sec), 100 mm/sec, 500 mm/sec, 1000 mm/sec, 2000 mm/sec, 3000 mm/sec, 4000 mm/sec, or 50000 mm/sec. The scanning speed of the scanning energy beam may be at most about 50 mm/sec, 100 mm/sec, 500 mm/sec, 1000 mm/sec, 2000 mm/sec, 3000 mm/sec. 4000 mm/sec, or 50000 mm/sec. The scanning speed of the scanning energy beam may any value between the afore-mentioned values (e.g., from about 50 mm/sec to about 50000 mm/sec, from about 50 mm/sec to about 3000 mm/sec, or from about 2000 mm/sec to about 50000 mm/sec). The scanning energy beam may be continuous or non-continuous (e.g., pulsing). In some embodiments, the scanning energy beam compensates for heat loss at the edges of the target surface after the heat tiling process (e.g., forming the tiles by utilizing the tiling energy beam).

In some embodiments, the tiling energy beam has an extended cross section. For example, the tiling energy beam has a FLS (e.g., cross section) that is larger than the scanning energy beam. The FLS of a cross section of the tiling energy beam may be at least about 0.2 millimeters (mm), 0.3 mm, 0.4 mm, 0.5 mm, 0.8 mm, 1 mm. 1.5 mm, 2 mm, 2.5 mm. 3 mm. 3.5 mm, 4 mm, 4.5 mm, or 5 mm. The FLS of a cross section of the tiling energy beam may be between any of the afore-mentioned values (e.g., from about 0.2 mm to about 5 mm, from about 0.3 mm to about 2.5 mm, or from about 2.5 mm to about 5 mm). The cross section of the tiling energy beam can be at least about 0.1 millimeter squared (mm²), or 0.2. The diameter of the tiling energy beam can be at least about 300 micrometers, 500 micrometers, or 600 micrometers. The distance between the first position and the second position can be at least about 100 micrometers, 200 micrometers, or 250 micrometers. The FLS may be measured at full width half maximum intensity of the energy beam. The FLS may be measured at 1/e² intensity of the energy beam. In some embodiments, the tiling energy beam is a focused energy beam. In some embodiments, the tiling energy beam is a defocused energy beam. The energy profile of the tiling energy beam may be (e.g., substantially) uniform (e.g., in the beam cross sectional area that forms the tile). The energy profile of the tiling energy beam may be (e.g., substantially) uniform during the exposure time (e.g., also referred to herein as tiling time, or dwell time). The exposure time (e.g., at the target surface) of the tiling energy beam may be at least about 0.1 milliseconds (msec), 0.5 msec, 1 msec, 10 msec, 20 msec. 30 msec, 40 msec, 50 msec. 60 msec, 70 msec, 80 msec, 90 msec, 100 msec, 200 msec, 400 msec, 500 msec, 1000 msec, 2500 msec, or 5000 msec. The exposure time (e.g., at the target surface) of the tiling energy beam may be at most about 10 msec, 20 msec, 30 msec, 40 msec, 50 msec, 60 msec, 70 msec, 80 msec, 90 msec, 100 msec, 200 msec, 400 msec, 500 msec, 1000 msec, 2500 msec, or 5000 msec. The exposure time may be between any of the above-mentioned exposure times (e.g., from about 0.1 msec to about 5000 msec, from about 0.1 to about 1 msec, from about 1 msec to about 50 msec, from about 50 msec to about 100 msec, from about 100 msec to about 1000 msec, from about 20 msec to about 200 msec, or from about 1000 msec to about 5000 msec). The exposure time may be the dwell time. The power per unit area of the tiling energy beam may be at least about 100 Watts per millimeter square (W/mm²), 200 W/mm², 300 W/mm², 400 W/mm², 500 W/mm², 600 W/mm², 700 W/mm², 800 W/mm², 900 W/mm², 1000 W/mm², 2000 W/mm², 3000 W/mm², 5000 W/mm2, or 7000 W/mm². The power per unit area of the tiling energy beam may be at most about 100 W/mm², 200 W/mm², 300 W/mm², 400 W/mm², 500 W/mm², 600 W/mm², 700 W/mm², 800 W/mm², 900 W/mm², 1000 W/mm², 2000 W/mm², 3000 W/mm², 5000 W/mm², 7000 W/mm², 8000 W/mm², 9000 W/mm², or 10000 W/mm². The power per unit area of the tiling energy beam may be any value between the afore-mentioned values (e.g., from about 100 W/mm² to about 3000 W/mm², from about 100 W/mm² to about 5000 W/mm², from about 100 W/mm² to about 9000 W/mm², from about 100 W/mm² to about 500 W/mm², from about 500 W/mm² to about 3000 W/mm², from about 1000 W/mm² to about 7000 W/mm², or from about 500 W/mm² to about 8000 W/mm²). The tiling energy beam may emit energy stream towards the target surface in a step and repeat sequence.

In some embodiments, the tiling energy source is the same as the scanning energy source. In some embodiments, the tiling energy source is different than the scanning energy source. The tiling energy source and/or scanning energy source can be disposed within the enclosure, outside of the enclosure, or within at least one wall of the enclosure. The optical mechanism through which the tiling energy flux and/or the scanning energy beam travel can be disposed within the enclosure, outside of the enclosure, or within at least one wall of the enclosure.

Energy may be evacuated from the material bed. The evacuation of energy may utilize a cooling member. Energy (e.g., heat) can be transferred from the material bed to a cooling member (e.g., heat sink FIG. 1, 113). Examples of cooling members, 3D printers, related control system, related methods, apparatuses, systems, and program instructions (e.g., software), can be found in U.S. patent application Ser. No. 17/881,797 files on Aug. 5, 2022, and in International Patent Application Serial No. PCT/US16/66000, filed on Dec. 9, 2016, each of which is incorporated herein by reference in its entirety.

In some embodiments, a layer dispensing mechanism dispenses the pre-transformed material (e.g., towards the build platform), planarizes, distributes, spreads, and/or removes the pre-transformed material (e.g., in the material bed). The layer dispensing mechanism may be utilized to (e.g., layerwise) form the material bed. The layer dispensing mechanism may be utilized to form the layer of pre-transformed material (or a portion thereof). The layer dispensing mechanism may be utilized to level (e.g., planarize) the layer of pre-transformed material (or a portion thereof). The leveling may be to a predetermined height. The layer dispensing mechanism may comprise at least one, two or three of a (i) material dispensing mechanism (e.g., FIG. 1, 116). (ii) material leveling mechanism (e.g., FIG. 1, 117), and (iii) material removal mechanism (e.g., FIG. 1, 118). The material removal mechanism may comprise a cyclonic separator (e.g., a cyclonic separation system). The cyclonic separator may separate pre-transformed material (e.g., powder), from one or more gasses that carry the pre-transformed material into the material removal mechanism (e.g., into the cyclonic separator). The pre-transformed material may be a particulate (e.g., powder) material. The layer dispensing mechanism may be controlled manually and/or by the controller (e.g., before, after, and/or during the 3D printing). Examples of layer dispensing mechanism and any of its components, 3D printers, related control system, related methods, apparatuses, systems, and program instructions (e.g., software), can be found in U.S. patent application Ser. No. 17/881,797, and in International Patent Application Serial number PCT/US15/36802, each of which is incorporated herein by reference in its entirety. The layer dispensing system may comprise a hopper. The layer dispensing system may comprise (e.g., may be) a recoater.

In some embodiments, one or more sensors (at least one sensor) detect the topology of the exposed surface of the material bed and/or the exposed surface of the 3D object (or any portion thereof). The sensor can detect the amount of pre-transformed material deposited in the material bed. The sensor can comprise a proximity sensor. For example, the sensor may detect the amount of pre-transformed (e.g., powder) material deposited on the build platform and/or on the exposed surface of a material bed. The sensor may detect the physical state of material deposited on the target surface (e.g., liquid, or solid (e.g., powder or bulk)). The sensor be able to detect the microstructure (e.g., crystallinity) of the pre-transformed material deposited on the target surface. The sensor may detect the amount of pre-transformed material disposed by the layer dispensing mechanism (e.g., powder dispenser). The sensor may detect the amount of pre-transformed material that is relocated by the layer dispensing mechanism (e.g., by the leveling mechanism). The sensor can detect the temperature of the pre-transformed and/or transformed material in the material bed. The sensor may detect the temperature of the pre-transformed material in a material (e.g., powder) dispensing mechanism, and/or in the material bed. The sensor may detect the temperature of the pre-transformed material during and/or after its transformation. The sensor may detect the temperature and/or pressure of the atmosphere within the enclosure (e.g., chamber). The sensor may detect the temperature of the material (e.g., powder) bed at one or more locations.

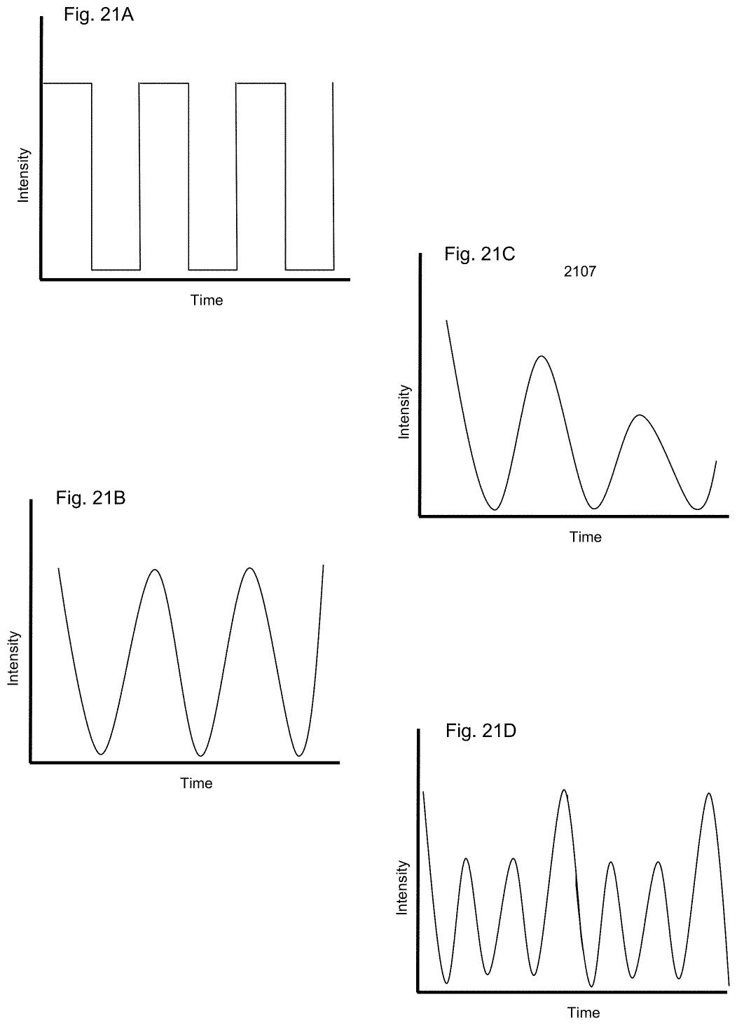

In some embodiments, a topological map is formed using at least one metrological sensor. The metrological sensor may comprise projection of a static or time varying oscillating (e.g., striped) pattern. The metrological sensor may comprise a fringe projection profilometry device. The metrological sensor may be at least a part of the height mapper system. The metrological sensor may comprise an emitter generating a sensing energy beam (e.g., emitter as in FIG. 3, 317) and a receiver (e.g., FIG. 3, 318). The emitter may comprise a projector. The emitter may project the sensing energy beam on a target surface. The target surface may comprise an exposed surface of a material bed, a layer of hardened material, a 3D object, and/or a melt pool. The sensing energy beam may form a pattern on the target (e.g., exposed) surface. The pattern may comprise areas of various levels of light intensity. FIGS. 21A-21D show various light intensity profiles as a function of time. The light intensity profile may comprise an on off pattern (e.g., FIG. 21A). The light intensity profile may comprise a fluctuating pattern. The fluctuating pattern may comprise gradually fluctuating intensity pattern (e.g., FIG. 21B) or abruptly fluctuating intensity pattern (e.g., FIG. 21A). The fluctuating pattern may comprise a superposition of a plurality of sinusoidal waves (e.g., FIG. 21D). The fluctuating pattern may comprise a superposition of a plurality of frequency functions (e.g., sine function and/or cosine function). The fluctuating pattern may comprise a superposition of a sinusoidal wave and a decreasing function (e.g., 2107, FIG. 21C). The decreasing function may be decreasing linearly, logarithmically, exponentially, or any combination thereof. The fluctuating pattern may comprise plurality of functions (e.g., that are super positioned). The plurality of functions may be shifted (e.g., by a phase and/or fringe). The plurality of functions may be shifted (e.g., by a phase and/or fringe) with respect to each other. At least two of the plurality of functions (e.g., all of the functions) may be shifted (e.g., by a phase and/or fringe) collectively. In some examples, the fluctuating pattern are shifted (e.g., by a phase and/or fringe). For example, the fluctuating pattern may be shifted during the use of the metrological detector (e.g., included in a height mapper system). For example, the fluctuating pattern may be shifted during the operation of (e.g., detection by) the metrological detector. The shift may be of at least a portion of a (e.g., a whole) wavelength (A) of the sensing energy beam. The shift may by at least about λ/10, λ/9, λ/8, λ/7, λ/6, λ/5, λ/4, λ/3, or λ/2. The shift may by at most about λ/10, λ/9, λ/8, λ/7, λ/6. λ/5, λ/4, λ/3, or λ/2. The shift may by any value between the afore-mentioned values (e.g., from about A to about λ/10, from about λ/2 to about λ/10, from about A/2 to about λ/5, from about λ/5 to about λ/10, or from about λ/2 to about λ/4,). The fluctuating pattern may be shifted by (e.g., substantially) the same (e.g., delta) value across the target surface. The fluctuating pattern may be shifted by different values across the target surface. For example, at least a first area of the target surface may be sensed with a shifting fluctuating pattern by about λ/3, and at least a second area of the target surface (that differs from the first area) may be sensed by a shifting fluctuating pattern by about λ/5. The fluctuating pattern may be shifted (i) by a first value across the target surface at a first time (or first time-period), and (ii) by a second value across the target surface at a second time (or second time-period). For example, the target surface may be sensed with a shifting and fluctuating pattern that is of λ/3 at time period t₁, and the target surface may be sensed by a shifting fluctuating pattern that is of λ/5 at time period t₂ (that differs from t₁). In some embodiments, the use of a certain shift in the fluctuating pattern at a certain area of the target surface relates to a certain sensitivity (e.g., resolution) of detection at that certain area. The use of different shift values in the fluctuating pattern at different areas of the target surface may allow detection of these different areas at a different sensitivity (e.g., resolution). The different shift in the fluctuating pattern may correlate to the different in material properties (e.g., phases). For example, a different shift value may be used on a target surfaced area comprising a pre-transformed material, than on a target surface area comprising a transformed material. The detector may comprise a plurality of sensing energy beams. The plurality of energy beams may form an interference pattern. The fluctuating pattern may comprise an interference pattern. The projected sensing energy beams may be of the same or of different colors. At least two of the projected sensing energy beams may be of the same or of (e.g., substantially) the same color. At least two of the projected sensing energy beams may be of different colors. The projected sensing energy beams may be of the same or of different frequencies. At least two of the projected sensing energy beams may be of different frequencies. At least two of the projected sensing energy beams may be of the same or of (e.g., substantially) the same frequency. The various plurality of projected sensing energy beams may be projected simultaneously or sequentially. At least two of the projected sensing energy beams may be of projected sequentially. At least two of the projected sensing energy beams may be projected (e.g., substantially) simultaneously. Substantial may be relative to the effect on the detection (e.g., effect on the resolution of the detection). The fluctuating pattern may scan the target surface (e.g., by projecting one or more shapes). At times, the fluctuating pattern may be apparent on at least a portion of the target surface (e.g., FIG. 19, showing fluctuating rectangles (e.g., thick lines) of various intensities). In some embodiments the fluctuating pattern is detectable (e.g., may appear) on at least a portion of the target surface, wherein fluctuating intensity pattern is presented as a function of location (e.g., of at least a portion of the target surface). The fluctuating positional intensity function may be similar to the functions shown in FIGS. 21A-21B, wherein the “Time” label is changed to a “Position” label. The fluctuating positional pattern may change as a function of time (e.g., as shown in FIGS. 21A-21B).

In some embodiments, the (e.g., metrological or temperature) sensor (or detector) comprises a filter (e.g., FIG. 3, 326). The energy beam that is used in transforming the pre-transformed material to a transformed material (e.g., scanning energy beam and/or tiling energy beam) may be referred to herein as the “transforming energy beam.” The filter may filter a sensing energy beam from the transforming energy beam (e.g., FIG. 3, 340). The sensing energy beam may comprise electromagnetic radiation (e.g., from a light emitting diode). The sensing energy beam may comprise collimated or non-collimated light. The filtering may be performed before, during and/or after building a 3D object. Filtering may reduce the amount of transforming energy beam that is sensed by the sensor. Filtering may protect the sensor from the transforming energy beam (e.g., having high intensity), e.g., during building of the 3D object. The filtering may allow measuring the sensing energy beam in real-time during operation of the transforming energy beam (e.g., forming at least a portion of the 3D object). Additionally, filtering may allow sensing and/or detecting in real-time (e.g., during build of the 3D object). FIG. 29 shows an example of a sensing energy beam 2908 that is separated from the transforming energy beam 2901. FIG. 29 shows an example of a processing chamber (e.g., having a wall 2907 and an atmosphere 2926) that is engaged with a build module (e.g., 2940) to form an enclosure. The build module may include a target surface (e.g., 2910). The 3D object may be built in a material bed 2904 by irradiating it with a transforming energy beam (e.g., 2901). FIG. 29 further shows a sensing energy beam (e.g., 2908) that is irradiated on the target surface. The sensing energy beam may be used to sense a characteristic of one or more positions of the target surface (e.g., of the building 3D object). The sensing energy beam may be generated by a light energy source (e.g., FIG. 29, 2922, e.g., LED lamp). The light source may comprise a digital light projector. The light source may comprise a digital light imager. The metrology detection system may comprise digital light processing. The light source may comprise a digital mirror (e.g., micro-mirror) device. The light source may comprise a lens (e.g., a lens array). The light source may comprise a mirror (e.g., microscopic mirror). The light source may comprise an array (e.g., of microscopic) mirrors. The array may be rectangular. The mirror in the array may be movable (e.g., controllably). The control may comprise electric (e.g., electrostatic) control. The light source may comprise a micro-opto-electromechanical system (e.g., a digital micromirror device, or DMD). The mirror may comprise silicon or aluminum. The digital light projector may comprise a digital micromirror device.

The sensing energy beam may comprise a wavelength different than the transforming energy beam. The sensing energy beam may comprise a wavelength that is below a thermal radiative beam (e.g., below red, or infra-red radiation). The sensing energy beam may comprise a wavelength that is above a plasma generating radiation (e.g., above ultraviolet radiation, e.g., from a purple to an orange visible light radiation). The wavelength of the sensing energy beam may be above about 100 nm, 200 nm, 300 nm, 350 nm, 400 nm, 450 nm, 500 nm, 550 nm, 600 nm, or 650 nm. The wavelength of the sensing energy beam may be below about 1000 nm, 950 nm, 900 nm, 850 nm, 800 nm, 750 nm, or 700 nm. The wavelength of the sensing energy beam may be any wavelength between the afore-mentioned wavelengths (e.g., from 100 nm to 1000 nm, from 300 nm to 800 nm, or from 400 nm to 500 nm). The sensing energy may be any energy beam described herein. At times, the transforming energy beam (e.g., 2901) may be projected through a first optical window (e.g., 2915). The sensing energy beam may be projected (e.g., optionally) through a second optical window (e.g., 2918). In some embodiments, the first and second optical window are the same optical window. In some embodiments, the first optical window is different than the second optical window. The energy beam reflected from the target surface (e.g., 2930) that reaches a receiver (e.g., 2925, a detector), may travel through the first optical window (e.g., 2915) and/or the second optical window (e.g., 2918). The detector may be (e.g., atmospherically) separated from the processing chamber by the optical window (e.g., 2925). At times, the detector may have the same atmosphere as the processing chamber (e.g., FIGS. 3, 318 and 317). The first and/or second optical window may have a coating on at least one of their respective surfaces. For example, the first and/or second optical window may have a coating at least on its surface that face the interior of the processing chamber (e.g., FIG. 29, 2926). The coating may comprise an anti-reflective, dielectric, wavelength filtering, transparent, conductive, and/or a transparent-conductive coating. The wavelength filtering coating may comprise an ultraviolet (e.g., extreme ultraviolet) filtering coating. At times, the coating may be applied on both surfaces of the optical window.

In some embodiments, the detection system comprises a plurality of detection systems (e.g., a plurality of receivers and/or transmitters). The plurality of receivers and/or transmitters may view the target location from a plurality of spatial position. The plurality of spatial positions may form a multi perspective image. Examples of detection systems, 3D printers, related control system, related methods, apparatuses, systems, and program instructions (e.g., software), can be found in International Patent Application serial no. PCT/US15/65297, filed on Dec. 11, 2015, titled “FEEDBACK CONTROL SYSTEMS FOR THREE-DIMENSIONAL PRINTING,” which is incorporated herein by reference in its entirety.

In some embodiments, at least one sensor is operatively coupled to a control system (e.g., computer control system). The sensor may comprise light sensor, acoustic sensor, vibration sensor, chemical sensor, electrical sensor, magnetic sensor, fluidity sensor, movement sensor, speed sensor, position sensor, pressure sensor, force sensor, density sensor, distance sensor, or proximity sensor. The sensor may comprise temperature sensor, weight sensor, material (e.g., powder) level sensor, metrology sensor, gas sensor, or humidity sensor. The metrology sensor may comprise a measurement sensor (e.g., height, length, width, angle, and/or volume). The metrology sensor may comprise a magnetic, acceleration, orientation, or optical sensor. The sensor may transmit and/or receive sound (e.g., echo), magnetic, electronic, and/or electromagnetic signal. The electromagnetic signal may comprise a visible, infrared, ultraviolet, ultrasound, radio wave, or microwave signal. The metrology sensor may measure a vertical, horizontal, and/or angular position of at least a portion of the target surface. The metrology sensor may measure a gap. The metrology sensor may measure at least a portion of the layer of material. The layer of material may be a pre-transformed material (e.g., powder), transformed material, or hardened material. The metrology sensor may measure at least a portion of the 3D object. The metrology sensor may measure the FLS (e.g., depth) of at least one melt pool. The metrology sensor may measure a height of a 3D object that protrudes from the exposed surface of the material bed. The metrology sensor may measure a height of a 3D object that deviates from the average and/or mean of the exposed surface of the material bed. The gas sensor may sense any of the gas. The distance sensor can be a type of metrology sensor. The distance sensor may comprise an optical sensor, or capacitance sensor. The temperature sensor can comprise Bolometer, Bimetallic strip, Calorimeter, Exhaust gas temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Silicon band gap temperature sensor, Special sensor microwave/imager, Temperature gauge, Thermistor, Thermocouple, Thermometer (e.g., resistance thermometer), or Pyrometer. The temperature sensor may comprise an optical sensor. The temperature sensor may comprise image processing. The temperature sensor may be coupled to a processor that would perform image processing by using at least one sensor generated signal. The temperature sensor may comprise a camera (e.g., IR camera, CCD camera).

In some embodiments, the light sensor comprises a semiconductive device. The light sensor may comprise p-doped metal-oxide-semiconductor (MOS), or complementary MOS (CMOS). In some embodiments, the light sensor comprises a material that is sensitive to light. The material sensitive to light may alter at least one of its properties as a response to incoming light photons. For example, the material sensitive to light may alter its temperature, color, refractive index, electrical conductivity, magnetic field, and/or volume as a response to incoming light photos. The material sensitive to light may alter the energy level population of its electrons as a response to incoming light photons. The alternation may take place in the areas which were exposed to the light (e.g., areas which absorbed the photons).

In some embodiments, the systems and/or apparatuses described herein comprise a temperature sensor. The temperature sensor may comprise a gas sensor. The temperature sensor may be sensitive to a radiation (e.g., electromagnetic radiation) having a wavelength of at least about 0.5 μm, 1 μm, 1.5 μm. 2.5 μm, 3 μm, 3.5 μm, 4 μm, 4.5 μm. 5 μm, 5.5 μm, 6 μm, 6.5 μm, 7 μm, 8 μm, or 9 μm. The temperature sensor may be sensitive to a radiation (e.g., electromagnetic radiation) having a wavelength of any value between the afore-mentioned values (e.g., from about 0.5 μm to about 9 μm, from about 0.5 μm to about 3 μm, from about 1 μm to about 5 μm, from about 1 μm to about 2.5 μm, or from about 5 μm to about 9 μm. The pressure sensor may comprise Barograph, Barometer, Boost gauge, Bourdon gauge, Hot filament ionization gauge, Ionization gauge, McLeod gauge, Oscillating U-tube, Permanent Downhole Gauge, Piezometer, Pirani gauge, Pressure sensor, Pressure gauge, Tactile sensor, or Time pressure gauge. The position sensor may comprise Auxanometer, Capacitive displacement sensor, Capacitive sensing, Free fall sensor, Gravimeter, Gyroscopic sensor, Impact sensor, Inclinometer, Integrated circuit piezoelectric sensor. Laser rangefinder, Laser surface velocimeter, LIDAR, Linear encoder, Linear variable differential transformer (LVDT), Liquid capacitive inclinometers, Odometer, Photoelectric sensor, Piezoelectric accelerometer, Rate sensor, Rotary encoder, Rotary variable differential transformer, Selsyn, Shock detector, Shock data logger, Tilt sensor, Tachometer, Ultrasonic thickness gauge, Variable reluctance sensor, or Velocity receiver. The detector may comprise an array of optical sensors. The optical sensor may comprise a Charge-coupled device, Colorimeter, Contact image sensor, Electro-optical sensor, Infra-red sensor, Kinetic inductance detector, light emitting diode (e.g., light sensor), Light-addressable potentiometric sensor, Nichols radiometer, Fiber optic sensors, Optical position sensor, Photo detector, Photodiode, Photomultiplier tubes, Phototransistor, Photoelectric sensor, Photoionization detector, Photomultiplier, Photo resistor, Photo switch, Phototube, Scintillometer, Shack-Hartmann, Single-photon avalanche diode, Superconducting nanowire single-photon detector, Transition edge sensor, Visible light photon counter, or Wave front sensor. The weight of the material bed can be monitored by one or more weight sensors. The weight sensor(s) may be disposed in, and/or adjacent to the material bed. A weight sensor disposed in the material bed can be disposed at the bottom of the material bed (e.g., adjacent to the build platform). The weight sensor can be between the bottom of the enclosure (e.g., FIG. 1, 111) and the substrate (e.g., FIG. 1, 109) on which the base (e.g., FIG. 1, build platform 102) or the material bed (e.g., FIG. 1, material bed 104) may be disposed. The weight sensor can be between the bottom of the enclosure and the base on which the material bed may be disposed. The weight sensor can be between the bottom of the enclosure and the material bed. A weight sensor can comprise a pressure sensor. The weight sensor may comprise a spring scale, a hydraulic scale, a pneumatic scale, or a balance. At least a portion of the pressure sensor can be exposed on a bottom surface of the material bed. The weight sensor can comprise a button load cell. The button load cell can sense pressure from the pre-transformed material (e.g., powder) adjacent to the load cell. In an example, one or more sensors (e.g., optical sensors, e.g., optical level sensors) can be provided adjacent to the material bed such as above, below, and/or to the side of the material bed. In some examples, the one or more sensors can sense the level (e.g., height and/or amount) of pre-transformed material in the material bed. The pre-transformed material (e.g., powder) level sensor can be in communication with a layer dispensing mechanism (e.g., powder dispenser). A sensor can be configured to monitor the weight of the material bed by monitoring a weight of a structure that contains the material bed. One or more position sensors (e.g., height sensors) can measure the height of the material bed relative to the build platform (e.g., at one of more positions). The position sensors can be optical sensors. The position sensors can determine a distance between one or more energy beams (e.g., a laser or an electron beam.) and the exposed surface of the material (e.g., powder) bed. The one or more sensors may be connected to a control system (e.g., to a processor and/or to a computer).

In some embodiments, the systems and/or apparatuses disclosed herein comprise one or more motors (e.g., one or more actuators). The motors may comprise servomotors. The servomotors may comprise actuated linear lead screw drive motors. The motors may comprise belt drive motors. The motors may comprise rotary encoders. The apparatuses and/or systems may comprise switches. The switches may comprise homing or limit switches. The motors may comprise actuators. The motors may comprise linear actuators. The motors may comprise belt driven actuators. The motors may comprise lead screw driven actuators. The actuators may comprise linear actuators. The systems and/or apparatuses disclosed herein may comprise one or more pistons.

In some examples, a pressure system is in fluid communication with the enclosure. The pressure system can be configured to regulate the pressure in the enclosure. In some examples, the pressure system includes one or more pumps. The one or more pumps may comprise a positive displacement pump. The positive displacement pump may comprise rotary-type positive displacement pump, reciprocating-type positive displacement pump, or linear-type positive displacement pump. The positive displacement pump may comprise rotary lobe pump, progressive cavity pump, rotary gear pump, piston pump, diaphragm pump, screw pump, gear pump, hydraulic pump, rotary vane pump, regenerative (peripheral) pump, peristaltic pump, rope pump, or flexible impeller. Rotary positive displacement pump may comprise gear pump, screw pump, or rotary vane pump. The reciprocating pump comprises plunger pump, diaphragm pump, piston pumps displacement pumps, or radial piston pump. The pump may comprise a valveless pump, steam pump, gravity pump, eductor-jet pump, mixed-flow pump, bellow pump, axial-flow pumps, radial-flow pump, velocity pump, hydraulic ram pump, impulse pump, rope pump, compressed-air-powered double-diaphragm pump, triplex-style plunger pump, plunger pump, peristaltic pump, roots-type pumps, progressing cavity pump, screw pump, or gear pump.

In some examples, the pressure system includes one or more vacuum pumps selected from mechanical pumps, rotary vain pumps, turbomolecular pumps, ion pumps, cryopumps, and diffusion pumps. The one or more vacuum pumps may comprise Rotary vane pump, diaphragm pump, liquid ring pump, piston pump, scroll pump, screw pump, Wankel pump, external vane pump, roots blower, multistage Roots pump, Toepler pump, or Lobe pump. The one or more vacuum pumps may comprise momentum transfer pump, regenerative pump, entrapment pump, Venturi vacuum pump, or team ejector. The pressure system can include valves, such as throttle valves. The pressure system can include a pressure sensor for measuring the pressure of the chamber and relaying the pressure to the controller, which can regulate the pressure with the aid of one or more vacuum pumps of the pressure system. The pressure sensor can be coupled to a control system (e.g., controller). The pressure can be electronically or manually controlled.

In some embodiments, the systems, apparatuses, and/or methods described herein comprise a material recycling mechanism (e.g., also referred to herein as a “powder conveyance system”). The recycling mechanism can collect at least unused pre-transformed material and return the unused pre-transformed material to a reservoir of a material dispensing mechanism (e.g., the material dispensing reservoir), or to a bulk reservoir that feeds the material dispensing mechanism. Examples of recycling mechanism, bulk reservoir, 3D printers, related control system, related methods, apparatuses, systems, and program instructions (e.g., software), can be found in U.S. patent application Ser. No. 17/881,797 filed on Aug. 5, 2022, which is incorporated herein by reference in its entirety.

In some cases, unused material (e.g., remainder) surrounds the 3D object in the material bed. The unused material can be (e.g., substantially) removed from the 3D object. The unused material may comprise pre-transformed material. Substantial removal may refer to material covering at most about 20%, 15%, 10%, 8%, 6%, 4%, 2%, 1%, 0.5%, or 0.1% of the surface of the 3D object after removal. Substantial removal may refer to removal of all the material that was disposed in the material bed and remained as pre-transformed material at the end of the 3D printing process (i.e., the remainder), except for at most about 10%, 3%, 1%, 0.3%, or 0.1% of the weight of the remainder. Substantial removal may refer to removal of all the remainder except for at most about 50%, 10%, 3%. 1%, 0.3%, or 0.1% of the weight of the printed 3D object. The unused material can be removed to permit retrieval of the 3D object without digging through the material bed. For example, the unused material can be suctioned out of the material bed by one or more vacuum ports (e.g., nozzles) built adjacent to the material bed, by brushing off the remainder of unused material, by lifting the 3D object from the unused material, by allowing the unused material to flow away from the 3D object (e.g., by opening an exit opening port on the side(s) and/or on the bottom of the material bed from which the unused material can exit). After the unused material is evacuated, the 3D object can be removed. The unused pre-transformed material can be re-circulated to a material reservoir for use in future builds. The re-circulation can be before a new build, after completion of a build, and/or (e.g., continuously) during the 3D printing. Examples of removal of the remainder and its effectuation, 3D printers, related control system, related methods, apparatuses, systems, and program instructions (e.g., software), can be found in U.S. patent application Ser. No. 17/881,797 filed on Aug. 5, 2022, and in International Patent Application Serial number PCT/US15/36802, each of which is incorporated herein by reference in its entirety. In some cases, cooling gas can be directed to the hardened material (e.g., 3D object) for cooling the hardened material during and/or following its retrieval (e.g., from the build module).

In some cases, the 3D object is fabricated (e.g., printed) with a set of transforming energy beams. The set of transforming energy beams may comprise one or more transforming energy beams (e.g., scanning and/or tiling energy beam). The rate in which the set of set of transforming energy beams fabricate the 3D object can be at least 1 cubic centimeter per hours (cm³/h), 5 cm³/h, 10 cm³/h, 20 cm³/h, 30 cm³/h, 40 cm³/h, 50 cm³/h, 60 cm³/h, 70 cm³/h, 80 cm³/h, 90 cm³/h, 100 cm³/h, 110 cm³%, 120 cm³ m, 130 cm³/h, 140 cm³/h, or 150 cm³/h. The rate in which the set of set of transforming energy beams fabricate the 3D object can be a value between the afore-mentioned values (e.g., from about 1 cm³/h to about 150 cm³ h, from about 20 cm³/h to about 120 cm³/h, from about 30 cm³/h to about 90 cm³/h, or from about 40 cm³/h to about 80 cm³/h).

In some examples, the final form of the 3D object is retrieved soon after cooling of a final layer of hardened material. Soon after cooling may be at most about 1 day. 12 hours (h). 6 h, 5 h. 4 h, 3 h, 2 h, 1 h, 30 minutes, 15 minutes, 5 minutes, 240 s, 220 s, 200 s, 180 s, 160 s, 140 s, 120 s, 100 s, 80 s, 60 s, 40 s, 20 s, 10 s, 9 s, 8 s, 7 s, 6 s, 5 s, 4 s, 3 s, 2 s, or 1 s. Soon after cooling may be between any of the afore-mentioned time values (e.g., from about 1 s to about 1 day, from about is to about 1 hour, from about 30 minutes to about 1 day, from about 20 s to about 240 s, from about 12 h to about 1 s, from about 12 h to about 30 min, from about 1 h to about is, or from about 30 min to about 40 s). In some cases, the cooling can occur by method comprising active cooling by convection using a cooled gas or gas mixture comprising argon, nitrogen, helium, neon, krypton, xenon, hydrogen, carbon monoxide, carbon dioxide, or oxygen. Cooling may be cooling to a handling temperature (e.g., ambient temperature). Cooling may be cooling to a temperature that allows a person to handle the 3D object.

At times, the generated 3D object (i.e., the printed 3D object) does not require further processing following its generation by a method described herein. The printed 3D object may require reduced amount of processing after its generation by a method described herein. For example, the printed 3D object may not require removal of auxiliary support (e.g., since the printed 3D object was generated as a 3D object devoid of auxiliary support). The printed 3D object may not require smoothing, flattening, polishing, or leveling. The printed 3D object may not require further machining. In some examples, the printed 3D object may require one or more treatment operations following its generation (e.g., post generation treatment, or post printing treatment). The further treatment step(s) may comprise surface scraping, machining, polishing, grinding, blasting (e.g., sand blasting, bead blasting, shot blasting, or dry ice blasting), annealing, or chemical treatment. Examples of 3D printing systems, apparatuses, devices, and components, controllers, software, and 3D printing processes (e.g., post-processing, post-generation treatment, and post-printing treatment) can be found in U.S. patent application Ser. No. 17/835,023, filed on Jun. 8, 2022, and in U.S. Provisional Patent Application Ser. No. 63/289,787, filed Dec. 15, 2021, each of which is entirely incorporated herein by reference.

In some examples, the generated 3D object requires very little or no further processing after its retrieval. In some examples, the diminished further processing (or lack thereof), will afford a 3D printing process that requires smaller amount of energy and/or less waste as compared to commercially available 3D printing processes. The smaller amount can be smaller by at least about 1.1, 1.3, 1.5, 2, 3, 4, 5, 6, 7, 8, 9, or 10. The smaller amount may be smaller by any value between the afore-mentioned values (e.g., from about 1.1 to about 10, or from about 1.5 to about 5). Further processing may comprise trimming (e.g., ablating). Further processing may comprise polishing (e.g., sanding). The generated 3D object can be retrieved and finalized without removal of transformed material and/or auxiliary features (e.g., since the 3D object does not comprise any). The 3D object can be retrieved when the 3D object, composed of hardened (e.g., solidified) material, is at a handling temperature that is suitable to permit its removal from the material bed without its substantial deformation. The handling temperature can be a temperature that is suitable for packaging of the 3D object. The handling temperature a can be at most about 120° C., 100° C., 80° C., 60° C. 40° C., 30° C., 25° C. 20° C., 10° C., or 5° C. The handling temperature can be of any value between the afore-mentioned temperature values (e.g., from about 120° C. to about 20° C., from about 40′C to about 5° C., or from about 40° C. to about 10′C).

In some embodiments, the methods, apparatuses, software, and systems provided herein result in fast and/or efficient formation of 3D objects. In some cases, the 3D object can be transported within at most about 120 min, 100 min, 80 min, 60 min, 40 min. 30 min, 20 min, 10 min, or 5 min after the last layer of the object hardens (e.g., solidifies). In some cases, the 3D object can be transported within at least about 120 min, 100 min, 80 min, 60 min. 40 min, 30 min, 20 min, 10 min, or 5 min after the last layer of the object forms (e.g., hardens). In some cases, the 3D object can be transported within any time between the above-mentioned values (e.g., from about 5 min to about 120 min, from about 5 min to about 60 min, or from about 60 min to about 120 min). The 3D object can be transported once it cools to a temperature of at most about 100° C., 90° C., 80° C., 70° C., 60° C., 50° C., 40° C., 30° C., 25° C., 20° C., 15° C., 10° C., or 5° C. The 3D object can be transported once it cools to a temperature value between the above-mentioned temperature values (e.g., from about 5° C. to about 100° C., from about 5° C. to about 40° C., or from about 15′C to about 40° C.). Transporting the 3D object can comprise packaging and/or labeling the 3D object. In some cases, the 3D object can be transported directly to a consumer.

In some examples, the methods, systems, apparatuses, and/or software presented herein facilitate formation of custom and/or a stock 3D objects for a customer. A customer can be an individual, a corporation, organization, government, non-profit organization, company, hospital, medical practitioner, engineer, retailer, any other entity, or individual. The customer may be one that is interested in receiving the 3D object and/or that ordered the 3D object. A customer can submit a request for formation of a 3D object. The customer can provide an item of value in exchange for the 3D object. The customer can provide a design or a model for the 3D object. The customer can provide the design in the form of a stereo lithography (STL) file. The customer can provide a design wherein the design can be a definition of the shape and/or dimensions of the 3D object in any other numerical or physical form. In some cases, the customer can provide a 3D model, sketch, and/or image as a design of an object to be generated. The design can be transformed into instructions usable by the printing system to additively generate the 3D object. The customer can provide a request to form the 3D object from a specific material or group of materials (e.g., a material as described herein). In some cases, the design may not contain auxiliary features (or marks of any past presence of auxiliary support features). In response to the customer request, the 3D object can be formed or generated with the printing method, system and/or apparatus as described herein. In some cases, the 3D object can be formed by an additive 3D printing process (e.g., additive manufacturing). Additively generating the 3D object can comprise successively depositing and transforming (e.g., melting) a pre-transformed material (e.g., powder) comprising one or more materials as specified by the customer. The 3D object can be subsequently delivered to the customer. The 3D object can be formed without generation or removal of auxiliary features (e.g., that is indicative of a presence or removal of the auxiliary support feature). Auxiliary features can be support features that prevent a 3D object from shifting, deforming, or moving during the formation of the 3D object.

In some examples, the generated 3D object adheres (e.g., substantially) to a requested model of the 3D object. Substantially may be with relation to the intended purpose of the 3D object. The 3D object (e.g., solidified material) that is generated can be formed with high fidelity, e.g., having a high fidelity (e.g., high accuracy) of one or more characteristics (e.g., dimensions) of the generated 3D object when compared to a model or simulation of the intended 3D object. For example, have an average deviation percentage from intended dimensions that are at most about 5%, 2%, 1%, 0.5%, 0.25%, 0.1%, 0.05%, or less. For example, the 3D object that is generated can have an average deviation value from the intended dimensions (e.g., of a requested 3D object) of at most about 0.5 microns (μm), 1 μm, 3 μm, 10 μm, 30 μm, 100 μm, 300 μm or less from a requested model of the 3D object. The deviation can be any value between the afore-mentioned values. The average deviation can be from about 0.5 μm to about 300 μm, from about 10 μm to about 50 μm, from about 15 μm to about 85 μm, from about 5 μm to about 45 μm, or from about 15 μm to about 35 μm. The 3D object can have a deviation from the intended dimensions in a specific direction, according to the formula Dᵥ+L/K_{dv}, wherein Dᵥ is a deviation value, L is the length of the 3D object in a specific direction, and K_{dv} is a constant. D, can have a value of at most about 300 μm, 200 μm, 100 μm, 50 μm, 40 μm, 30 μm. 20 μm. 10 μm, 5 μm, 1 μm, or 0.5 μm. D, can have a value of at least about 0.5 μm, 1 μm, 3 μm, 5 μm, 10 μm, 20 μm, 30 μm, 50 μm, 70 μm, 100 μm, 300 μm or less. D, can have any value between the afore-mentioned values. For example, D, can have a value that is from about 0.5 μm to about 300 μm, from about 10 μm to about 50 μm, from about 15 μm to about 85 μm, from about 5 μm to about 45 μm, or from about 15 μm to about 35 μm. K_{dv} can have a value of at most about 3000, 2500, 2000, 1500, 1000, or 500. K_{dv} can have a value of at least about 500, 1000, 1500, 2000, 2500, or 3000. K_{dv} can have any value between the afore-mentioned values. For example, K_{dv} can have a value that is from about 3000 to about 500, from about 1000 to about 2500, from about 500 to about 2000, from about 1000 to about 3000, or from about 1000 to about 2500.

In some examples, the intended dimensions of the 3D object are derived from a model design of the 3D object. The 3D part can have the stated accuracy value immediately after its formation, without additional processing or manipulation. Receiving the order for the object, formation of the object, and delivery of the object to the customer can take at most about 7 days, 6 days, 5 days, 3 days, 2 days, 1 day, 12 hours, 6 hours, 5 hours, 4 hours, 3 hours, 2 hours, 1 hour, 30 min, 20 min, 10 min, 5 min, 1 min, 30 seconds, or 10 seconds. Receiving the order for the object, formation of the object, and delivery of the object to the customer can take a period of time between any of the afore-mentioned time periods (e.g., from about 10 seconds to about 7 days, from about 10 seconds to about 12 hours, from about 12 hours to about 7 days, or from about 12 hours to about 10 minutes). In some cases, the 3D object can be generated in a period between any of the afore-mentioned time periods (e.g., from about 10 seconds to about 1 days, from about 10 seconds to about 12 hours, from about 12 hours to about 7 days, or from about 12 hours to about 10 minutes). The time can vary based on the physical characteristics of the object, including the size and/or complexity of the object.

In some embodiments, the system, methods, software, and/or apparatus comprise at least one control mechanism (e.g., at least one controller). The methods, systems, apparatuses, and/or software disclosed herein may incorporate at least one controller that controls one or more of the (e.g., 3D printer) components described herein. In some embodiments, one controller controls two or more of the components. In some embodiments, at least two of the components are controlled by different controllers, the controller may comprise a computer-processing unit (e.g., a computer) that is operatively coupled to any of the systems and/or apparatuses, or their respective components (e.g., the energy source(s)). The systems and/or apparatuses disclosed herein may be coupled to a processing unit. The methods and/or software may incorporate the operation of a processing unit. The computer can be operatively coupled through a wired and/or through a wireless connection. In some cases, the computer can be on board a user device. A user device can be a laptop computer, desktop computer, tablet, smartphone, or another computing device. The controller can be in communication with a cloud computer system and/or a server. The controller can be programmed to (e.g., selectively) direct the energy source(s) to apply energy to the at least a portion of the target surface at a power per unit area. The controller can be in communication with the optical system (e.g., the scanner) configured to articulate the energy source(s) to apply energy to at least a portion of the target surface at a power per unit area. The optical system may comprise an optical setup.

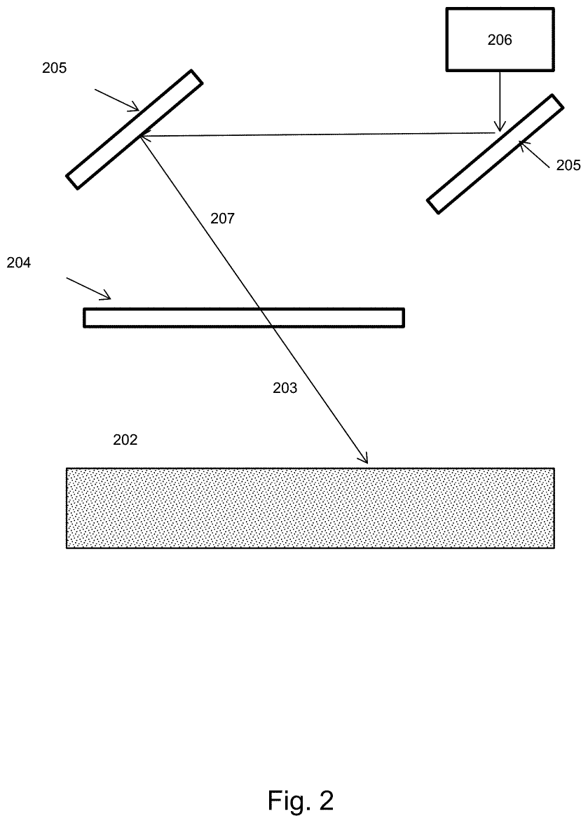

The controller may control the layer dispensing mechanism and/or any of its components. The controller may control the build module and/or the substrate (e.g., piston). The controller may control the one or more sensors. The controller may control any of the components of the 3D printing system and/or apparatus. The controller may control any of the mechanisms used to effectuate the methods described herein. The control may comprise controlling (e.g., directing and/or regulating) the movement speed (velocity) of any of the 3D printing mechanisms and/or components. The movement may be horizontal, vertical, and/or in an angle (planar and/or compound). The controller may control at least one characteristic of the transforming energy beam. The controller may control the movement of the transforming energy beam (e.g., according to a path). The controller may control the source of the (e.g., transforming and/or sensing) energy beam. The energy beam (e.g., transforming energy beam, and/or sensing energy beam) may travel through an optical setup. The optical setup may comprise a mirror, a lens, a focusing device, a prism, or an optical window. FIG. 2 shows an example of an optical setup in which an energy beam is projected from the energy source 206, and is deflected by two mirrors 205, and travels through an optical element 204. The optical element 204 can be an optical window, in which case the incoming beam 207 is a (e.g., substantially) unaltered beam 203 after crossing the optical window. The optical element 204 can be a focus altering device (e.g., lens), in which case the focus (e.g., cross section) of the incoming beam 207 is altered after passing through the optical element 204 and emerging as the beam 203. The controller may control the scanner that directs the movement of the transforming energy beam and/or platform. The focus altering device can converge or diverge the lens. The focus altering device may alter the focus (e.g., before, after, and/or during the 3D printing) dynamically. The dynamic focus alteration may result in a range of focus alteration of the energy beam. The focus altering device may be static or dynamic. The dynamic focus altering device may be controller (e.g., manually and/or automatically by at least one controller). The dynamic focus alteration may be motorized (e.g., using at least one motor).

In some embodiments, the controller controls the level of pressure (e.g., vacuum, ambient, or positive pressure) in the material removal mechanism material dispensing mechanism, and/or the enclosure (e.g., chamber). The pressure level (e.g., vacuum, ambient, or positive pressure) may be constant or varied. The pressure level may be turned on and off manually and/or automatically (e.g., by the controller). The controller may control at least one characteristic and/or component of the layer dispensing mechanism. For example, the controller may control the direction and/or rate of movement of the layer dispensing mechanism and any of its components, with respect to the target surface. The controller may control the cooling member (e.g., external and/or internal). The movement of the layer dispensing mechanism or any of its components may be predetermined. The movement of the layer dispensing mechanism or any of its components may be according to a computational scheme.

Examples of control processes (e.g., schemes), 3D printers, control system, related methods, apparatuses, systems, and program instructions (e.g., software), can be found in U.S. patent application Ser. No. 17/881,797 filed on Aug. 5, 2022, an in international patent application number PCT/US15/36802, each of which is incorporated herein by reference in its entirety. The control may be manual and/or automatic. The control may be programmed and/or be effectuated a whim. The control may be according to a computational scheme. The computational scheme may comprise a 3D printing computational scheme, or a motion control scheme. The algorithm may consider the (virtual) model of the 3D object.

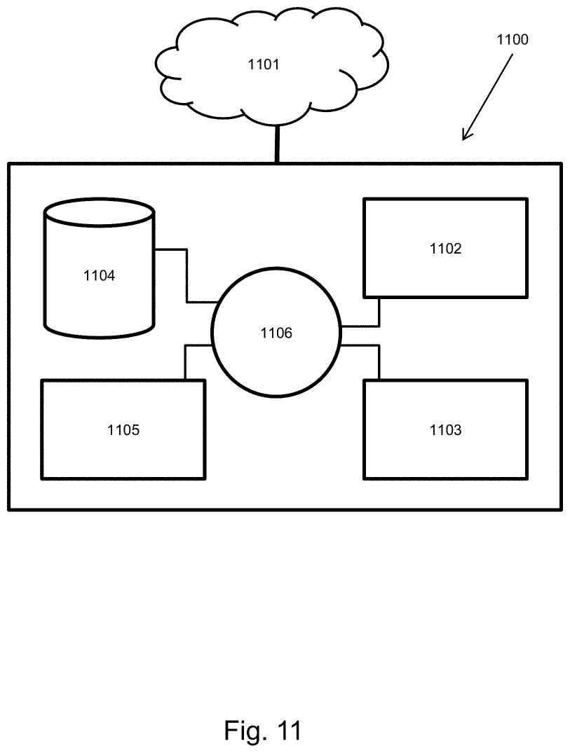

In some embodiments, the 3D printing system comprises a processor. The processor may comprise a processing unit. The controller may comprise a processing unit. The processing unit may be central. The processing unit may comprise a central processing unit (herein “CPU”). The controllers or control mechanisms (e.g., comprising a computer system) may be programmed to implement methods of the disclosure. The controller may control at least one component of the systems and/or apparatuses disclosed herein. FIG. 11 is a schematic example of a computer system 1100 that is programmed or otherwise configured to facilitate the formation of a 3D object according to the methods provided herein. The computer system 1100 can control (e.g., direct and/or regulate) various features of printing methods, software, apparatuses and systems of the present disclosure, such as, for example, regulating force, translation, heating, cooling and/or maintaining the temperature of a material bed (e.g., powder bed), process parameters (e.g., chamber pressure), scanning rate (e.g., of the energy beam and/or the build platform), scanning route of the energy source, position and/or temperature of the cooling member(s), application of the amount of energy emitted to a selected location, or any combination thereof. The computer system 1101 can be part of, or be in communication with, a printing system or apparatus, such as a 3D printing system or apparatus of the present disclosure. The computer may be operatively coupled to one or more mechanisms disclosed herein, and/or any parts thereof. For example, the computer may be operatively coupled to one or more sensors, valves, switches, motors, pumps, optical components, or any combination thereof.

In some embodiments, the computer system 1100 includes a processing unit 1106 (also “processor,” “computer” and “computer processor” used herein). The computer system may include memory or memory location 1102 (e.g., random-access memory, read-only memory, flash memory), electronic storage unit 1104 (e.g., hard disk), communication interface 1103 (e.g., network adapter) for communicating with one or more other systems, and peripheral devices 1105, such as cache, other memory, data storage and/or electronic display adapters. The memory 1102, storage unit 1104, interface 1103, and peripheral devices 1105 are in communication with the processing unit 1106 through a communication bus (solid lines), such as a motherboard. The storage unit can be a data storage unit (or data repository) for storing data. The computer system can be operatively coupled to a computer network (“network”) 1101 with the aid of the communication interface. The network can be the Internet, and/or an internet and/or extranet (e.g., an intranet and/or extranet that is in communication with the Internet). In some cases, the network is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server.

In some embodiments, the processing unit executes a sequence of machine-readable instructions (e.g., non-transitory machine readable program instructions) that can be embodied in a program or software. The instructions may be stored in a memory location, such as the memory 1102. The instructions can be directed to the processing unit, which can subsequently program or otherwise configure the processing unit to implement methods of the present disclosure. Examples of operations performed by the processing unit can include fetch, decode, execute, and/or write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), at least one controller, a programmable logic device (PLD), a chipset, a field programmable gate array (FPGA), or any combination thereof. The processing unit can be part of a circuit, such as an integrated circuit. One or more other components of the system 1100 can be included in the circuit.

In some embodiments, the storage unit (e.g., 1104) stores files, such as drivers, libraries and/or saved programs. The storage unit can store user data (e.g., user preferences and user programs). In some cases, the computer system can include one or more additional data storage units that are external to the computer system, such as located on a remote server that is in communication with the computer system through an intranet or the Internet.

In some embodiments, the computer system communicates with one or more remote computer systems through the network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system via the network.

In some embodiments, the methods described herein are implemented by way of machine (e.g., computer processor) executable code stored on an electronic storage location of the computer system, such as, for example, on the memory (e.g., 1102) or electronic storage unit (e.g., 1104). The machine executable or machine-readable code can be provided in the form of software. During use, the processor (e.g., 1106) can execute the code. In some cases, the code can be retrieved from the storage unit and stored on the memory for ready access by the processor. In some situations, the electronic storage unit can be precluded, and machine-executable instructions are stored on memory. The code can be pre-compiled and configured for use with a machine comprising a processer adapted to execute the code or can be compiled during runtime. The code can be supplied in a programming language that can be selected to enable the code to execute in a pre-compiled or as-compiled fashion.

In some embodiments, the processing unit includes one or more cores. The computer system may comprise a single core processor, mufti core processor, or a plurality of processors for parallel processing. The processing unit may comprise one or more central processing unit (CPU) and/or a graphic processing unit (GPU). The multiple cores may be disposed in a physical unit (e.g., Central Processing Unit, or Graphic Processing Unit). The processing unit may include one or more processing units. The physical unit may be a single physical unit. The physical unit may be a die. The physical unit may comprise cache coherency circuitry. The multiple cores may be disposed in close proximity. The physical unit may comprise an integrated circuit chip. The integrated circuit chip may comprise one or more transistors. The integrated circuit chip may comprise at least about 0.2 billion transistors (BT), 0.5 BT, 1BT, 2 BT, 3 BT, 5 BT, 6 BT, 7 BT, 8 BT, 9 BT, 10 BT, 15 BT, 20 BT, 25 BT, 30 BT, 40 BT, or 50 BT. The integrated circuit chip may comprise at most about 7 BT, 8 BT, 9 BT, 10 BT, 15 BT, 20 BT, 25 BT, 30 BT, 40 BT, 50 BT, 70 BT, or 100 BT. The integrated circuit chip may comprise any number of transistors between the afore-mentioned numbers (e.g., from about 0.2 BT to about 100 BT, from about 1 BT to about 8 BT, from about 8 BT to about 40 BT, or from about 40 BT to about 100 BT). The integrated circuit chip may have an area of at least about 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of at most about 50 mm², 60 mm², 70 mm², 80 mm², 90 mm², 100 mm², 200 mm², 300 mm², 400 mm². 500 mm², 600 mm², 700 mm², or 800 mm². The integrated circuit chip may have an area of any value between the afore-mentioned values (e.g., from about 50 mm² to about 800 mm², from about 50 mm² to about 500 mm², or from about 500 mm² to about 800 mm²). The close proximity may allow substantial preservation of communication signals that travel between the cores. The close proximity may diminish communication signal degradation. A core, as understood herein, is a computing component having independent central processing capabilities. The computing system may comprise a plurality of cores, which are disposed on a single computing component. The plurality of cores may include two or more independent central processing units. The independent central processing units may constitute a unit that reads and executes program instructions. The independent central processing units may constitute one or more parallel processing units. The parallel processing units may be cores and/or digital signal processing slices (DSP slices). The plurality of cores can be parallel cores. The plurality of DSP slices can be parallel DSP slices. The plurality of cores and/or DSP slices can function in parallel. The plurality of cores may include at least about 2, 10, 40, 100, 400, 1000, 2000, 3000, 4000, 5000, 6000, 7000, 8000, 9000, 10000, 11000, 12000, 13000, 14000 or 15000 cores. The plurality of cores may include at most about 1000, 2000, 3000, 4000, 5000, 6000, 7000, 8000, 9000, 10000, 11000, 12000, 13000, 14000, 15000, 20000, 30000, or 40000 cores. The plurality of cores may include cores of any number between the afore-mentioned numbers (e.g., from about 2 to about 40000, from about 2 to about 400, from about 400 to about 4000, from about 2000 to about 4000, from about 4000 to about 10000, from about 4000 to about 15000, or from about 15000 to about 40000 cores). In some processors (e.g., FPGA), the cores may be equivalent to multiple digital signal processor (DSP) slices (e.g., slices). The plurality of DSP slices may be equal to any of plurality core values mentioned herein. The processor may comprise low latency in data transfer (e.g., from one core to another). Latency may refer to the time delay between the cause and the effect of a physical change in the processor (e.g., a signal). Latency may refer to the time elapsed from the source (e.g., first core) sending a packet to the destination (e.g., second core) receiving it (also referred as two-point latency). One-point latency may refer to the time elapsed from the source (e.g., first core) sending a packet (e.g., signal) to the destination (e.g., second core) receiving it, and the destination sending a packet back to the source (e.g., the packet making a round trip). The latency may be sufficiently low to allow a high number of floating-point operations per second (FLOPS). The number of FLOPS may be at least about 0.1 Tera FLOPS (T-FLOPS), 0.2 T-FLOPS, 0.25 T-FLOPS, 0.5 T-FLOPS, 0.75 T-FLOPS, 1 T-FLOPS, 2 T-FLOPS, 3 T-FLOPS, 5 T-FLOPS, 6 T-FLOPS, 7 T-FLOPS, 8 T-FLOPS, 9 T-FLOPS, or 10 T-FLOPS. The number of flops may be at most about 0.2 T-FLOPS, 0.25 T-FLOPS, 0.5 T-FLOPS, 0.75 T-FLOPS, 1 T-FLOPS, 2 T-FLOPS, 3 T-FLOPS, 5 T-FLOPS, 6 T-FLOPS, 7 T-FLOPS, 8 T-FLOPS, 9 T-FLOPS, 10 T-FLOPS, 20 T-FLOPS, 30 T-FLOPS, 50 T-FLOPS, 100 T-FLOPS, 1 P-FLOPS, 2 P-FLOPS, 3 P-FLOPS, 4 P-FLOPS, 5 P-FLOPS, 10 P-FLOPS, 50 P-FLOPS, 100 P-FLOPS, 1 EXA-FLOP, 2 EXA-FLOPS or 10 EXA-FLOPS. The number of FLOPS may be any value between the afore-mentioned values (e.g., from about 0.1 T-FLOP to about 10 EXA-FLOPS, from about 0.1 T-FLOPS to about 1 T-FLOPS, from about 1 T-FLOPS to about 4 T-FLOPS, from about 4 T-FLOPS to about 10 T-FLOPS, from about 1 T-FLOPS to about 10 T-FLOPS, from about 10 T-FLOPS to about 30 T-FLOPS, from about 50 T-FLOPS to about 1 EXA-FLOP, or from about 0.1 T-FLOP to about 10 EXA-FLOPS). In some processors (e.g., FPGA), the operations per second may be measured as (e.g., Giga) multiply-accumulate operations per second (e.g., MACs or GMACs). The MACs value can be equal to any of the T-FLOPS values mentioned herein measured as Tera-MACs (T-MACs) instead of T-FLOPS respectively. The FLOPS can be measured according to a benchmark. The benchmark may be a HPC Challenge Benchmark. The benchmark may comprise mathematical operations (e.g., equation calculation such as linear equations), graphical operations (e.g., rendering), or encryption/decryption benchmark. The benchmark may comprise a High Performance LINPACK, matrix multiplication (e.g., DGEMM), sustained memory bandwidth to/from memory (e.g., STREAM), array transposing rate measurement (e.g., PTRANS), Random-access, rate of Fast Fourier Transform (e.g., on a large one-dimensional vector using the generalized Cooley-Tukey algorithm), or Communication Bandwidth and Latency (e.g., MPI-centric performance measurements based on the effective bandwidth/latency benchmark). LINPACK may refer to a software library for performing numerical linear algebra on a digital computer. DGEMM may refer to double precision general matrix multiplication. STREAM benchmark may refer to a synthetic benchmark designed to measure sustainable memory bandwidth (in MB/s) and a corresponding computation rate for four simple vector kernels (Copy, Scale, Add and Triad). PTRANS benchmark may refer to a rate measurement at which the system can transpose a large array (global). MPI may refer to Message Passing Interface.

The computer system may include hyper-threading technology. The computer system may include a chip processor with integrated transform, lighting, triangle setup, triangle clipping, rendering engine, or any combination thereof. The rendering engines may be capable of processing at least about 10 million calculations per second. The rendering engine may be capable of processing at least about 10 million polygons per second. As an example, the GPU may include a GPU by Nvidia, ATI Technologies, S3 Graphics, Advanced Micro Devices (AMD), or Matrox. The processing unit may be able to process computational schemes comprising a matrix or a vector. The core may comprise a complex instruction set computing core (CISC), or reduced instruction set computing (RISC).

In some examples, the computer system includes an electronic chip that is reprogrammable (e.g., field programmable gate array (FPGA)). For example, the FPGA may comprise Tabula, Altera, or Xilinx FPGA. The electronic chips may comprise one or more programmable logic blocks (e.g., an array). The logic blocks may compute combinational functions, logic gates, or any combination thereof. The computer system may include custom hardware. The custom hardware may comprise a computational scheme.

In some embodiments, the computer system includes configurable computing, partially reconfigurable computing, reconfigurable computing, or any combination thereof. The computer system may include an FPGA. The computer system may include an integrated circuit that performs the computational scheme. For example, the reconfigurable computing system may comprise FPGA, CPU, GPU, or multi-core microprocessors. The reconfigurable computing system may comprise a High-Performance Reconfigurable Computing architecture (HPRC). The partially reconfigurable computing may include module-based partial reconfiguration, or difference-based partial reconfiguration. The reconfigurable computing environment may comprise reconfigure one or more models (e.g., physical models) used for 3D printing. The FPGA may comprise configurable FPGA logic, and/or fixed-function hardware comprising: multipliers, memories, microprocessor cores, first in-first out (FIFO) and/or error correcting code (ECC) logic, digital signal processing (DSP) blocks, peripheral component interconnect express (PCI Express) controllers, Ethernet media access control (MAC) blocks, or high-speed serial transceivers. DSP blocks can be DSP slices.

In some embodiments, the computing system includes an integrated circuit that performs the computational scheme (e.g., control scheme). The physical unit (e.g., the cache coherency circuitry within) may have a clock time of at least about 0.1 Gigabits per second (Gbit/s), 0.5 Gbit/s, 1 Gbit/s, 2 Gbit/s, 5 Gbit/s, 6 Gbit/s, 7 Gbit/s, 8 Gbit/s, 9 Gbit/s, 10 Gbit/s, or 50 Gbit/s. The physical unit may have a clock time of any value between the afore-mentioned values (e.g., from about 0.1 Gbit/s to about 50 Gbit/s, or from about 5 Gbit/s to about 10 Gbit/s). The physical unit may produce the computational scheme output in at most about 0.1 microsecond (μs), 1 μs, 10 μs, 100 μs, or 1 millisecond (ms). The physical unit may produce the computational scheme output in any time between the afore-mentioned times (e.g., from about 0.1 μs, to about 1 ms, from about 0.1 μs, to about 100 μs, or from about 0.1 μs to about 10 μs).

In some instances, the controller uses calculations, real-time measurements, or any combination thereof, to regulate at least one characteristic of the energy beam(s) and/or energy source(s). The sensor (e.g., temperature and/or metrological sensor) may provide a signal (e.g., input for the controller and/or processor) at a rate of at least about 0.1 KHz, 1 KHz, 10 KHz, 100 KHz, 1000 KHz, or 10000 KHz). The sensor may provide a signal at a rate between any of the above-mentioned rates (e.g., from about 0.1 KHz to about 10000 KHz, from about 0.1 KHz to about 1000 KHz, or from about 1000 KHz to about 10000 KHz). The memory bandwidth of the processing unit may be at least about 1 gigabyte per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processing unit may be at most about 1 gigabyte per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processing unit may have any value between the afore-mentioned values (e.g., from about 1 Gbytes/s to about 1000 Gbytes/s, from about 100 Gbytes/s to about 500 Gbytes/s, from about 500 Gbytes/s to about 1000 Gbytes/s, or from about 200 Gbytes/s to about 400 Gbytes/s). The sensor measurements may be real-time measurements. The real-time measurements may be conducted during the 3D printing process. The real-time measurements may be in situ measurements in the 3D printing system and/or apparatus. The real-time measurements may be during at least a portion of the formation of the 3D object. In some instances, the processing unit may use the signal obtained from the at least one sensor to provide a processing unit output, which output is provided by the processing system at a speed of at most about 100 min, 50 min, 25 min, 15 min, 10 min. 5 min, 1 min, 0.5 min (i.e., 30 sec), 15 sec, 10 sec, 5 sec, 1 sec, 0.5 sec, 0.25 sec, 0.2 sec, 0.1 sec, 80 milliseconds (msec), 50 msec, 10 msec, 5 msec, 1 msec, 80 microseconds (μsec), 50 μsec, 20 μsec, 10 μsec, 5 μsec, or 1 μsec. In some instances, the processing unit may use the signal obtained from the at least one sensor to provide a processing unit output, which output is provided at a speed of any value between the afore-mentioned values (e.g., from about 100 min to about 1 μsec, from about 100 min to about 10 min, from about 10 min to about 1 min, from about 5 min to about 0.5 min, from about 30 sec to about 0.1 sec, from about 0.1 sec to about 1 msec, from about 80 msec to about 10 μsec, from about 50 μsec to about 1 μsec, from about 20 μsec to about 1 μsec, or from about 10 μsec to about 1 μsec).

The processing unit output may comprise an evaluation of: a temperature at a location, a map of temperatures at locations, a position at a location (e.g., vertical and/or horizontal), or a map of positions at locations. The position may be horizontal and/or vertical. The position may be in space (e.g., comprising X Y and Z coordinates). The location may be on the target surface. The map may comprise a topological and/or temperature map. The temperature sensor may comprise a temperature imaging device (e.g., IR imaging device).

In some embodiments, the processing unit uses the signal obtained from the at least one sensor in a computational scheme that is used in controlling the energy beam (e.g., in the 3D printing instructions). The computational scheme may comprise the path of the energy beam. In some instances, the computational scheme may be used to alter the path (e.g., trajectory) of the energy beam on the target surface. The path may deviate from a cross section of a (virtual) model corresponding to the requested 3D object. The processing unit may use the output in a computational scheme that is used in determining the manner in which a model of the requested 3D object may be sliced. In some embodiments, the processing unit uses the signal obtained from the at least one sensor in a computational scheme that is used to configure one or more parameters, systems, and/or apparatuses relating to the 3D printing process. The parameters may comprise a characteristic of the energy beam. The parameters may comprise movement of the build platform and/or material bed. The parameters may comprise relative movement of the energy beam to the material bed. In some instances, the energy beam, the build platform (e.g., material bed disposed on the build platform), or both may translate. The controller may use historical data for the control. The processing unit may use historical data in its one or more computational schemes. The parameters may comprise the height of the layer of pre-transformed (e.g., powder) material disposed in the enclosure and/or the gap by which the cooling element (e.g., heat sink) is separated from the target surface. The target surface may be the exposed layer of the material bed.

In some embodiments, aspects of the systems, apparatuses, and/or methods provided herein, such as the computer system, are embodied in programming (e.g., using a software). Various aspects of the technology may be thought of as “product,” “object,” or “articles of manufacture” typically in the form of machine (or processor) executable code and/or associated data that is carried on or embodied in a type of machine-readable medium. Machine-executable code can be stored on an electronic storage unit, such as memory (e.g., read-only memory, random-access memory, flash memory) or a hard disk. The storage may comprise non-volatile storage media. “Storage” type media can include any or all the tangible memory of the computers, processors or the like, or associated modules thereof, such as various semiconductor memories, tape drives, disk drives, external drives, and the like, which may provide non-transitory storage at any time for the software programming. The memory may comprise a random-access memory (RAM), dynamic random-access memory (DRAM), static random-access memory (SRAM), synchronous dynamic random-access memory (SDRAM), ferroelectric random-access memory (FRAM), read only memory (ROM), programmable read only memory (PROM), erasable programmable read only memory (EPROM), electrically erasable programmable read only memory (EEPROM), a flash memory, or any combination thereof. The flash memory may comprise a negative-AND (NAND) or NOR logic gates. A NAND gate (negative-AND) may be a logic gate which produces an output which is false only if all its inputs are true. The output of the NAND gate may be complemented to that of the AND gate. The storage may include a hard disk (e.g., a magnetic disk, an optical disk, a magneto-optic disk, a solid-state disk, etc.), a compact disc (CD), a digital versatile disc (DVD), a floppy disk, a cartridge, a magnetic tape, and/or another type of computer-readable medium, along with a corresponding drive.

In some embodiments, at least portions (e.g., all) of the software may at times be communicated through the Internet or various other telecommunication networks. Such communications, for example, may enable loading of the software from one computer or processor into another, for example, from a management server and/or a host computer, into the computer platform of an application server. Thus, another type of media that may bear the software elements comprises optical, electrical, or electromagnetic waves; for example, such as the ones used across physical interfaces between local devices, through wired and optical landline networks, and/or over various air-links. The physical elements that carry such waves (e.g., such as wired or wireless links, optical links, or the like) also may be considered as media bearing the software. As used herein, unless restricted to non-transitory, tangible “storage” media, terms such as computer or machine “readable medium” refer to any medium that participates in providing instructions to a processor for execution.

In some embodiments, the computer system utilizes a machine-readable medium/media to execute, or direction execution of, operation(s). The program instructions can be inscribed in a machine executable code, such as computer-executable code, which may take many forms, including but not limited to, a tangible storage medium, a carrier wave medium, or physical transmission medium. Non-volatile storage media include, for example, optical or magnetic disks, such as any of the storage devices in any computer(s) or the like, such as may be used to implement the databases.

Volatile storage media can include dynamic memory, such as main memory of a computer platform. Tangible transmission media can include coaxial cables, wire (e.g., copper wire), and/or fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, any other medium from which a computer may read programming code and/or data, or any combination thereof. The memory and/or storage may comprise a storing device external to and/or removable from device, such as a Universal Serial Bus (USB) memory stick, or/and a hard disk. Many of these forms of computer readable media may be involved in carrying one or more sequences of one or more instructions to a processor for execution.

In some embodiments, the computer system comprises an electronic display. The computer system can include, or be in communication with, the electronic display. The electronic display may comprise a user interface (UI) for providing, for example, a model design or graphical representation of a 3D object to be printed (e.g., before, after, and/or during the 3D printing (e.g., in real-time)). Examples of UI's include, without limitation, a graphical user interface (GUI) and web-based user interface. The computer system can monitor and/or control various aspects of the 3D printing system. The control may be manual and/or programmed. The control may rely on one or more feedback mechanisms (e.g., using signals from the one or more sensors). The control may consider historical data. The control mechanism may be pre-programmed. The control mechanisms may rely on input from sensors (described herein) that are connected to the control unit (i.e., control system or control mechanism). The computer system may store historical data concerning various aspects of the operation of the 3D printer. The historical data may be retrieved at predetermined times and/or at a whim. The historical data may be accessed by an operator and/or by a user. The historical, sensor, and/or operative data may be provided in an output unit (e.g., a display unit). The output unit (e.g., monitor) may output various parameters of the 3D printing system (as described herein) in real-time and/or in a delayed time (e.g., before, after, and/or during the 3D printing). The output unit may output the current 3D printed object (e.g., build), the requested (e.g., ordered) 3D printed object, or both. The output unit may output the printing progress of the 3D printed object (e.g., in rea-time). The output unit may output at least one of the total time, time remaining, and time expanded on printing the 3D object. The output unit may output (e.g., display, voice, and/or print) the status of sensors, their reading, and/or time for their calibration or maintenance. The output unit may output the type of material(s) used and various characteristics of the material(s) such as temperature and flowability of the pre-transformed material. The output unit may output the amount of oxygen, water, and pressure in the printing chamber (i.e., the chamber where the 3D object is being printed). The computer may generate a report comprising various parameters of the 3D printing system, method, and or objects at predetermined time(s), on a request (e.g., from an operator), and/or at a whim. The output unit may comprise a screen, printer, or speaker. The control system may provide a report. The report may comprise any items recited as an output of the output unit.

In some embodiments, the system and/or apparatus described herein (e.g., controller) and/or any of their components comprise an output and/or an input device. The input device may comprise a keyboard, touch pad, camera, touch screen, or microphone. The output device may be a sensory output device. The output device may comprise a visual, tactile, or audio device. The audio device may include a loudspeaker. The visual output device may include a screen and/or a printed hard copy (e.g., paper). The output device may include a (e.g., two-dimensional) printer (e.g., paper printer). The apparatus may record one or more operations and/or specifications of the system and/or apparatus. The record may be used for process optimization, certification, and/or specification. The input device may include a camera, a microphone, a keyboard, or a (e.g., touch) screen. The system and/or apparatus described herein (e.g., controller) and/or any of their components may comprise Bluetooth technology. The system and/or apparatus described herein (e.g., controller) and/or any of their components may comprise a communication port. The communication port may be a serial port or a parallel port. The communication port may be a Universal Serial Bus port (i.e., USB). The system and/or apparatus described herein (e.g., controller) and/or any of their components may comprise USB ports. The USB can be micro or mini-USB. The USB port may relate to device classes comprising 00 h, 01 h, 02 h, 03 h, 05 h, 06 h, 07 h, 08h, 09 h, 0 Ah, 0Bh, 0Dh, 0Eh, 0Fh, 10 h, 11 h, DCh, E0 h, Efh, Feh, or FFh. The system and/or apparatus described herein (e.g., controller) and/or any of their components may comprise a plug and/or a socket (e.g., electrical, AC power, DC power). The system and/or apparatus described herein (e.g., controller) and/or any of their components may comprise an adapter (e.g., AC and/or DC power adapter). The system and/or apparatus described herein (e.g., controller) and/or any of their components may comprise a power connector. The power connector can be an electrical power connector. The power connector may comprise a magnetically coupled (e.g., attached) power connector. The power connector can be a dock connector. The connector can be a data and power connector. The connector may comprise pins. The connector may comprise at least 10, 15, 18, 20, 22, 24, 26, 28, 30, 40, 42, 45, 50, 55, 80, or 100 pins.

In some examples, the systems, methods, software, and/or apparatuses disclosed herein may comprise receiving a request for a 3D object (e.g., from a customer). The request can include a model (e.g., CAD) of the requested 3D object. Alternatively, or additionally, a (virtual) model of the requested 3D object may be generated. The model may be used to generate 3D printing instructions. In some examples, the 3D printing instructions may exclude the 3D model (e.g., and include a modification thereof, e.g., a geometric modification). The 3D printing instructions may be based on the 3D model. The 3D printing instructions may take the 3D model into account. The 3D printing instructions may be alternatively or additionally based on simulations (e.g., thermos-mechanical simulations). The 3D printing instructions may use the 3D model. The 3D printing instructions may comprise using a computational scheme (e.g., embedded in a software) that considers the 3D model, simulations, historical data, sensor input, or any combination thereof. The control can be of at least one characteristic of the energy beam (e.g., as disclosed herein). The control can comprise using a simulation. The computer model (e.g., physical model) may comprise one or more simulation. The simulation can comprise a temperature or mechanical simulation of the 3D printing (e.g., of the requested and/or requested 3D object). The simulation may comprise thermo-mechanical simulation. The simulation can comprise a material property of the requested 3D object. The thermo-mechanical simulation can comprise elastic or plastic simulation. The control can comprise using a graphical processing unit (GPU), system-on-chip (SOC), application specific integrated circuit (ASIC), application specific instruction-set processor (ASIPs), programmable logic device (PLD), or field programmable gate array (FPGA). The processor may compute at least a portion of the computational scheme during the 3D printing process (e.g., in real-time), during the formation of the 3D object, prior to the 3D printing process, after the 3D printing process, or any combination thereof. The processor may compute the computational scheme in the interval between pulses of the (e.g., transforming) energy beam, during the dwell time of the energy beam, before the energy beam translates to a new position, while the energy beam is not translating, while the energy beam does not irradiate the target surface, while the energy beam irradiates the target surface, or any combination thereof. For example, the processor may compute the computational scheme while the energy beam translates and does (e.g., substantially) not irradiate the exposed surface. For example, the processor may compute the computational scheme while the energy beam does not translate and/or irradiates the exposed surface. For example, the processor may compute the computational scheme while the energy beam does not (e.g., substantially) translate and does (e.g., substantially) not irradiate the exposed surface. For example, the processor may compute the computational scheme while the energy beam does translate and/or irradiates the exposed surface.

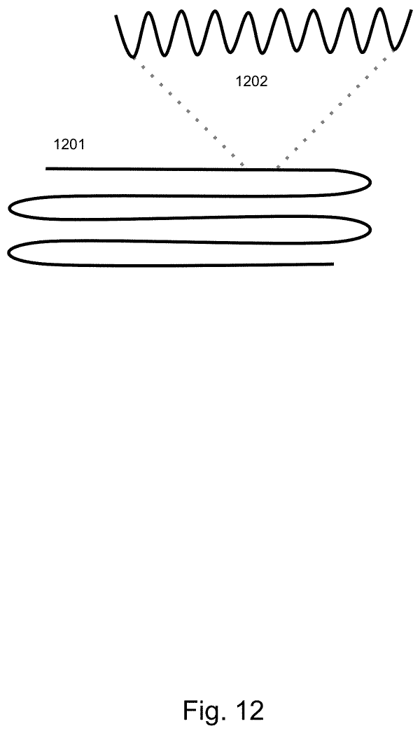

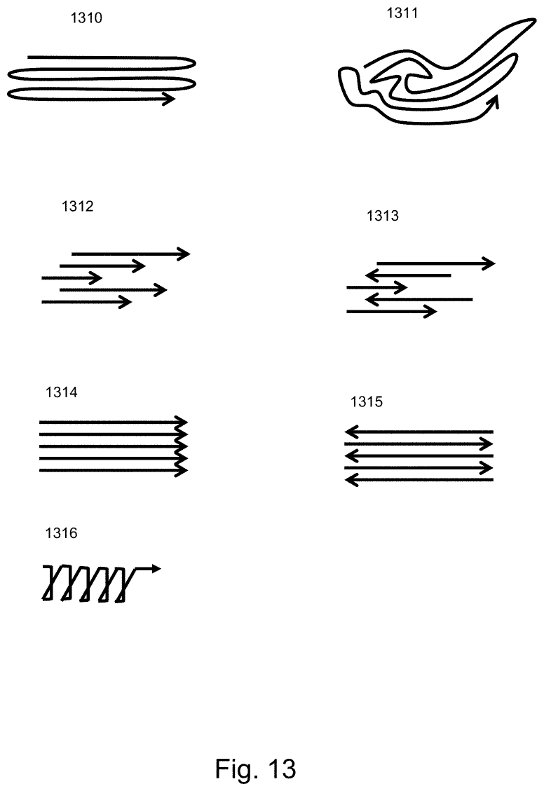

In some embodiments, the energy beam translates along an entire path or a portion thereof. The path may correspond to a cross section of the model of the requested 3D object. The translation of the energy beam may be translation along at least one hatching within the path. The path of the energy beam may comprise an oscillating pattern, e.g., FIG. 12. The path of the energy beam may comprise a zigzag, wave (e.g., curved, triangular, or square), or curve pattern. The curved wave may comprise a sine or cosine wave. The path of the energy beam may comprise a sub-pattern. The path of the energy beam may comprise an oscillating (e.g., zigzag), wave (e.g., curved, triangular, or square), and/or curved sub-pattern. The curved wave may comprise a sine or cosine wave. FIG. 13 shows examples of various paths 1310, 1311, 1312, 1313, 1314, 1315, and 1316. The direction of the arrow(s) in FIG. 13 represents the direction according to which the energy beam scans the target surface. The path may correspond to a position in the exposed surface of the material bed with which the energy beam interacts. The various vectors depicted in FIG. 13, 1314 show an example of various hatchings. The respective movement of the energy beam with respect to the material bed may oscillate while traveling along the path. For example, the propagation of the energy beam along a path may be by small path deviations (e.g., variations such as oscillations). FIG. 12 shows an example of a path 1201. The sub path 1202 is a magnification of a portion of the path 1201 showing path deviations (e.g., oscillations). FIG. 12 shows an example of a path 1201 of an energy beam comprising a zigzag sub-pattern (e.g., energy beam sub-path 1202 shown as an expansion (e.g., blow-up) of a portion of the path 1201). The sub-path of the energy beam may comprise a wave (e.g., sine or cosine wave) pattern. The sub-path may be a small path that forms the large path. The sub-path may be a component (e.g., a portion) of the large path. The path that the energy beam follows may be a predetermined path. A model may predetermine the path by utilizing at least one controller or an individual (e.g., human). The controller may comprise a processor. The processor may comprise a computer, computer program, drawing or drawing data, statue or statue data, or any combination thereof. The hatch lines or paths may be straight or curved. The hatch lines or paths may be winding. At times, the path comprises successive lines. The successive lines may touch each other. The successive lines may overlap each other in at least one point. The successive lines may (e.g., substantially) overlap each other. The successive lines may be spaced by a first distance (e.g., hatch spacing). Examples of 3D printing systems, apparatuses, devices and any component thereof, controllers, software, and 3D printing processes (e.g., hatch spacings) can be found in International Patent Application Serial No PCT/US16/34857 filed on May 27, 2016, titled “THREE-DIMENSIONAL PRINTING AND THREE-DIMENSIONAL OBJECTS FORMED USING THE SAME” that is entirely incorporated herein by reference.

In some embodiments, the 3D printer includes, or is operatively coupled to, a height mapper system. The height mapper system comprises one or more detectors (e.g., cameras), and optical image generator. The optical image generator may comprise a projector or a laser. The optical image generator may generate a detectable oscillating optical image, e.g., as disclosed herein. At times, the height mapper system is integrated with optical windows (e.g., FIG. 1, 115). The height mapper system may comprise (1) one or more optical detectors, (2) one or more projectors, and (3) one or more processors configured to process the detected image. The one or more processors may be operatively coupled to, or part of, one or more controllers. The one or more controllers (e.g., control system) may be the control may be configured to control the 3D printing of one or more 3D objects. The control system may be a hierarchical control system (e.g., comprising three or more hierarchical levels of control).

In some embodiments, the 3D printer includes a plurality of energy beam (e.g., lasers). The 3D printer may comprise at least 2, 4, 6, 8, 10, 12, 16, 20, 24, 32, 36, 64 or more energy beams. Each of the energy beam may be coupled with its own optical window. At times, at least two energy beams may shine through the same optical window. At times, at least two energy beams may shine through different optical windows.

In some embodiments, the height mapper system projects a light pattern onto the exposed surface of a material bed that includes a protruding object (e.g., FIGS. 14, 1400 and 1413). The protruding object may reflect (e.g., specular) light that causes saturation of the metrological detector. Disposing an additional detector distant from the first detector can alleviate the detection problem by supplementing a detection of the protruding object that by a non-saturated detector. Disposing an additional optical image generator distant from the first optical image generator that is configured to project the image on the exposed surface from another angle, can alleviate the detection problem by projecting an image on the exposed surface that will not cause saturation of the detector.

In some embodiments, the enclosure comprises, or is operatively coupled to, optical windows. A plurality of optical windows may be distributed about the enclosure (e.g., wall(s) of the enclosure comprising the ceiling) to facilitate impingement of the energy beam(s) of the optical system onto the target surface. The plurality of optical windows may comprise at least about two, four, six, eight, ten, twelve, fourteen, sixteen, eighteen, twenty, twenty-four, twenty-eight, thirty-two, thirty-six, sixty-four, ninety-six, or more optical windows. The plurality of optical windows may be arranged in an array of optical windows. The array of optical windows, e.g., at least two optical windows, may be distributed asymmetrically with respect to each other. The array of optical windows may be distributed asymmetrically with respect to the enclosure and/or target surface. The array of optical windows may be distributed symmetrically with respect to each other. The components of the metrological detection system (e.g., height mapper) may be distributed symmetrically (i) with respect to the ceiling of the enclosure, (ii) with respect to the target surface, and/or (iii) with respect to each other. The symmetry of at least a portion of the metrology detection system components may correspond to the symmetry of the optical windows. The symmetry of the optical windows may correspond to the symmetry of the optical assemblies in the optical system. Symmetrically arranged may comprise a rotational symmetry axis or a mirror symmetry plane. The rotational symmetry axis may be disposed between two optical windows or a pair of optical windows. The mirror symmetry plane may be disposed between two optical windows. The rotational symmetry axis and/or the mirror symmetry plane may be oriented perpendicular to a floor of the enclosure relative to a gravitational center (e.g., gravitational center of the environment, e.g., the Earth), and/or perpendicular to a surface of a build plate. The rotational symmetry axis may comprise a C2 (180 degrees), C3 (120 degrees), or C4 (90 degrees) symmetry axis. The rotational symmetry axis and/or the mirror symmetry plane may be perpendicular (i) to a plane in which an optical windows are disposed, (ii) to the target surface (iii) to the build plate, and/or (iv) to the plane in which the optical assemblies are disposed. In some embodiments, the rotational symmetry axis is parallel (i) to a plane in which an optical windows are disposed, (ii) to the target surface (iii) to the build plate, and/or (iv) to the plane in which the optical assemblies are disposed. The rotational symmetry axis can be perpendicular or parallel to the gravitational vector pointing towards the environmental gravitational vector. The mirror plane can include the gravitational vector pointing towards the environmental gravitational vector. The array of optical windows may comprise at least one linear array of optical windows. The array of optical windows may comprise a two-dimensional array of optical windows, for example, including at least four optical windows. The array of optical windows may comprise a two-dimensional array of optical windows including at least two linear arrays, where the optical windows of each linear array are aligned with respect to a central axis of the linear array and where the central axis of each linear array is arranged parallel to each other. For example, the array of optical windows includes four linear arrays of two optical windows each. For example, the array of optical windows includes 8 linear arrays of at least 8 optical windows each, e.g., for a total of at least about 64 optical windows in the two-dimensional array. The optical window may comprise an FLS, e.g., a thickness, substantially sufficient to retain (e.g., within the enclosure) an internal atmospheric environment within the enclosure that is separate from an external atmospheric environment outside the enclosure, e.g., any atmospheric environment disclosed herein. The optical window(s) may comprise a material, for example, sapphire, beryllium, zinc selenide, calcium fluoride, or fused silica. The optical window(s) may comprise a material having a (e.g., substantially) diminished thermal lensing effect during a three-dimensional printing process. At least one optical window may be engaged by a component of a metrological detection system, e.g., may facilitate line-of-sight by a component of a metrological detection system of the target surface within the enclosure. Further details of the metrological detection system are discussed herein. The components of the metrology detection system may couple to the enclosure (e.g., ceiling thereof) by windows similar to those configured to transmit the energy beam. The component may comprise projector(s) or detector(s).

FIG. 38 illustrates an example of a device comprising a plurality of window holders 3810a-f disposed in two manifolds. Each of holders 3810a-d is supporting each of windows 3804a-d, respectively. The window holders 3810a-d are connected through an integrated manifold 3805a. Each of holders 3810e-h is supporting each of windows 3804e-h, respectively. The window holders 3810e-h are connected through an integrated manifold 3805b. Any of the integrated manifold may include a gas passage through which gas is directed into a purge gas passage in each of the window holders 3810a-d. The device comprising the optical windows 3804a-h is configured for disposition at a ceiling of a processing chamber in which one or more 3D object can be printed. Each of the windows 3804a-h is configured to facilitate passage of a transforming energy beam into the processing chamber. The device in FIG. 38 comprises two components 3801, 3802, and 3803 of a metrological detection system, the two components 3801 and 3802 being of a first type, and component 3803 of a different type. The first type can be a detector (e.g., a metrological detector comprising a camera), and the second type can be a projector configured to project an image. The second type can be a detector (e.g., a metrological detector), and the first type can be a projector configured to project an image. FIG. 38 shows an example of two components of a metrology detection system that are related to each other. Dotted line 3851 can represent a mirror symmetry plane perpendicular to the page and going through dotted line 3851, or a C2 symmetry axis running along line 3851. Components 3801 and 3802 of the metrology detection system (that are of the same type) relate to each other via the C2 symmetry axis running along 3851, or though a mirror plane going through dotted line 3851. Components 3801 and 3802 relate to each other by an inversion symmetry point in the intersection between dotted line 3851 and dotted line 3850. Components 3801 and 3802 relate to each other by a C2 rotational axis going through the intersection between dotted line 3851 and 3850. Components 3801 and 3802 of the metrology detection system (that are of the same type) relate to each other via a symmetrical relationship through another component of the metrology detection system 3803 (of a different type as 3801 and 3802). Examples of gas flow system, 3D printers, related control system, related methods, apparatuses, systems, and program instructions (e.g., software), can be found in International Patent Application Serial No. PCT/US22/16550 filed Feb. 16, 2022, which is incorporated herein by reference in its entirety.

In some embodiments, debris is generated during the 3D printing process, e.g., as a by-product. The debris may comprise soot. When the debris is disposed between the optical window and the target surface, the debris may absorb and/or scatter the energy beam, and thus a lower-than-expected radiation intensity will impinge the target surface. The lower radiation may cause formation of defect(s) in a 3D object resulting from such printing process. When using a plurality of energy beams to irradiate a layer of material bed to generate one or more 3D objects in a print cycle, it may be preferable to complete an irradiation task of a first energy beam before initiating irradiation of a second energy beam. For example, when the first energy beam may generate soot that could obstruct the second energy beam. In order to coordinate timing of radiating with the first energy beam and with the second energy beam, the controllers of the first energy beam and of the second energy beam should be aligned. The alignment may include path alignment, intensity alignment, cross sectional alignment, optical alignment, and/or time alignment (e.g., time synchronization). For example, a controller of a particular energy beam participating in the irradiation of a material bed layer, should wait (i) until all previously irradiating energy beams having irradiation task(s) in that layer, finish their irradiation task(s) for the layer; (ii) until all previously irradiating energy beams having irradiation task(s) in that layer that generate debris that obstruct the optical path of the particular energy beam and its target on the material bed layer, finish their irradiation task(s) for that layer; and/or (iii) until the energy beam having the longest irradiation task for that layer, finishes its irradiation task.

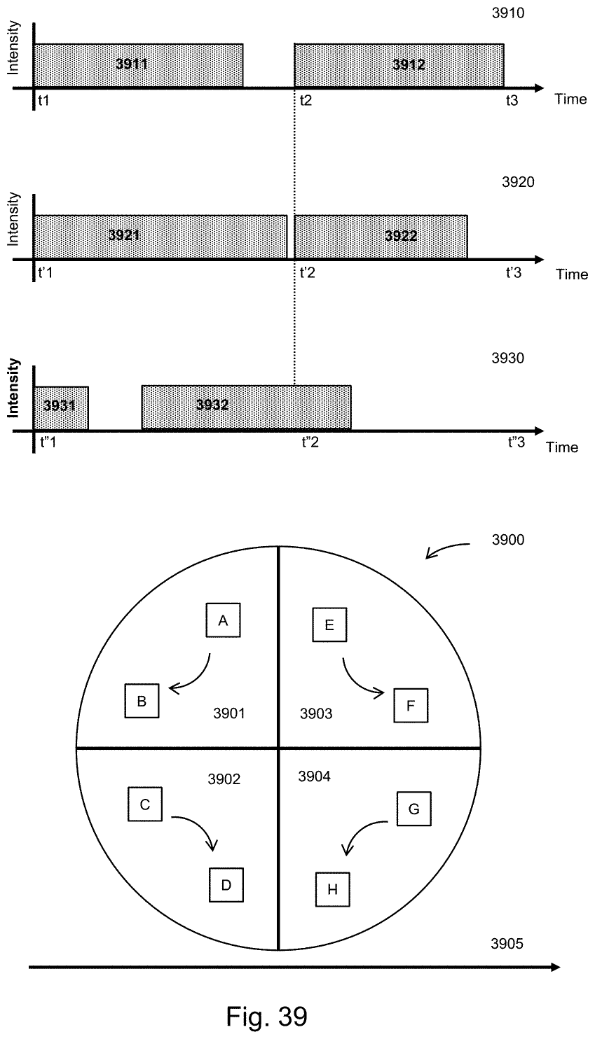

FIG. 39 shows an example of an exposed surface of a material bed 3900 having portions 3901, 3902, 3903, and 3904. A first energy beam is tasked with irradiating locations A and B in material bed portion 3901; a second energy beam is tasked with irradiating locations C and D in material bed portion 3902; a third energy beam is tasked with irradiating locations E and F in material bed portion 3903; and a fourth energy beam is tasked with irradiating locations G and H in material bed portion 3904. Graph 3910 shows irradiation intensity as a function of time of the first energy beam; graph 3920 shows irradiation intensity as a function of time of the second energy beam; and graph 3930 shows irradiation intensity as a function of time of the third energy beam. Arrow 3905 shows a direction of movement of the gas flow above material bed 3900. Section 3911 depicts radiation intensity vs. time of the first energy beam that irradiates location A, and Section 3912 depicts radiation intensity vs. time of the first energy beam that irradiates location B. Section 3921 depicts radiation intensity vs. time of the second energy beam that irradiates location B, and Section 3922 depicts radiation intensity vs. time of the second energy beam that irradiates location D. A time gap exists between sections 3921 and 3922 in the example shown in FIG. 39. However, in other examples, successive intensity vs. time sections contact each other such that there is no time gap therebetween. Section 3931 depicts radiation intensity vs. time of the third energy beam that irradiates location E, and Section 3932 depicts radiation intensity vs. time of the third energy beam that irradiates location F. The first and the second energy beams can irradiate locations A in portion 3901 and C in portion 3902 simultaneously, and B in portion 3901 and D in portion 3902 simultaneously (e.g., t₁=t′₁ and t₂=t′₂), such as when the debris generated by the irradiation in one portion (e.g., 3902) does not obstruct the irradiation in the other location (e.g., 3901), to form a requested 3D object printed with prescribed radiation intensity. This can happen, e.g., when the debris does not (e.g., substantially) spread from portion 3901 to 3902 and from 3902 to 3901, while the debris is carried away from locations A, B, C and D along vector 3905. The first and the second energy beams can irradiate locations A and C sequentially, and B and D sequentially (e.g., t′₁>t₃ and t′2>>t₃), when any generated debris is carried away from above portion 3901 and 3902 by the gas flow along vector 3905. The third energy beam may potentially be directed to irradiation locations E and F after the first energy beam ceased to irradiate any location in portion 3901 of the material bed layer, as any generation of debris from irradiation portion 3901 by the first energy beam has a potential for disposition along the optical path of the third energy beam targeting locations E or F in portion 3903, e.g., when the debris generated by the first energy beam will be carried by the gas flow along vector 3905 in the direction from portion 3901 to portion 3903 (e.g., t₁>t₃). The third energy beam can be directed to irradiation locations E and F after the second energy beam ceased to irradiate any location in portion 3902 of the material bed layer, when any generation of debris from irradiation portion 3902 by the second energy beam has a potential for disposition along the optical path of the third energy beam targeting locations E or F in portion 3903, e.g., when the debris generated by the second energy beam will be carried by the gas flow along vector 3905 in the direction from portion 3901 to portion 3903 (e.g., t*₁>t′₃). The fourth energy beam may potentially be directed to irradiation locations G and H after the second energy beam ceased to irradiate any location in portion 3902 of the material bed layer, as any generation of debris from irradiation portion 3902 by the second energy beam has a potential for disposition along the optical path of the fourth energy beam targeting locations G or H in portion 3904, e.g., when the debris generated by the second energy beam will be carried by the gas flow along vector 3905 in the direction from portion 3902 to portion 3904. The fourth energy beam can be directed to irradiation locations G and H after the first energy beam ceased to irradiate any location in portion 3901 of the material bed layer, when any generation of debris from irradiation portion 3901 by the first energy beam has a potential for disposition along the optical path of the fourth energy beam targeting G and H in portion 3904, e.g., when the debris generated by the first energy beam will be carried by the gas flow along vector 3905 in the direction from portion 3901 to portion 3904, e.g., due to spreading of the debris as it is carried away by the gas flow along vector 3905. The third and the fourth energy beams can irradiate locations E in portion 3903 and G in portion 9304 simultaneously, and F in portion 3903 and H in portion 3904 simultaneously, e.g., when the debris generated by the irradiation in one portion (e.g., 3903) does not obstruct the irradiation of the other location in the other portion (e.g., 3904), to form a requested 3D object printed with prescribed radiation intensity. The third and the fourth energy beams can irradiate locations E in portion 3903 and G in portion 9304 sequentially. The third and the fourth energy beams can irradiate locations F in portion 3903 and H in portion 3904 sequentially.

In some embodiments, one or more controllers are disposed on a printed circuit board (PCB). For example, two controllers may be disposed on a PCB. In some embodiments, one or more energy beam (e.g., laser) may be controlled by one or more controllers disposed on a PCB board. For example, a controller that controls an energy beam (e.g., laser) can be disposed on a PCB board. For example, a controller that controls a plurality of energy beams (e.g., lasers) can be disposed on a PCB board. For example, a plurality of controllers that control a plurality of energy beams (e.g., lasers) can be disposed on one PCB board. For example, two controllers that each controls a different energy beam (e.g., laser) can be disposed on one PCB. At times, the 3D printer comprises a plurality of energy beams (e.g., at least 2, 4, 6, 8, 10, 12, 14, 16, 24, 32, or 38 energy beams). In some embodiments, a plurality of PCBs include controllers that control the plurality of energy beams. At least two energy beams may be controlled by one controller. In some embodiments, a controller controls an energy beam. For example, for a system controlling eight energy beams, there may be fours PCBs, each including two controllers that each control an energy beam. To synchronize commands to the energy beams that participate in printing a single layer in a build cycle, the PCBs should be synchronized. Synchronization between the BCPs may include clock synchronization. In some embodiments, each PCB comprises its own clock (e.g., crystal oscillation-based clock). In some embodiments, the PCBs are synchronized with respect to a global clock.

In some embodiments, the controller facilitates alignment of energy beams with respect to time. For example, operation of the energy beams is aligned with respect to time. For example, operations of controllers (e.g., residing in different control boards) is aligned with respect to time. For example, operation of circuit boards are aligned with respect to time, the circuit boards facilitating control of the energy beam, e.g., respectively. The timing synchronization may comprise interlocks such as synchronizing barriers. The synchronization may be implemented using software. In some embodiments, an alignment (e.g., timing alignment) of respective controllers for a first energy beam and a second energy beam can be implemented utilizing interlock(s), e.g., utilizing synchronizing barriers. Interlock(s) can be implemented at each controller to enforce a condition for releasing the controller to proceed to a next step (e.g., a next irradiation task). For example, a condition may be waiting for at least one other controller of another energy beam to engage its respective interlock. For example, a condition may be waiting for respective controllers of the energy beams to each engage its respective interlock.

In some embodiments, optical calibration marks are generated in situ and in real-time during a printing cycle. For example, the calibration marks can be generated after generating a layer as part of the material bed, and before transforming at least a portion of the material bed to form at least a portion of one or more 3D objects.

At times, the energy beam generates calibration marks by transforming at least a portion of the material bed, e.g., by transforming at least a portion of a pre-transformed material. The transformation may generate visibly transformed material, e.g., to facilitate their detection by the detector(s) (e.g., camera(s)). The calibration marks comprising the transformed material may be referred to as “dust markers”. These calibration marks may comprise transformed material that is not fully fused (e.g., sintered). These calibration marks may comprise clumped up, or agglomerated, material. The visibly transformed material may be in an agglomerate form that can be attracted by a layer dispensing mechanism, e.g., by the material removal mechanism as part of the layer dispensing mechanism. At times, the energy beam generates calibration marks that are optical calibration marks and are devoid of (e.g., do not comprise) transformed material. The calibration marks generated by transformation may be generated at the end of the printing cycle (e.g., at the end of a built).

At times, the scanner that facilitates translation of the energy beam across the material and/or controller(s) thereof utilizes one coordinate system, and the program instructions (e.g., software) facilitating alignment of the detected calibration marks with their expected positions uses another coordinate system. The calibration marks can be detected by one or more detectors (e.g., cameras). The detector (e.g., camera) may capture a 2D image of the calibration marks (e.g., of the material bed having the calibration marks). The scanner may use mirrors (e.g., two mirrors) to spatially direct an energy beam along the exposed surface of the material bed. For example, the scanner (e.g., galvanometer scanner) and/or controller(s) thereof may use angular coordinates to move the two mirrors of the scanner (e.g., alpha angles for a first mirror and beta angles for the second mirror), and the alignment program instructions (e.g., alignment software module) uses a Cartesian coordinate system. A coordinate translation model may be utilized for translation between the angular to Cartesian coordinate system (e.g., from one coordination system to the other, and/or vice versa). The energy beam may be used (i) to form the calibration marks (e.g., optical and/or transformed material calibration marks) and/or (ii) to generate the 3D object(s). The coordinate translation model may comprise transformation of Cartesian coordinate system into an angular coordinate system for the scanner mirrors. (e.g., for the hardware of the controller(s) that controls the energy beam scanners (e.g., galvanometer scanners)). The coordination translation model may utilize a plurality of parameters. The value of the parameters is determined by aligning the projected positions of the markers with the actual (e.g., detected) position of the markers. The position of the markers may be determined relative to a rim (e.g., circumference) of the material bed. The exposed surface of the material bed may be elliptical (e.g., circular) or rectangular (e.g., square). In some embodiments, the exposed surface of the material bed is circular.

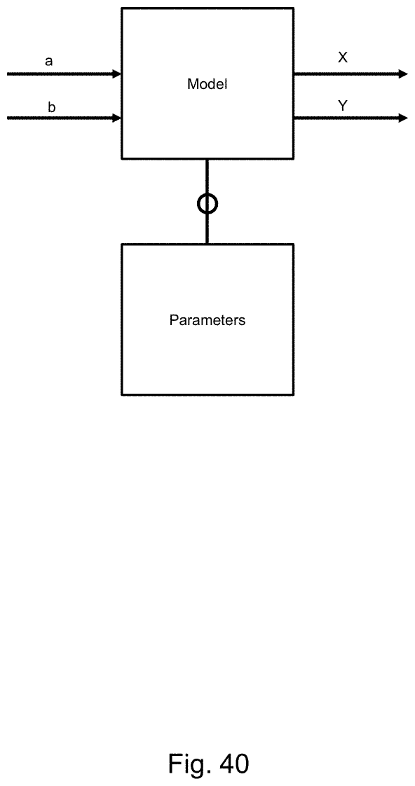

FIG. 40 shows an example of parameter conversion from angular coordinates (e.g., using alpha and beta to another (e.g., cartesian) coordinate system using X and Y. The model comprises linked Parameter set. The parameter set can comprise at least 2, 5, 10, 15, 20, or 50 parameters. The parameters can be initially estimated. The parameter estimation can be corroborated, or altered, using the measured calibration marks. The calibrated model can subsequently be used to direct the energy beam(s) to print the 3D object. The usage of the model for directing the energy beams(s) can be by one or more controllers (e.g., by the control system).

In some instances, the computer system includes a user interface. The computer system can include, or be in communication with, an electronic display unit that comprises a user interface (UI) for providing, for example, a model design or graphical representation of an object to be printed. Examples of UI's include a graphical user interface (GUI) and web-based user interface. The historical and/or operative data may be displayed on a display unit. The computer system may store historical data concerning various aspects of the operation of the cleaning system. The historical data may be retrieved at predetermined times and/or at a whim. The historical data may be accessed by an operator and/or by a user. The display unit (e.g., monitor) may display various parameters of the printing system (as described herein) in real-time or in a delayed time. The display unit may display the requested printed 3D object (e.g., according to a model), the printed 3D object, real-time display of the 3D object as it is being printed, or any combination thereof. The display unit may display the cleaning progress of the object, or various aspects thereof. The display unit may display at least one of the total time, time remaining, and time expanded on the cleaned object during the cleaning process. The display unit may display the status of sensors, their reading, and/or time for their calibration or maintenance. The display unit may display the type or types of material used and various characteristics of the material or materials such as temperature and flowability of the pre-transformed material. The display unit may display the amount of a certain gas in the chamber. The gas may comprise an oxidizing gas (e.g., oxygen), hydrogen, water vapor, or any of the gasses mentioned herein. The gas may comprise a reactive agent. The display unit may display the pressure in the chamber. The computer may generate a report comprising various parameters of the methods, objects, apparatuses, or systems described herein. The report may be generated at predetermined time(s), on a request (e.g., from an operator) or at a whim.

Methods, apparatuses, and/or systems of the present disclosure can be implemented by way of one or more computational schemes. A computational scheme can be implemented by way of software upon execution by one or more computer processors. For example, the processor can be programmed to calculate the path of the energy beam and/or the power per unit area emitted by the energy source (e.g., that should be provided to the material bed in order to achieve the requested result). Examples of control and/or computational schemes, 3D printers, related control system, related methods, apparatuses, systems, and program instructions (e.g., software), can be found in International Patent Application Serial No. PCT/US17/18191, filed Feb. 16, 2017, titled “ACCURATE THREE-DIMENSIONAL PRINTING;” which is incorporated herein by reference in its entirety.

In some embodiments, the 3D printer comprises and/or communicates with a plurality of processors. The processors may form a network architecture. The 3D printer may comprise at least one processor (referred herein as the “3D printer processor”). The 3D printer may comprise a plurality of processors. At least two of the plurality of the 3D printer processors may interact with each other. At times, at least two of the plurality of the 3D printer processors may not interact with each other.

In some embodiments, a 3D printer processor interacts with at least one processor that acts as a 3D printer interface (also referred to herein as “machine interface processor”). The processor (e.g., machine interface processor) may be stationary or mobile. The processor may be a remote computer systems. The machine interface one or more processors may be connected to at least one 3D printer processor. The connection may be through a wire (e.g., cable) and/or be wireless (e.g., via Bluetooth technology). The machine interface may be hardwired to the 3D printer. The machine interface may directly connect to the 3D printer (e.g., to the 3D printer processor). The machine interface may indirectly connect to the 3D printer (e.g., through a server, or through wireless communication). The cable may comprise coaxial cable, shielded twisted cable pair, unshielded twisted cable pair, structured cable (e.g., used in structured cabling), or fiber-optic cable.

In some embodiments, the machine interface processor directs 3D print job production, 3D printer management, 3D printer monitoring, or any combination thereof. The machine interface processor may not be able to influence (e.g., direct, or be involved in) pre-print or 3D printing process development. The machine management may comprise controlling the 3D printer controller (e.g., directly or indirectly). The printer controller may direct start (e.g., initiation) of a 3D printing process, stopping a 3D printing process, maintenance of the 3D printer, clearing alarms (e.g., concerning safety features of the 3D printer).

In some embodiments, the machine interface processor allows monitoring of the 3D printing process (e.g., accessible remotely or locally). The machine interface processor may allow viewing a log of the 3D printing and status of the 3D printer at a certain time (e.g., 3D printer snapshot). The machine interface processor may allow to monitor one or more 3D printing parameters. The one or more printing parameters monitored by the machine interface processor can comprise 3D printer status (e.g., 3D printer is idle, preparing to 3D print, 3D printing, maintenance, fault, or offline), active 3D printing (e.g., including a build module number), status and/or position of build module(s), status of build module and processing chamber engagement, type and status of pre-transformed material used in the 3D printing (e.g., amount of pre-transformed material remaining in the reservoir), status of a filter, atmosphere status (e.g., pressure, gas level(s)), ventilator status, layer dispensing mechanism status (e.g., position, speed, rate of deposition, level of exposed layer of the material bed), status of the optical system (e.g., optical window, mirror), status of scanner, alarm (boot log, status change, safety events, motion control commands (e.g., of the energy beam, or of the layer dispensing mechanism), or printed 3D object status (e.g., what layer number is being printed),

In some embodiments, the machine interface processor allows controlling (e.g., monitoring) the 3D print job management. The 3D print job management may comprise status of each build enclosure, e.g., atmosphere condition, power levels of the energy beam, type of pre-transformed material loaded, 3D printing operation diagnostics, status of a filter, or the like. The machine interface processor (e.g., output device thereof) may allow viewing and/or editing any of the job management and/or one or more printing parameters. The machine interface processor may show the permission level given to the user (e.g., view, or edit). The machine interface processor may allow prioritize 3D objects to be printed, pause 3D objects during 3D printing, delete 3D objects to be printed, select a certain 3D printer for a particular 3D printing job, insert and/or edit considerations for restarting a 3D printing job that was removed from 3D printer. The machine interface processor may allow initiating, pausing, and/or stopping a 3D printing job. The machine interface processor may output message notification (e.g., alarm), log (e.g., other than Excursion log or other default log), or any combination thereof.

In some embodiments, the 3D printer interacts with at least one server (e.g., print server). The 3D print server may be separate or interrelated in the 3D printer. One or more users may interact with the one or more 3D printing processors through one or more user processors (e.g., respectively). The interaction may be in parallel and/or sequentially. The users may be clients. The users may belong to entities that request a 3D object to be printed, or entities who prepare the 3D object printing instructions. The one or more users may interact with the 3D printer (e.g., through the one or more processors of the 3D printer) directly and/or indirectly. Indirect interaction may be through the server. One or more users may be able to monitor one or more aspects of the 3D printing process. One or more users can monitor aspects of the 3D printing process through at least one connection (e.g., network connection). For example, one or more users can monitor aspects of the printing process through direct or indirect connection. Direct connection may be using a local area network (LAN), and/or a wide area network (WAN). The network may interconnect computers within a limited area (e.g., a building, campus, neighborhood). The limited area network may comprise Ethernet or Wi-Fi. The network may have its network equipment and interconnects locally managed. The network may cover a larger geographic distance than the limited area. The network may use telecommunication circuits and/or internet links. The network may comprise Internet Area Network (IAN), and/or the public switched telephone network (PSTN). The communication may comprise web communication. The aspect of the 3D printing process may comprise a 3D printing parameter, machine status, or sensor status. The 3D printing parameter may comprise hatch strategy, energy beam power, energy beam speed, energy beam focus, thickness of a layer (e.g., of hardened material or of pre-transformed material).

In some embodiments, a user develops at least one 3D printing instruction and directs the 3D printer (e.g., through communication with the 3D printer processor) to print in a requested manner according to the developed at least one 3D printing instruction. A user may or may not be able to control (e.g., locally or remotely) the 3D printer controller, e.g., depending on permission preferences. For example, a client may not be able to control the 3D printing controller (e.g., maintenance of the 3D printer).

In some embodiments, the user (e.g., other than a client) processor may use real-time and/or historical 3D printing data of one or more 3D printers. The 3D printing data may comprise metrology data. The user processor may comprise quality control. The quality control may use a statistical method (e.g., statistical process control (SPC)). The user processor may log excursion log, report when a signal deviates from the nominal level, or any combination thereof. The user processor may generate a configurable response. The configurable response may comprise a print/pause/stop command (e.g., automatically) to the 3D printer (e.g., to the 3D printing processor). The configurable response may be based on a user defined parameter, threshold, or any combination thereof. The configurable response may result in a user defined action. The user processor may control the 3D printing process and ensure that it operates at its full potential. For example, at its full potential, the 3D printing process may make a maximum number of 3D object with a minimum of waste and/or 3D printer down time. The SPC may comprise a control chart, design of experiments, and/or focus on continuous improvement.

Examples. The following are illustrative and non-limiting examples of methods of the present disclosure.

Example 1: In a 25 cm by 25 cm by 30 cm container at ambient temperature and pressure, Inconel 718 powder of average particle size 32 □m is deposited to form a powder bed. A 200 W 1060 nm fiber-laser beam fabricated a plurality of rectangular 3D objects comprising elongated surfaces of approximate dimensions 6 mm by 30 mm, 3D objects were formed by melting respective portions of the powder bed. The fabricated 3D objects were anchorlessly suspended in the powder bed during and after their fabrication. The surfaces expressed various degrees of warping as depicted in FIG. 19 (e.g., 1903, 1904, and 1905). A visible light emitting diode projected a sine wave on the exposed surface of the powder bed containing these surfaces, visibly showing their planarity or the degree of deviation from planarity of various portions of the surfaces. The deviation may be correlated to the manner (e.g., magnitude and direction) of deviation from the expected projection of the oscillating light (e.g., 1901 and 1902) or lack thereof. The portion of the powder bed containing the surfaces was imaged by a 4 Mega pixel complementary metal-oxide-semiconductor (CMOS) camera. The sine wave image on the camera has a periodicity of approximately 16 pixels.

Example 2: In a processing chamber at ambient atmosphere and temperature, and at a pressure of about 3,000 Pa above atmospheric pressure, a planar 3D object made of Inconel 718 was disposed above a base, which planar 3D object was 6 mm wide, 25 mm long, and 770 micrometers thick. A 400 W fiber 1060 nm laser beam fabricated a series of tiles as follows: (a) a planar exposed surface of the 3D object was irradiated with a defocused Gaussian beam of cross section diameter of about 0.5 mm (measured at 1/e² of the Gaussian beam) during dwell time t₁, to form a first tile (e.g., FIG. 35, 3501); (b) the laser beam translated to the position of the future second tile during intermission time t₂; and (c) the energy beam irradiated at the second position during dwell time t₂ to form the second tile (e.g., FIG. 35, 3502). Steps (a)-(c) were repeated while the energy beam moved along a predetermined trajectory with predetermined dwell time scheme (e.g., using open loop control) to form the tiled surface shown in FIG. 35 as a top view that depicts a series of (e.g., substantially) identical tiles. The delay time t₂ was (e.g., substantially) constant during the formation of the tiled surface. The dwell times (e.g., t1 and t3) were varied to predetermined times to form melt pools of (e.g., substantially) constant dimensions. This was done while overcoming the pre-heating effect of previously formed melt pools, as well as edge effects at the edge of the melt pool array. The 3D object was not anchored to the base during irradiation of the laser. The power of the laser stayed (e.g., substantially) constant during its irradiation. FIG. 35 was imaged by a 2 Mega pixel charge-coupled device (CCD) camera under an optical microscope.

While preferred embodiments of the present disclosure have been shown and described herein, it will be obvious to those skilled in the art that such embodiments are provided by way of example only. It is not intended that the present disclosure be limited by the specific examples provided within the specification. While the present disclosure has been described with reference to the aforementioned specification, the descriptions and illustrations of the embodiments herein are not meant to be construed in a limiting sense. Numerous variations, changes, and substitutions will now occur to those skilled in the art without departing from the present disclosure. Furthermore, it shall be understood that all aspects of the present disclosure are not limited to the specific depictions, configurations, or relative proportions set forth herein which depend upon a variety of conditions and variables. It should be understood that various alternatives to the embodiments of the present disclosure described herein may be employed in practicing the present disclosure. It is therefore contemplated that the present disclosure shall also cover any such alternatives, modifications, variations, or equivalents. It is intended that the following claims define the scope of the present disclosure and that methods and structures within the scope of these claims and their equivalents be covered thereby.

What is claimed is:

1. A device for three-dimensional printing, the device comprising: at least three components comprising (i) a first projector, (ii) a second projector, (iii) a first detector or (iv) a second detector, the device being configured to detect at least one optical variation corresponding to a physical variation in uniformity of an exposed surface of a material bed utilized in the three-dimensional printing, the material bed supported by a build platform;
each of the at least three components is separated by at least one gap;
the first projector configured to project a first light pattern on the exposed surface of the material bed;
the second projector configured to project a second light pattern on the exposed surface of the material bed;
the first detector configured to optically detect (A) at least a first portion of the first light pattern appearing on the exposed surface and (B) a first variation between the first portion of the first light pattern detected and a corresponding at least the first portion of the first light pattern projected, the first variation corresponding to variation in uniformity of the exposed surface, the first detector disposed adjacent to the build platform; and
the second detector configured to optically detect (1) at least a second portion of the second light pattern appearing on the exposed surface and (II) a second variation between the first portion of the first light pattern detected and a corresponding at least the second portion of the second light pattern projected, the second variation corresponding to variation in uniformity of the exposed surface, the second detector disposed adjacent to the build platform.

2. The device of claim 1, wherein the device comprises (i) the first projector, (ii) the first detector and (iii) the second detector.

3. The device of claim 2, wherein the first detector is distanced from the second detector by the at least one gap such that during optical detection the device optically detects the exposed surface without becoming saturated.

4. The device of claim 1, wherein the device comprises (i) the first projector, (ii) the second projector, and (iii) the first detector.

5. The device of claim 4, wherein the first projector is distanced from the second projector by the at least one gap such that during optical detection the device is configured to optically detects the exposed surface without becoming saturated.

6. The device of claim 1, wherein at least two of the at least three components are symmetrically related to each other in a symmetrical relationship; and optionally wherein (I) symmetrically related to each other is through a third component of the at least three components, (II) the symmetrical relationship comprises a mirror plane, a C₂ rotational symmetry, or an inversion symmetry point, or (III) a combination of (I) and (II).

7. The device of claim 1, wherein the first detector and/or the second detector, is configured to differentiate between uniformity along a length and/or a width of the material bed.

8. The device of claim 1, wherein the device is part of, or is operatively coupled to, a three-dimensional printing system utilized in the three-dimensional printing.

9. The device of claim 1, wherein the at least three components are disposed successively along a direction; and optionally wherein the at least three components are disposed successively in a single file.

10. The device of claim 1, wherein the at least three components are disposed in a plane (i) above to the build platform, (ii) parallel or substantially parallel to the build platform, (iii) among optical windows configured to project energy beams to form at least one three-dimensional object above the build platform during the three-dimensional printing, or (iv) any combination of (i) (ii) and (iii); and wherein above is in a direction opposite to a gravitational center of an external environment to a three-dimensional printing system comprising the build platform, and the optical windows.

11. The device of claim 1, wherein the light pattern projected comprises a repeating unit.

12. The device of claim 1, wherein the device is included in, or is operatively coupled to, a three-dimensional printing system configured for the three-dimensional printing comprising generating one or more melt pools and controlling a temperature of a melt pool of the one or more melt pools.

13. The device of claim 12, wherein the three-dimensional printing system is configured to (A) control the temperature of the melt pool (1) in real time during the three-dimensional printing and/or (II) utilizing feed forward control using a physics model of at least one process as part of the three-dimensional printing.

14. The device of claim 12, wherein (A) the three-dimensional printing system is configured to communicate between (I) a processor disposed at the three-dimensional printing site and (II) a processor disposed remotely and separate from the three-dimensional printing site; and/or (B) the device is configured to operatively couple to a layer dispensing mechanism that comprises, or that is operatively coupled to, a cyclonic separator.

15. The device of claim 1, wherein the device is configured to facilitate synchronizing energy beams utilized for the three-dimensional printing using (i) visible markers and/or (ii) markers removable by a layer dispensing mechanism utilized to dispense the material bed; and wherein synchronizing is of (I) the energy beams with respect to each other, (II) each of the energy beams with respect to its controller, and/or (III) each of the energy beams with respect to its scanner, the device being configure to facilitate the synchronization at least in part by using the first detector and/or the second detector.

16. The device of claim 1, wherein the material bed is disposed in an enclosure comprising an atmosphere including (i) a positive pressure above an ambient pressure external to the enclosure and/or (ii) a reactive species at a level below its level in an ambient atmosphere external to the enclosure, which reactive species reacts with pre-transformed material during printing; wherein the device is configured to operate during the three-dimensional printing; optionally wherein the reactive species comprises oxygen or water; optionally wherein the atmosphere of the enclosure comprises an inert gas; and optionally wherein the inert gas comprises argon or nitrogen.

17. The device of claim 1, wherein the at least one gap comprises (i) two gaps that are of the same distance or substantially of the same distance or (ii) two different gaps of two different distances.

18. A method for three-dimensional printing, the method comprising executing one or more operations associated with at least one configuration of the device of claim 1.

19. An apparatus for three-dimensional printing, the apparatus comprising at least one controller comprising a power connector, the at least one controller being configured (i) operatively couple to the device of claim 1, and (ii) direct executing one or more operations associated with at least one configuration of the device; and optionally wherein the power connector comprises an electrical inlet or an electrical outlet.

20. Non-transitory computer readable program instructions for three-dimensional printing, the non-transitory computer readable program instructions, when read by one or more processors operatively coupled to the device of claim 1, cause the one or more processors to direct executing one or more operations associated with at least one configuration of the device, the non-transitory computer readable program instructions being inscribed on a medium or on media.
